(19) United States
(12) Patent Application Publication
(10) Pub. No.: US 2026/0043484 A1
(43) Pub. Date: Feb. 12, 2026

(54) FLUID CIRCUIT SYSTEM

(71) Applicant: DENSO CORPORATION, Kariya-city (JP)

(72) Inventor: Tetsuma TAKEDA, Kariya-city (JP)

(21) Appl. No.: 19/365,626

(22) Filed: Oct. 22, 2025

Related U.S. Application Data
(63) Continuation of application No. PCT/JP2024/015642, filed on Apr. 19, 2024.

(30) Foreign Application Priority Data
Apr. 28, 2023 (JP) 2023-074717

(51) Int. Cl. F16K 11/056; B60L 58/24

(52) U.S. Cl. CPC F16K 11/056; B60L 58/24

(57) ABSTRACT

A fluid circuit system for guiding a fluid to a plurality of connection devices includes a fluid circuit and a plurality of valve devices. The plurality of valve devices each have a multi-way valve structure including a housing in which an inlet and an outlet are formed, and a valve member, and guide the fluid to a necessary connection device and prohibit the fluid from flowing to an unnecessary connection device. A flow of the fluid to an unnecessary inlet and an unnecessary outlet in an open state in a predetermined valve device among the plurality of valve devices is prohibited by closing the inlet and the outlet of a valve device different from the predetermined valve device among the plurality of valve devices.

### CROSS REFERENCE TO RELATED APPLICATION

The present application is a continuation application of International Patent Application No. PCT/JP2024/015642 filed on Apr. 19, 2024, which designated the U.S. and claims the benefit of priority from Japanese Patent Application No. 2023-074717 filed on Apr. 28, 2023. The entire disclosures of all of the above applications are incorporated herein by reference.

### TECHNICAL FIELD

The present disclosure relates to a fluid circuit system.

### BACKGROUND

A fluid circuit system has been used in various apparatuses such as an electric vehicle.

### SUMMARY

According to one aspect of the present disclosure, a fluid circuit system is configured to guide fluid to a plurality of connection devices. The fluid circuit system comprises: a fluid circuit configured to allow fluid to flow therethrough; and a plurality of valve devices configured to switch flow of fluid through the fluid circuit. Each of the valve devices includes a housing defining an inlet for introducing fluid and an outlet for discharging fluid, and a valve member accommodated inside the housing and configured to open and close the inlet and the outlet. Each of the valve devices has a multi-way valve structure defining inlets including the inlet and outlets including the outlet. Each of the valve devices is switchable between guiding fluid by the valve member to the connection device that requires fluid to flow and prohibiting fluid by the valve member from flowing to the connection device that does not require fluid to flow. An unnecessary inlet may be the inlet, which is connected to the connection device that does not require fluid to flow. An unnecessary outlet may be the outlet, which is connected to the connection device that does not require fluid to flow. One of the valve devices, which is different from a predetermined valve device among the valve devices, may be configured to close the inlet and the outlet to prohibit flow of fluid to the unnecessary inlet of the predetermined valve device in an open state and the unnecessary outlet of the predetermined valve device in the open state.

### BRIEF DESCRIPTION OF THE DRAWINGS

The above and other objects, features and advantages of the present disclosure will become more apparent from the following detailed description made with reference to the accompanying drawings. In the drawings:

FIG. 1 is an overall configuration diagram of a temperature control device to which a fluid circuit system according to a first embodiment is applied;

FIG. 2 is a diagram illustrating a refrigeration cycle provided in the temperature control device according to the first embodiment;

FIG. 3 is an external view of a first multi-way valve according to the first embodiment;

FIG. 4 is an external view of a second multi-way valve according to the first embodiment;

FIG. 5 is an external view of a third multi-way valve according to the first embodiment;

FIG. 6 is a cross-sectional view of the second multi-way valve according to the first embodiment;

FIG. 7 is a diagram illustrating a second fixed disk according to the first embodiment;

FIG. 8 is a partial cross-sectional view of a second movable disk according to the first embodiment;

FIG. 9 is a diagram illustrating a second through hole and a second communication hole of the second movable disk according to the first embodiment;

FIG. 10 is a diagram illustrating a state in which the second through hole and the second communication hole communicate with a flow hole of the second fixed disk according to the first embodiment;

FIG. 11 is a diagram illustrating a first fixed disk according to the first embodiment;

FIG. 12 is a diagram illustrating a first through hole and a first communication hole of a first movable disk according to the first embodiment;

FIG. 13 is a diagram illustrating a third fixed disk according to the first embodiment;

FIG. 14 is a diagram illustrating a third through hole and a third communication hole of a third movable disk according to the first embodiment;

FIG. 15 is a diagram illustrating a flow of a coolant flowing through the fluid circuit system when the temperature control device operates in a 1-1 mode;

FIG. 16 is a diagram illustrating a flow of the coolant flowing through the fluid circuit system when the temperature control device operates in a 1-2 mode;

FIG. 17 is a diagram illustrating a flow of the coolant flowing through the fluid circuit system when the temperature control device operates in a 1-3 mode;

FIG. 18 is a diagram illustrating a flow of the coolant flowing through the fluid circuit system when the temperature control device operates in a 1-4 mode;

FIG. 19 is a diagram illustrating a flow of the coolant flowing through the fluid circuit system when the temperature control device operates in a 1-5 mode;

FIG. 20 is a diagram illustrating a flow of the coolant flowing through the fluid circuit system when the temperature control device operates in a 1-6 mode;

FIG. 21 is a diagram illustrating a comparative second fixed disk;

FIG. 22 is a diagram illustrating a second through hole and a second communication hole of the comparative second movable disk;

FIG. 23 is a diagram illustrating a comparative third fixed disk;

FIG. 24 is a diagram illustrating a relative position of the first movable disk with respect to the first fixed disk, a relative position of the comparative second movable disk with respect to the comparative second fixed disk, and a relative position of the third movable disk with respect to the comparative third fixed disk when the temperature control device operates in the 1-1 mode;

FIG. 25 is a diagram illustrating a relative position of the first movable disk with respect to the first fixed disk, a relative position of the comparative second movable disk with respect to the comparative second fixed disk, and a relative position of the third movable disk with respect to the comparative third fixed disk when the temperature control device operates in the 1-2 mode;

FIG. 26 is a diagram illustrating a relative position of the first movable disk with respect to the first fixed disk, a relative position of the comparative second movable disk with respect to the comparative second fixed disk, and a relative position of the third movable disk with respect to the comparative third fixed disk when the temperature control device operates in the 1-3 mode;

FIG. 27 is a diagram illustrating a relative position of the first movable disk with respect to the first fixed disk, a relative position of the comparative second movable disk with respect to the comparative second fixed disk, and a relative position of the third movable disk with respect to the comparative third fixed disk when the temperature control device operates in the 1-4 mode;

FIG. 28 is a diagram illustrating a relative position of the first movable disk with respect to the first fixed disk, a relative position of the comparative second movable disk with respect to the comparative second fixed disk, and a relative position of the third movable disk with respect to the comparative third fixed disk when the temperature control device operates in the 1-5 mode;

FIG. 29 is a diagram illustrating a relative position of the first movable disk with respect to the first fixed disk, a relative position of the comparative second movable disk with respect to the comparative second fixed disk, and a relative position of the third movable disk with respect to the comparative third fixed disk when the temperature control device operates in the 1-6 mode;

FIG. 30 is a diagram illustrating a relative position of the first movable disk with respect to the first fixed disk, a relative position of the second movable disk with respect to the second fixed disk, and a relative position of the third movable disk with respect to the third fixed disk when the temperature control device operates in the 1-1 mode;

FIG. 31 is a diagram illustrating that an unnecessary outlet of the second multi-way valve is closed by the first multi-way valve when the temperature control device operates in the 1-1 mode;

FIG. 32 is a diagram illustrating a relative position of the first movable disk with respect to the first fixed disk, a relative position of the second movable disk with respect to the second fixed disk, and a relative position of the third movable disk with respect to the third fixed disk when the temperature control device operates in the 1-2 mode;

FIG. 33 is a diagram illustrating that an unnecessary outlet of the second multi-way valve is closed by the first multi-way valve when the temperature control device operates in the 1-2 mode;

FIG. 34 is a diagram illustrating a relative position of the first movable disk with respect to the first fixed disk, a relative position of the second movable disk with respect to the second fixed disk, and a relative position of the third movable disk with respect to the third fixed disk when the temperature control device operates in the 1-3 mode;

FIG. 35 is a diagram illustrating that the unnecessary outlet of the second multi-way valve is closed by the first multi-way valve when the temperature control device operates in the 1-3 mode;

FIG. 36 is a diagram illustrating a relative position of the first movable disk with respect to the first fixed disk, a relative position of the second movable disk with respect to the second fixed disk, and a relative position of the third movable disk with respect to the third fixed disk when the temperature control device operates in the 1-4 mode;

FIG. 37 is a diagram illustrating that no fluid flows through an unnecessary inlet and an unnecessary outlet of the second multi-way valve when the temperature control device operates in the 1-4 mode;

FIG. 38 is a diagram illustrating a relative position of the first movable disk with respect to the first fixed disk, a relative position of the second movable disk with respect to the second fixed disk, and a relative position of the third movable disk with respect to the third fixed disk when the temperature control device operates in the 1-5 mode;

FIG. 39 is a diagram illustrating that an unnecessary outlet of the second multi-way valve is closed by the second multi-way valve when the temperature control device operates in the 1-5 mode;

FIG. 40 is a diagram illustrating a relative position of the first movable disk with respect to the first fixed disk, a relative position of the second movable disk with respect to the second fixed disk, and a relative position of the third movable disk with respect to the third fixed disk when the temperature control device operates in the 1-6 mode;

FIG. 41 is a diagram illustrating a flow of the coolant flowing through the fluid circuit system when the temperature control device operates in the 1-6 mode;

FIG. 42 is an overall configuration diagram of a temperature control device to which a fluid circuit system according to a second embodiment is applied;

FIG. 43 is a diagram illustrating an operation of a first multi-way valve according to the second embodiment;

FIG. 44 is a diagram illustrating an operation of a second multi-way valve according to the second embodiment;

FIG. 45 is a diagram illustrating an operation of a third multi-way valve according to the second embodiment;

FIG. 46 is a diagram illustrating a fourth through hole and a fourth communication hole of a fourth fixed disk according to the second embodiment;

FIG. 47 is a diagram illustrating an operation of a fourth multi-way valve according to the second embodiment;

FIG. 48 is a diagram illustrating a fifth through hole and a fifth communication hole of a fifth fixed disk according to the second embodiment;

FIG. 49 is a diagram illustrating an operation of a fifth multi-way valve according to the second embodiment;

FIG. 50 is a diagram illustrating a flow of a coolant flowing through the fluid circuit system when the temperature control device operates in a 2-1 mode;

FIG. 51 is a diagram illustrating a flow of the coolant flowing through the fluid circuit system when the temperature control device operates in a 2-2 mode;

FIG. 52 is a diagram illustrating a flow of the coolant flowing through the fluid circuit system when the temperature control device operates in a 2-3 mode;

FIG. 53 is a diagram illustrating a flow of the coolant flowing through the fluid circuit system when the temperature control device operates in a 2-4 mode;

FIG. 54 is a diagram illustrating a relative position of a comparative second movable disk with respect to a second fixed disk when the temperature control device operates in the 2-1 mode;

FIG. 55 is a diagram illustrating a relative position of the comparative second movable disk with respect to the second fixed disk when the temperature control device operates in the 2-2 mode;

FIG. 56 is a diagram illustrating a relative position of the comparative second movable disk with respect to the second fixed disk when the temperature control device operates in the 2-3 mode;

FIG. 57 is a diagram illustrating a relative position of the comparative second movable disk with respect to the second fixed disk when the temperature control device operates in the 2-4 mode;

FIG. 58 is a diagram illustrating a relative position of a first movable disk with respect to a first fixed disk, a relative position of the second movable disk with respect to the second fixed disk, and a relative position of a third movable disk with respect to a third fixed disk when the temperature control device operates in the 2-1 mode;

FIG. 59 is a diagram illustrating that an unnecessary outlet of a second multi-way valve is closed by a first multi-way valve when the temperature control device operates in the 2-1 mode;

FIG. 60 is a diagram illustrating a relative position of the first movable disk with respect to the first fixed disk, a relative position of the second movable disk with respect to the second fixed disk, and a relative position of the third movable disk with respect to the third fixed disk when the temperature control device operates in the 2-2 mode;

FIG. 61 is a diagram illustrating that an unnecessary inlet of the second multi-way valve is closed by the first multi-way valve when the temperature control device operates in the 2-2 mode;

FIG. 62 is a diagram illustrating a relative position of the first movable disk with respect to the first fixed disk, a relative position of the second movable disk with respect to the second fixed disk, and a relative position of the third movable disk with respect to the third fixed disk when the temperature control device operates in the 2-3 mode;

FIG. 63 is a diagram illustrating that an unnecessary inlet of the second multi-way valve is closed by the first multi-way valve when the temperature control device operates in the 2-3 mode;

FIG. 64 is a diagram illustrating a relative position of the first movable disk with respect to the first fixed disk, a relative position of the second movable disk with respect to the second fixed disk, and a relative position of the third movable disk with respect to the third fixed disk when the temperature control device operates in the 2-4 mode;

FIG. 65 is an overall configuration diagram of a temperature control device to which a fluid circuit system according to a third embodiment is applied;

FIG. 66 is a diagram illustrating that the second multi-way valve according to the second embodiment can be replaced with a sixth multi-way valve according to the third embodiment;

FIG. 67 is a diagram illustrating a sixth through hole and a sixth communication hole of a sixth fixed disk according to the third embodiment;

FIG. 68 is a diagram illustrating a relative position of a sixth movable disk with respect to the sixth fixed disk when the fluid circuit system executes a first operation;

FIG. 69 is a diagram illustrating a relative position of the sixth movable disk with respect to the sixth fixed disk when the fluid circuit system executes a second operation;

FIG. 70 is a diagram illustrating a relative position of the sixth movable disk with respect to the sixth fixed disk when the fluid circuit system executes a third operation;

FIG. 71 is a diagram illustrating a relative position of the sixth movable disk with respect to the sixth fixed disk when the fluid circuit system executes a fourth operation;

FIG. 72 is an overall configuration diagram of a temperature control device to which a fluid circuit system according to the fourth embodiment is applied;

FIG. 73 is an external view of a fluid control valve according to the fourth embodiment;

FIG. 74 is a cross-sectional view of the fluid control valve according to the fourth embodiment;

FIG. 75 is a front view of a main body of the fluid control valve according to the fourth embodiment;

FIG. 76 is a top view of the main body of the fluid control valve according to the fourth embodiment;

FIG. 77 is a diagram illustrating a valve of the fluid control valve according to the fourth embodiment;

FIG. 78 is a cross-sectional view of the fluid control valve according to the fourth embodiment;

FIG. 79 is a schematic diagram simply illustrating the valve according to the fourth embodiment;

FIG. 80 is a development view of the valve in a circumferential direction according to the fourth embodiment;

FIG. 81 is a diagram illustrating a state before a sealing member according to the fourth embodiment is attached to the main body;

FIG. 82 is a diagram illustrating a state in which the sealing member according to the fourth embodiment is attached to the main body;

FIG. 83 is a diagram illustrating a flow of a coolant flowing through the fluid circuit system when the temperature control device operates in a 3-1 mode;

FIG. 84 is a diagram illustrating a flow of the coolant flowing through the fluid circuit system when the temperature control device operates in a 3-2 mode;

FIG. 85 is a diagram illustrating a flow of the coolant flowing through the fluid circuit system when the temperature control device operates in a 3-3 mode;

FIG. 86 is a diagram illustrating a flow of the coolant flowing through the fluid circuit system when the temperature control device operates in a 3-4 mode;

FIG. 87 is a diagram illustrating a flow of the coolant flowing through the fluid circuit system when the temperature control device operates in a 3-5 mode;

FIG. 88 is a schematic diagram simply illustrating a comparative valve;

FIG. 89 is a development view of the comparative valve in the circumferential direction;

FIG. 90 is a schematic diagram simply illustrating an opening formed in the main body of the fluid control valve according to the fourth embodiment;

FIG. 91 is a diagram illustrating a relative position of the comparative valve with respect to the opening and a relative position of a third movable disk with respect to a third fixed disk when the temperature control device operates in the 3-1 mode;

FIG. 92 is a diagram illustrating a relative position of the comparative valve with respect to the opening and a relative position of the third movable disk with respect to the third fixed disk when the temperature control device operates in the 3-2 mode;

FIG. 93 is a diagram illustrating a relative position of the comparative valve with respect to the opening and a relative position of the third movable disk with respect to the third fixed disk when the temperature control device operates in the 3-3 mode;

FIG. 94 is a diagram illustrating a relative position of the comparative valve with respect to the opening and a relative position of the third movable disk with respect to the third fixed disk when the temperature control device operates in the 3-4 mode;

FIG. 95 is a diagram illustrating a relative position of the comparative valve with respect to the opening and a relative position of the third movable disk with respect to the third fixed disk when the temperature control device operates in the 3-5 mode;

FIG. 96 is a diagram illustrating a relative position of the valve with respect to the opening and a relative position of the third movable disk with respect to the third fixed disk when the temperature control device operates in the 3-1 mode;

FIG. 97 is a diagram illustrating that an unnecessary outlet of the fluid control valve is closed by a third multi-way valve and the fluid control valve when the temperature control device operates in the 3-1 mode;

FIG. 98 is a diagram illustrating a relative position of the valve with respect to the opening and a relative position of the third movable disk with respect to the third fixed disk when the temperature control device operates in the 3-2 mode;

FIG. 99 is a diagram illustrating that no fluid flows through an unnecessary inlet and an unnecessary outlet of the fluid control valve when the temperature control device operates in the 3-2 mode;

FIG. 100 is a diagram illustrating a relative position of the valve with respect to the opening and a relative position of the third movable disk with respect to the third fixed disk when the temperature control device operates in the 3-3 mode;

FIG. 101 is a diagram illustrating that an unnecessary outlet of the fluid control valve is closed by the third multi-way valve and the fluid control valve when the temperature control device operates in the 3-3 mode;

FIG. 102 is a diagram illustrating a relative position of the valve with respect to the opening and a relative position of the third movable disk with respect to the third fixed disk when the temperature control device operates in the 3-4 mode;

FIG. 103 is a diagram illustrating that no fluid flows through an unnecessary inlet and an unnecessary outlet of the fluid control valve when the temperature control device operates in the 3-4 mode;

FIG. 104 is a diagram illustrating a relative position of the valve with respect to the opening and a relative position of the third movable disk with respect to the third fixed disk when the temperature control device operates in the 3-5 mode;

FIG. 105 is a diagram illustrating that no fluid flows through an unnecessary inlet and an unnecessary outlet of the fluid control valve when the temperature control device operates in the 3-5 mode;

FIG. 106 is a diagram illustrating an example of a ball valve of a ball valve device provided in a fluid circuit system according to another embodiment;

FIG. 107 is a diagram illustrating a fluid flow path inside the ball valve;

FIG. 108 is a diagram illustrating an example of a ball valve of a ball valve device provided in a fluid circuit system according to another embodiment;

FIG. 109 is a diagram illustrating a fluid flow path inside the ball valve; and

FIG. 110 is a diagram illustrating an example of a valve body of a ball valve provided in a fluid circuit system according to another embodiment.

### DETAILED DESCRIPTION

Hereinafter, examples of the present disclosure will be described.

According to an example of the present disclosure, a fluid circuit system is used in an electric vehicle and includes a multi-way valve that switches a flow of a coolant that is a fluid. The multi-way valve in the fluid circuit system includes openings and a valve body that opens and closes the openings. The fluid circuit system switches a flow of a fluid by rotating the valve body of the multi-way valve to open and close the plurality of openings, and controls the flow of the fluid to various connection devices connected to the fluid circuit system.

More specifically, According to an example, in the fluid circuit system among the openings of the multi-way valve, the opening communicating with the connection device that allows the fluid to flow in, and the opening communicating with the connection device that does not allow the fluid to flow in is closed. Accordingly, the fluid circuit system guides the fluid to the connection device that allows the fluid to flow in, and prohibits the fluid from being discharged to the connection device that does not allow the fluid to flow in.

According to an example, in the fluid circuit system, when the number of connection devices connected to the fluid circuit system increases, in accordance with the increase in the number of connection devices, it may be necessary to increase the number of openings of the multi-way valve or to complicate a structure of the valve body that opens and closes the openings. However, as a result of detailed studies by the inventor, it has been found that the increase in the number of openings of the multi-way valve and the complication of the structure of the valve body increase a pressure loss when the fluid flows through the multi-way valve. As a result of further studies by the inventor, it has been found that an increase in the pressure loss that occurs in the multi-way valve causes an increase in a pressure loss of the entire fluid circuit system.

According to an example of the present disclosure, a fluid circuit system is configured to guide fluid to a plurality of connection devices. The fluid circuit system comprises: a fluid circuit configured to allow fluid to flow therethrough; and a plurality of valve devices configured to switch flow of fluid through the fluid circuit. Each of the valve devices includes a housing defining an inlet for introducing fluid and an outlet for discharging fluid, and a valve member accommodated inside the housing and configured to open and close the inlet and the outlet. Each of the valve devices has a multi-way valve structure defining inlets including the inlet and outlets including the outlet. Each of the valve devices is switchable between guiding fluid by the valve member to the connection device that requires fluid to flow and prohibiting fluid by the valve member from flowing to the connection device that does not require fluid to flow. An unnecessary inlet is the inlet, which is connected to the connection device that does not require fluid to flow. An unnecessary outlet is the outlet, which is connected to the connection device that does not require fluid to flow. One of the valve devices, which is different from a predetermined valve device among the valve devices, is configured to close the inlet and the outlet to prohibit flow of fluid to the unnecessary inlet of the predetermined valve device in an open state and the unnecessary outlet of the predetermined valve device in the open state.

If an inlet and an outlet connected to a connection device that does not require a flow of a fluid are necessarily closed by a valve member, there is a concern that sizes of the inlet and the outlet in a valve device may be restricted. Accordingly, when the sizes of the inlet and the outlet are made smaller than necessary, there is a concern that a pressure loss may increase when the fluid flows through the inlet and the outlet.

In contrast, by prohibiting a flow of the fluid to an unnecessary inlet and an unnecessary outlet of a predetermined valve device in an open state, by closing an inlet and an outlet of the valve device different from the predetermined valve device, it is possible to reduce a restriction on an inlet and an outlet in the predetermined valve device. Therefore, it is possible to cause the fluid to flow into the connection device that requires the fluid to flow while reducing a pressure loss that occurs when the fluid flows through the inlet and the outlet.

Hereinafter, embodiments of the present disclosure will be described with reference to the drawings. In the following embodiments, the same or equivalent parts as those described in the preceding embodiments are denoted by the same reference numerals, and the description thereof may be omitted. When only a part of components is described in the embodiment, components described in the preceding embodiments can be applied to other parts of the components. In the following embodiments, the embodiments can be partially combined with each other as long as the embodiments do not cause any trouble in combination, even when the combination is not specified in particular.

### First Embodiment

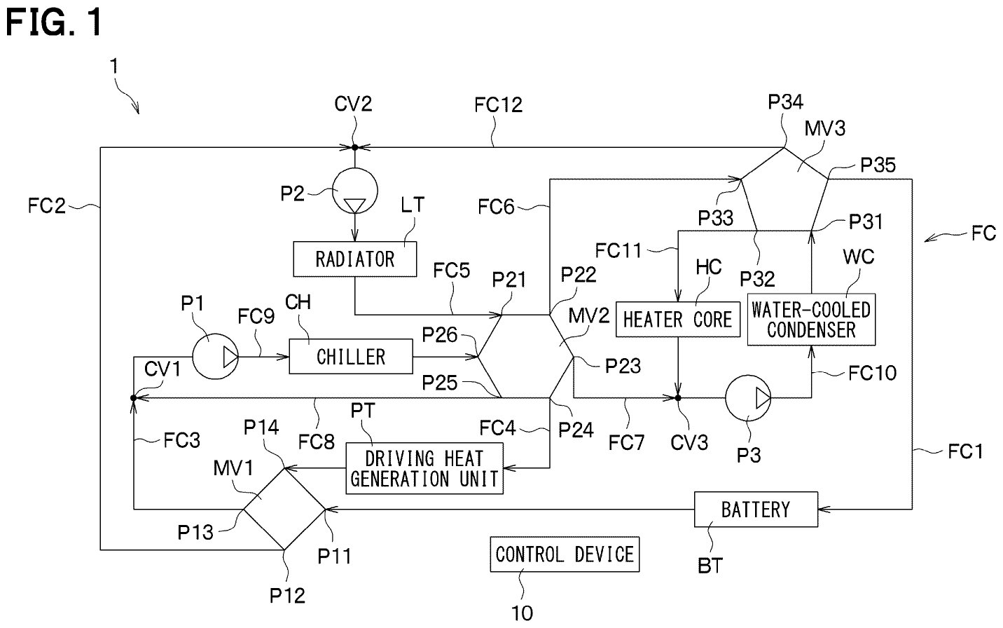

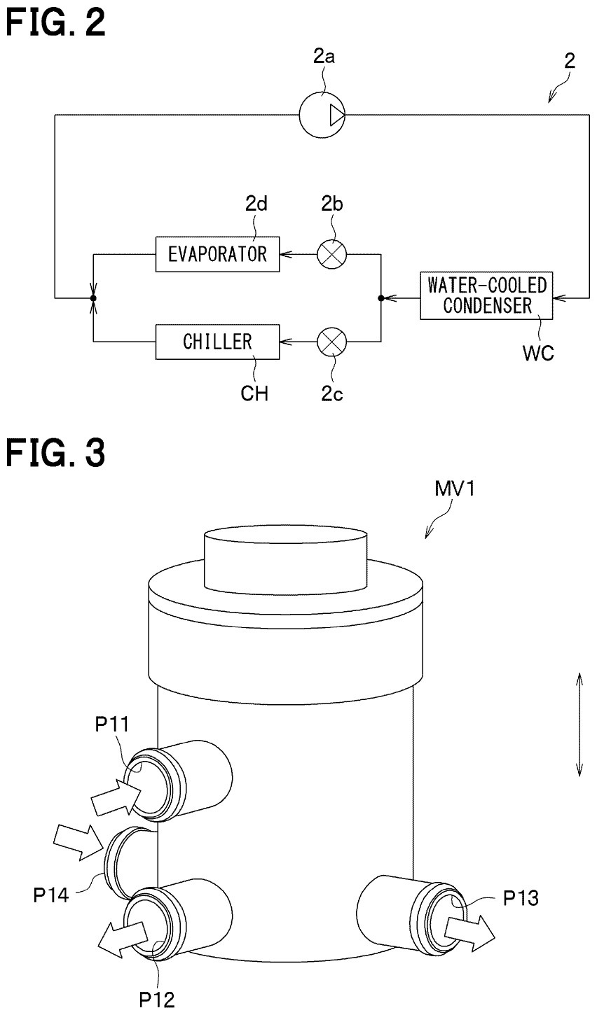

A fluid circuit system 1 according to the present embodiment will be described with reference to FIGS. 1 to 41. In the present embodiment, an example in which the fluid circuit system 1 illustrated in FIG. 1 is applied to a temperature control device (not illustrated) mounted on an electric vehicle will be described. The temperature control device includes, in addition to the fluid circuit system 1 that circulates a fluid that is a heat transport medium, a vehicle air conditioning device (not illustrated) that includes a compressor 2a, expansion valves 2b and 2c, an evaporator 2d, and the like constituting a refrigeration cycle 2 illustrated in FIG. 2 that circulates a refrigerant that is the heat transport medium. The temperature control device is a heat distribution system for appropriately distributing heat generated in the refrigeration cycle 2 and heat generated in various heat generating devices to various connection devices requiring heat via the refrigerant circulating in the refrigeration cycle 2 and the fluid circulating in the fluid circuit system 1.

The refrigeration cycle 2 adopts, for example, an HFO refrigerant, specifically, R1234yf, as a refrigerant, and a vapor compression type subcritical refrigeration cycle is implemented in which a pressure of a refrigerant discharged from the compressor 2a does not exceed a critical pressure of the refrigerant. As the refrigerant, an HFC-based refrigerant such as R134a may be used, or a natural refrigerant such as carbon dioxide may be used.

In the fluid circuit system 1, for example, a coolant can be adopted as the fluid. Specifically, as the coolant, a solution containing ethylene glycol, dimethylpolysiloxane, nanofluid, or the like, or an antifreeze can be used. The coolant may be a liquid containing water other than the antifreeze.

As illustrated in FIG. 1, a water-cooled condenser WC, a radiator LT, a chiller CH, a heater core HC, a driving heat generation unit PT, and a battery BT are connected to the temperature control device as connection devices connected to the fluid circuit system 1. The fluid circuit system 1 includes a fluid circuit FC that guides a fluid to various connection devices of the temperature control device, pumps P1, P2, and P3 for generating a flow of the fluid, connection portions CV1, CV2, and CV3 for connecting a plurality of flow paths, and multi-way valves MV1, MV2, and MV3 for switching the fluid circuit FC. The fluid circuit system 1 is configured to guide heat generated in the refrigeration cycle 2 to various connection devices of the temperature control device by switching the fluid circuit FC according to an operation mode of the temperature control device to be described later.

First, the refrigeration cycle 2 will be described with reference to FIG. 2. The refrigeration cycle 2 includes the compressor 2a, the water-cooled condenser WC, the first expansion valve 2b, the second expansion valve 2c, the evaporator 2d, and the chiller CH.

The compressor 2a draws in, compresses, and discharges the refrigerant in the refrigeration cycle 2. The compressor 2a is an electric compressor in which a fixed displacement compression mechanism, which has a fixed discharge capacity, is rotationally driven by an electric motor. The compressor 2a is electrically connected to a control device 10 to be described later, and a rotation speed, that is, a refrigerant discharge capacity is controlled by a control signal output from the control device 10. The water-cooled condenser WC is connected to a discharge port of the compressor 2a.

The water-cooled condenser WC is a water-refrigerant heat exchanger that exchanges heat between the high-pressure refrigerant discharged from the compressor 2a and the coolant circulating in the fluid circuit system 1 to cool the refrigerant and heat the coolant. The water-cooled condenser WC has a refrigerant passage through which the high-pressure refrigerant discharged from the compressor 2a flows, and a water passage through which the coolant circulating in the fluid circuit system 1 flows. The first expansion valve 2b and the second expansion valve 2c are connected to an outlet of the refrigerant passage of the water-cooled condenser WC.

The first expansion valve 2b is, for example, a pressure reducing device that reduces a pressure of a high-pressure refrigerant flowing out of the refrigerant passage of the water-cooled condenser WC and adjusts a flow rate of the refrigerant flowing out downstream, that is, a mass flow rate during an operation mode for cooling a vehicle interior. The first expansion valve 2b is an electric variable throttle mechanism including a valve body configured to change a throttle opening degree and an electric actuator that changes an opening degree of the valve body.

The first expansion valve 2b adjusts a flow rate of the refrigerant flowing through a passage by changing the valve opening degree in a range from fully closed to fully open. The first expansion valve 2b is electrically connected to the control device 10, and an operation thereof is controlled by a control signal output from the control device 10. An outlet side of the first expansion valve 2b is connected to an inlet side of the evaporator 2d.

The second expansion valve 2c is, for example, a pressure reducing device that reduces a pressure of the refrigerant flowing out of the refrigerant passage of the water-cooled condenser WC and adjusts a flow rate of the refrigerant flowing out downstream during an operation mode for cooling the battery BT. Since a basic configuration of the second expansion valve 2c is the same as that of the first expansion valve 2b, detailed description thereof will be omitted. An outlet side of the second expansion valve 2c is connected to an inlet side of the chiller CH.

The evaporator 2d is a cooling heat exchanger that exchanges heat between a low-pressure refrigerant depressurized in the first expansion valve 2b and blown air flowing through an air conditioning case of a vehicle air conditioning device (not illustrated) to evaporate the low-pressure refrigerant, and causes the low-pressure refrigerant to exhibit a heat absorption effect to cool the blown air. The evaporator 2d is disposed in the air conditioning case. A refrigerant outlet of the evaporator 2d is connected to a suction port side of the compressor 2a.

The chiller CH is, for example, an evaporator that exchanges heat between the low-pressure refrigerant depressurized in the second expansion valve 2c and the coolant circulating in the fluid circuit system 1 during an operation mode for cooling the battery BT, evaporates the low-pressure refrigerant, and exerts a heat absorption effect. An outlet of the chiller CH is connected to the suction port side of the compressor 2a.

Next, the connection device connected to the fluid circuit system 1 will be described with reference to FIG. 1. The connection devices connected to the fluid circuit system 1 include the water-cooled condenser WC, the chiller CH, the heater core HC, the radiator LT, the driving heat generation unit PT, and the battery BT.

As described above, the water-cooled condenser WC is a water-refrigerant heat exchanger for heating the coolant circulating in the fluid circuit system 1 using the high-pressure refrigerant discharged from the compressor 2a of the refrigeration cycle 2. The water-cooled condenser WC is provided between a third pump P3 to be described later and the third multi-way valve MV3 to be described later.

As described above, the chiller CH is an evaporator that cools the coolant circulating in the fluid circuit system 1 using the low-pressure refrigerant depressurized in the second expansion valve 2c. The chiller CH is provided between a first pump P1 to be described later and the second multi-way valve MV2 to be described later.

The heater core HC is a heating device that heats the blown air by exchanging heat between the blown air cooled by the evaporator 2d and the coolant heated by the water-cooled condenser WC in the air conditioning case of the vehicle air conditioning device. The heater core HC is disposed downstream of the evaporator 2d in an air flow in the air conditioning case, and heats the blown air cooled by passing through the evaporator 2d. The heater core HC is provided between the third multi-way valve MV3 to be described later and the third connection portion CV3 to be described later.

An air mix door (not illustrated) is provided in the air conditioning case to adjust an air volume ratio between an air volume of the blown air passing through the heater core HC and an air volume of the blown air bypassing the heater core HC, in the blown air after passing through the evaporator 2d. The air mix door adjusts a temperature of conditioned air flowing through the air conditioning case and blown into the vehicle interior.

The radiator LT is a water-outside air heat exchanger that exchanges heat between a heat medium heated in the water-cooled condenser WC and outside air blown from an outside airfan (not illustrated). The radiator LT is disposed, for example, on a front side of a drive device that drives a vehicle. The radiator LT is provided between the second pump P2 to be described later and the second multi-way valve MV2 to be described later.

The driving heat generation unit PT is an electric component for obtaining a driving force for driving the electric vehicle. The driving heat generation unit PT includes, for example, an electric motor for traveling that outputs a driving force for traveling, an inverter that supplies electric power for driving the electric motor for traveling, and a DCDC converter that adjusts a voltage supplied from the battery BT. The driving heat generation unit PT may include a motor generator in which a transmission and a final gear-differential gear are integrated. The driving heat generation unit PT including these electric components is a heat generation unit that generates heat during operation.

When a temperature of the driving heat generation unit PT becomes high, electronic components such as an electric circuit are easily deteriorated. When the temperature of the driving heat generation unit PT becomes low, it may be difficult to operate normally. Therefore, it is desirable that the driving heat generation unit PT is maintained within an appropriate temperature range from the viewpoint of protection of the electric circuit and normal operation.

Therefore, the driving heat generation unit PT according to the present embodiment has a water passage (not illustrated) through which the coolant circulating in the fluid circuit system 1 flows, and is configured to exchange heat with the coolant circulating in the fluid circuit system 1. After a certain period of time has elapsed since the driving heat generation unit PT started to be driven, when a coolant having a temperature lower than the temperature of the driving heat generation unit PT itself flows through the water passage, the coolant absorbs heat and cools the driving heat generation unit PT. When not much time has elapsed since the start of driving, such as immediately after the start of driving, when the coolant having a temperature higher than the temperature of the driving heat generation unit PT itself flows through the water passage, the driving heat generation unit PT absorbs heat from the coolant and is heated. The driving heat generation unit PT is provided between the first multi-way valve MV1 to be described later and the second multi-way valve MV2 to be described later.

The battery BT is a secondary battery that can supply power to the DCDC converter or the like that is the driving heat generation unit PT and store power by charging. The battery BT is formed, for example, by electrically connecting a plurality of battery cells in series or in parallel. The battery BT is a heat generation unit that generates heat by itself when being charged with power supplied from an external power source provided outside the vehicle or when supplying power to an outside.

In the battery BT, an output tends to decrease at a low temperature, and tends to deteriorate at a high temperature. Therefore, it is desirable that the temperature of the battery BT is maintained within an appropriate temperature range in which charge and discharge capacity of the battery BT can be sufficiently utilized.

Therefore, the battery BT according to the present embodiment has a water passage (not illustrated) through which the coolant circulating in the fluid circuit system 1 flows, and is configured to exchange heat with the coolant circulating in the fluid circuit system 1. When a certain period of time has elapsed since the start of power supply or when a certain period of time has elapsed since the start of charging, when the coolant having a temperature lower than a temperature of the battery BT itself flows through the water passage, the coolant absorbs heat and cools the battery BT. When not much time has elapsed since the start of power supply or charging, such as immediately after the start of power supply or charging, when the coolant having a temperature higher than the temperature of the battery BT itself flows through the water passage, the battery BT absorbs heat from the coolant and is heated. The battery BT is provided between the first multi-way valve MV1 to be described later and the third multi-way valve MV3 to be described later.

Subsequently, the fluid circuit system 1 will be described with reference to FIGS. 1 and 3 to 14. The fluid circuit system 1 includes the fluid circuit FC that guides a coolant to each of the water-cooled condenser WC, the chiller CH, the heater core HC, the radiator LT, the driving heat generation unit PT, and the battery BT, which are connection devices. The fluid circuit system 1 includes the first pump P1, the second pump P2, and the third pump P3 that generate a flow for the coolant to flow through the fluid circuit FC. The fluid circuit system 1 includes the first connection portion CV1, the second connection portion CV2, and the third connection portion CV3 that connect a plurality of flow paths through which the coolant flows in the fluid circuit FC and allow the plurality of flow paths to communicate. Further, the fluid circuit system 1 includes the first multi-way valve MV1, the second multi-way valve MV2, and the third multi-way valve MV3 that switch the fluid circuit FC.

The first pump P1, the second pump P2, and the third pump P3 are water pumps that pump the coolant flowing through the fluid circuit FC downstream of a water flow. Each of the first pump P1, the second pump P2, and the third pump P3 is electrically connected to the control device 10, and an electric pump is adopted in which a rotation speed, that is, a pumping capacity, is controlled by a control voltage output from the control device 10. The first pump P1, the second pump P2, and the third pump P3 change a flow velocity of the coolant pumped by themselves according to a change in the control voltage output from the control device 10, thereby changing a flow rate per unit time of the coolant flowing downstream of the pumps themselves.

The first pump P1 is provided between the first multi-way valve MV1 and the second multi-way valve MV2, and generates a flow for the coolant to flow from the first multi-way valve MV1 toward the second multi-way valve MV2. The second pump P2 is provided between the first multi-way valve MV1 and the third multi-way valve MV3 and the second multi-way valve MV2. The second pump P2 generates a flow for the coolant to flow from the first multi-way valve MV1 toward the second multi-way valve MV2, and generates a flow for the coolant to flow from the third multi-way valve MV3 toward the second multi-way valve MV2. The third pump P3 is provided between the second multi-way valve MV2 and the third multi-way valve MV3, and generates a flow for the coolant to flow from the second multi-way valve MV2 toward the third multi-way valve MV3.

The first connection portion CV1, the second connection portion CV2, and the third connection portion CV3 are three-way joints having three port portions to which flow paths are connected. The first connection portion CV1, the second connection portion CV2, and the third connection portion CV3 are connected to outlet sides of flow paths connected to two port portions among the three port portions. The first connection portion CV1, the second connection portion CV2, and the third connection portion CV3 are connected to an inlet side of a flow path connected to the remaining one port portion. That is, the first connection portion CV1, the second connection portion CV2, and the third connection portion CV3 have two inflow ports through which the coolant flows in and one outflow port through which the coolant flows out. The first connection portion CV1, the second connection portion CV2, and the third connection portion CV3 allow the coolant flowing in from each of the two inflow ports to flow out to the one outflow port.

In the first connection portion CV1, a flow path through which the coolant flowing out of the first multi-way valve MV1 flows is connected to one of the two inflow ports, and a flow path through which the coolant flowing out of the second multi-way valve MV2 flows is connected to the other inflow port. A flow path for guiding the coolant to the second multi-way valve MV2 is connected to the outflow port of the first connection portion CV1.

In the second connection portion CV2, a flow path through which the coolant flowing out of the first multi-way valve MV1 flows is connected to one of the two inflow ports, and a flow path through which the coolant flowing out of the third multi-way valve MV3 flows is connected to the other inflow port. A flow path for guiding the coolant to the second multi-way valve MV2 is connected to the outflow port of the second connection portion CV2.

In the third connection portion CV3, a flow path through which the coolant flowing out of the second multi-way valve MV2 flows is connected to one of the two inflow ports, and a flow path through which the coolant flowing out of the third multi-way valve MV3 flows is connected to the other inflow port. A flow path for guiding the coolant to the third multi-way valve MV3 is connected to the outflow port of the third connection portion CV3.

Each of the first multi-way valve MV1, the second multi-way valve MV2, and the third multi-way valve MV3 is a valve device having a multi-way valve structure that has a plurality of coolant inlets and a plurality of coolant outlets and causes the coolant flowing into the valve device to flow out from the coolant outlet corresponding to each operation mode of the temperature control device. Hereinafter, the first multi-way valve MV1, the second multi-way valve MV2, and the third multi-way valve MV3 may be referred to as the first multi-way valve MV1 to the third multi-way valve MV3.

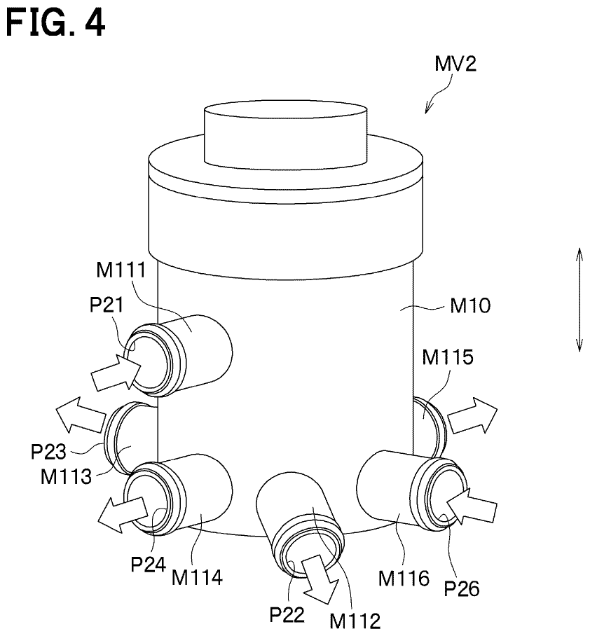

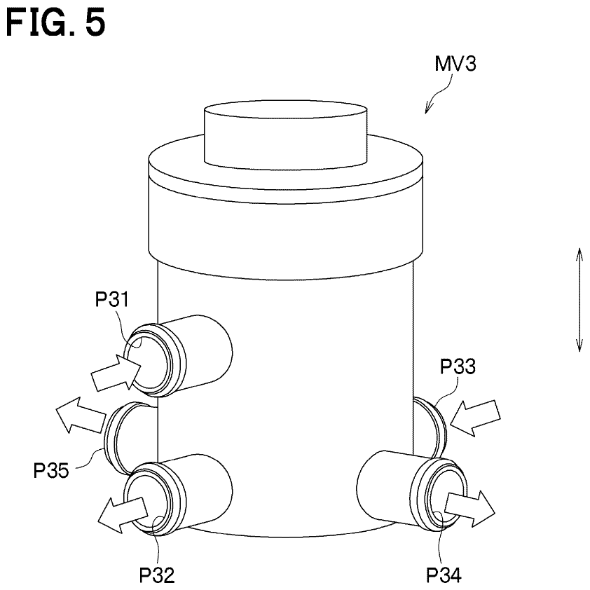

As illustrated in FIGS. 1 and 3, the first multi-way valve MV1 is a four-way valve having two coolant inlets and two coolant outlets. As illustrated in FIGS. 1 and 4, the second multi-way valve MV2 is a six-way valve having two coolant inlets and four coolant outlets. As illustrated in FIGS. 1 and 5, the third multi-way valve MV3 is a five-way valve having two coolant inlets and three coolant outlets.

Hereinafter, the two coolant inlets formed in the first multi-way valve MV1 are referred to as a 1-1 opening P11 and a 1-4 opening P14, and the two coolant outlets formed in the first multi-way valve MV1 are referred to as a 1-2 opening P12 and a 1-3 opening P13. The two coolant inlets formed in the second multi-way valve MV2 are referred to as a 2-1 opening P21 and a 2-6 opening P26. The four coolant outlets formed in the second multi-way valve MV2 are referred to as a 2-2 opening P22, a 2-3 opening P23, a 2-4 opening P24, and a 2-5 opening P25. The two coolant inlets formed in the third multi-way valve MV3 are referred to as a 3-1 opening P31 and a 3-3 opening P33, and the three coolant outlets formed in the third multi-way valve MV3 are referred to as a 3-2 opening P32, a 3-4 opening P34, and a 3-5 opening P35.

In the first multi-way valve MV1 indicated by a square in FIG. 1 and the like, four vertices of the square indicate the 1-1 opening P11, the 1-2 opening P12, the 1-3 opening P13, and the 1-4 opening P14 of the first multi-way valve MV1. In the second multi-way valve MV2 indicated by a hexagon in FIG. 1 and the like, six vertices of the hexagon indicate the 2-1 opening P21, the 2-2 opening P22, the 2-3 opening P23, the 2-4 opening P24, the 2-5 opening P25, and the 2-6 opening P26 of the second multi-way valve MV2. In the third multi-way valve MV3 indicated by a pentagon in FIG. 1 and the like, five vertices of the pentagon indicate the 3-1 opening P31, the 3-2 opening P32, the 3-3 opening P33, the 3-4 opening P34, and the 3-5 opening P35 of the third multi-way valve MV3.

The first multi-way valve MV1 has the 1-1 opening P11 connected to the 3-5 opening P35 of the third multi-way valve MV3, the 1-2 opening P12 connected to one inflow port of the second connection portion CV2, and the 1-3 opening P13 connected to one inflow port of the first connection portion CV1. The 1-4 opening P14 of the first multi-way valve MV1 is connected to the 2-4 opening P24 of the second multi-way valve MV2.

The second multi-way valve MV2 has the 2-1 opening P21 connected to the outflow port of the second connection portion CV2, the 2-2 opening P22 connected to the 3-3 opening P33 of the third multi-way valve MV3, and the 2-3 opening P23 connected to one of the inflow ports of the third connection portion CV3. The second multi-way valve MV2 has the 2-4 opening P24 connected to the 1-4 opening P14 of the first multi-way valve MV1, the 2-5 opening P25 connected to the other inflow port of the first connection portion CV1, and the 2-6 opening P26 connected to the outflow port of the first connection portion CV1.

The third multi-way valve MV3 has the 3-1 opening P31 connected to the outflow port of the third connection portion CV3, the 3-2 opening P32 connected to the other inflow port of the third connection portion CV3, and the 3-3 opening P33 connected to the 2-2 opening P22 of the second multi-way valve MV2. The third multi-way valve MV3 has the 3-4 opening P34 connected to the other inflow port of the second connection portion CV2, and the 3-5 opening P35 connected to the 1-1 opening P11 of the first multi-way valve MV1.

Hereinafter, a flow path connecting the 1-1 opening P11 of the first multi-way valve MV1 and the 3-5 opening P35 of the third multi-way valve MV3 is referred to as a P35-P11 flow path FC1. A flow path connecting the 1-2 opening P12 of the first multi-way valve MV1 and the one inflow port of the second connection portion CV2 is referred to as a P12-CV2 flow path FC2. A flow path connecting the 1-3 opening P13 of the first multi-way valve MV1 and the one inflow port of the first connection portion CV1 is referred to as a P13-CV1 flow path FC3. A flow path connecting the 1-4 opening P14 of the first multi-way valve MV1 and the 2-4 opening P24 of the second multi-way valve MV2 is referred to as a P24-P14 flow path FC4.

A flow path connecting the 2-1 opening P21 of the second multi-way valve MV2 and the outflow port of the second connection portion CV2 is referred to as a CV2-P21 flow path FC5. A flow path connecting the 2-2 opening P22 of the second multi-way valve MV2 and the 3-3 opening P33 of the third multi-way valve MV3 is referred to as a P22-P33 flow path FC6. A flow path connecting the 2-3 opening P23 of the second multi-way valve MV2 and one inflow port of the third connection portion CV3 is referred to as a P23-CV3 flow path FC7. A flow path connecting the 2-5 opening P25 of the second multi-way valve MV2 and the other inflow port of the first connection portion CV1 is referred to as a P25-CV1 flow path FC8. A flow path connecting the 2-6 opening P26 of the second multi-way valve MV2 and the outflow port of the first connection portion CV1 is referred to as a CV1-P26 flow path FC9.

A flow path connecting the 3-1 opening P31 of the third multi-way valve MV3 and the outflow port of the third connection portion CV3 is referred to as a CV3-P31 flow path FC10. A flow path connecting the 3-2 opening P32 of the third multi-way valve MV3 and the other inflow port of the third connection portion CV3 is referred to as a P32-CV3 flow path FC11. A flow path connecting the 3-4 opening P34 of the third multi-way valve MV3 and the other inflow port of the second connection portion CV2 is referred to as a P34-CV2 flow path FC12.

The battery BT is provided in the P35-P11 flow path FC1. The driving heat generation unit PT is provided in the P24-P14 flow path FC4. The radiator LT is provided in the CV2-P21 flow path FC5. The chiller CH is provided in the CV1-P26 flow path FC9. The water-cooled condenser WC is provided in the CV3-P31 flow path FC10. The heater core HC is provided in the P32-CV3 flow path FC11.

The first multi-way valve MV1 to the third multi-way valve MV3 are configured to change an outflow destination of the coolant flowing into themselves by communicating the coolant inlet of themselves with the coolant outlet of themselves. The first multi-way valve MV1 to the third multi-way valve MV3 can switch the flow path through which the coolant flows in the fluid circuit FC by changing the outflow destination of the coolant.

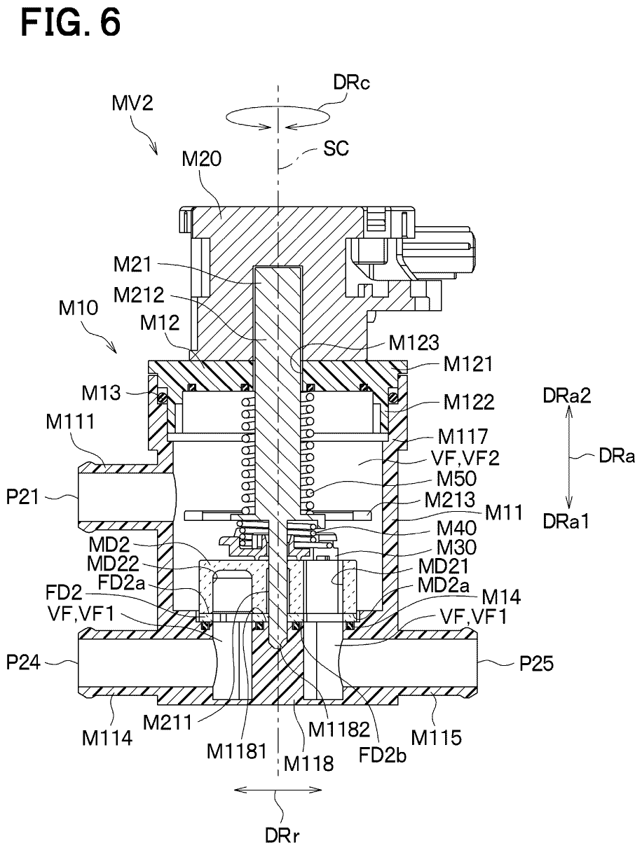

The first multi-way valve MV1 to the third multi-way valve MV3 have a similar basic structure although the numbers of the coolant outlets are different from each other. Therefore, among the first multi-way valve MV1 to the third multi-way valve MV3, a detailed structure of the second multi-way valve MV2 will be described with reference to FIG. 6, and a detailed description of the first multi-way valve MV1 and the third multi-way valve MV3 will be omitted.

As illustrated in FIG. 6, the second multi-way valve MV2 according to the present embodiment includes a housing M10, a second fixed disk FD2, a second movable disk MD2, a drive unit M20, a lever M30, a torsion spring M40, a compression spring M50, and the like. The second multi-way valve MV2 according to the present embodiment is implemented as a disk valve device that switches the fluid circuit FC by the drive unit M20 rotating the second movable disk MD2 integrally with a shaft M21 to be described later. The second multi-way valve MV2 is configured to switch an operation mode of the temperature control device by switching the fluid circuit FC. The operation mode of the temperature control device is switched by the drive unit M20 rotating the second movable disk MD2.

The housing M10 is a housing that forms an outer shell of the second multi-way valve MV2 and forms a valve body flow path VF therein through which the coolant flows. The housing M10 is a non-rotating member that does not rotate. Specifically, the housing M10 includes a lower housing M11 having a bottomed cylindrical shape and an upper housing M12 that closes an opening side of the lower housing M11. The lower housing M11 and the upper housing M12 are molded by, for example, injection molding in which a resin material is poured into a metal mold and solidified into a desired shape.

As illustrated in FIG. 6, the shaft M21 is inserted into the housing M10, spanning from the lower housing M11 through the upper housing M12 to the drive unit M20. The housing M10 accommodates components such as the second fixed disk FD2, the second movable disk MD2, the lever M30, the torsion spring M40, and the compression spring M50. The valve body flow path VF formed inside the housing M10 is defined by the second fixed disk FD2 and the second movable disk MD2 in a direction in which a shaft axis SC of the shaft M21 extends.

Hereinafter, as illustrated in FIG. 1 and the like, various configurations and the like will be described with a direction along the shaft axis SC of the shaft M21 as an axial direction DRa, a direction on one side in the axial direction DRa as a downward direction DRa1, and a direction opposite to the downward direction DRa1 as an upward direction DRa2. The downward direction DRa1 is a direction from an upper housing M12 side toward a lower housing M11 side in the axial direction DRa.

Various configurations will be described with a direction perpendicular to the axial direction DRa and radially extending from the axial direction DRa as a shaft radial direction DRr, and a direction around the shaft axis SC centered on the shaft axis SC as a shaft circumferential direction DRc. The shaft circumferential direction DRc is a rotation direction of the shaft M21 rotated by a driving force supplied from the drive unit M20. In FIGS. 3, 4, and 5, the drive unit M20 and the shaft M21 are omitted. Directions illustrated in FIG. 3 and the like are examples, and do not limit an installation state of the second multi-way valve MV2 according to the present disclosure.

Of the valve body flow path VF in the housing M10, a flow path on a downward direction DRa1 side of the second fixed disk FD2 and second movable disk MD2 is also referred to as a lower flow path VF1, and a flow path on an upward direction DRa2 side of the second fixed disk FD2 and second movable disk MD2 is also referred to as an upper flow path VF2. That is, in the present embodiment, the valve body flow path VF in the housing M10 is defined into the upper flow path VF2 and the lower flow path VF1 by the second fixed disk FD2 and the second movable disk MD2.

The lower housing M11 has a bottomed cylindrical shape and forms the valve body flow path VF formed by the housing M10. In a specific example, the lower housing M11 forms the upper flow path VF2 and the lower flow path VF1.

The lower housing M11 is connected to six ports M111, M112, M113, M114, M115, and M116 for introducing the coolant into the upper flow path VF2 and the lower flow path VF1 or discharging the fluid from the lower flow path VF1. The lower housing M11 has a side wall portion M117 surrounding the shaft axis SC and a bottom wall portion M118 forming a bottom surface. The lower housing M11 is implemented as an integrally molded product in which the side wall portion M117 and the bottom wall portion M118 are integrally molded.

The side wall portion M117 has a cylindrical shape surrounding the valve body flow path VF in the shaft circumferential direction DRc and extends along the axial direction DRa. The side wall portion M117 is provided with an O-ring M13 that closes a gap between the lower housing M11 and the upper housing M12 on the upward direction DRa2 side which is an opening side. The bottom wall portion M118 is continuous with the side wall portion M117 on the downward direction DRa1 side. As illustrated in FIG. 3, six ports M111, M112, M113, M114, M115, and M116 are connected to an outer peripheral portion of the side wall portion M117.

Although not illustrated, a receiving groove for receiving a projection of the second fixed disk FD2 is formed inside the side wall portion M117. The projection of the second fixed disk FD2 is fitted into the receiving groove of the side wall portion M117, so that rotation of the second fixed disk FD2 in the shaft circumferential direction DRc is restricted. Rotation stop of the second fixed disk FD2 may be achieved by, for example, a rotation stop pin instead of the projection.

Among the six ports M111, M112, M113, M114, M115, and M116, the two ports M111 and M116 are inlet ports that function as inlets for allowing the fluid to flow into the valve body flow path VF in the housing M10. In contrast, the remaining four ports M112, M113, M114, and M115 are outlet ports that function as outlets through which the fluid flowing into the valve body flow path VF in the housing M10 flows out of the second multi-way valve MV2. The six ports M111, M112, M113, M114, M115, and M116 are each formed of a tubular member formed such that a fluid can flow therethrough.

As illustrated in FIG. 4, one port M111 of the two ports M111 and M116, which are the inlet ports, is provided on the upward direction DRa2 side of the lower housing M11, and has the 2-1 opening P21 on a side opposite to a side connected to the side wall portion M117. The other port M116 of the two ports M111 and M116, which are inlet ports, is provided on the lower housing M11 on the downward direction DRa1 side, and has the 2-6 opening P26 on the side opposite to the side connected to the side wall portion M117.

In contrast, the four ports M112, M113, M114, and M115, which are the outlet ports, are provided side by side along the shaft circumferential direction DRc on the downward direction DRa1 side of the lower housing M11. The four ports M113, M114, M112, and M115 are provided side by side in this order from one side to the other side in the shaft circumferential direction DRc. The four ports M113, M114, M112, and M115 respectively have the 2-3 opening P23, the 2-4 opening P24, the 2-2 opening P22, and the 2-5 opening P25 on the side opposite to the side connected to the side wall portion M117.

In the following description, of the two ports M111 and M116, which are the inlet ports, the inlet port having the 2-1 opening P21 is referred to as the 2-1 port M111, and the inlet port having the 2-6 opening P26 is referred to as the 2-6 port M116. Among the four ports M112, M113, M114, and M115, which are the outlet ports, the outlet port having the 2-2 opening P22 is referred to as the 2-2 port M112, and the outlet port having the 2-3 opening P23 is referred to as the 2-3 port M113. Among the four ports M112, M113, M114, and M115, which are the outlet ports, the outlet port having the 2-4 opening P24 is referred to as the 2-4 port M114, and the outlet port having the 2-5 opening P25 is referred to as the 2-5 port M115.

The 2-1 port M111 and the 2-4 port M114 are provided side by side along the axial direction DRa. The 2-3 port M113, the 2-4 port M114, the 2-2 port M112, the 2-6 port M116, and the 2-5 port M115 are provided side by side at predetermined intervals along the shaft circumferential direction DRc in an outer peripheral portion of the lower housing M11. The 2-3 port M113, the 2-4 port M114, the 2-2 port M112, the 2-6 port M116, and the 2-5 port M115 are formed on the downward direction DRa1 side of the second fixed disk FD2 and the second movable disk MD2 in the outer peripheral portion of the lower housing M11.

The 2-1 port M111 communicates with the upper flow path VF2. The 2-3 port M113, the 2-4 port M114, the 2-2 port M112, the 2-6 port M116, and the 2-5 port M115 communicate with the lower flow path VF1. The arrangement of the 2-1 port M111, the 2-2 port M112, the 2-3 port M113, the 2-4 port M114, the 2-5 port M115, and the 2-6 port M116 is not limited to this example, and can be appropriately changed.

As illustrated in FIG. 6, the bottom wall portion M118 is a portion on which the second fixed disk FD2 is disposed and which supports the shaft M21 on the downward direction DRa1 side. The bottom wall portion M118 has an installation surface M1181 for mounting the second fixed disk FD2 on the upward direction DRa2 side, and the second fixed disk FD2 is disposed on the installation surface M1181. A gasket M14 is disposed on the installation surface M1181 to seal a gap between the second fixed disk FD2 and the installation surface M1181. The bottom wall portion M118 has a bearing hole M1182 that supports the shaft M21. The downward direction DRa1 side of the shaft M21 is fitted into the bearing hole M1182, and the shaft M21 is rotatably supported.

The bottom wall portion M118 is provided with steps corresponding to five flow holes FD22, FD23, FD24, FD25, and FD26 (described later) of the second fixed disk FD2. That is, the bottom wall portion M118 is formed such that portions of the bottom wall portion M118 facing the five flow holes FD22, FD23, FD24, FD25, and FD26 (described later) of the second fixed disk FD2 are recessed in the downward direction DRa1. A portion of the bottom wall portion M118 facing the five flow holes FD22, FD23, FD24, FD25, and FD26 of the second fixed disk FD2 is a portion forming the lower flow path VF1. That is, five lower flow paths VF1 are formed in the bottom wall portion M118. These five lower flow paths VF1 correspond to any of the 2-2 port M112, the 2-3 port M113, the 2-4 port M114, the 2-5 port M115, and the 2-6 port M116, and communicate with the corresponding inlet port or outlet port. These five lower flow paths VF1 communicate with the five flow holes FD22, FD23, FD24, FD25, and FD26 of the second fixed disk FD2.

As illustrated in FIG. 6, the second fixed disk FD2 is disposed between the installation surface M1181 of the bottom wall portion M118 and the second movable disk MD2. The second fixed disk FD2 is a sealing member that seals a gap between the lower housing M11 and the second movable disk MD2. The second fixed disk FD2 is formed in a disk shape, and is disposed such that a central axis thereof coincides with the shaft axis SC.

The second fixed disk FD2 has a seal surface FD2a that abuts against the second movable disk MD2 and a support surface FD2b that abuts against the installation surface M1181. The second fixed disk FD2 has a fixed disk hole FD2c formed substantially at a center of the second fixed disk FD2, through which the shaft M21 is inserted.

The second fixed disk FD2 is made of a material having a smaller linear expansion coefficient, better wear resistance, and a smaller friction coefficient than a constituent material for the housing M10. For example, the second fixed disk FD2 is made of a high-hardness material having higher hardness than the housing M10. Specifically, the second fixed disk FD2 is made of at least one of phenol, resin, and ceramic. The second fixed disk FD2 according to the present embodiment is made of ceramic.

In the second fixed disk FD2, only a portion forming the seal surface FD2a against which the second movable disk MD2 slides may be formed of a material, such as ceramic, which has a smaller linear expansion coefficient and better wear resistance than the constituent material for the housing M10. The second fixed disk FD2 may be implemented by combining a plurality of components.

The second fixed disk FD2 is provided so as not to relatively rotate in the shaft circumferential direction DRc in the housing M10. In a specific example, the second fixed disk FD2 has the projection that projects outward in the shaft radial direction DRr. The second fixed disk FD2 is not rotatable in the shaft circumferential direction DRc with rotation of the shaft M21 by fitting the projection into the receiving groove (not illustrated) formed in an inner peripheral portion of the side wall portion M117.

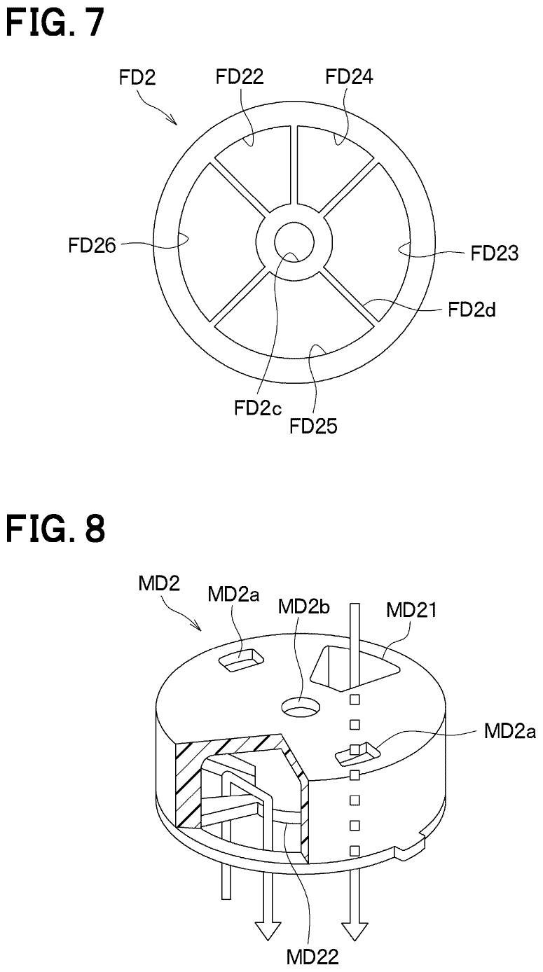

As illustrated in FIG. 7, the five flow holes FD22, FD23, FD24, FD25, and FD26 penetrating in the axial direction DRa are formed in the second fixed disk FD2 according to the present embodiment. The second fixed disk FD2 has five second partition portions FD2d provided between the five flow holes FD22, FD23, FD24, FD25, and FD26. The five flow holes FD22, FD23, FD24, FD25, and FD26 penetrate the second fixed disk FD2 in the axial direction DRa, and the fluid can pass therethrough. The five flow holes FD22, FD23, FD24, FD25, and FD26 and the five second partition portions FD2d are alternately disposed in the shaft circumferential direction DRc over an entire circumference of the second fixed disk FD2. Each of the five flow holes FD22, FD23, FD24, FD25, and FD26 has a substantially fan-shaped cross section in a direction perpendicular to the axial direction DRa.

The five flow holes FD22, FD23, FD24, FD25, and FD26 communicate with any of the five lower flow paths VF1 formed in the bottom wall portion M118. That is, the five flow holes FD22, FD23, FD24, FD25, and FD26 communicate with the 2-2 port M112, the 2-3 port M113, the 2-4 port M114, the 2-5 port M115, and the 2-6 port M116, which communicate with the lower flow path VF1.

In the following description, among the five flow holes FD22, FD23, FD24, FD25, and FD26, the flow hole communicating with the 2-2 port M112 is referred to as the 2-2 flow hole FD22, and the flow hole communicating with the 2-3 port M113 is referred to as the 2-3 flow hole FD23. A flow hole communicating with the 2-4 port M114 is referred to as the 2-4 flow hole FD24, a flow hole communicating with the 2-5 port M115 is referred to as the 2-5 flow hole FD25, and a flow hole communicating with the 2-6 port M116 is referred to as the 2-6 flow hole FD26. In the present embodiment, the 2-2 flow hole FD22, the 2-4 flow hole FD24, the 2-3 flow hole FD23, the 2-5 flow hole FD25, and the 2-6 flow hole FD26 are provided side by side in this order along the shaft circumferential direction DRc.

As illustrated in FIG. 6, the second movable disk MD2 is provided in the lower housing M11 and is in surface contact with the seal surface FD2a of the second fixed disk FD2. As illustrated in FIGS. 6 and 8, the second movable disk MD2 according to the present embodiment is formed in a disk shape having an outer diameter substantially equal to that of the second fixed disk FD2, and is disposed such that a central axis thereof coincides with the shaft axis SC.

The second movable disk MD2 has a sliding surface MD2a that slides against the second fixed disk FD2. In the second movable disk MD2, a movable disk hole MD2b through which the shaft M21 is inserted is formed substantially at a center, and two press-fitting grooves MD2c into which the lever M30 described later is press-fitted are formed.

Similarly to the second fixed disk FD2, the second movable disk MD2 is made of a material having a smaller linear expansion coefficient, better wear resistance, and a smaller friction coefficient than the constituent material for the housing M10. For example, the second movable disk MD2 is made of a high-hardness material having higher hardness than the housing M10. Specifically, the second movable disk MD2 is made of at least one of phenol, resin, and ceramic. The second movable disk MD2 according to the present embodiment is made of ceramic, which is the same material as the second fixed disk FD2.

In the second movable disk MD2, only a portion forming the sliding surface MD2a that slides against the second fixed disk FD2 may be formed of a material, such as ceramic, which has a smaller linear expansion coefficient and better wear resistance than the constituent material for the housing M10. The second movable disk MD2 may be implemented by combining a plurality of components.

The second movable disk MD2 has an outer diameter smaller than an inner diameter of the lower housing M11, and is rotatable about the shaft axis SC of the shaft M21. The second movable disk MD2 has one second through hole MD21 penetrating the second movable disk MD2 in the axial direction DRa and one second communication hole MD22 not penetrating the second movable disk MD2.

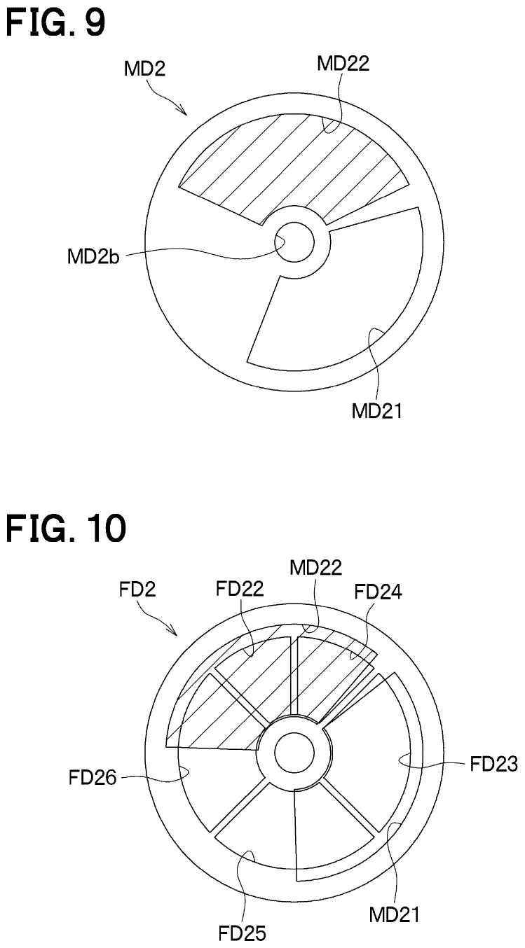

As illustrated in FIG. 9, each of the second through hole MD21 and the second communication hole MD22 has a substantially fan-shaped cross section in a direction perpendicular to the axial direction DRa. The second through hole MD21 and the second communication hole MD22 have substantially the same cross section in the direction perpendicular to the axial direction DRa.

The second through hole MD21 penetrates the second movable disk MD2 and is formed so that a fluid can pass therethrough. The second through hole MD21 communicates with any one of the 2-2 flow hole FD22, the 2-3 flow hole FD23, the 2-4 flow hole FD24, the 2-5 flow hole FD25, and the 2-6 flow hole FD26 of the second fixed disk FD2 on the downward direction DRa1 side. The second through hole MD21 communicates with the upper flow path VF2 on the upward direction DRa2 side.

The second through hole MD21 has a larger flow path cross-sectional area than the 2-2 flow hole FD22, the 2-3 flow hole FD23, the 2-4 flow hole FD24, the 2-5 flow hole FD25, and the 2-6 flow hole FD26 of the second fixed disk FD2. The second through hole MD21 has a size capable of covering all of the 2-2 flow hole FD22, the 2-3 flow hole FD23, the 2-4 flow hole FD24, the 2-5 flow hole FD25, and the 2-6 flow hole FD26.

Further, the second through hole MD21 is able to communicate with any two or three of the 2-2 flow hole FD22, the 2-3 flow hole FD23, the 2-4 flow hole FD24, the 2-5 flow hole FD25, and the 2-6 flow hole FD26 according to a rotational position of the second movable disk MD2. Specifically, when the second through hole MD21 overlaps two of the 2-2 flow hole FD22, the 2-3 flow hole FD23, the 2-4 flow hole FD24, the 2-5 flow hole FD25, and the 2-6 flow hole FD26 in the axial direction DRa, the second through hole MD21 communicates with the two overlapped flow holes. Specifically, when the second through hole MD21 overlaps three of the 2-2 flow hole FD22, the 2-3 flow hole FD23, the 2-4 flow hole FD24, the 2-5 flow hole FD25, and the 2-6 flow hole FD26 in the axial direction DRa, the second through hole MD21 communicates with the three overlapped flow holes.

In other words, the second through hole MD21 communicates with two or three of the 2-2 port M112, the 2-3 port M113, the 2-4 port M114, the 2-5 port M115, and the 2-6 port M116 by rotating with the rotation of the shaft M21.

The second communication hole MD22 is formed by recessing a part of the sliding surface MD2a on a side sliding against the second fixed disk FD2. That is, the second communication hole MD22 is formed without penetrating the second movable disk MD2. The second communication hole MD22 has a larger flow path cross-sectional area than the 2-2 flow hole FD22, the 2-3 flow hole FD23, the 2-4 flow hole FD24, the 2-5 flow hole FD25, and the 2-6 flow hole FD26 of the second fixed disk FD2. The second communication hole MD22 has a size capable of covering all of the 2-2 flow hole FD22, the 2-3 flow hole FD23, the 2-4 flow hole FD24, the 2-5 flow hole FD25, and the 2-6 flow hole FD26.

In the present embodiment, the second communication hole MD22 is formed in a size capable of simultaneously covering a part of any two or three of the 2-2 flow hole FD22, the 2-3 flow hole FD23, the 2-4 flow hole FD24, the 2-5 flow hole FD25, and the 2-6 flow hole FD26.

Further, the second communication hole MD22 allows any two or three of the 2-2 flow hole FD22, the 2-3 flow hole FD23, the 2-4 flow hole FD24, the 2-5 flow hole FD25, and the 2-6 flow hole FD26 to communicate with each other. Specifically, when the second communication hole MD22 overlaps any two of the 2-2 flow hole FD22, the 2-3 flow hole FD23, the 2-4 flow hole FD24, the 2-5 flow hole FD25, and the 2-6 flow hole FD26 in the axial direction DRa, the second communication hole MD22 allows the two overlapped flow holes to communicate with each other. When the second communication hole MD22 overlaps any three of the 2-2 flow hole FD22, the 2-3 flow hole FD23, the 2-4 flow hole FD24, the 2-5 flow hole FD25, and the 2-6 flow hole FD26, the second communication hole MD22 allows the three overlapped flow holes to communicate with each other. Accordingly, among the 2-2 flow hole FD22, the 2-3 flow hole FD23, the 2-4 flow hole FD24, the 2-5 flow hole FD25, and the 2-6 flow hole FD26, the flow holes that communicate with each other via the second communication hole MD22 communicate with each other.

In other words, the second communication hole MD22 allows a plurality of ports among the 2-2 port M112, the 2-3 port M113, the 2-4 port M114, the 2-5 port M115, and the 2-6 port M116 to communicate by rotating with the rotation of the shaft M21.

FIG. 10 illustrates an example of a state in which a part of the 2-2 flow hole FD22, the 2-3 flow hole FD23, the 2-4 flow hole FD24, the 2-5 flow hole FD25, and the 2-6 flow hole FD26 communicates with the second through hole MD21 and the second communication hole MD22. FIG. 10 illustrates relative positions of the second through hole MD21 and the second communication hole MD22 with respect to the 2-2 flow hole FD22, the 2-3 flow hole FD23, the 2-4 flow hole FD24, the 2-5 flow hole FD25, and the 2-6 flow hole FD26. Specifically, FIG. 10 illustrates a state in which the second through hole MD21 communicates with the 2-3 flow hole FD23 and the 2-5 flow hole FD25, and the second communication hole MD22 communicates with the 2-2 flow hole FD22, the 2-4 flow hole FD24, and the 2-6 flow hole FD26. In FIG. 10, in order to make the drawings easy to see, a portion of the second fixed disk FD2 covered by the second communication hole MD22 is hatched.

Thus, when the second movable disk MD2 rotates and stops at a predetermined position, the second through hole MD21 communicates with two or three of the 2-2 flow hole FD22, the 2-3 flow hole FD23, the 2-4 flow hole FD24, the 2-5 flow hole FD25, and the 2-6 flow hole FD26. The second through hole MD21 communicates with a port among the 2-2 port M112, the 2-3 port M113, the 2-4 port M114, the 2-5 port M115, and the 2-6 port M116 that corresponds to a flow hole with which the second through hole MD21 communicates. Accordingly, the second through hole MD21 allows a port with which the second through hole MD21 communicates among the 2-2 port M112, the 2-3 port M113, the 2-4 port M114, the 2-5 port M115, and the 2-6 port M116 to communicate with the 2-1 port M111.

When the second movable disk MD2 rotates and stops at a predetermined position, the second communication hole MD22 allows two or three of the 2-2 flow hole FD22, the 2-3 flow hole FD23, the 2-4 flow hole FD24, the 2-5 flow hole FD25, and the 2-6 flow hole FD26 to communicate with each other. The second communication hole MD22 communicates with a port communicating with each of two or three flow holes with which the second communication hole MD22 communicates, among the 2-2 port M112, the 2-3 port M113, the 2-4 port M114, the 2-5 port M115, and the 2-6 port M116. Accordingly, the second communication hole MD22 allows two or three ports with which the second communication hole MD22 communicates among the 2-2 port M112, the 2-3 port M113, the 2-4 port M114, the 2-5 port M115, and the 2-6 port M116 to communicate with each other.

In the present embodiment, a rotation range of the second movable disk MD2 is predetermined, and the second through hole MD21 can communicate with any two or three of the 2-2 flow hole FD22, the 2-3 flow hole FD23, the 2-4 flow hole FD24, and the 2-5 flow hole FD25. Among the 2-2 flow hole FD22, the 2-3 flow hole FD23, the 2-4 flow hole FD24, and the 2-5 flow hole FD25, the flow hole communicating with the second through hole MD21 communicates with the upper flow path VF2 and the lower flow path VF1. Accordingly, the 2-2 port M112, the 2-3 port M113, the 2-4 port M114, and the 2-5 port M115, which communicate with the second through hole MD21, communicate with the 2-1 port M111. That is, the 2-2 opening P22 of the 2-2 port M112, the 2-3 opening P23 of the 2-3 port M113, the 2-4 opening P24 of the 2-4 port M114, and the 2-5 opening P25 of the 2-5 port M115 can communicate with the 2-1 opening P21 of the 2-1 port M111 via the second through hole MD21.

The second through hole MD21 cannot communicate with the 2-6 flow hole FD26. That is, the second through hole MD21 cannot allow the 2-6 port M116 communicating with the 2-6 flow hole FD26 to communicate with the 2-1 port M111.

The second communication hole MD22 communicates with the 2-6 flow hole FD26 and can communicate with at least one of the 2-2 flow hole FD22, the 2-4 flow hole FD24, and the 2-5 flow hole FD25. The second communication hole MD22 allows the 2-6 flow hole FD26 to communicate with one or more of the 2-2 flow hole FD22, the 2-4 flow hole FD24, and the 2-5 flow hole FD25. Accordingly, the 2-6 port M116 communicating with the 2-6 flow hole FD26 communicates with the 2-2 port M112, the 2-4 port M114, and the 2-5 port M115 via the second communication hole MD22. That is, the 2-6 opening P26 of the 2-6 port M116 can communicate with one or more of the 2-2 opening P22 of the 2-2 port M112, the 2-4 opening P24 of the 2-4 port M114, and the 2-5 opening P25 of the 2-5 port M115 via the second communication hole MD22.

The second communication hole MD22 cannot communicate with the 2-3 flow hole FD23. That is, the 2-6 port M116 cannot communicate with the 2-3 port M113 via the second communication hole MD22.

The upper housing M12 is a member that covers the opening side of the lower housing M11. As illustrated in FIG. 6, the upper housing M12 has the bottomed cylindrical shape and includes a lid portion M121 for closing the lower housing M11 and a rib portion M122 that is fitted into the lower housing M11.

The lid portion M121 is a member that covers an opening of the lower housing M11. The lid portion M121 is formed in a disk shape whose outer diameter is substantially the same as an outer diameter of the side wall portion M117 of the lower housing M11. The lid portion M121 has a through hole M123 that supports the shaft M21. The shaft M21 penetrates and is fitted into the through hole M123, and the shaft M21 is rotatably supported.

The rib portion M122 is a portion to be fitted into the opening side of the lower housing M11. The rib portion M122 has a tubular shape and protrudes in the downward direction DRa1 from a surface of the lid portion M121 on the downward direction DRa1 side. An outer diameter of the rib portion M122 is smaller than an inner diameter of the side wall portion M117, and the rib portion M122 can be fitted from the opening side of the lower housing M11.

The O-ring M13 is sandwiched between an outer peripheral surface of the rib portion M122 and an inner peripheral surface of the side wall portion M117. The O-ring M13 is made of urethane rubber, which is an annular elastic body, and is compressed and held between the rib portion M122 and the side wall portion M117.

The drive unit M20 is provided on the upward direction DRa2 side of the upper housing M12. The drive unit M20 is a device for outputting a rotational force for rotating the shaft M21. The drive unit M20 includes a shaft M21, a motor (not illustrated) as a drive source that rotates the shaft M21, and a gear portion (not illustrated) that transmits an output of the motor to the shaft M21. As the motor, for example, a servo motor, a stepping motor, or a brushless motor can be adopted. As the gear portion, for example, a gear mechanism including a helical gear or a spur gear can be adopted. Although not illustrated, the motor rotates according to a control signal from the control device 10 electrically coupled to the motor.

The shaft M21 is a rotation axis that rotates about the shaft axis SC by the rotational force output from the drive unit M20. The shaft M21 extends in the axial direction DRa. Both sides of the shaft M21 in the axial direction DRa are rotatably supported by the housing M10. In a specific example, the shaft M21 has the downward direction DRa1 side rotatably supported in the bearing hole M1182 of the lower housing M11, and the upward direction DRa2 side passing through the through hole M123 of the upper housing M12 so as to be rotatably supported. That is, the shaft M21 has a both-end support structure.

The shaft M21 is rotatably supported by a bearing (not illustrated) provided in the bearing hole M1182 on the downward direction DRa1 side, and is rotatably supported by a bearing (not illustrated) provided in the through hole M123 on the upward direction DRa2 side. As these bearings, a slide bearing, a ball bearing, or the like can be adopted.

The shaft M21 penetrates the second fixed disk FD2 and the second movable disk MD2 and is rotatably supported by the lower housing M11 and the upper housing M12. An end portion of the shaft M21 on the upward direction DRa2 side is connected to the gear portion of the drive unit M20. Accordingly, the output of the motor is transmitted to the shaft M21 via the gear portion.

The shaft M21 has a lower axial portion M211, an upper axial portion M212, and a flange portion M213. The lower axial portion M211, the upper axial portion M212, and the flange portion M213 are integrally formed of, for example, a metal member, and are integrally rotatable by a rotational force output from the motor of the drive unit M20. The lower axial portion M211 and the upper axial portion M212 are connected in this order from the downward direction DRa1 side to the upward direction DRa2 side. The lower axial portion M211 has a smaller outer diameter than the upper axial portion M212. The flange portion M213 is formed at an end portion of the upper axial portion M212 on the downward direction DRa1 side.

The lower axial portion M211 is a rod-shaped member extending in the axial direction DRa and is inserted through the second fixed disk FD2 and the second movable disk MD2. The outer diameter of the lower axial portion M211 is smaller than an inner diameter of the fixed disk hole FD2c of the second fixed disk FD2 and an inner diameter of the movable disk hole MD2b of the second movable disk MD2, and the lower axial portion M211 is not directly connected to the second fixed disk FD2 and the second movable disk MD2. That is, the lower axial portion M211 is not directly fixed to the second fixed disk FD2 and the second movable disk MD2. Therefore, when the lower axial portion M211 rotates, the rotational force of the shaft M21 is not directly transmitted to the second movable disk MD2 by the lower axial portion M211.

In the present embodiment, the lever M30 and the torsion spring M40 for transmitting the rotational force of the shaft M21 to the second movable disk MD2 are provided in the lower housing M11. The second movable disk MD2 is connected to the lower axial portion M211 via the lever M30 and the torsion spring M40. The torsion spring M40 is disposed around the lower axial portion M211 between the lever M30 and the flange portion M213.

The upper axial portion M212 is a rod-shaped member extending in the axial direction DRa and is inserted into the upper housing M12. The compression spring M50 is disposed around the upper axial portion M212.

The flange portion M213 is a portion that supports the torsion spring M40 and the compression spring M50. The flange portion M213 protrudes outward in the shaft radial direction DRr from an end portion of an outer peripheral surface of the upper axial portion M212 on the downward direction DRa1 side, and is formed in an annular thin plate shape having a plate surface in the axial direction DRa.

The flange portion M213 has a hook portion (not illustrated) on the downward direction DRa1 side that faces the shaft circumferential direction DRc of the torsion spring M40, and supports one end portion of the torsion spring M40 in the shaft circumferential direction DRc. The flange portion M213 supports an end portion of the compression spring M50 on the downward direction DRa1 side.

The lever M30 is a coupling member that couples the shaft M21 and the second movable disk MD2 via the torsion spring M40. The lever M30 is fixed to the second movable disk MD2, and integrally rotatably connects the second movable disk MD2 and the shaft M21 while allowing the second movable disk MD2 to be displaced in the axial direction DRa.

The lever M30 has a substantially disk shape with a plate thickness direction in the axial direction DRa, and includes a protrusion (not illustrated) that is press-fitted into the press-fitting groove MD2c of the second movable disk MD2 and an engagement receiving portion (not illustrated) facing the shaft circumferential direction DRc of the torsion spring M40. The lever M30 is connected to the second movable disk MD2 by press-fitting the protrusion into the press-fitting groove MD2c. The lever M30 supports, in the shaft circumferential direction DRc, the end portion of the torsion spring M40 on a side opposite to the side supported by the flange portion M213.

The torsion spring M40 is a torsion coil spring that biases the second movable disk MD2 to one side in the shaft circumferential direction DRc with respect to the housing M10. The torsion spring M40 is formed by being wound in a coil shape around the lower axial portion M211. An inner diameter of the coil of the torsion spring M40 is larger than the outer diameter of the lower axial portion M211. The torsion spring M40 has an end portion on the downward direction DRa1 side in the axial direction DRa connected to the engagement receiving portion of the lever M30 in a relatively non-rotatable manner, and the end portion on the upward direction DRa2 side in the axial direction DRa connected to the hook portion of the flange portion M213 in a relatively non-rotatable manner. The torsion spring M40 is twisted in the shaft circumferential direction DRc to be elastically deformed.

Accordingly, the torsion spring M40 generates a biasing force, by its own elastic deformation, for biasing the second movable disk MD2 to the one side in the shaft circumferential direction DRc. When the rotational force generated by the drive unit M20 is transmitted to the shaft M21, the rotational force is transmitted to the second movable disk MD2 via the flange portion M213, the torsion spring M40, and the lever M30. Then, the second movable disk MD2 rotates about the shaft axis SC integrally with the shaft M21 as the shaft M21 rotates.

The compression spring M50 is an elastic member that biases the second movable disk MD2 in the axial direction DRa. Specifically, the compression spring M50 is a compression coil spring that is elastically deformable in the axial direction DRa by being compressed in the axial direction DRa. The compression spring M50 is formed by being wound in a coil shape around the upper axial portion M212. The compression spring M50 has a coil whose inner diameter is larger than an outer diameter of the upper axial portion M212 and whose outer diameter is smaller than the inner diameter of the torsion spring M40. The compression spring M50 has an end portion on the upward direction DRa2 side supported by the upper housing M12, and an end portion on the downward direction DRa1 side supported by the flange portion M213. The compression spring M50 is disposed between the upper housing M12 and the flange portion M213 in a compressed and elastically deformed state.

Accordingly, the compression spring M50 biases the flange portion M213, the torsion spring M40 and the lever M30 in the downward direction DRa1 by its own elastic deformation, thereby generating a biasing force for biasing the second movable disk MD2 in the downward direction DRa1. Therefore, when the second movable disk MD2 rotates integrally with the shaft M21 by the biasing force of the compression spring M50, the sliding surface MD2a slides against the seal surface FD2a while being pressed against the seal surface FD2a.

The control device 10 is a computer including a memory that is a non-transitory tangible storage medium, a processor, and the like. The control device 10 executes a computer program stored in the memory and executes various control processes according to the computer program. The control device 10 executes the computer program stored in the memory to transmit a control signal for changing the rotational position of the shaft M21 to the second multi-way valve MV2. The second multi-way valve MV2 changes the rotational position of the second movable disk MD2 based on the control signal transmitted from the control device 10.

In the second multi-way valve MV2 thus configured, the 2-1 opening P21 and the 2-6 opening P26, which are the coolant inlets, are opened and closed depending on the rotational position of the second movable disk MD2. In the second multi-way valve MV2, the 2-2 opening P22, the 2-3 opening P23, the 2-4 opening P24, and the 2-5 opening P25, which are the coolant outlets, are opened and closed depending on the rotational position of the second movable disk MD2. In the second multi-way valve MV2, the 2-1 opening P21 and the 2-6 opening P26 communicate with the 2-2 opening P22, the 2-3 opening P23, the 2-4 opening P24, and the 2-5 opening P25 depending on the rotational position of the second movable disk MD2.

Specifically, the 2-1 opening P21 communicates with any two or three of the 2-2 opening P22, the 2-3 opening P23, the 2-4 opening P24, and the 2-5 opening P25 depending on the rotational position of the second movable disk MD2. The 2-6 opening P26 communicates with one or two of the 2-2 opening P22, the 2-4 opening P24, and the 2-5 opening P25 depending on the rotational position of the second movable disk MD2.

The rotational position of the second movable disk MD2 of the second multi-way valve MV2 is adjusted by the control device 10 according to each operation mode of the temperature control device. That is, the coolant outlet communicating with the coolant inlet in the second multi-way valve MV2 is changed according to each operation mode of the temperature control device.

The above is the detailed description of the structure of the second multi-way valve MV2. The first multi-way valve MV1 and the third multi-way valve MV3 have a similar basic structure as the second multi-way valve MV2. The first multi-way valve MV1 and the third multi-way valve MV3 are different from the second multi-way valve MV2 in the number of coolant outlets.

Therefore, in the first multi-way valve MV1, a shape of a first fixed disk FD1 in the first multi-way valve MV1 is different from that of the second fixed disk FD2 according to the number of coolant outlets. In the first multi-way valve MV1, a shape of a first movable disk MD1 in the first multi-way valve MV1 is different from that of the second movable disk MD2.

In the third multi-way valve MV3, a shape of a third fixed disk FD3 in the third multi-way valve MV3 is different from that of the second fixed disk FD2 according to the number of coolant outlets. In the third multi-way valve MV3, a shape of a third movable disk MD3 in the third multi-way valve MV3 is different from that of the second movable disk MD2.

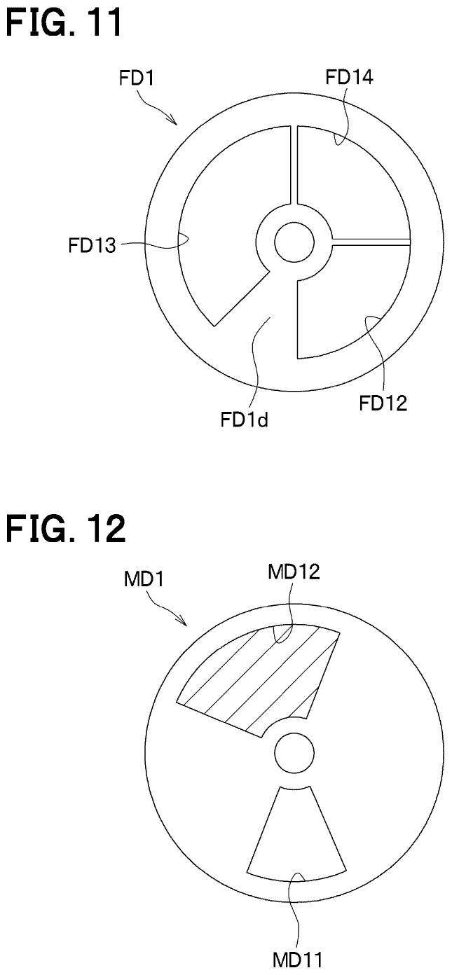

As illustrated in FIG. 11, the first fixed disk FD1 has a 1-2 flow hole FD12 communicating with the 1-2 opening P12, a 1-3 flow hole FD13 communicating with the 1-3 opening P13, and a 1-4 flow hole FD14 communicating with the 1-4 opening P14. The first fixed disk FD1 has three first partition portions FD1d provided between the 1-2 flow hole FD12, the 1-3 flow hole FD13, and the 1-4 flow hole FD14. In the present embodiment, the 1-2 flow hole FD12, the 1-3 flow hole FD13, and the 1-4 flow hole FD14 are provided side by side in this order along the shaft circumferential direction DRc.

As illustrated in FIG. 12, the first movable disk MD1 has one first through hole MD11 penetrating the first movable disk MD1 in the axial direction DRa and one first communication hole MD12 not penetrating the first movable disk MD1.

In the first multi-way valve MV1, the 1-1 opening P11 and the 1-4 opening P14, which are the coolant inlets, are opened and closed depending on the rotational position of the first movable disk MD1. In the first multi-way valve MV1, the 1-2 opening P12 and the 1-3 opening P13, which are the coolant outlets, are opened and closed depending on the rotational position of the first movable disk MD1. In the first multi-way valve MV1, the 1-1 opening P11 and the 1-4 opening P14 communicate with the 1-2 opening P12 and the 1-3 opening P13 depending on the rotational position of the first movable disk MD1.

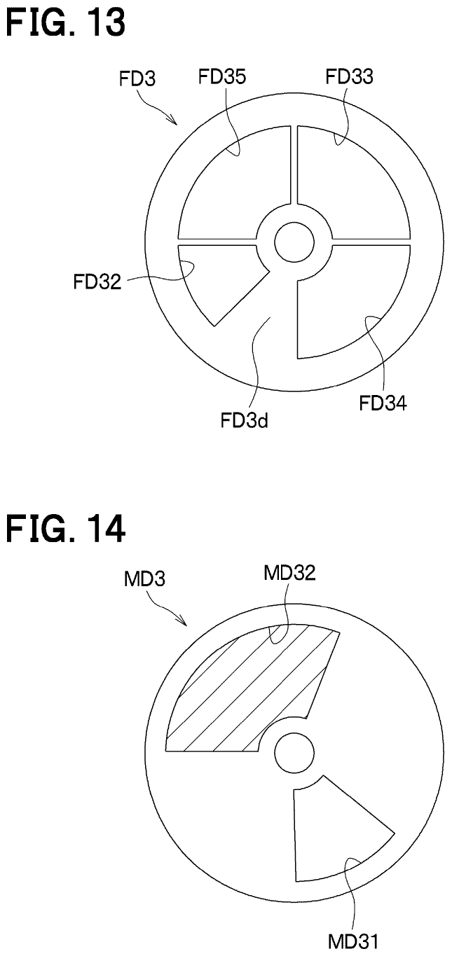

As illustrated in FIG. 13, the third fixed disk FD3 has a 3-2 flow hole FD32 communicating with the 3-2 opening P32, a 3-3 flow hole FD33 communicating with the 3-3 opening P33, and a 3-4 flow hole FD34 communicating with the 3-4 opening P34. Further, the third fixed disk FD3 has a 3-5 flow hole FD35 communicating with the 3-5 opening P35. The third fixed disk FD3 has four third partition portions FD3d provided between the 3-2 flow hole FD32, the 3-3 flow hole FD33, the 3-4 flow hole FD34, and the 3-5 flow hole FD35. In the present embodiment, the 3-2 flow hole FD32, the 3-5 flow hole FD35, the 3-3 flow hole FD33, and the 3-4 flow hole FD34 are provided side by side in this order along the shaft circumferential direction DRc.

As illustrated in FIG. 14, the third movable disk MD3 has one third through hole MD31 penetrating the third movable disk MD3 in the axial direction DRa and one third communication hole MD32 not penetrating the first movable disk MD1.

In the third multi-way valve MV3, the 3-1 opening P31 and the 3-3 opening P33, which are the coolant inlets, are opened and closed depending on a rotational position of a third movable disk MD3. In the third multi-way valve MV3, the 3-2 opening P32, the 3-4 opening P34, and the 3-5 opening P35, which are the coolant outlets, are opened and closed depending on the rotational position of the third movable disk MD3. In the third multi-way valve MV3, the 3-1 opening P31 and the 3-3 opening P33 communicate with the 3-2 opening P32, the 3-4 opening P34, and the 3-5 opening P35 depending on the rotational position of the third movable disk MD3.

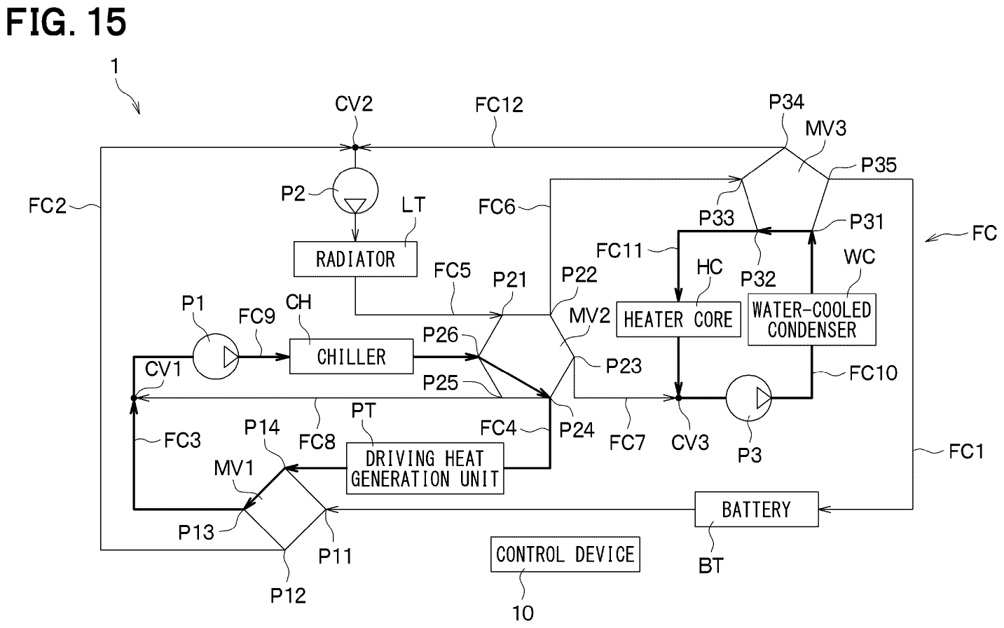

Next, the operation mode of the temperature control device according to the present embodiment will be described. The temperature control device according to the present embodiment can cool and heat the vehicle interior using the vehicle air conditioning device by switching the operation mode. The temperature control device can cool and heat the battery BT, which is a connection device connected to the fluid circuit system 1. The temperature control device can discard heat generated in the driving heat generation unit PT, which is a connection device connected to the temperature control device, and further cool the driving heat generation unit PT. The switching of the operation mode is executed by the control device 10. Hereinafter, among the operation modes executed by the temperature control device according to the present embodiment, six representative operation modes will be described with reference to FIGS. 15 to 20. In FIGS. 15 to 20, a flow of the coolant circulating in the fluid circuit system 1 is indicated by an arrow thicker than an arrow indicating the fluid circuit FC.

In the following description of the six operation modes, the operation mode for heating the battery BT is not included, but the temperature control device according to the present embodiment can also heat the battery BT by guiding the heated coolant to the battery BT.

### (1) 1-1 Mode

The 1-1 mode is an operation mode in which the vehicle interior is heated by utilizing heat of the driving heat generation unit PT that generates heat during operation without cooling or heating the battery BT. In the 1-1 mode, the coolant is circulated by the fluid circuit system 1 as illustrated in FIG. 15. Specifically, in the 1-1 mode, the fluid circuit system 1 operates the first pump P1 to circulate the coolant between the chiller CH and the driving heat generation unit PT using the CV1-P26 flow path FC9, the P24-P14 flow path FC4, and the P13-CV1 flow path FC3.

The driving heat generation unit PT uses heat generated by an operation of the driving heat generation unit PT itself by exchanging heat with the coolant circulating in the fluid circuit FC to heat the coolant. The chiller CH exchanges heat between the low-pressure refrigerant that has passed through the second expansion valve 2c of the refrigeration cycle 2 and the coolant to heat the low-pressure refrigerant.

In the 1-1 mode, the fluid circuit system 1 operates the third pump P3 to circulate the coolant between the water-cooled condenser WC and the heater core HC using the P32-CV3 flow path FC11 and the CV3-P31 flow path FC10.

The water-cooled condenser WC exchanges heat between a high-temperature and high-pressure refrigerant discharged from the compressor 2a of the refrigeration cycle 2 and the coolant circulating through the fluid circuit FC to heat the coolant. The heater core HC exchanges heat between the coolant heated in the water-cooled condenser WC and blown air flowing in the air conditioning case to heat the blown air. The blown air heated by the heater core HC is blown into the vehicle interior to heat the vehicle interior.

In the 1-1 mode, since the coolant is not circulated to the battery BT, the battery BT is not heated or cooled.

When the fluid circuit system 1 circulates the coolant in this way, the first multi-way valve MV1 needs to adjust the rotational position of the first movable disk MD1 to allow the 1-4 opening P14, which is the coolant inlet, to communicate with the 1-3 opening P13, which is the coolant outlet. The second multi-way valve MV2 needs to adjust the rotational position of the second movable disk MD2 to allow the 2-6 opening P26, which is the coolant inlet, to communicate with the 2-4 opening P24, which is the coolant outlet. The third multi-way valve MV3 needs to adjust the rotational position of the third movable disk MD3 to allow the 3-1 opening P31, which is the coolant inlet, to communicate with the 3-2 opening P32, which is the coolant outlet.

### (2) 1-2 Mode

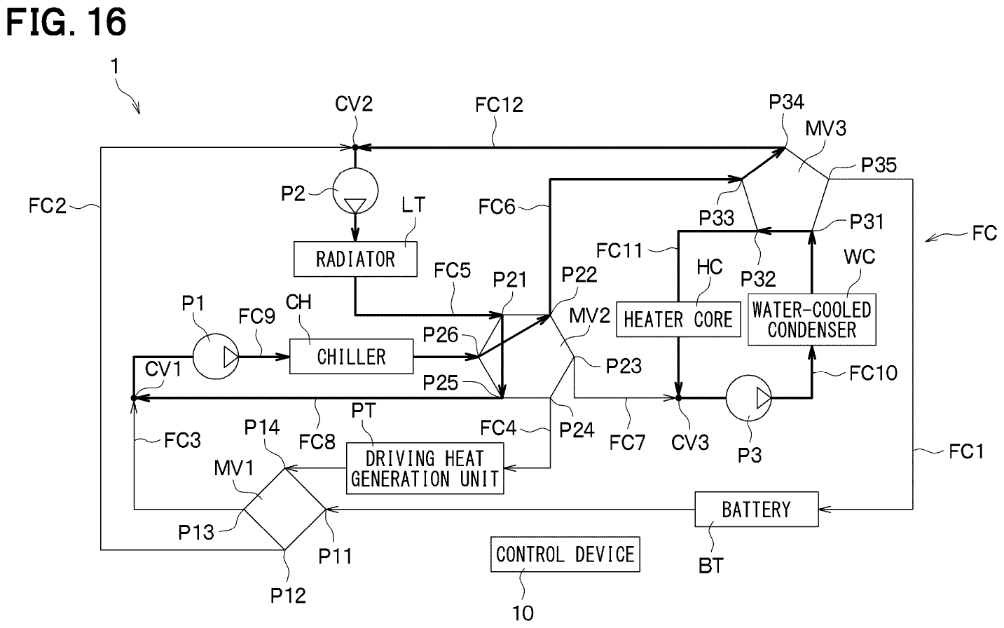

The 1-2 mode is an operation mode in which the vehicle interior is heated without cooling or heating the battery BT and the driving heat generation unit PT. In the 1-2 mode, the coolant is circulated by the fluid circuit system 1 as illustrated in FIG. 16. Specifically, in the 1-2 mode, the fluid circuit system 1 operates the first pump P1 and the second pump P2 to circulate the coolant between the radiator LT and the chiller CH using the P25-CV1 flow path FC8, the CV1-P26 flow path FC9, the P22-P33 flow path FC6, the P34-CV2 flow path FC12, and the CV2-P21 flow path FC5.

The radiator LT absorbs heat from outside air to heat the coolant circulating in the fluid circuit FC. The chiller CH exchanges heat between the coolant heated by absorbing heat from the outside air and the refrigerant circulating in the refrigeration cycle 2 to heat the refrigerant.

In the 1-2 mode, the fluid circuit system 1 operates the third pump P3 to circulate the coolant between the water-cooled condenser WC and the heater core HC using the P32-CV3 flow path FC11 and the CV3-P31 flow path FC10. The water-cooled condenser WC exchanges heat between the high-temperature and high-pressure refrigerant discharged from the compressor 2a of the refrigeration cycle 2 and the coolant circulating through the fluid circuit FC to heat the coolant. The heater core HC exchanges the heat between the coolant heated in the water-cooled condenser WC and the blown air flowing in the air conditioning case to heat the blown air. The blown air heated by the heater core HC is blown into the vehicle interior to heat the vehicle interior.

In the 1-2 mode, since the coolant is not circulated to the battery BT and the driving heat generation unit PT, the battery BT and the driving heat generation unit PT are not heated or cooled. In this case, the heat generated by the operation of the driving heat generation unit PT is stored in the driving heat generation unit PT. In the 1-2 mode, the coolant is not circulated to the battery BT. Therefore, the battery BT is not heated or cooled.

When the fluid circuit system 1 circulates the coolant in this way, the second multi-way valve MV2 needs to adjust the rotational position of the second movable disk MD2 to allow the 2-1 opening P21, which is the coolant inlet, to communicate with the 2-5 opening P25, which is the coolant outlet. Further, the second multi-way valve MV2 needs to adjust the rotational position of the second movable disk MD2 to allow the 2-6 opening P26, which is the coolant inlet, to communicate with the 2-2 opening P22, which is the coolant outlet. The third multi-way valve MV3 needs to adjust the rotational position of the third movable disk MD3 to allow the 3-1 opening P31, which is the coolant inlet, to communicate with the 3-2 opening P32, which is the coolant outlet. Further, the third multi-way valve MV3 needs to adjust the rotational position of the third movable disk MD3 to allow the 3-3 opening P33, which is the coolant inlet, to communicate with the 3-4 opening P34, which is the coolant outlet.

### (3) 1-3 Mode

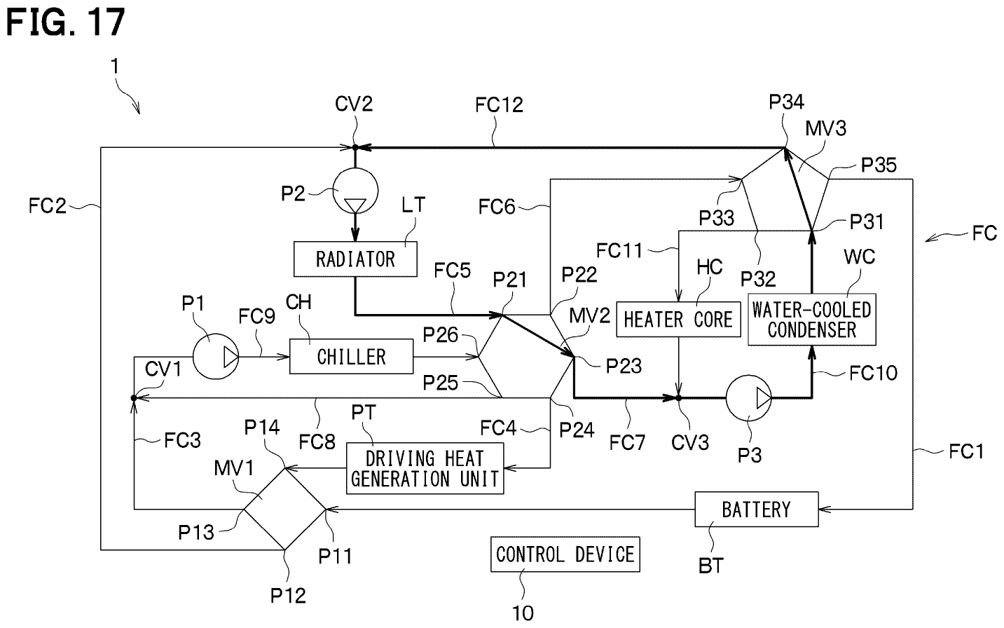

The 1-3 mode is an operation mode in which the vehicle interior is cooled without cooling or heating the battery BT and the driving heat generation unit PT. In the 1-3 mode, the coolant is circulated by the fluid circuit system 1 as illustrated in FIG. 17. Specifically, in the 1-3 mode, the fluid circuit system 1 operates the second pump P2 and the third pump P3 to circulate the coolant between the water-cooled condenser WC and the radiator LT using the CV2-P21 flow path FC5, the P23-CV3 flow path FC7, the CV3-P31 flow path FC10, and the P34-CV2 flow path FC12.

The water-cooled condenser WC exchanges heat between the high-temperature and high-pressure refrigerant discharged from the compressor 2a of the refrigeration cycle 2 and the coolant circulating through the fluid circuit FC to cool the refrigerant and heat the coolant. The radiator LT exchanges heat between the coolant heated by the water-cooled condenser WC and the outside air to cool the coolant.

In the 1-3 mode, since the coolant is not circulated to the battery BT and the driving heat generation unit PT, the battery BT and the driving heat generation unit PT are not heated or cooled. In this case, the heat generated by the operation of the driving heat generation unit PT is stored in the driving heat generation unit PT. In the 1-3 mode, the coolant is not circulated to the battery BT. Therefore, the battery BT is not heated or cooled.

When the fluid circuit system 1 circulates the coolant in this way, the second multi-way valve MV2 needs to adjust the rotational position of the second movable disk MD2 to allow the 2-1 opening P21, which is the coolant inlet, to communicate with the 2-3 opening P23, which is the coolant outlet. The third multi-way valve MV3 needs to adjust the rotational position of the third movable disk MD3 to allow the 3-1 opening P31, which is the coolant inlet, to communicate with the 3-4 opening P34, which is the coolant outlet.

### (4) 1-4 Mode

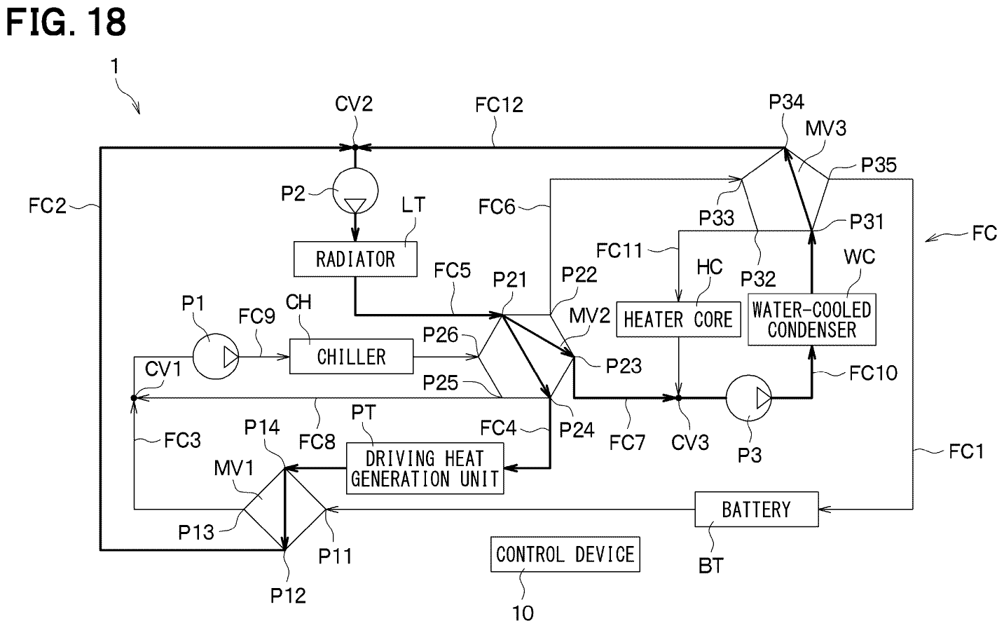

The 1-4 mode is an operation mode in which the vehicle interior is cooled and the driving heat generation unit PT is cooled without cooling or heating the battery BT. In the 1-4 mode, the coolant is circulated by the fluid circuit system 1 as illustrated in FIG. 18. Specifically, in the 1-4 mode, the fluid circuit system 1 operates the second pump P2 and the third pump P3 to circulate the coolant between the water-cooled condenser WC, the radiator LT, and the driving heat generation unit PT using the P12-CV2 flow path FC2, the CV2-P21 flow path FC5, the P24-P14 flow path FC4, the P23-CV3 flow path FC7, the CV3-P31 flow path FC10, and the P34-CV2 flow path FC12.

The water-cooled condenser WC exchanges heat between the high-temperature and high-pressure refrigerant discharged from the compressor 2a of the refrigeration cycle 2 and the coolant circulating through the fluid circuit FC to cool the refrigerant and heat the coolant. The radiator LT exchanges heat between the coolant heated by the water-cooled condenser WC and the outside air to cool the coolant. The driving heat generation unit PT is cooled by exchanging heat with the coolant cooled by the water-cooled condenser WC.

In the 1-4 mode, since the coolant is not circulated to the battery BT, the battery BT is not heated or cooled.

When the fluid circuit system 1 circulates the coolant in this way, the first multi-way valve MV1 needs to adjust the rotational position of the first movable disk MD1 to allow the 1-4 opening P14, which is the coolant inlet, to communicate with the 1-2 opening P12, which is the coolant outlet. The second multi-way valve MV2 needs to adjust the rotational position of the second movable disk MD2 to allow the 2-1 opening P21, which is the coolant inlet, to communicate with the 2-3 opening P23 and the 2-4 opening P24, which are the coolant outlets. The third multi-way valve MV3 needs to adjust the rotational position of the third movable disk MD3 to allow the 3-1 opening P31, which is the coolant inlet, to communicate with the 3-4 opening P34, which is the coolant outlet.

### (5) 1-5 Mode

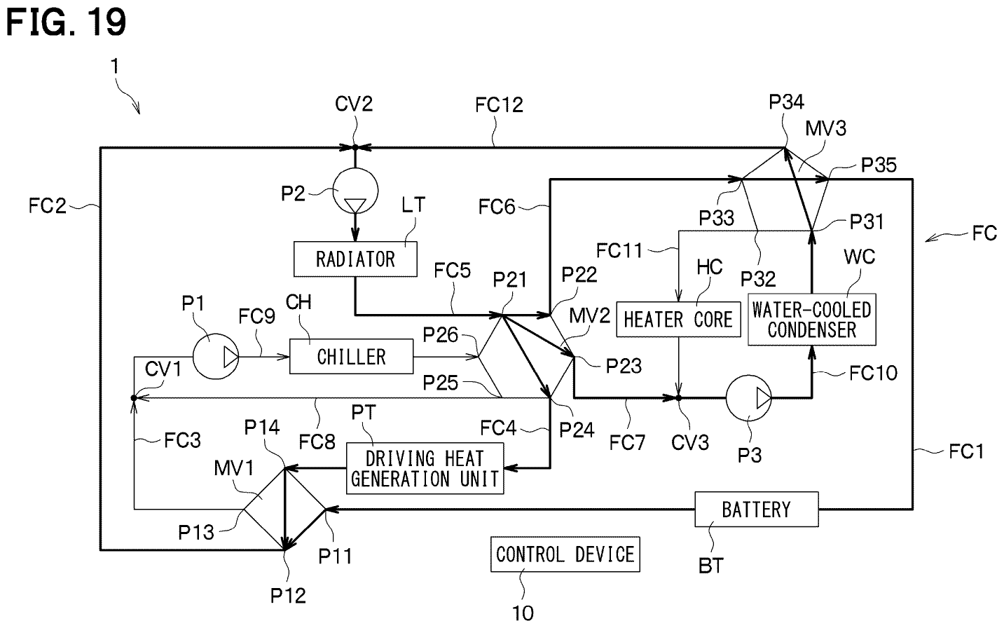

The 1-5 mode is an operation mode in which the vehicle interior is cooled and the battery BT and the driving heat generation unit PT are cooled. In the 1-5 mode, the coolant is circulated by the fluid circuit system 1 as illustrated in FIG. 19. Specifically, in the 1-5 mode, the fluid circuit system 1 operates the second pump P2 and the third pump P3 to circulate the coolant between the water-cooled condenser WC, the radiator LT, the driving heat generation unit PT, and the battery BT using the P12-CV2 flow path FC2, the CV2-P21 flow path FC5, the P24-P14 flow path FC4, the P23-CV3 flow path FC7, the CV3-P31 flow path FC10, the P34-CV2 flow path FC12, the P22-P33 flow path FC6, and the P35-P11 flow path FC1.

The water-cooled condenser WC exchanges heat between the high-temperature and high-pressure refrigerant discharged from the compressor 2a of the refrigeration cycle 2 and the coolant circulating through the fluid circuit FC to cool the refrigerant and heat the coolant. The radiator LT exchanges heat between the coolant heated by the water-cooled condenser WC and the outside air to cool the coolant. The driving heat generation unit PT and the battery BT are cooled by exchanging heat with the coolant cooled by the radiator LT.

When the fluid circuit system 1 circulates the coolant in this way, the first multi-way valve MV1 needs to adjust the rotational position of the first movable disk MD1 to allow the 1-1 opening P11 and the 1-4 opening P14, which are the coolant inlets, to communicate with the 1-2 opening P12, which is the coolant outlet. The second multi-way valve MV2 needs to adjust the rotational position of the second movable disk MD2 to allow the 2-1 opening P21, which is the coolant inlet, to communicate with the 2-2 opening P22, the 2-3 opening P23, and the 2-4 opening P24, which are the coolant outlets. The third multi-way valve MV3 needs to adjust the rotational position of the third movable disk MD3 to allow the 3-1 opening P31, which is the coolant inlet, to communicate with the 3-4 opening P34, which is the coolant outlet. Further, the third multi-way valve MV3 needs to adjust the rotational position of the third movable disk MD3 to allow the 3-3 opening P33, which is the coolant inlet, to communicate with the 3-5 opening P35, which is the coolant outlet.

### (6) 1-6 Mode

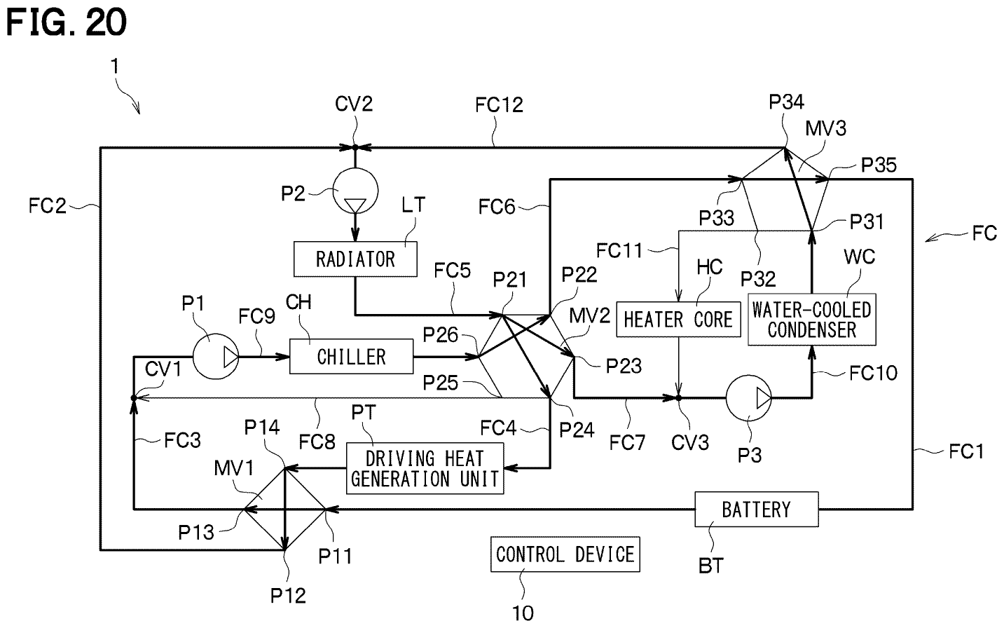

The 1-6 mode is an operation mode in which the vehicle interior is cooled and the battery BT and the driving heat generation unit PT are cooled. The 1-6 mode is a mode for cooling the battery BT further than the 1-5 mode. In the 1-6 mode, the coolant is circulated by the fluid circuit system 1 as illustrated in FIG. 20. Specifically, in the 1-6 mode, the fluid circuit system 1 operates the first pump P1 to circulate the coolant between the chiller CH and the battery BT using the P22-P33 flow path FC6, the P35-P11 flow path FC1, the P13-CV1 flow path FC3, and the CV1-P26 flow path FC9.

The chiller CH evaporates the low-pressure refrigerant passing through the second expansion valve 2c of the refrigeration cycle 2 and absorbs heat from the coolant circulating in the fluid circuit FC. The battery BT is cooled by exchanging heat with the coolant cooled by heat absorbing in the chiller CH.

In the 1-6 mode, the fluid circuit system 1 operates the second pump P2 and the third pump P3 to circulate the coolant between the water-cooled condenser WC, the radiator LT, and the driving heat generation unit PT using the P12-CV2 flow path FC2, the CV2-P21 flow path FC5, the P24-P14 flow path FC4, the P23-CV3 flow path FC7, the CV3-P31 flow path FC10, and the P34-CV2 flow path FC12.

The water-cooled condenser WC exchanges heat between the high-temperature and high-pressure refrigerant discharged from the compressor 2a of the refrigeration cycle 2 and the coolant circulating through the fluid circuit FC to cool the refrigerant and heat the coolant. The radiator LT exchanges heat between the coolant heated by the water-cooled condenser WC and the outside air to cool the coolant. The driving heat generation unit PT is cooled by exchanging heat with the coolant cooled by the radiator LT.

When the fluid circuit system 1 circulates the coolant in this way, the first multi-way valve MV1 needs to adjust the rotational position of the first movable disk MD1 to allow the 1-1 opening P11, which is the coolant inlet, to communicate with the 1-3 opening P13, which is the coolant outlet. Further, the first multi-way valve MV1 needs to adjust the rotational position of the first movable disk MD1 to allow the 1-4 opening P14, which is the coolant inlet, to communicate with the 1-2 opening P12, which is the coolant outlet. The second multi-way valve MV2 needs to adjust the rotational position of the second movable disk MD2 to allow the 2-1 opening P21, which is the coolant inlet, to communicate with the 2-3 opening P23 and the 2-4 opening P24, which are the coolant outlets. Further, the second multi-way valve MV2 needs to adjust the rotational position of the second movable disk MD2 to allow the 2-6 opening P26, which is the coolant inlet, to communicate with the 2-2 opening P22, which is the coolant outlet. The third multi-way valve MV3 needs to adjust the rotational position of the third movable disk MD3 to allow the 3-1 opening P31, which is the coolant inlet, to communicate with the 3-4 opening P34, which is the coolant outlet. Further, the third multi-way valve MV3 needs to adjust the rotational position of the third movable disk MD3 to allow the 3-3 opening P33, which is the coolant inlet, to communicate with the 3-5 opening P35, which is the coolant outlet.

It is assumed that the temperature control device can execute such six operation modes. In this case, according to the operation mode, the fluid circuit system 1 needs to open and close the coolant inlet through which the coolant flows into each of the first multi-way valve MV1 to the third multi-way valve MV3 and open and close the coolant outlet through which the coolant flows out. Specifically, in the fluid circuit system 1, it is necessary to open the coolant inlet and the coolant outlet of each of the first multi-way valve MV1, the second multi-way valve MV2, and the third multi-way valve MV3, which are connected to the connection device that requires the flow of the coolant in each operation mode.

In a circuit system including a plurality of valve devices such as the first multi-way valve MV1 to the third multi-way valve MV3 according to the present embodiment, a coolant inlet and a coolant outlet that are not connected to the connection device that requires the flow of the coolant are generally closed. This is to prevent the coolant from flowing into the connection device that does not require the coolant to flow in each operation mode by opening the coolant inlet and the coolant outlet connected to the connection device that does not require the coolant to flow.

Hereinafter, among the plurality of coolant inlets of each of the first multi-way valve MV1 to the third multi-way valve MV3, the coolant inlet connected to the connection device that does not require the coolant to flow is referred to as an unnecessary inlet. The coolant inlet connected to the connection device that does not require the coolant to flow is referred to as an unnecessary outlet.

For example, in the 1-1 mode in which the coolant flows through the driving heat generation unit PT and the chiller CH, of the 1-1 opening P11 and the 1-4 opening P14 which are the coolant inlets of the first multi-way valve MV1, the 1-1 opening P11 connected to the battery BT is the unnecessary inlet. In the 1-1 mode, of the 1-2 opening P12 and the 1-3 opening P13 which are the coolant outlets of the first multi-way valve MV1, the 1-2 opening P12 connected to the radiator LT is the unnecessary inlet.

In the 1-1 mode in which the coolant flows through the driving heat generation unit PT and the chiller CH, of the 2-1 opening P21 and the 2-6 opening P26 that are the coolant inlet of the second multi-way valve MV2, the 2-1 opening P21 portion connected to the radiator LT is the unnecessary inlet. In the 1-1 mode, among the 2-2 opening P22, the 2-3 opening P23, the 2-4 opening P24, and the 2-5 opening P25, which are the coolant outlets of the second multi-way valve MV2, the 2-2 opening P22 connected to the battery BT is the unnecessary outlet. The 2-3 opening P23 connected to the water-cooled condenser WC and the 2-5 opening P25 connected to the chiller CH are the unnecessary outlets.

It is assumed that the fluid circuit system 1 according to the present embodiment is configured to close all the unnecessary inlets and the unnecessary outlets of the first multi-way valve MV1 to the third multi-way valve MV3 when the temperature control device executes the six operation modes. A hypothetical configuration of the first multi-way valve MV1 to the third multi-way valve MV3 when such a fluid circuit system 1 closes the unnecessary inlet and the unnecessary outlet of each of the first multi-way valve MV1 to the third multi-way valve MV3 will be described. Hereinafter, the configuration of the first multi-way valve MV1 to the third multi-way valve MV3 when the fluid circuit system 1 closes the unnecessary inlet and the unnecessary outlet of the first multi-way valve MV1 to the third multi-way valve MV3 is referred to as a closed configuration.

When the temperature control device executes the 1-1 mode and the first multi-way valve MV1 is in the closed configuration, the first multi-way valve MV1 allows the 1-4 opening P14 to communicate with the 1-3 opening P13, but needs to close the 1-1 opening P11 and the 1-2 opening P12. When the second multi-way valve MV2 is in the closed configuration, the second multi-way valve MV2 allows the 2-6 opening P26 to communicate with the 2-4 opening P24, but needs to close the 2-2 opening P22, the 2-3 opening P23, and the 2-5 opening P25. When the third multi-way valve MV3 is in the closed configuration, the third multi-way valve MV3 allows the 3-1 opening P31 to communicate with the 3-2 opening P32, but needs to close the 3-3 opening P33, the 3-4 opening P34, and the 3-5 opening P35.

When the temperature control device executes the 1-2 mode and the second multi-way valve MV2 is in the closed configuration, the second multi-way valve MV2 allows the 2-1 opening P21 to communicate with the 2-5 opening P25 and allows the 2-6 opening P26 to communicate with the 2-2 opening P22. However, the second multi-way valve MV2 needs to close the 2-3 opening P23 and the 2-4 opening P24. When the third multi-way valve MV3 is in the closed configuration, the third multi-way valve MV3 allows the 3-1 opening P31 to communicate with the 3-2 opening P32 and allows the 3-3 opening P33 to communicate with the 3-4 opening P34. However, the third multi-way valve MV3 needs to close the 3-5 opening P35.

When the temperature control device executes the 1-3 mode and the second multi-way valve MV2 is in the closed configuration, the second multi-way valve MV2 allows the 2-1 opening P21 to communicate with the 2-3 opening P23. However, the second multi-way valve MV2 needs to close the 2-2 opening P22, the 2-4 opening P24, the 2-5 opening P25, and the 2-6 opening P26. When the third multi-way valve MV3 is in the closed configuration, the third multi-way valve MV3 allows the 3-1 opening P31 to communicate with the 3-4 opening P34, but needs to close the 3-2 opening P32, the 3-3 opening P33, and the 3-5 opening P35.

When the temperature control device executes the 1-4 mode and the first multi-way valve MV1 is in the closed configuration, the first multi-way valve MV1 allows the 1-4 opening P14 to communicate with the 1-2 opening P12, but needs to close the 1-1 opening P11 and the 1-3 opening P13. When the second multi-way valve MV2 is in the closed configuration, the second multi-way valve MV2 allows the 2-1 opening P21 to communicate with the 2-3 opening P23 and the 2-4 opening P24. However, the second multi-way valve MV2 needs to close the 2-2 opening P22, the 2-5 opening P25, and the 2-6 opening P26. When the third multi-way valve MV3 is in the closed configuration, the third multi-way valve MV3 allows the 3-1 opening P31 to communicate with the 3-4 opening P34, but needs to close the 3-2 opening P32, the 3-3 opening P33, and the 3-5 opening P35.

When the temperature control device executes the 1-5 mode and the first multi-way valve MV1 is in the closed configuration, the first multi-way valve MV1 allows the 1-1 opening P11 and the 1-4 opening P14 to communicate with the 1-2 opening P12, but needs to close the 1-3 opening P13. When the second multi-way valve MV2 is in the closed configuration, the second multi-way valve MV2 allows the 2-1 opening P21 to communicate with the 2-2 opening P22, the 2-3 opening P23, and the 2-4 opening P24, but needs to close the 2-5 opening P25 and the 2-6 opening P26. When the third multi-way valve MV3 is in the closed configuration, the third multi-way valve MV3 allows the 3-1 opening P31 to communicate with the 3-4 opening P34 and allows the 3-3 opening P33 to communicate with the 3-5 opening P35, but needs to close the 3-2 opening P32.

When the temperature control device executes the 1-6 mode and the second multi-way valve MV2 is in the closed configuration, the second multi-way valve MV2 allows the 2-1 opening P21 to communicate with the 2-3 opening P23 and the 2-4 opening P24. The second multi-way valve MV2 allows the 2-6 opening P26 to communicate with the 2-2 opening P22. However, the second multi-way valve MV2 needs to close the 2-5 opening P25. When the third multi-way valve MV3 is in the closed configuration, the third multi-way valve MV3 allows the 3-1 opening P31 to communicate with the 3-4 opening P34 and allows the 3-3 opening P33 to communicate with the 3-5 opening P35, but needs to close the 3-2 opening P32.

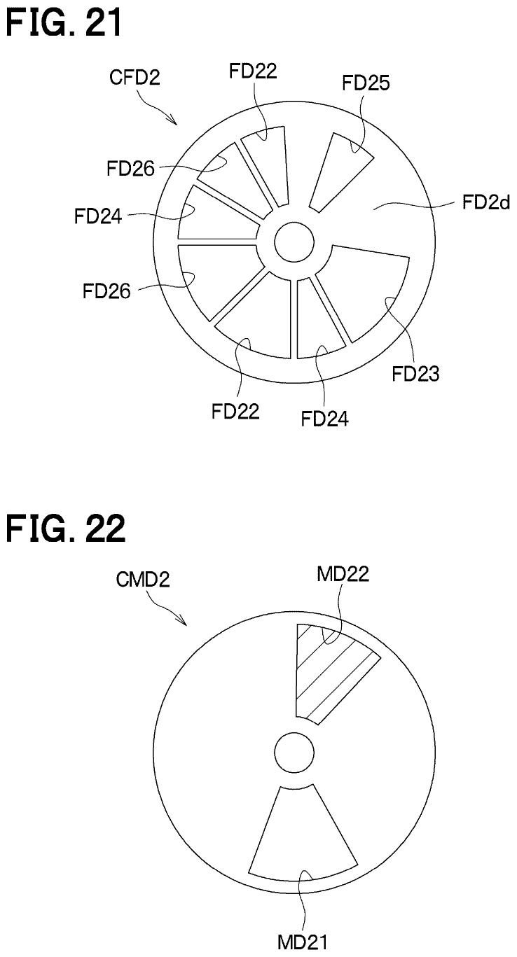

A comparative example in which the first multi-way valve MV1 to the third multi-way valve MV3 are in the closed configuration in all of the six operation modes as described above will be described with reference to comparative examples of FIGS. 21 to 29. FIGS. 21 to 29 illustrate comparative configurations for the fluid circuit system 1 to close all of the unnecessary inlets and the unnecessary outlets of the first multi-way valve MV1 to the third multi-way valve MV3 in all of the six operation modes. In the comparative configuration, the second fixed disk FD2 of the second multi-way valve MV2 is replaced with a comparative second fixed disk CFD2, and the second movable disk MD2 is replaced with a comparative second movable disk CMD2. The third fixed disk FD3 of the third multi-way valve MV3 is replaced with a comparative third fixed disk CFD3.

Specifically, as illustrated in FIG. 21, the comparative second fixed disk CFD2 is different from the second fixed disk FD2 in shapes of the 2-2 flow hole FD22, the 2-3 flow hole FD23, the 2-4 flow hole FD24, the 2-5 flow hole FD25, and the 2-6 flow hole FD26. The comparative second fixed disk CFD2 is configured to close an unnecessary inlet and an unnecessary outlet in each of the six operation modes.

Specifically, in the comparative second fixed disk CFD2, sizes of the 2-2 flow hole FD22, the 2-3 flow hole FD23, the 2-4 flow hole FD24, the 2-5 flow hole FD25, and the 2-6 flow hole FD26 are smaller than those of the second fixed disk FD2. In the comparative second fixed disk CFD2, two 2-2 flow holes FD22, two 2-4 flow holes FD24, and two 2-6 flow holes FD26 are formed. Further, in the comparative second fixed disk CFD2, a range in which the flow holes are formed is smaller than that of the second fixed disk FD2. That is, a proportion of the flow holes in the comparative second fixed disk CFD2 is smaller than that in the second fixed disk FD2.

The two 2-2 flow holes FD22, the two 2-4 flow holes FD24, and the two 2-6 flow holes FD26 communicate with each other in the housing M10 by a communication mechanism (not illustrated) provided in the housing M10.

As illustrated in FIG. 22, the comparative second movable disk CMD2 is different from the second movable disk MD2 in shapes of the second through hole MD21 and the second communication hole MD22. The comparative second movable disk CMD2 corresponds to the comparative second fixed disk CFD2 in which the sizes of the 2-2 flow hole FD22, the 2-3 flow hole FD23, the 2-4 flow hole FD24, the 2-5 flow hole FD25, and the 2-6 flow hole FD26 are smaller than those of the second fixed disk FD2. Specifically, in the comparative second movable disk CMD2, a size of each of the second through hole MD21 and the second communication hole MD22 is smaller than that of the second movable disk MD2.

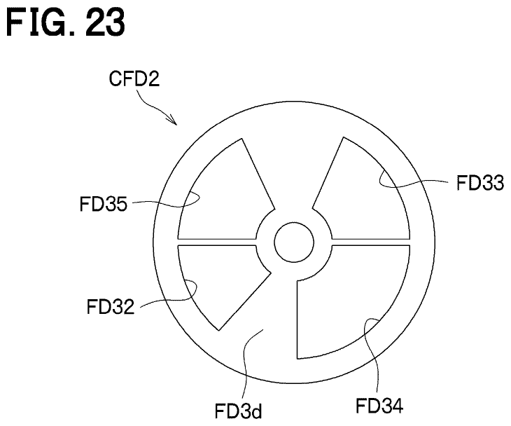

As illustrated in FIG. 23, the comparative third fixed disk CFD3 is different from the third fixed disk FD3 in shapes of the 3-3 flow hole FD33 and the 3-5 flow hole FD35. The comparative third fixed disk CFD3 is configured to close an unnecessary inlet and an unnecessary outlet in each of the six operation modes.

Specifically, in the comparative third fixed disk CFD3, the size of each of the 3-3 flow hole FD33 and the 3-5 flow hole FD35 is smaller than that of the third fixed disk FD3. Further, in the comparative third fixed disk CFD3, a range in which the flow hole is formed is smaller than that of the third fixed disk FD3. That is, a proportion of the flow holes in the comparative third fixed disk CFD3 is smaller than that in the third fixed disk FD3.

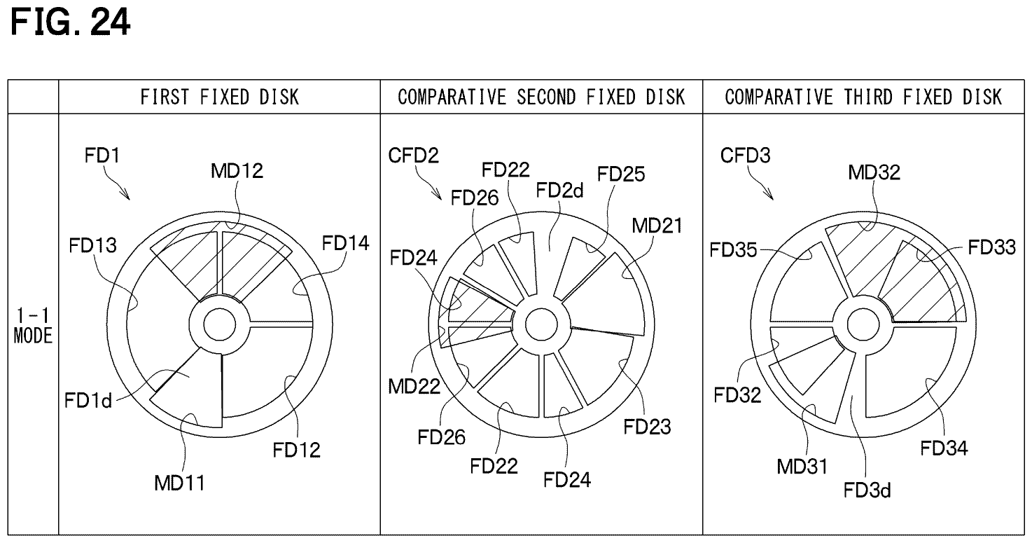

Each operation mode when the second multi-way valve MV2 has the comparative second fixed disk CFD2 and the comparative second movable disk CMD2 and the third multi-way valve MV3 has the comparative third fixed disk CFD3 will be described with reference to FIGS. 24 to 29. FIGS. 24 to 29 illustrate relative positions of the first through hole MD11 and the first communication hole MD12 with respect to the 1-2 flow hole FD12, the 1-3 flow hole FD13, and the 1-4 flow hole FD14 of the first fixed disk FD1 in the six operation modes. FIGS. 24 to 29 illustrate relative positions of the second through hole MD21 and the second communication hole MD22 with respect to the 2-2 flow hole FD22, the 2-3 flow hole FD23, the 2-4 flow hole FD24, the 2-5 flow hole FD25, and the 2-6 flow hole FD26 of the comparative second fixed disk CFD2 in the six operation modes. FIGS. 24 to 29 illustrate relative positions of the third through hole MD31 and the third communication hole MD32 with respect to the 3-2 flow hole FD32, the 3-3 flow hole FD33, the 3-4 flow hole FD34, and the 3-5 flow hole FD35 of the comparative third fixed disk CFD3 in the six operation modes. In FIGS. 24 to 29, in order to make the drawings easy to see, a portion covered by the first communication hole MD12 with respect to the first fixed disk FD1 and a portion covered by the second communication hole MD22 with respect to the comparative second fixed disk CFD2 are hatched. A portion covered by the third communication hole MD32 with respect to the comparative third fixed disk CFD3 is hatched.

First, the 1-1 mode will be described. When the operation mode of the temperature control device is set to the 1-1 mode, the first movable disk MD1 is positioned at a rotational position illustrated in FIG. 24. Specifically, when the operation mode is set to the 1-1 mode, the first movable disk MD1 is positioned at a position where the first through hole MD11 faces the first partition portion FD1d. The first movable disk MD1 is positioned at a position where the first communication hole MD12 communicates with the 1-3 flow hole FD13 and the 1-4 flow hole FD14. The 1-2 flow hole FD12 does not face either the first through hole MD11 or the first communication hole MD12.

Accordingly, since the first through hole MD11 is closed by the first partition portion FD1d, the 1-1 opening P11 does not communicate with any of the 1-2 flow hole FD12, the 1-3 flow hole FD13, and the 1-4 flow hole FD14. Therefore, the 1-1 opening P11 is closed. The 1-4 opening P14 communicates with the 1-3 opening P13 via the 1-4 flow hole FD14, the first communication hole MD12, and the 1-3 flow hole FD13. The 1-2 flow hole FD12 is closed by the first movable disk MD1 without communicating with either the first through hole MD11 or the first communication hole MD12. Therefore, the 1-2 opening P12 is closed.

When the operation mode of the temperature control device is set to the 1-1 mode, the comparative second movable disk CMD2 is positioned at a position where the second through hole MD21 faces the second partition portion FD2d. The comparative second movable disk CMD2 is positioned at a position where the second communication hole MD22 communicates with one of the two 2-6 flow holes FD26 and one of the two 2-4 flow holes FD24. The two 2-2 flow holes FD22, the 2-3 flow hole FD23, the other of the two 2-4 flow holes FD24, the 2-5 flow hole FD25, and the other of the two 2-6 flow holes FD26 do not face either the second through hole MD21 or the second communication hole MD22.

Accordingly, since the second through hole MD21 is closed by the second partition portion FD2d, the 2-1 opening P21 does not communicate with any of the 2-2 flow hole FD22, the 2-3 flow hole FD23, the 2-4 flow hole FD24, the 2-5 flow hole FD25, and the 2-6 flow hole FD26. The 2-6 opening P26 communicates with the 2-4 opening P24 via one 2-6 flow hole FD26, the second communication hole MD22, and one 2-4 flow hole FD24. The 2-2 flow hole FD22, the 2-3 flow hole FD23, and the 2-5 flow hole FD25 do not communicate with either the second through hole MD21 or the second communication hole MD22, and are closed by the comparative second movable disk CMD2. Therefore, the 2-2 opening P22, the 2-3 opening P23, and the 2-5 opening P25 are closed.

When the operation mode of the temperature control device is set to the 1-1 mode, the third movable disk MD3 is positioned at a position where the third through hole MD31 communicates with the 3-2 flow hole FD32. The third movable disk MD3 is positioned at a position where the third communication hole MD32 faces the 3-3 flow hole FD33. The 3-4 flow hole FD34 and the 3-5 flow hole FD35 do not face either the third through hole MD31 or the third communication hole MD32.

Accordingly, the 3-1 opening P31 communicates with the 3-2 opening P32 via the third through hole MD31 and the 3-2 flow hole FD32. The 3-3 flow hole FD33 is closed by the third communication hole MD32. Therefore, the 3-3 opening P33 is closed. The 3-4 flow hole FD34 and the 3-5 flow hole FD35 do not communicate with either the third through hole MD31 or the third communication hole MD32, and are closed by the third movable disk MD3. Therefore, the 3-4 opening P34 and the 3-5 opening P35 are closed.

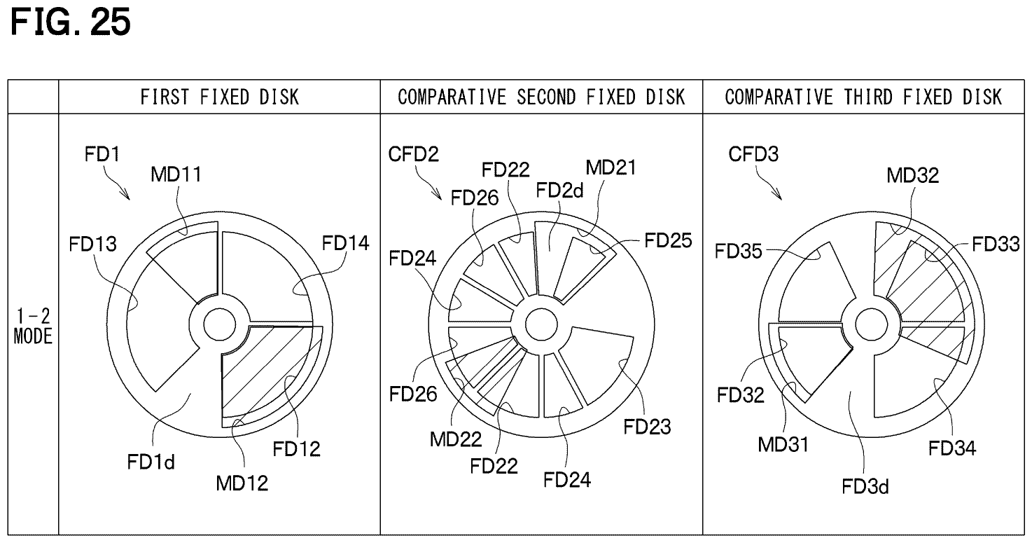

Next, the 1-2 mode will be described. When the operation mode of the temperature control device is set to the 1-2 mode, the first movable disk MD1 is positioned at a rotational position illustrated in FIG. 25. Specifically, when the operation mode is set to the 1-2 mode, the first movable disk MD1 is positioned at a position where the first through hole MD11 communicates with the 1-3 flow hole FD13, and the first communication hole MD12 communicates with the 1-2 flow hole FD12. The 1-4 flow hole FD14 does not face either the first through hole MD11 or the first communication hole MD12.

Accordingly, the 1-1 opening P11 communicates with the 1-3 opening P13 via the first through hole MD11 and the 1-3 flow hole FD13. The 1-2 flow hole FD12 is closed by the first communication hole MD12. Therefore, the 1-2 opening P12 is closed. The 1-4 flow hole FD14 is closed by the first movable disk MD1 without communicating with either the first through hole MD11 or the first communication hole MD12. Therefore, the 1-4 opening P14 is closed.

When the operation mode of the temperature control device is set to the 1-2 mode, the comparative second movable disk CMD2 is positioned at a position where the second through hole MD21 communicates with the 2-5 flow hole FD25. The comparative second movable disk CMD2 is positioned at a position where the second communication hole MD22 communicates with one of the two 2-6 flow holes FD26 and one of the two 2-2 flow holes FD22. The other of the two 2-2 flow holes FD22, the 2-3 flow hole FD23, the two 2-4 flow holes FD24, and the other of the two 2-6 flow holes FD26 do not face either the second through hole MD21 or the second communication hole MD22.

Accordingly, the 2-1 opening P21 communicates with the 2-5 opening P25 via the second through hole MD21 and the 2-5 flow hole FD25. The 2-6 opening P26 communicates with the 2-2 opening P22 via the one 2-6 flow hole FD26, the second communication hole MD22, and the one 2-2 flow hole FD22. The 2-3 flow hole FD23 and the 2-4 flow hole FD24 do not communicate with either the second through hole MD21 or the second communication hole MD22, and are closed by the comparative second movable disk CMD2. Therefore, the 2-3 opening P23 and the 2-4 opening P24 are closed.

When the operation mode of the temperature control device is set to the 1-2 mode, the third movable disk MD3 is positioned at a position where the third through hole MD31 communicates with the 3-2 flow hole FD32. The third movable disk MD3 is positioned at a position where the third communication hole MD32 communicates with the 3-3 flow hole FD33 and the 3-4 flow hole FD34. The 3-5 flow hole FD35 does not face either the third through hole MD31 or the third communication hole MD32.

Accordingly, the 3-1 opening P31 communicates with the 3-2 opening P32 via the third through hole MD31 and the 3-2 flow hole FD32. The 3-3 opening P33 communicates with the 3-4 opening P34 via the 3-3 flow hole FD33, the third communication hole MD32, and the 3-4 flow hole FD34. The 3-5 flow hole FD35 is closed by the third movable disk MD3 without communicating with either the third through hole MD31 or the third communication hole MD32. Therefore, the 3-5 opening P35 is closed.

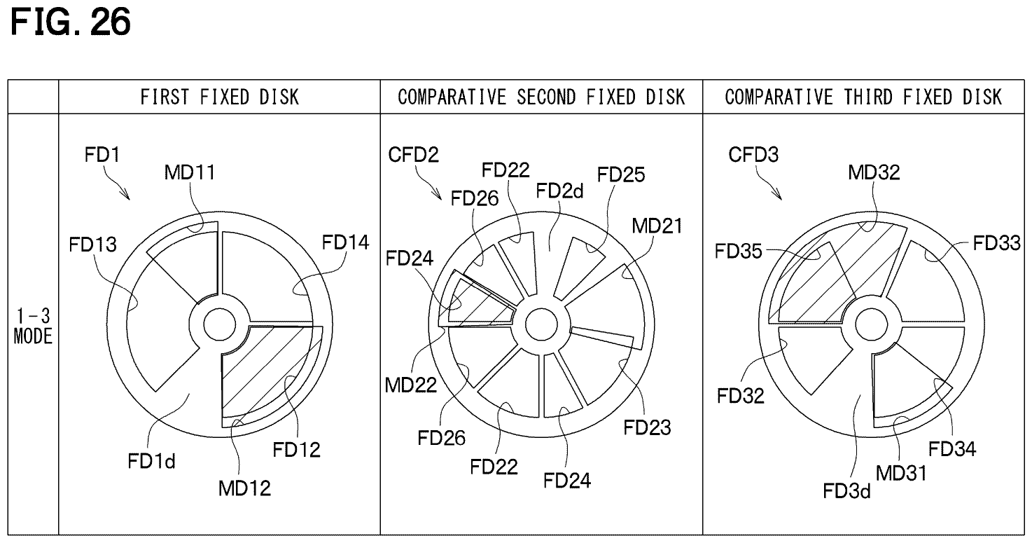

Next, the 1-3 mode will be described. When the operation mode of the temperature control device is set to the 1-3 mode, the first movable disk MD1 is positioned at a rotational position illustrated in FIG. 26. Specifically, when the operation mode is set to the 1-3 mode, the first movable disk MD1 is positioned at a position where the first through hole MD11 communicates with the 1-3 flow hole FD13, and the first communication hole MD12 communicates with the 1-2 flow hole FD12. The 1-4 flow hole FD14 does not face either the first through hole MD11 or the first communication hole MD12.

Accordingly, the 1-1 opening P11 communicates with the 1-3 opening P13 via the first through hole MD11 and the 1-3 flow hole FD13. The 1-2 flow hole FD12 is closed by the first communication hole MD12. Therefore, the 1-2 opening P12 is closed. The 1-4 flow hole FD14 is closed by the first movable disk MD1 without communicating with either the first through hole MD11 or the first communication hole MD12. Therefore, the 1-4 opening P14 is closed.

When the operation mode of the temperature control device is set to the 1-3 mode, the comparative second movable disk CMD2 is positioned at a position where the second through hole MD21 slightly communicates with the 2-3 flow hole FD23. The comparative second movable disk CMD2 is positioned at a position where the second communication hole MD22 communicates with one of the two 2-4 flow holes FD24. The two 2-2 flow holes FD22, the other of the two 2-4 flow holes FD24, the 2-5 flow hole FD25, and the two 2-6 flow holes FD26 do not face either the second through hole MD21 or the second communication hole MD22.

Accordingly, the 2-1 opening P21 communicates with the 2-3 opening P23 via the second through hole MD21 and the 2-3 flow hole FD23. The one of the two 2-4 flow holes FD24 is closed by the second communication hole MD22, and the other is closed by the comparative second movable disk CMD2. Therefore, the 2-4 opening P24 is closed. The 2-2 flow hole FD22, the 2-5 flow hole FD25, and the two 2-6 flow holes FD26 do not communicate with either the second through hole MD21 or the second communication hole MD22, and are closed by the comparative second movable disk CMD2. Therefore, the 2-2 opening P22, the 2-3 opening P23, the 2-5 opening P25, and the 2-6 opening P26 are closed.

When the operation mode of the temperature control device is set to the 1-3 mode, the third movable disk MD3 is positioned at a position where the third through hole MD31 communicates with the 3-4 flow hole FD34, and the third communication hole MD32 communicates with the 3-5 flow hole FD35. The 3-2 flow hole FD32 and the 3-3 flow hole FD33 do not face either the third through hole MD31 or the third communication hole MD32.

Accordingly, the 3-1 opening P31 communicates with the 3-4 opening P34 via the third through hole MD31 and the 3-4 flow hole FD34. The 3-5 flow hole FD35 is closed by the third communication hole MD32. Therefore, the 3-5 opening P35 is closed. The 3-2 flow hole FD32 and the 3-3 flow hole FD33 do not communicate with either the third through hole MD31 or the third communication hole MD32, and are closed by the third movable disk MD3. Therefore, the 3-2 opening P32 and the 3-3 opening P33 are closed.

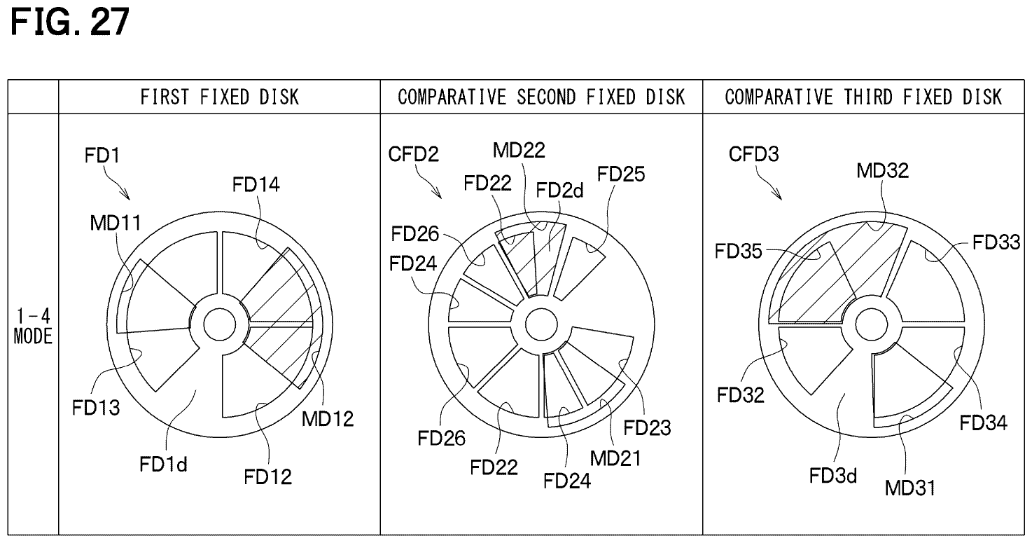

Next, the 1-4 mode will be described. When the operation mode of the temperature control device is set to the 1-4 mode, the first movable disk MD1 is positioned at a rotational position illustrated in FIG. 27. Specifically, when the operation mode is set to the 1-4 mode, the first movable disk MD1 is positioned at a position where the first through hole MD11 communicates with the 1-3 flow hole FD13. The first movable disk MD1 is positioned at a position where the first communication hole MD12 communicates with the 1-2 flow hole FD12 and the 1-4 flow hole FD14.

Accordingly, the 1-1 opening P11 communicates with the 1-3 opening P13 via the first through hole MD11 and the 1-3 flow hole FD13. The 1-4 opening P14 communicates with the 1-2 opening P12 via the 1-4 flow hole FD14, the first communication hole MD12, and the 1-2 flow hole FD12.

When the operation mode of the temperature control device is set to the 1-4 mode, the comparative second movable disk CMD2 is positioned at a position where the second through hole MD21 communicates with the 2-3 flow hole FD23 and one of the two 2-4 flow holes FD24. The comparative second movable disk CMD2 is positioned at a position where the second communication hole MD22 communicates with the one of the two 2-2 flow holes FD22. The other of the two 2-2 flow holes FD22, the other of the two 2-4 flow holes FD24, the 2-5 flow hole FD25, and the two 2-6 flow holes FD26 do not face either the second through hole MD21 or the second communication hole MD22.

Accordingly, the 2-1 opening P21 communicates with the 2-3 opening P23 via the second through hole MD21 and the 2-3 flow hole FD23, and communicates with the 2-4 opening P24 via the second through hole MD21 and the one 2-4 flow hole FD24. The one 2-2 flow hole FD22 is closed by the second communication hole MD22, and the other 2-2 flow hole FD22 does not communicate with either the second through hole MD21 or the second communication hole MD22 and is closed by the comparative second movable disk CMD2. Therefore, the 2-2 opening P22 is closed. The 2-5 flow hole FD25 and the two 2-6 flow holes FD26 do not communicate with either the second through hole MD21 or the second communication hole MD22, and are closed by the comparative second movable disk CMD2. Therefore, the 2-5 opening P25 and the 2-6 opening P26 are closed.

When the operation mode of the temperature control device is set to the 1-4 mode, the third movable disk MD3 is positioned at a position where the third through hole MD31 communicates with the 3-4 flow hole FD34, and the third communication hole MD32 communicates with the 3-5 flow hole FD35. The 3-2 flow hole FD32 and the 3-3 flow hole FD33 do not face either the third through hole MD31 or the third communication hole MD32.

Accordingly, the 3-1 opening P31 communicates with the 3-4 opening P34 via the third through hole MD31 and the 3-4 flow hole FD34. The 3-5 flow hole FD35 is closed by the third communication hole MD32. Therefore, the 3-5 opening P35 is closed. The 3-2 flow hole FD32 and the 3-3 flow hole FD33 do not communicate with either the third through hole MD31 or the third communication hole MD32, and are closed by the third movable disk MD3. Therefore, the 3-2 opening P32 and the 3-3 opening P33 are closed.

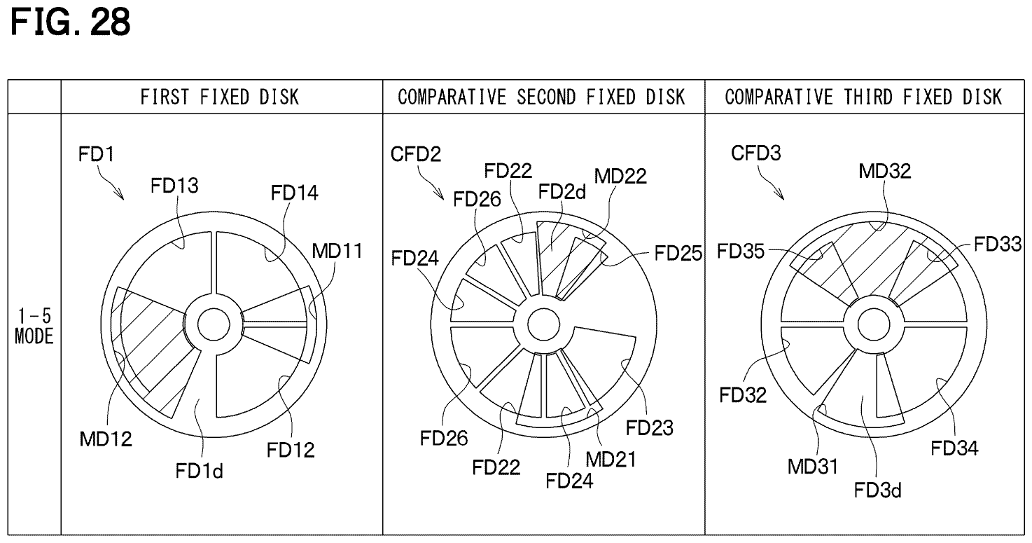

Next, the 1-5 mode will be described. When the operation mode of the temperature control device is set to the 1-5 mode, the first movable disk MD1 is positioned at a rotational position illustrated in FIG. 28. Specifically, when the operation mode is set to the 1-5 mode, the first movable disk MD1 is positioned at a position where the first through hole MD11 communicates with the 1-2 flow hole FD12 and the 1-4 flow hole FD14. The first movable disk MD1 is positioned at a position where the first communication hole MD12 communicates with the 1-3 flow hole FD13.

Accordingly, the 1-1 opening P11 communicates with the 1-2 opening P12 via the first through hole MD11 and the 1-2 flow hole FD12. The 1-4 opening P14 communicates with the 1-2 opening P12 via the 1-4 flow hole FD14, the first through hole MD11, and the 1-2 flow hole FD12. The 1-3 flow hole FD13 is closed by the first communication hole MD12. Therefore, the 1-3 opening P13 is closed.

When the operation mode of the temperature control device is set to the 1-5 mode, the comparative second movable disk CMD2 is positioned at a position where the second through hole MD21 communicates with the 2-3 flow hole FD23 and one of the two 2-2 flow holes FD22 and one of the two 2-4 flow holes FD24. The comparative second movable disk CMD2 is positioned at a position where the second communication hole MD22 communicates with the 2-5 flow hole FD25. The other of the two 2-2 flow holes FD22, the other of the two 2-4 flow holes FD24, and the two 2-6 flow holes FD26 do not face either the second through hole MD21 or the second communication hole MD22.

Accordingly, the 2-1 opening P21 communicates with the 2-2 opening P22 via the second through hole MD21 and the one 2-2 flow hole FD22, and communicates with the 2-3 opening P23 via the second through hole MD21 and the 2-3 flow hole FD23. Further, the 2-1 opening P21 communicates with the 2-4 opening P24 via the second through hole MD21 and the one 2-4 flow hole FD24. The 2-5 flow hole FD25 is closed by the second communication hole MD22. Therefore, the 2-5 opening P25 is closed. The two 2-6 flow holes FD26 do not communicate with either the second through hole MD21 or the second communication hole MD22, and are closed by the comparative second movable disk CMD2. Therefore, the 2-6 opening P26 is closed.

When the operation mode of the temperature control device is set to the 1-5 mode, the third movable disk MD3 is positioned at a position where the third through hole MD31 communicates with the 3-4 flow hole FD34. The third movable disk MD3 is positioned at a position where the third communication hole MD32 communicates with the 3-3 flow hole FD33 and the 3-5 flow hole FD35. The 3-2 flow hole FD32 does not face either the third through hole MD31 or the third communication hole MD32.

Accordingly, the 3-1 opening P31 communicates with the 3-4 opening P34 via the third through hole MD31 and the 3-4 flow hole FD34. The 3-3 opening P33 communicates with the 3-5 opening P35 via the 3-3 flow hole FD33, the third communication hole MD32, and the 3-5 flow hole FD35. The 3-2 flow hole FD32 does not communicate with either the third through hole MD31 or the third communication hole MD32, and is closed by the third movable disk MD3. Therefore, the 3-2 opening P32 is closed.

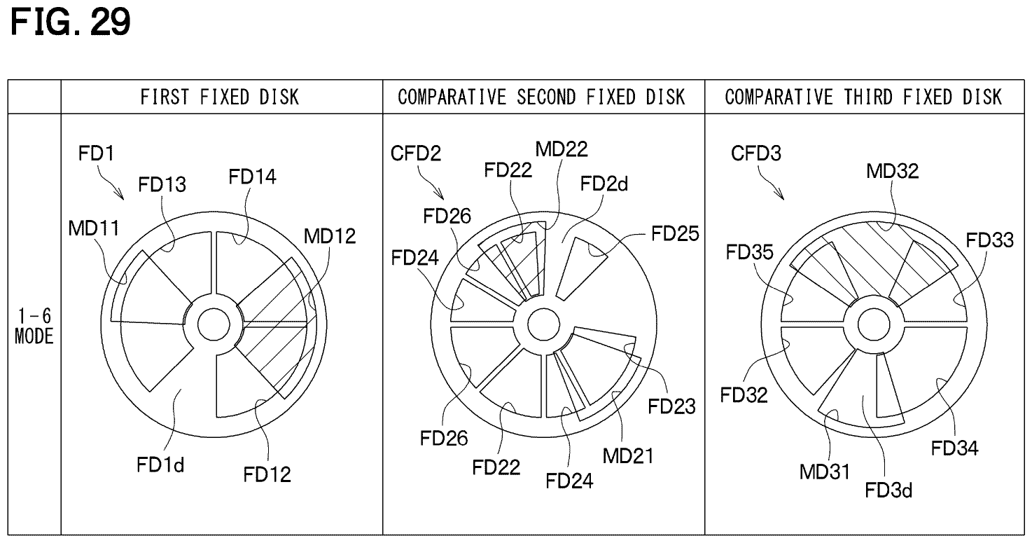

Next, the 1-6 mode will be described. When the operation mode of the temperature control device is set to the 1-6 mode, the first movable disk MD1 is positioned at a rotational position illustrated in FIG. 29. Specifically, when the operation mode is set to the 1-6 mode, the first movable disk MD1 is positioned at a position where the first through hole MD11 communicates with the 1-3 flow hole FD13. The first movable disk MD1 is positioned at a position where the first communication hole MD12 communicates with the 1-2 flow hole FD12 and the 1-4 flow hole FD14.

Accordingly, the 1-1 opening P11 communicates with the 1-3 opening P13 via the first through hole MD11 and the 1-3 flow hole FD13. The 1-4 opening P14 communicates with the 1-2 opening P12 via the 1-4 flow hole FD14, the first communication hole MD12, and the 1-2 flow hole FD12.

When the operation mode of the temperature control device is set to the 1-6 mode, the comparative second movable disk CMD2 is positioned at a position where the second through hole MD21 slightly communicates with the 2-3 flow hole FD23 and one of the two 2-4 flow holes FD24. Further, the comparative second movable disk CMD2 is positioned at a position where the second communication hole MD22 slightly communicates with one of the two 2-2 flow holes FD22 and one of the two 2-6 flow holes FD26. The other of the two 2-2 flow holes FD22, the other of the two 2-4 flow holes FD24, the 2-5 flow hole FD25, and the other of the two 2-6 flow holes FD26 do not face either the second through hole MD21 or the second communication hole MD22.

Accordingly, the 2-1 opening P21 communicates with the 2-3 opening P23 via the second through hole MD21 and the 2-3 flow hole FD23, and communicates with the 2-4 opening P24 via the second through hole MD21 and the one 2-4 flow hole FD24. The 2-6 opening P26 communicates with the 2-2 opening P22 via the one 2-6 flow hole FD26, the second communication hole MD22, and the one 2-2 flow hole FD22. The 2-5 flow hole FD25 does not communicate with either the second through hole MD21 or the second communication hole MD22, and is closed by the comparative second movable disk CMD2. Therefore, the 2-5 opening P25 is closed.

When the operation mode of the temperature control device is set to the 1-6 mode, the third movable disk MD3 is positioned at a position where the third through hole MD31 communicates with the 3-4 flow hole FD34. The third movable disk MD3 is positioned at a position where the third communication hole MD32 communicates with the 3-3 flow hole FD33 and the 3-5 flow hole FD35. The 3-2 flow hole FD32 does not face either the third through hole MD31 or the third communication hole MD32.

Accordingly, the 3-1 opening P31 communicates with the 3-4 opening P34 via the third through hole MD31 and the 3-4 flow hole FD34. The 3-3 opening P33 communicates with the 3-5 opening P35 via the 3-3 flow hole FD33, the third communication hole MD32, and the 3-5 flow hole FD35. The 3-2 flow hole FD32 does not communicate with either the third through hole MD31 or the third communication hole MD32, and is closed by the third movable disk MD3. Therefore, the 3-2 opening P32 is closed.

Thus, even when the fluid circuit system 1 includes the second multi-way valve MV2 having the comparative second fixed disk CFD2 and the comparative second movable disk CMD2 and the third multi-way valve MV3 having the comparative third fixed disk CFD3, it is possible to cope with the six operation modes of the temperature control device. When the second multi-way valve MV2 and the third multi-way valve MV3 are in the closed configuration, there is a possibility that a pressure loss that occurs when the coolant flows through the second multi-way valve MV2 and the third multi-way valve MV3 increases.

For example, the sizes of the 2-2 flow hole FD22, the 2-3 flow hole FD23, the 2-4 flow hole FD24, the 2-5 flow hole FD25, and the 2-6 flow hole FD26 formed in the comparative second fixed disk CFD2 are smaller than those of the second fixed disk FD2. Therefore, a pressure loss when the coolant passes through each of the 2-2 flow hole FD22, the 2-3 flow hole FD23, the 2-4 flow hole FD24, the 2-5 flow hole FD25, and the 2-6 flow hole FD26 may be larger than that of the second fixed disk FD2 according to the present embodiment.

As described above, in the comparative second fixed disk CFD2, the two 2-2 flow holes FD22, the two 2-4 flow holes FD24, and the two 2-6 flow holes FD26 are formed. Therefore, for example, when the second through hole MD21 or the second communication hole MD22 communicates with the 2-2 flow hole FD22 to allow the coolant to pass therethrough, there is a possibility that the pressure loss increases as compared with a case where the coolant flows through the 2-2 flow hole FD22 of the second fixed disk FD2 according to the present embodiment.

The comparative second fixed disk CFD2 has a greater number of the number of the 2-2 flow holes FD22, the 2-4 flow holes FD24, and the 2-6 flow holes FD26 formed than the second fixed disk FD2 according to the present embodiment. Therefore, a structure of the comparative second fixed disk CFD2 is more complicated than that of the second fixed disk FD2 according to the present embodiment. When the inlet port and the outlet port corresponding to each of the flow holes are provided in the side wall portion M117 of the housing M10, a size of each port is restricted. Therefore, compared with a configuration in which the second multi-way valve MV2 has the second fixed disk FD2 according to the present embodiment, a pressure loss that occurs when the coolant flows through the inlet port and the outlet port may increase.

Further, since the second multi-way valve MV2 and the third multi-way valve MV3 are in the closed configuration in the six operation modes of the temperature control device, sizes and positions of the 2-2 flow hole FD22, the 2-3 flow hole FD23, the 2-4 flow hole FD24, the 2-5 flow hole FD25, and the 2-6 flow hole FD26 are restricted. Therefore, as in an example illustrated in the 1-3 mode, overlapping ranges of the 2-3 flow holes FD23 communicating with the second through hole MD21 may be small. When the coolant flows through such a slightly communicating portion, a pressure loss that occurs when the coolant flows tends to increase.

Such an increase in the pressure loss leads to an increase in a pressure loss in the entire fluid circuit system 1, and is therefore undesirable.

The two 2-2 flow holes FD22, the two 2-4 flow holes FD24, and the two 2-6 flow holes FD26 formed in the comparative second movable disk CMD2 communicate with each other in the housing M10 by the communication mechanism (not illustrated). In this case, a structure in the housing M10 may be complicated as compared with the second multi-way valve MV2 according to the present embodiment.

Such complication of the second multi-way valve MV2 increases production cost of the second multi-way valve MV2 and increases production cost of the entire fluid circuit system 1, and is therefore undesirable.

When the number of operation modes of the temperature control device increases to more than six, the number of flow holes required for the comparative second movable disk CMD2 may increase. However, when the number of flow holes cannot be increased or when ports corresponding to the flow holes cannot be provided in the side wall portion M117, it is necessary to further add a valve device to the fluid circuit system 1. However, the increase in the number of valve devices increases the production cost of the entire fluid circuit system 1, and is therefore undesirable.

Thus, there are various problems when the fluid circuit system 1 is configured to close the unnecessary inlet and the unnecessary outlet of the first multi-way valve MV1 to the third multi-way valve MV3 when the temperature control device executes the six operation modes.

In contrast, the fluid circuit system 1 according to the present embodiment is not necessarily configured to close the unnecessary inlet and the unnecessary outlet of the first multi-way valve MV1, the second multi-way valve MV2, and the third multi-way valve MV3. That is, the fluid circuit system 1 according to the present embodiment is configured such that a state of the unnecessary inlet and the unnecessary outlet of the first multi-way valve MV1, the second multi-way valve MV2, and the third multi-way valve MV3 may be either an open state or a closed state.

In the fluid circuit system 1, a configuration of the first multi-way valve MV1 to the third multi-way valve MV3 is a configuration for preventing the coolant from flowing into the connection device that does not require the coolant to flow in each of the six operation modes. Specifically, in the fluid circuit system 1 according to the present embodiment, the second movable disk MD2 of the second multi-way valve MV2 has a configuration different from that of the comparative second movable disk CMD2, and the second fixed disk FD2 has a configuration different from that of the comparative second fixed disk CFD2. In the fluid circuit system 1, the third fixed disk FD3 of the third multi-way valve MV3 has a configuration different from that of the comparative third fixed disk CFD3.

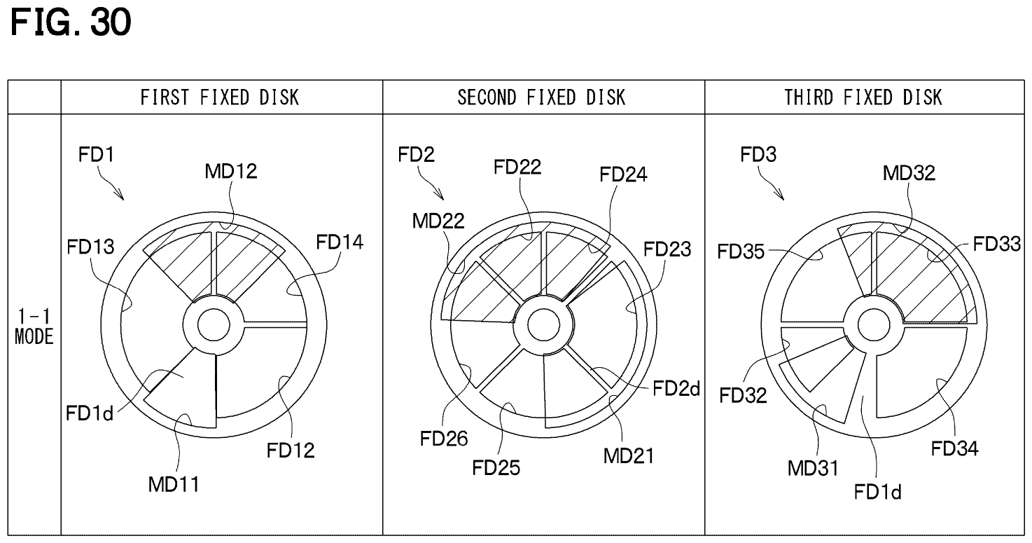

The fluid circuit system 1 including the first multi-way valve MV1, the second multi-way valve MV2, and the third multi-way valve MV3 having such a different configuration will be described with reference to FIGS. 30 to 41. Since the configuration of the first multi-way valve MV1 is the same as that of the comparative example described above, detailed description of an operation of the first multi-way valve MV1 in each operation mode will be omitted.

First, the 1-1 mode will be described. When the operation mode of the temperature control device is set to the 1-1 mode, the first movable disk MD1 is positioned at a rotational position illustrated in FIG. 30. Accordingly, the 1-1 opening P11 and the 1-2 opening P12 are closed. The 1-4 opening P14 communicates with the 1-3 opening P13 via the 1-4 flow hole FD14, the first communication hole MD12, and the 1-3 flow hole FD13.

When the operation mode of the temperature control device is set to the 1-1 mode, the second movable disk MD2 is positioned at a position where the second through hole MD21 communicates with the 2-3 flow hole FD23 and the 2-5 flow hole FD25. The second movable disk MD2 is positioned at a position where the second communication hole MD22 communicates with the 2-2 flow hole FD22, the 2-4 flow hole FD24, and the 2-6 flow hole FD26.

Accordingly, the 2-1 opening P21 communicates with the 2-3 opening P23 via the second through hole MD21 and the 2-3 flow hole FD23, and communicates with the 2-5 opening P25 via the second through hole MD21 and the 2-5 flow hole FD25. The 2-6 opening P26 communicates with the 2-2 opening P22 via the second communication hole MD22 and the 2-2 flow hole FD22, and communicates with the 2-4 opening P24 via the second communication hole MD22 and the 2-4 flow hole FD24.

When the operation mode of the temperature control device is set to the 1-1 mode, the third movable disk MD3 is positioned at a position where the third through hole MD31 communicates with the 3-2 flow hole FD32. The third movable disk MD3 is positioned at a position where the third communication hole MD32 communicates with the 3-3 flow hole FD33 and the 3-5 flow hole FD35. The 3-4 flow hole FD34 does not face either the third through hole MD31 or the third communication hole MD32.

Accordingly, the 3-1 opening P31 communicates with the 3-2 opening P32 via the third through hole MD31 and the 3-2 flow hole FD32. The 3-3 opening P33 communicates with the 3-5 opening P35 via the third communication hole MD32 and the 3-5 flow hole FD35. The 3-4 flow hole FD34 does not communicate with either the third through hole MD31 or the third communication hole MD32, and is closed by the third movable disk MD3. Therefore, the 3-4 opening P34 is closed.

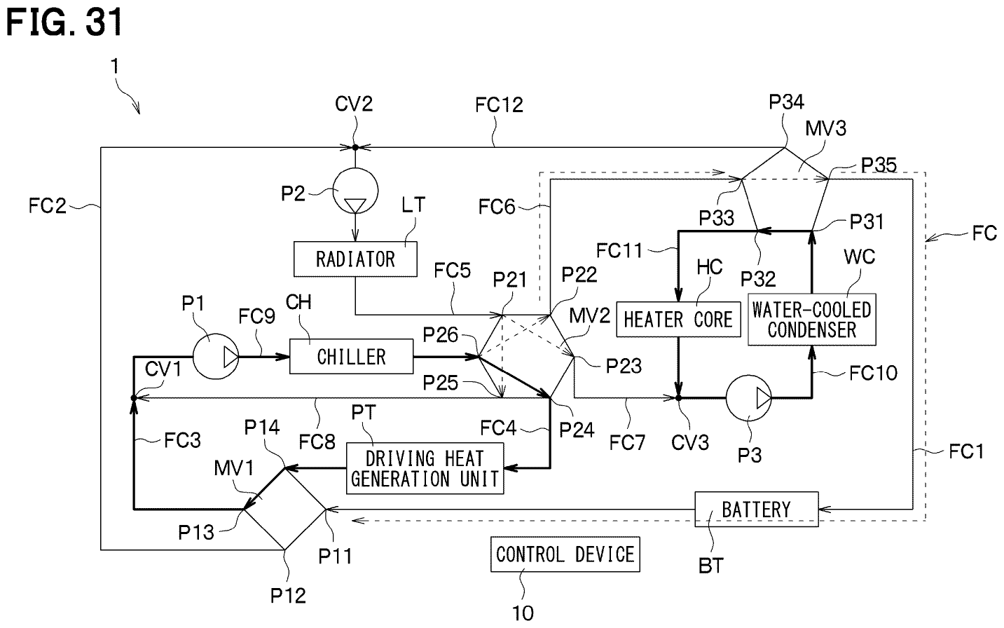

A flow of the coolant in the fluid circuit FC when open and closed states of the coolant inlet and the coolant outlet of the first multi-way valve MV1, the second multi-way valve MV2, and the third multi-way valve MV3 are set in this manner will be described with reference to FIG. 31.

As described above, in the 1-1 mode, the fluid circuit system 1 allows the 1-4 opening P14 of the first multi-way valve MV1 to communicate with the 1-3 opening P13, and allows the 2-6 opening P26 of the second multi-way valve MV2 to communicate with the 2-4 opening P24. In the fluid circuit system 1, the 3-1 opening P31 of the third multi-way valve MV3 communicates with the 3-2 opening P32. Accordingly, the fluid circuit system 1 can circulate the coolant through the CV1-P26 flow path FC9, the P24-P14 flow path FC4, and the P13-CV1 flow path FC3 by operating the first pump P1. The fluid circuit system 1 can guide the coolant to the chiller CH and the driving heat generation unit PT.

The fluid circuit system 1 can circulate the coolant through the P32-CV3 flow path FC11 and the CV3-P31 flow path FC10 by operating the third pump P3. The fluid circuit system 1 can guide the coolant to the water-cooled condenser WC and the heater core HC.

In the fluid circuit system 1 according to the present embodiment, the 2-6 opening P26 of the second multi-way valve MV2 communicates with the 2-2 opening P22, which is the unnecessary outlet, and the 3-3 opening P33, which is the unnecessary inlet of the third multi-way valve MV3, communicates with the 3-5 opening P35, which is the unnecessary outlet. In this case, the coolant pumped by the first pump P1 may flow through the P22-P33 flow path FC6 and the P35-P11 flow path FC1 and flow into the battery BT that does not require the coolant to flow.

In contrast, in the fluid circuit system 1 according to the present embodiment, in the 1-1 mode, the 1-1 opening P11 of the first multi-way valve MV1 connected to a downstream side of a refrigerant flow of the P35-P11 flow path FC1 in which the battery BT is disposed is closed by the first movable disk MD1. Therefore, it is possible to prevent the coolant pumped by the first pump P1 from flowing through the P22-P33 flow path FC6 and the P35-P11 flow path FC1 to the battery BT. That is, the fluid circuit system 1 can prohibit a flow of the coolant that may pass through an unnecessary inlet and an unnecessary outlet in an open state in the second multi-way valve MV2 and the third multi-way valve MV3 by the first multi-way valve MV1 different from the second multi-way valve MV2 and the third multi-way valve MV3.

In the fluid circuit system 1 according to the present embodiment, the 2-1 opening P21 of the second multi-way valve MV2, which is the unnecessary inlet, communicates with the 2-3 opening P23 and the 2-5 opening P25, which are the unnecessary outlets. However, a circuit formed by the P32-CV3 flow path FC11 and the CV3-P31 flow path FC10 to which the 2-3 opening P23 is connected is a closed circuit. Therefore, the coolant does not flow from the 2-3 opening P23 to the P23-CV3 flow path FC7, or the coolant does not flow from the P23-CV3 flow path FC7 to the 2-3 opening P23.

A circuit formed by the CV1-P26 flow path FC9, the P24-P14 flow path FC4, and the P13-CV1 flow path FC3 to which the 2-5 opening P25 is connected is a closed circuit. Therefore, the coolant does not flow from the 2-5 opening P25 to the P25-CV1 flow path FC8, or the coolant does not flow from the P25-CV1 flow path FC8 to the 2-5 opening P25.

In FIG. 31 and the like, flow paths communicating by opening and closing the unnecessary inlet and the unnecessary outlet of the second multi-way valve MV2 and the third multi-way valve MV3 are indicated by broken lines.

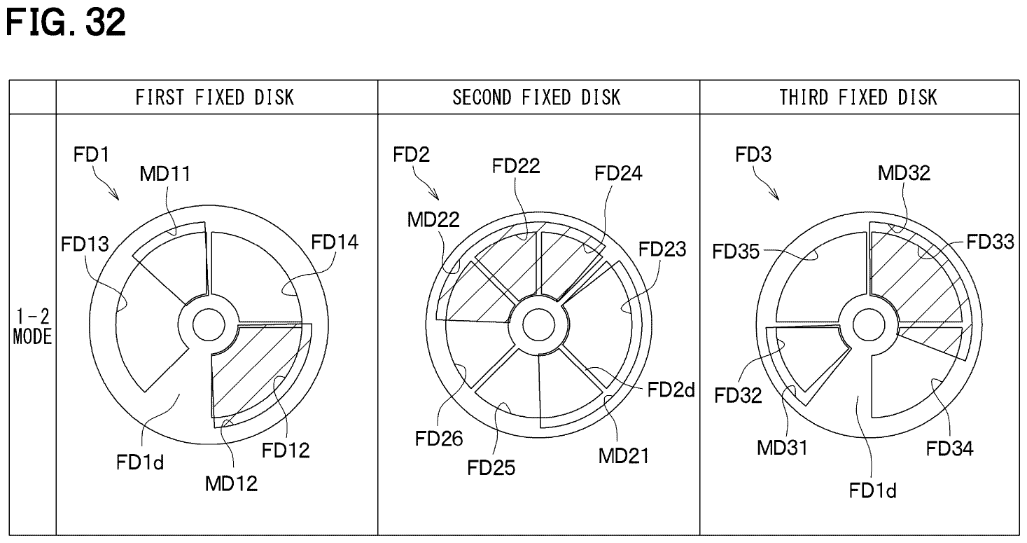

Next, the 1-2 mode will be described. When the operation mode of the temperature control device is set to the 1-2 mode, the first movable disk MD1 is positioned at a rotational position illustrated in FIG. 32. Accordingly, the 1-1 opening P11 communicates with the 1-3 opening P13 via the first through hole MD11 and the 1-3 flow hole FD13. The 1-2 opening P12 and the 1-4 opening P14 are closed.

When the operation mode of the temperature control device is set to the 1-2 mode, the second movable disk MD2 is positioned at a position where the second through hole MD21 communicates with the 2-3 flow hole FD23 and the 2-5 flow hole FD25. The second movable disk MD2 is positioned at a position where the second communication hole MD22 communicates with the 2-2 flow hole FD22, the 2-4 flow hole FD24, and the 2-6 flow hole FD26.

Accordingly, the 2-1 opening P21 communicates with the 2-3 opening P23 via the second through hole MD21 and the 2-3 flow hole FD23, and communicates with the 2-5 opening P25 via the second through hole MD21 and the 2-5 flow hole FD25. The 2-6 opening P26 communicates with the 2-2 opening P22 via the second communication hole MD22 and the 2-2 flow hole FD22, and communicates with the 2-4 opening P24 via the second communication hole MD22 and the 2-4 flow hole FD24.

When the operation mode of the temperature control device is set to the 1-2 mode, the third movable disk MD3 is positioned at a position where the third through hole MD31 communicates with the 3-2 flow hole FD32. The third movable disk MD3 is positioned at a position where the third communication hole MD32 communicates with the 3-3 flow hole FD33 and the 3-4 flow hole FD34. The 3-5 flow hole FD35 does not face either the third through hole MD31 or the third communication hole MD32.

Accordingly, the 3-1 opening P31 communicates with the 3-2 opening P32 via the third through hole MD31 and the 3-2 flow hole FD32. The 3-3 opening P33 communicates with the 3-4 opening P34 via the third communication hole MD32 and the 3-4 flow hole FD34. The 3-5 flow hole FD35 does not communicate with either the third through hole MD31 or the third communication hole MD32, and is closed by the third movable disk MD3. Therefore, the 3-5 opening P35 is closed.

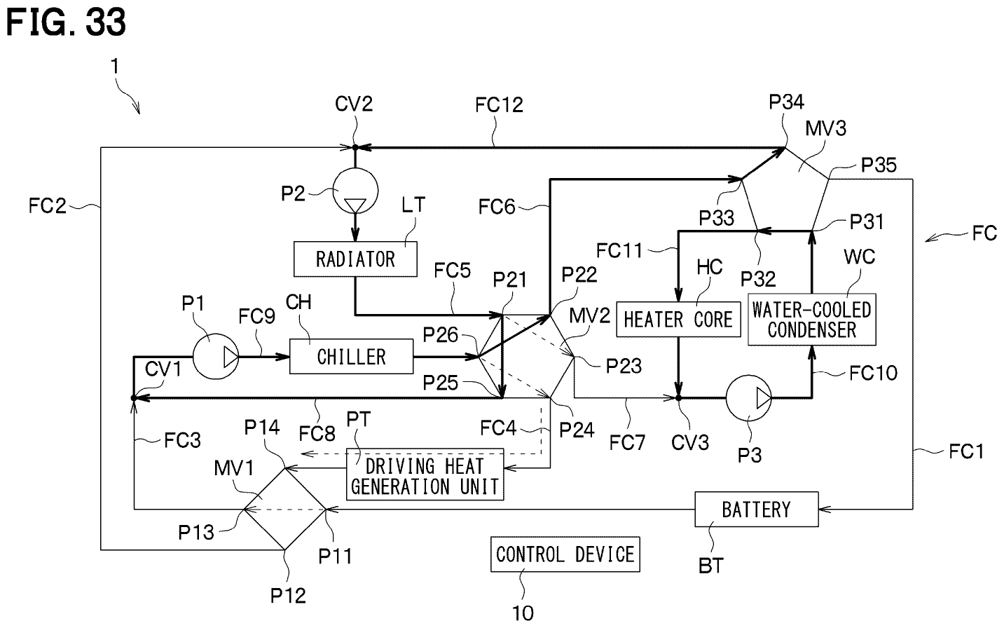

A flow of the coolant in the fluid circuit FC when open and closed states of the coolant inlet and the coolant outlet of the first multi-way valve MV1, the second multi-way valve MV2, and the third multi-way valve MV3 are set in this manner will be described with reference to FIG. 33.

As described above, in the 1-2 mode, the fluid circuit system 1 allows the 2-1 opening P21 of the second multi-way valve MV2 to communicate with the 2-5 opening P25, and allows the 2-6 opening P26 to communicate with the 2-2 opening P22. In the fluid circuit system 1, the 3-3 opening P33 of the third multi-way valve MV3 communicates with the 3-4 opening P34. Accordingly, the fluid circuit system 1 can circulate the coolant through the P25-CV1 flow path FC8, the CV1-P26 flow path FC9, the P22-P33 flow path FC6, the P34-CV2 flow path FC12, and the CV2-P21 flow path FC5 by operating the first pump P1 and the second pump P2. The fluid circuit system 1 can guide the coolant to the radiator LT and the chiller CH.

The fluid circuit system 1 can circulate the coolant through the P32-CV3 flow path FC11 and the CV3-P31 flow path FC10 by operating the third pump P3. The fluid circuit system 1 can guide the coolant to the water-cooled condenser WC and the heater core HC.

In the fluid circuit system 1 according to the present embodiment, the 2-6 opening P26 of the second multi-way valve MV2 communicates with the 2-4 opening P24 which is the unnecessary outlet. In this case, the coolant pumped by the first pump P1 may flow through the P24-P14 flow path FC4 and flows into the driving heat generation unit PT that does not require the coolant to flow.

In contrast, in the fluid circuit system 1 according to the present embodiment, in the 1-2 mode, the 1-4 opening P14 of the first multi-way valve MV1 connected to a downstream side of a refrigerant flow of the P24-P14 flow path FC4 in which the driving heat generation unit PT is disposed is closed by the first movable disk MD1. Therefore, it is possible to prevent the coolant pumped by the first pump P1 from flowing through the P24-P14 flow path FC4 to the driving heat generation unit PT. That is, the fluid circuit system 1 can prohibit a flow of the coolant that may pass through an unnecessary outlet in an open state in the second multi-way valve MV2 by the first multi-way valve MV1 different from the second multi-way valve MV2.

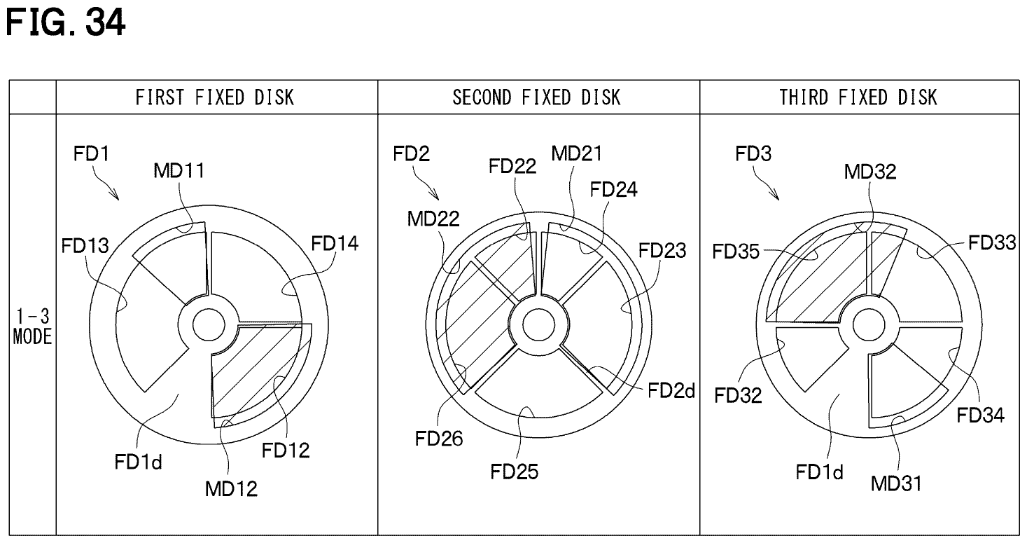

Next, the 1-3 mode will be described. When the operation mode of the temperature control device is set to the 1-3 mode, the first movable disk MD1 is positioned at a rotational position illustrated in FIG. 34. Accordingly, the 1-1 opening P11 communicates with the 1-3 opening P13 via the first through hole MD11 and the 1-3 flow hole FD13. The 1-2 opening P12 and the 1-4 opening P14 are closed.

When the operation mode of the temperature control device is set to the 1-3 mode, the second movable disk MD2 is positioned at a position where the second through hole MD21 communicates with the 2-3 flow hole FD23 and the 2-4 flow hole FD24. The second movable disk MD2 is positioned at a position where the second communication hole MD22 communicates with the 2-2 flow hole FD22 and the 2-6 flow hole FD26.

Accordingly, the 2-1 opening P21 communicates with the 2-3 opening P23 via the second through hole MD21 and the 2-3 flow hole FD23, and communicates with the 2-4 opening P24 via the second through hole MD21 and the 2-4 flow hole FD24. The 2-6 opening P26 communicates with the 2-2 opening P22 via the second communication hole MD22 and the 2-2 flow hole FD22.

When the operation mode of the temperature control device is set to the 1-3 mode, the third movable disk MD3 is positioned at a position where the third through hole MD31 communicates with the 3-4 flow hole FD34. The third movable disk MD3 is positioned at a position where the third communication hole MD32 communicates with the 3-3 flow hole FD33 and the 3-5 flow hole FD35. The 3-2 flow hole FD32 does not face either the third through hole MD31 or the third communication hole MD32.

Accordingly, the 3-1 opening P31 communicates with the 3-4 opening P34 via the third through hole MD31 and the 3-4 flow hole FD34. The 3-3 opening P33 communicates with the 3-5 opening P35 via the third communication hole MD32 and the 3-5 flow hole FD35. The 3-2 flow hole FD32 does not communicate with either the third through hole MD31 or the third communication hole MD32, and is closed by the third movable disk MD3. Therefore, the 3-2 opening P32 is closed.

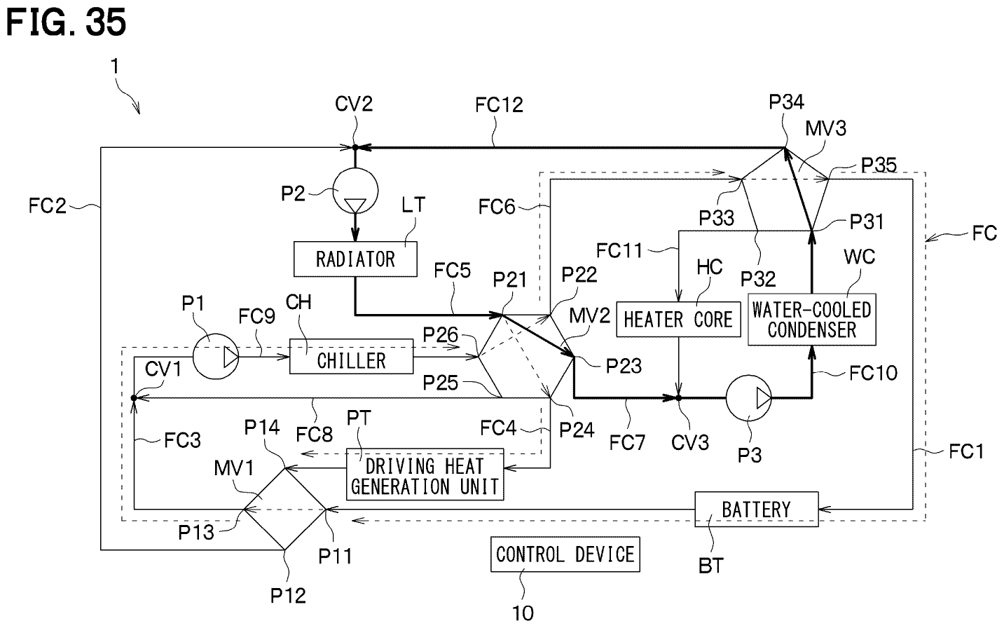

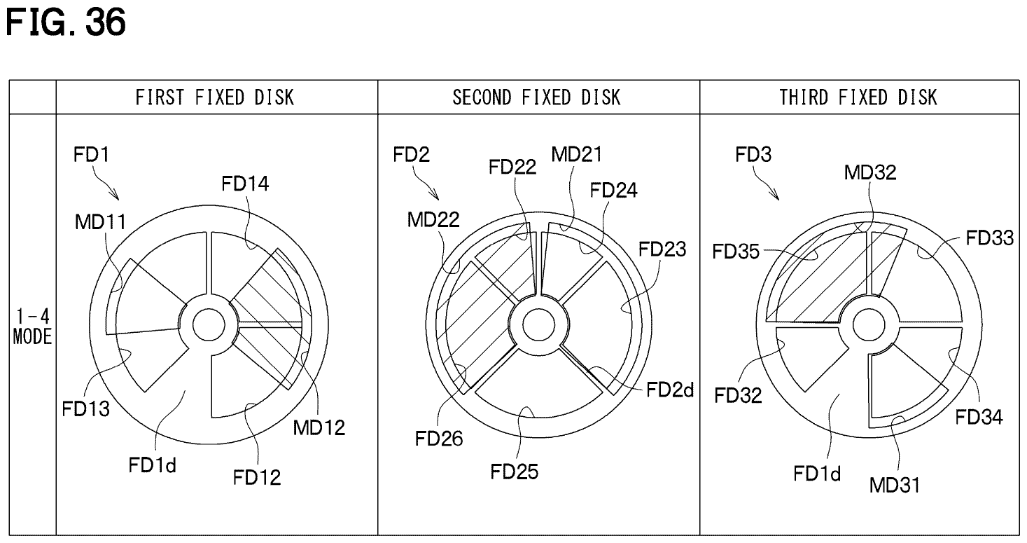

A flow of the coolant in the fluid circuit FC when open and closed states of the coolant inlet and the coolant outlet of the first multi-way valve MV1, the second multi-way valve MV2, and the third multi-way valve MV3 are set in this manner will be described with reference to FIG. 35.

As described above, in the 1-3 mode, the 2-1 opening P21 of the second multi-way valve MV2 communicates with the 2-3 opening P23, and the 3-1 opening P31 of the third multi-way valve MV3 communicates with the 3-4 opening P34. Accordingly, the fluid circuit system 1 can circulate the coolant through the CV2-P21 flow path FC5, the P23-CV3 flow path FC7, the CV3-P31 flow path FC10, and the P34-CV2 flow path FC12 by operating the second pump P2 and the third pump P3. The fluid circuit system 1 can guide the coolant to the radiator LT and the water-cooled condenser WC.

In the fluid circuit system 1 according to the present embodiment, the 2-1 opening P21 of the second multi-way valve MV2 communicates with the 2-4 opening P24 which is the unnecessary outlet, and the 2-6 opening P26 which is the unnecessary inlet communicates with the 2-2 opening P22 which is the unnecessary outlet. The fluid circuit system 1 allows the 3-3 opening P33, which is the unnecessary inlet of the third multi-way valve MV3, to communicate with the 3-5 opening P35, which is the unnecessary outlet. In this case, the coolant pumped by the second pump P2 may flow through the P24-P14 flow path FC4 and flows into the driving heat generation unit PT that does not require the coolant to flow. The coolant pumped by the first pump P1 may flow through the P22-P33 flow path FC6 and the P35-P11 flow path FC1 and flow into the battery BT that does not require the coolant to flow.

In contrast, in the fluid circuit system 1 according to the present embodiment, in the 1-3 mode, the 1-4 opening P14 of the first multi-way valve MV1 connected to the downstream side of the refrigerant flow of the P24-P14 flow path FC4 in which the driving heat generation unit PT is disposed is closed by the first movable disk MD1. Therefore, it is possible to prevent the coolant pumped by the second pump P2 from flowing through the P24-P14 flow path FC4 to the driving heat generation unit PT. That is, the fluid circuit system 1 can prohibit a flow of the coolant that may pass through an unnecessary outlet in an open state in the second multi-way valve MV2 by the first multi-way valve MV1 different from the second multi-way valve MV2.

The fluid circuit system 1 according to the present embodiment does not operate the first pump P1 in the 1-3 mode. Therefore, the 2-6 opening P26 of the second multi-way valve MV2 communicates with the 2-2 opening P22, and the 3-3 opening P33 of the third multi-way valve MV3 communicates with the 3-5 opening P35, so that a circuit including the P35-P11 flow path FC1 in which the battery BT is disposed enables circulation of the coolant. Even in this case, the coolant does not flow into the battery BT. That is, the fluid circuit system 1 can open the unnecessary inlet and the unnecessary outlet that communicate with a circuit in which the first pump P1, which does not operate in the 1-3 mode, is disposed.

Next, the 1-4 mode will be described. When the operation mode of the temperature control device is set to the 1-4 mode, the first movable disk MD1 is positioned at a rotational position illustrated in FIG. 36. Accordingly, the 1-1 opening P11 communicates with the 1-3 opening P13 via the first through hole MD11 and the 1-3 flow hole FD13. The 1-4 opening P14 communicates with the 1-2 opening P12 via the 1-4 flow hole FD14, the first communication hole MD12, and the 1-2 flow hole FD12.

When the operation mode of the temperature control device is set to the 1-4 mode, the second movable disk MD2 is positioned at a position where the second through hole MD21 communicates with the 2-3 flow hole FD23 and the 2-4 flow hole FD24. The second movable disk MD2 is positioned at a position where the second communication hole MD22 communicates with the 2-2 flow hole FD22 and the 2-6 flow hole FD26.

Accordingly, the 2-1 opening P21 communicates with the 2-3 opening P23 via the second through hole MD21 and the 2-3 flow hole FD23, and communicates with the 2-4 opening P24 via the second through hole MD21 and the 2-4 flow hole FD24. The 2-6 opening P26 communicates with the 2-2 opening P22 via the second communication hole MD22 and the 2-2 flow hole FD22.

When the operation mode of the temperature control device is set to the 1-4 mode, the third movable disk MD3 is positioned at a position where the third through hole MD31 communicates with the 3-4 flow hole FD34. The third movable disk MD3 is positioned at a position where the third communication hole MD32 communicates with the 3-3 flow hole FD33 and the 3-5 flow hole FD35. The 3-2 flow hole FD32 does not face either the third through hole MD31 or the third communication hole MD32.

Accordingly, the 3-1 opening P31 communicates with the 3-4 opening P34 via the third through hole MD31 and the 3-4 flow hole FD34. The 3-3 opening P33 communicates with the 3-5 opening P35 via the third communication hole MD32 and the 3-5 flow hole FD35. The 3-2 flow hole FD32 does not communicate with either the third through hole MD31 or the third communication hole MD32, and is closed by the third movable disk MD3. Therefore, the 3-2 opening P32 is closed.

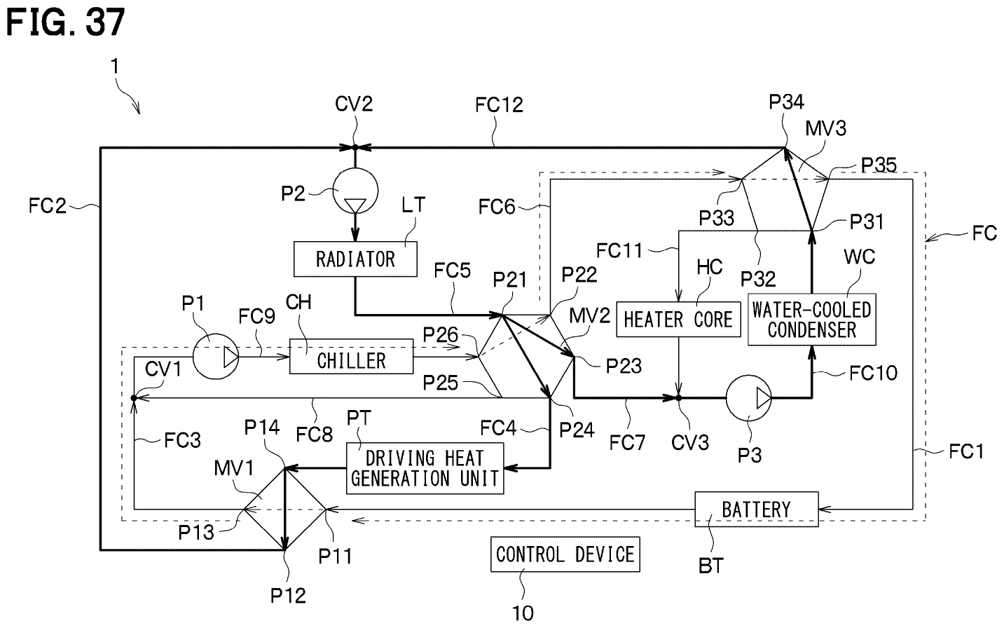

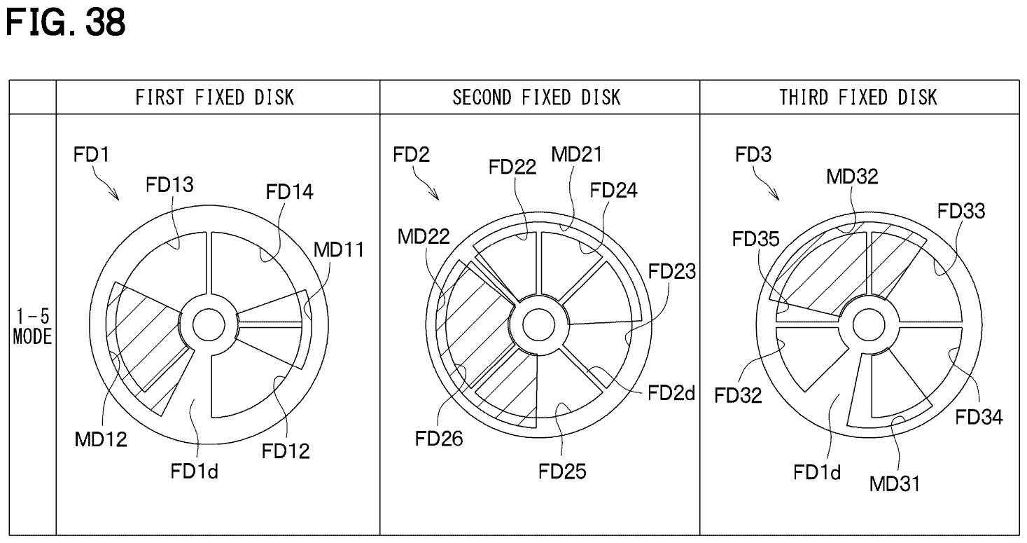

A flow of the coolant in the fluid circuit FC when open and closed states of the coolant inlet and the coolant outlet of the first multi-way valve MV1, the second multi-way valve MV2, and the third multi-way valve MV3 are set in this manner will be described with reference to FIG. 37.

As described above, in the 1-4 mode, the fluid circuit system 1 allows the 1-4 opening P14 of the first multi-way valve MV1 to communicate with the 1-2 opening P12, and allows the 2-1 opening P21 of the second multi-way valve MV2 to communicate with the 2-3 opening P23 and the 2-4 opening P24. In the fluid circuit system 1, the 3-1 opening P31 of the third multi-way valve MV3 communicates with the 3-4 opening P34.

Accordingly, the fluid circuit system 1 can circulate the coolant through the P12-CV2 flow path FC2, the CV2-P21 flow path FC5, the P24-P14 flow path FC4, the P23-CV3 flow path FC7, the CV3-P31 flow path FC10, and the P34-CV2 flow path FC12 by operating the second pump P2 and the third pump P3. The fluid circuit system 1 can guide the coolant to the water-cooled condenser WC, the radiator LT, and the driving heat generation unit PT.

In the fluid circuit system 1 according to the present embodiment, the 2-6 opening P26, which is the unnecessary inlet, communicates with the 2-2 opening P22, which is the unnecessary outlet. The fluid circuit system 1 allows the 3-3 opening P33, which is the unnecessary inlet of the third multi-way valve MV3, to communicate with the 3-5 opening P35, which is the unnecessary outlet. In this case, the coolant pumped by the first pump P1 may flow through the P22-P33 flow path FC6 and the P35-P11 flow path FC1 and flow into the battery BT that does not require the coolant to flow.

In contrast, similarly to the 1-3 mode, in the 1-4 mode, the fluid circuit system 1 does not operate the first pump P1. Therefore, the 2-6 opening P26 of the second multi-way valve MV2 communicates with the 2-2 opening P22, and the 3-3 opening P33 of the third multi-way valve MV3 communicates with the 3-5 opening P35, so that the circuit including the P35-P11 flow path FC1 in which the battery BT is disposed enables circulation of the coolant. Even in this case, the coolant does not flow into the battery BT. That is, the fluid circuit system 1 can open the unnecessary inlet and the unnecessary outlet that communicate with the circuit in which the first pump P1, which does not operate in the 1-4 mode, is disposed.

Next, the 1-5 mode will be described. When the operation mode of the temperature control device is set to the 1-5 mode, the first movable disk MD1 is positioned at a rotational position illustrated in FIG. 38. Accordingly, the 1-1 opening P11 communicates with the 1-2 opening P12 via the first through hole MD11 and the 1-2 flow hole FD12. The 1-4 opening P14 also communicates with the 1-2 opening P12 via the first through hole MD11 and the 1-2 flow hole FD12. The 1-3 opening P13 is closed.

When the operation mode of the temperature control device is set to the 1-5 mode, the second movable disk MD2 is positioned at a position where the second through hole MD21 communicates with the 2-2 flow hole FD22, the 2-3 flow hole FD23, and the 2-4 flow hole FD24. The second movable disk MD2 is positioned at a position where the second communication hole MD22 communicates with the 2-5 flow hole FD25 and the 2-6 flow hole FD26.

Accordingly, the 2-1 opening P21 communicates with the 2-2 opening P22 via the second through hole MD21 and the 2-2 flow hole FD22, communicates with the 2-3 opening P23 via the second through hole MD21 and the 2-3 flow hole FD23, and communicates with the 2-4 opening P24 via the second through hole MD21 and the 2-4 flow hole FD24. The 2-6 opening P26 communicates with the 2-5 opening P25 via the second communication hole MD22 and the 2-5 flow hole FD25.

When the operation mode of the temperature control device is set to the 1-5 mode, the third movable disk MD3 is positioned at a position where the third through hole MD31 communicates with the 3-4 flow hole FD34. The third movable disk MD3 is positioned at a position where the third communication hole MD32 communicates with the 3-3 flow hole FD33 and the 3-5 flow hole FD35. The 3-2 flow hole FD32 does not face either the third through hole MD31 or the third communication hole MD32.

Accordingly, the 3-1 opening P31 communicates with the 3-4 opening P34 via the third through hole MD31 and the 3-4 flow hole FD34. The 3-3 opening P33 communicates with the 3-5 opening P35 via the third communication hole MD32 and the 3-5 flow hole FD35. The 3-2 flow hole FD32 does not communicate with either the third through hole MD31 or the third communication hole MD32, and is closed by the third movable disk MD3. Therefore, the 3-2 opening P32 is closed.

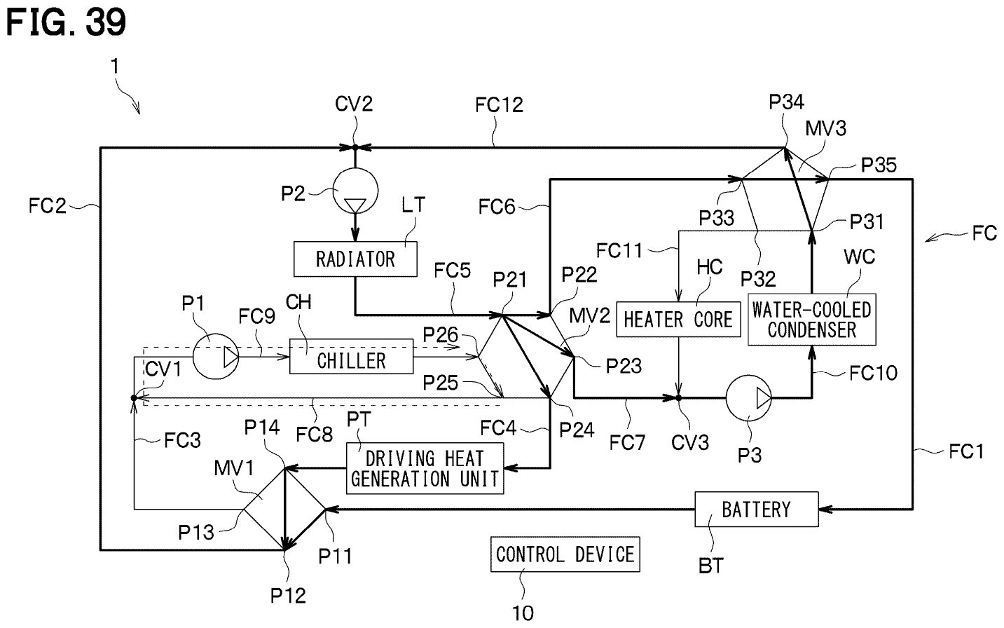

A flow of the coolant in the fluid circuit FC when open and closed states of the coolant inlet and the coolant outlet of the first multi-way valve MV1, the second multi-way valve MV2, and the third multi-way valve MV3 are set in this manner will be described with reference to FIG. 39.

As described above, in the 1-5 mode, the fluid circuit system 1 allows the 1-1 opening P11 and the 1-4 opening P14 of the first multi-way valve MV1 to communicate with the 1-2 opening P12, and allows the 2-1 opening P21 of the second multi-way valve MV2 to communicate with the 2-3 opening P23. In the fluid circuit system 1, the 3-1 opening P31 of the third multi-way valve MV3 communicates with the 3-4 opening P34, and the 3-3 opening P33 communicates with the 3-5 opening P35.

Accordingly, the fluid circuit system 1 can circulate the coolant through the P12-CV2 flow path FC2, the CV2-P21 flow path FC5, the P24-P14 flow path FC4, the P23-CV3 flow path FC7, the CV3-P31 flow path FC10, the P34-CV2 flow path FC12, the P22-P33 flow path FC6, and the P35-P11 flow path FC1 by operating the second pump P2 and the third pump P3. The fluid circuit system 1 can guide the coolant to the water-cooled condenser WC, the radiator LT, the driving heat generation unit PT, and the battery BT.

In the fluid circuit system 1 according to the present embodiment, the 2-6 opening P26, which is the unnecessary inlet, communicates with the 2-5 opening P25, which is the unnecessary outlet. In this case, the coolant pumped by the first pump P1 may flow through the CV1-P26 flow path FC9 and the P25-CV1 flow path FC8 and flow into the chiller CH that does not require the coolant to flow.

In contrast, the fluid circuit system 1 according to the present embodiment does not operate the first pump P1 in the 1-5 mode. Therefore, since the 2-6 opening P26 of the second multi-way valve MV2 communicates with the 2-5 opening P25, even when a circuit including the CV1-P26 flow path FC9 in which the chiller CH is disposed enables circulation of the coolant, the coolant does not flow into the chiller CH. That is, the fluid circuit system 1 can open the unnecessary inlet and the unnecessary outlet that communicate with a circuit in which the first pump P1, which does not operate in the 1-5 mode, is disposed.

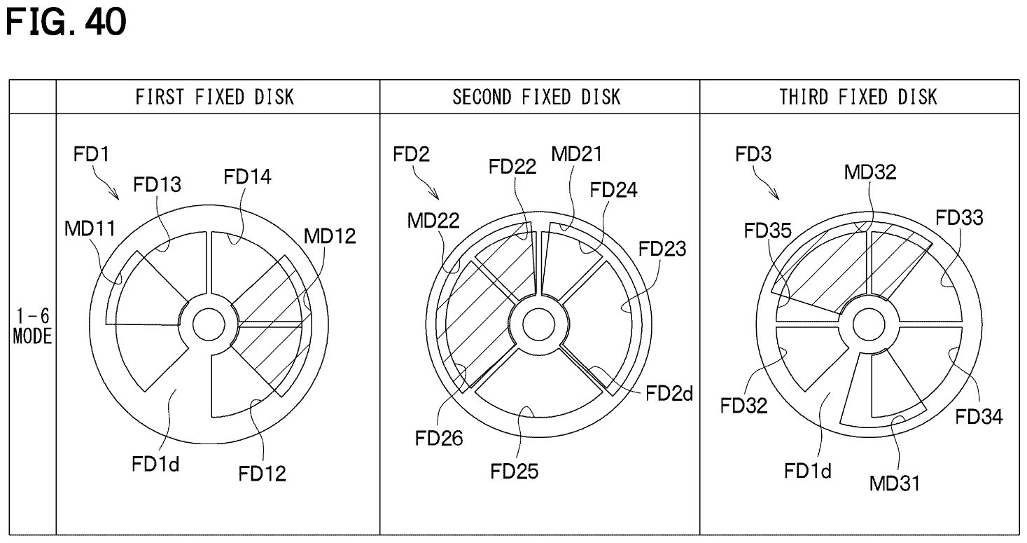

Next, the 1-6 mode will be described. When the operation mode of the temperature control device is set to the 1-6 mode, the first movable disk MD1 is positioned at a rotational position illustrated in FIG. 40. Accordingly, the 1-1 opening P11 communicates with the 1-3 opening P13 via the first through hole MD11 and the 1-3 flow hole FD13. The 1-4 opening P14 communicates with the 1-2 opening P12 via the 1-4 flow hole FD14, the first communication hole MD12, and the 1-2 flow hole FD12.

When the operation mode of the temperature control device is set to the 1-6 mode, the second movable disk MD2 is positioned at a position where the second through hole MD21 communicates with the 2-3 flow hole FD23 and the 2-4 flow hole FD24. The second movable disk MD2 is positioned at a position where the second communication hole MD22 communicates with the 2-2 flow hole FD22 and the 2-6 flow hole FD26.

Accordingly, the 2-1 opening P21 communicates with the 2-3 opening P23 via the second through hole MD21 and the 2-3 flow hole FD23, and communicates with the 2-4 opening P24 via the second through hole MD21 and the 2-4 flow hole FD24. The 2-6 opening P26 communicates with the 2-2 opening P22 via the second communication hole MD22 and the 2-2 flow hole FD22.

When the operation mode of the temperature control device is set to the 1-6 mode, the third movable disk MD3 is positioned at a position where the third through hole MD31 communicates with the 3-4 flow hole FD34. The third movable disk MD3 is positioned at a position where the third communication hole MD32 communicates with the 3-3 flow hole FD33 and the 3-5 flow hole FD35. The 3-2 flow hole FD32 does not face either the third through hole MD31 or the third communication hole MD32.

Accordingly, the 3-1 opening P31 communicates with the 3-4 opening P34 via the third through hole MD31 and the 3-4 flow hole FD34. The 3-3 opening P33 communicates with the 3-5 opening P35 via the third communication hole MD32 and the 3-5 flow hole FD35. The 3-2 flow hole FD32 does not communicate with either the third through hole MD31 or the third communication hole MD32, and is closed by the third movable disk MD3. Therefore, the 3-2 opening P32 is closed.

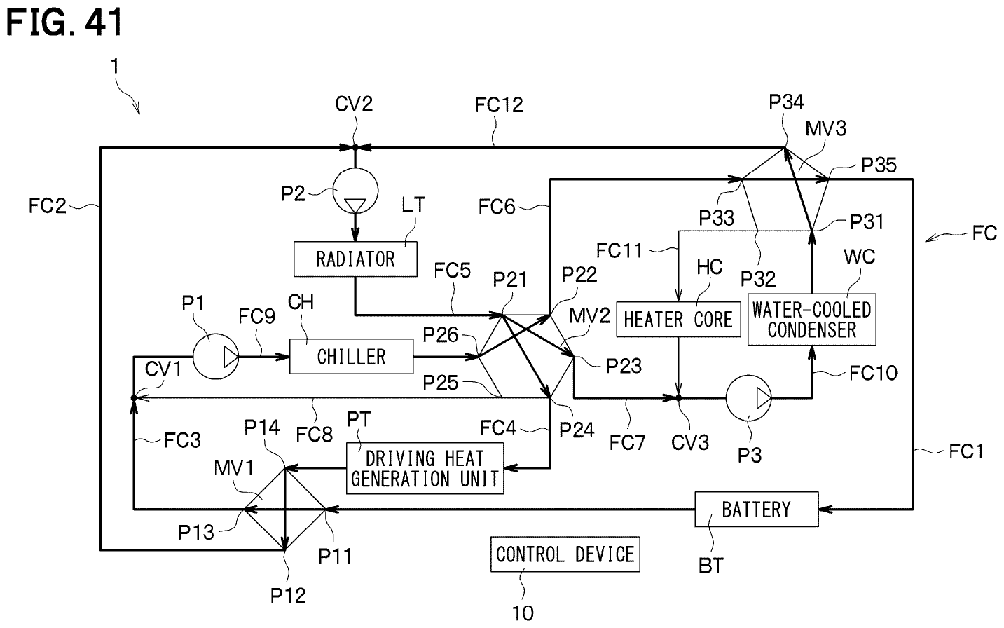

A flow of the coolant in the fluid circuit FC when open and closed states of the coolant inlet and the coolant outlet of the first multi-way valve MV1, the second multi-way valve MV2, and the third multi-way valve MV3 are set in this manner will be described with reference to FIG. 41.

As described above, in the 1-6 mode, the fluid circuit system 1 allows the 1-1 opening P11 of the first multi-way valve MV1 to communicate with the 1-3 opening P13, and allows the 1-4 opening P14 to communicate with the 1-2 opening P12. In the fluid circuit system 1, the 2-1 opening P21 of the second multi-way valve MV2 communicates with the 2-2 opening P22, the 2-3 opening P23, and the 2-4 opening P24, and the 2-6 opening P26 communicates with the 2-2 opening P22. In the fluid circuit system 1, the 3-1 opening P31 of the third multi-way valve MV3 communicates with the 3-4 opening P34, and the 3-3 opening P33 communicates with the 3-5 opening P35.

Accordingly, the fluid circuit system 1 can circulate the coolant through the P22-P33 flow path FC6, the P35-P11 flow path FC1, the P13-CV1 flow path FC3, and the CV1-P26 flow path FC9 by operating the first pump P1. The fluid circuit system 1 can guide the coolant to the chiller CH and the battery BT. The fluid circuit system 1 can circulate the coolant through the P12-CV2 flow path FC2, the CV2-P21 flow path FC5, the P24-P14 flow path FC4, the P23-CV3 flow path FC7, the CV3-P31 flow path FC10, and the P34-CV2 flow path FC12 by operating the second pump P2 and the third pump P3. The fluid circuit system 1 can guide the coolant to the water-cooled condenser WC, the radiator LT, and the driving heat generation unit PT.

As described above, the fluid circuit system 1 according to the present embodiment prohibits the flow of the fluid to the unnecessary inlet and the unnecessary outlet of the second multi-way valve MV2 in the open state by closing the unnecessary inlet and the unnecessary outlet of the third multi-way valve MV3 different from the second multi-way valve MV2.

Accordingly, as compared with a case where the fluid circuit system 1 is configured to close the unnecessary inlet and the unnecessary outlet of the first multi-way valve MV1 to the third multi-way valve MV3 when the temperature control device executes the six operation modes, restrictions on the first multi-way valve MV1 to the third multi-way valve MV3 are reduced.

For example, when the first multi-way valve MV1 to the third multi-way valve MV3 are in the closed configuration, it is necessary to close the unnecessary inlet and the unnecessary outlet of the first multi-way valve MV1 to the third multi-way valve MV3 in all of the six operation modes. In this case, a size and position of a flow hole formed in the first fixed disk FD1 to the third fixed disk FD3 provided in the first multi-way valve MV1 to the third multi-way valve MV3, which are disk valves, are likely to be restricted.

When the size of the flow hole formed in the first fixed disk FD1, the second fixed disk FD2, and the third fixed disk FD3 is restricted, a pressure loss when the fluid flows through the flow hole is likely to increase. That is, the pressure loss when the fluid flows through the first multi-way valve MV1 to the third multi-way valve MV3 increases. This causes an increase in power consumption of the first pump P1, the second pump P2, and the third pump P3 that generate a fluid flow in the fluid circuit FC.

However, by adopting a configuration in which a state of the unnecessary inlet and the unnecessary outlet of the first multi-way valve MV1 to the third multi-way valve MV3 may be either the open state or the closed state, it is easy to increase the size of the flow hole formed in the first fixed disk FD1 to the third fixed disk FD3. By enlarging the flow hole, it is possible to reduce a pressure loss when the fluid flows through the flow hole.

Since the size and position of the flow hole formed in the first fixed disk FD1 to the third fixed disk FD3 are not easily restricted, it is not necessary to form two 2-2 flow holes FD22 or the like as in the comparative second fixed disk CFD2 described above. Therefore, the number of flow holes formed in the second fixed disk FD2 can be reduced.

Accordingly, the structure of the second fixed disk FD2 can be simplified. Since it is not necessary to provide the communication mechanism for allowing the two 2-2 flow holes FD22 to communicate in the housing M10, the structure in the housing M10 can be simplified. Therefore, it is possible to reduce a pressure loss when the fluid flows through the second multi-way valve MV2. Accordingly, the production cost of the second multi-way valve MV2 can be reduced.

When the side wall portion M117 of the housing M10 is configured to have an inlet port and an outlet port corresponding to the flow hole and to have the comparative second fixed disk FD2, a size of the port is not restricted as compared with the configuration having the second fixed disk CFD2. Specifically, the second multi-way valve MV2 according to the present embodiment can have larger inlet port and the outlet port than the configuration having the comparative second fixed disk CFD2. Therefore, a pressure loss that occurs when the fluid flows through the inlet port and the outlet port can be reduced.

The size and position of the flow hole formed in the first fixed disk FD1 to the third fixed disk FD3 are unlikely to be restricted. Therefore, it is easy to ensure a communication range when communicating with the first through hole MD11, the first communication hole MD12, the second through hole MD21, the second communication hole MD22, the third through hole MD31, and the third communication hole MD32. Therefore, it is possible to reduce a pressure loss when the fluid flows through the first through hole MD11, the first communication hole MD12, the second through hole MD21, the second communication hole MD22, the third through hole MD31, and the third communication hole MD32.

Therefore, it is possible to reduce a pressure loss when the fluid flows through the first multi-way valve MV1 to the third multi-way valve MV3. Accordingly, it is possible to reduce the power consumption of the first pump P1, the second pump P2, and the third pump P3 that generate the flow of the fluid in the fluid circuit FC. Therefore, running cost of the entire fluid circuit system 1 can be reduced.

By reducing the pressure loss when the fluid flows through the first multi-way valve MV1 to the third multi-way valve MV3, capacities of the first pump P1, the second pump P2, and the third pump P3 can be reduced. Therefore, initial cost of the entire fluid circuit system 1 can be reduced.

Since the size and position of the flow holes formed in the first fixed disk FD1 to the third fixed disk FD3 are not easily restricted, even when the number of operation modes of the temperature control device is increased to more than six, flow holes corresponding to the increased operation modes are easily formed. Therefore, since no flow holes can be formed, there is no need to further add a valve device. Therefore, even when the number of operation modes of the temperature control device increases to more than six, it is possible to reduce an increase in the production cost of the entire fluid circuit system 1.

### Modification of First Embodiment

In the first embodiment, the example has been described in which the flow of the fluid to the unnecessary inlet and the unnecessary outlet of the second multi-way valve MV2 in the open state is prohibited by closing the unnecessary inlet and the unnecessary outlet of the third multi-way valve MV3 different from the second multi-way valve MV2, but the invention is not limited thereto. For example, the fluid circuit system 1 may be configured to prohibit the flow of the fluid to the unnecessary inlet and the unnecessary outlet of the first multi-way valve MV1 in the open state by closing the unnecessary inlet and the unnecessary outlet of the second multi-way valve MV2 or the third multi-way valve MV3. The fluid circuit system 1 may be configured to prohibit the flow of the fluid to the unnecessary inlet and the unnecessary outlet of the third multi-way valve MV3 in the open state by closing the unnecessary inlet and the unnecessary outlet of the first multi-way valve MV1 or the second multi-way valve MV2.

### Second Embodiment

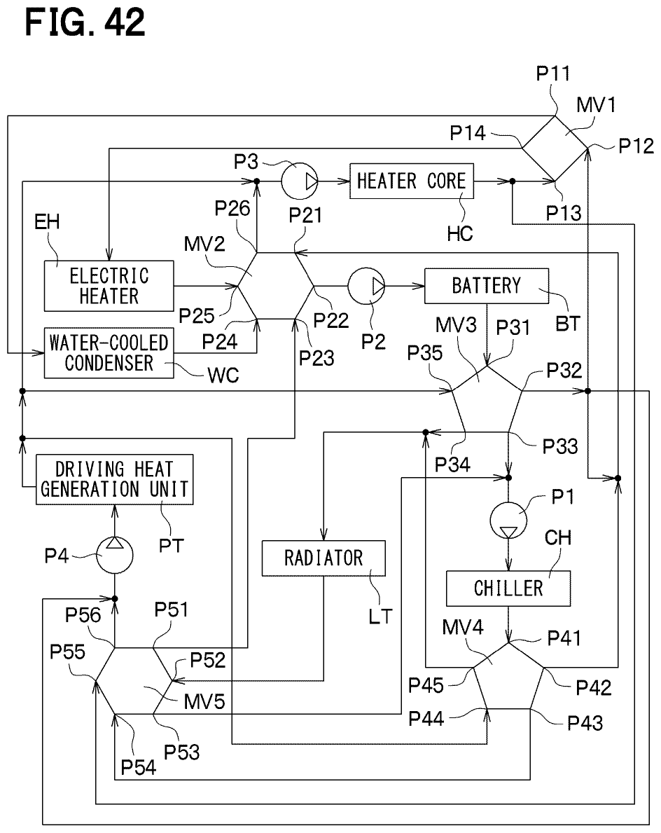

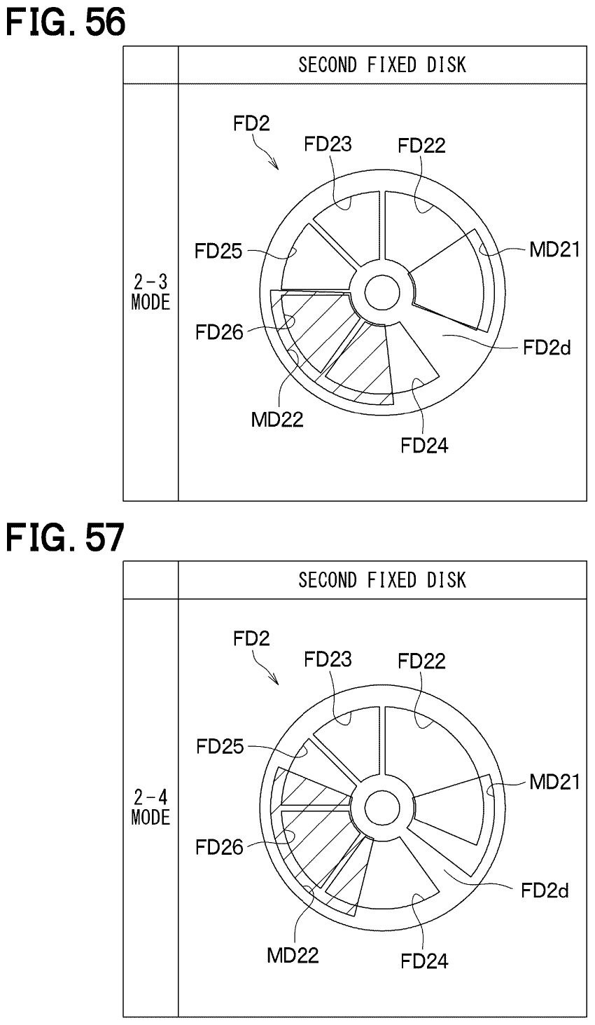

Next, the second embodiment will be described with reference to FIGS. 42 to 64. The present embodiment is different from the first embodiment in that an electric heater EH is added as a device connected to the temperature control device. The present embodiment is different from the first embodiment in that a fourth pump P4, a fourth multi-way valve MV4, and a fifth multi-way valve MV5 are added to the fluid circuit system 1, and a part of the fluid circuit FC is changed with the addition of the electric heater EH, the fourth multi-way valve MV4, and the fifth multi-way valve MV5. The other configuration is similar as that of the first embodiment. Therefore, in the present embodiment, portions different from the first embodiment will be mainly described, and description of portions similar to the first embodiment may be omitted.

As illustrated in FIG. 42, the electric heater EH is connected to the temperature control device according to the present embodiment. When the vehicle air conditioning device performs heating, the coolant to be introduced into the heater core HC is heated. The electric heater EH is provided upstream of the heater core HC in the coolant flow. The fluid circuit system 1 includes the fourth multi-way valve MV4 and the fifth multi-way valve MV5 in addition to the first multi-way valve MV1, the second multi-way valve MV2, and the third multi-way valve MV3 for switching the flow of the coolant to various connection devices of the temperature control device including the electric heater EH.

The first multi-way valve MV1 to the third multi-way valve MV3 have the same basic configuration, but a part of the configuration of the coolant inlet and the coolant outlet is different from that of the first embodiment. Specifically, the first multi-way valve MV1 has different combinations of the coolant inlet and the coolant outlet for the 1-1 opening P11, the 1-2 opening P12, the 1-3 opening P13, and the 1-4 opening P14. The second multi-way valve MV2 has different combinations of the coolant inlet and the coolant outlet for the 2-3 opening P23, the 2-4 opening P24, the 2-5 opening P25, and the 2-6 opening P26. The third multi-way valve MV3 has different combinations of the coolant inlet and the coolant outlet for the 3-3 opening P33 and the 3-5 opening P35.

The fourth multi-way valve MV4 and the fifth multi-way valve MV5 are disk valves having the same basic configuration as the first multi-way valve MV1 to the third multi-way valve MV3. The fourth multi-way valve MV4 and the fifth multi-way valve MV5 have a plurality of coolant inlets and a plurality of coolant outlets, cause the coolant flowing into themselves to flow out from coolant outlets corresponding to the operation mode of the temperature control device, and switch the fluid circuit FC according to the operation mode.

As illustrated in FIG. 42, the first multi-way valve MV1 has two coolant inlets and two coolant outlets. In the present embodiment, the two coolant inlets formed in the first multi-way valve MV1 are referred to as the 1-2 opening P12 and the 1-3 opening P13, and the two coolant outlets formed in the first multi-way valve MV1 are referred to as the 1-1 opening P11 and the 1-4 opening P14.

The first multi-way valve MV1 includes the first fixed disk FD1, which will be described later, having a 1-1 flow hole FD11 capable of communicating with the 1-1 opening P11, the 1-3 flow hole FD13 capable of communicating with the 1-3 opening P13, and the 1-4 flow hole FD14 capable of communicating with the 1-4 opening P14. The first multi-way valve MV1 includes the first movable disk MD1 described later that rotates while sliding on the first fixed disk FD1 and has the first through hole MD11 and the first communication hole MD12 communicating with the 1-1 flow hole FD11, the 1-3 flow hole FD13, and the 1-4 flow hole FD14.

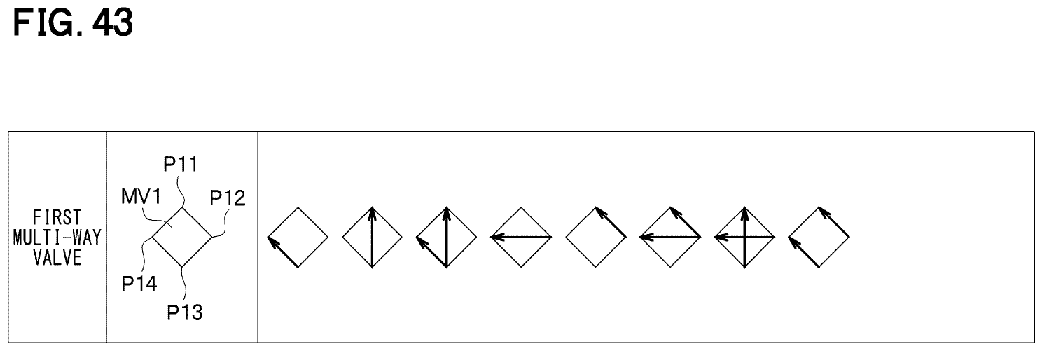

The first multi-way valve MV1 is provided in the upward direction DRa2 relative to the first movable disk MD1 and the first fixed disk FD1, and the 1-2 opening P12 is formed in a port (not illustrated) for introducing the coolant into the first multi-way valve MV1. As illustrated in FIG. 43, the first multi-way valve MV1 according to the present embodiment can switch an outflow destination of the coolant flowing in from the 1-2 opening P12 and the 1-3 opening P13 to the 1-1 opening P11 and the 1-4 opening P14 according to the operation mode of the temperature control device.

Specifically, the first multi-way valve MV1 can be switched to any one of eight operations: an operation in which the 1-3 opening P13 communicates with the 1-4 opening P14, an operation in which the 1-3 opening P13 communicates with the 1-1 opening P11, an operation in which the 1-3 opening P13 communicates with the 1-1 opening P11 and the 1-4 opening P14, an operation in which the 1-2 opening P12 communicates with the 1-4 opening P14, an operation in which the 1-2 opening P12 communicates with the 1-1 opening P11, an operation in which the 1-2 opening P12 communicates with the 1-1 opening P11 and the 1-4 opening P14, an operation in which the 1-3 opening P13 communicates with the 1-1 opening P11 and the 1-2 opening P12 communicates with the 1-4 opening P14, and an operation in which the 1-3 opening P13 communicates with the 1-4 opening P14 and the 1-2 opening P12 communicates with the 1-1 opening P11.

As illustrated in FIG. 42, the second multi-way valve MV2 has four coolant inlets and two coolant outlets. In the present embodiment, the four coolant inlets formed in the second multi-way valve MV2 are referred to as the 2-1 opening P21, the 2-3 opening P23, the 2-4 opening P24, and the 2-5 opening P25, and the two coolant outlets formed in the second multi-way valve MV2 are referred to as the 2-2 opening P22 and the 2-6 opening P26.

The second multi-way valve MV2 includes the second fixed disk FD2, which will be described later, having the 2-2 flow hole FD22 capable of communicating with the 2-2 opening P22, the 2-3 flow hole FD23 capable of communicating with the 2-3 opening P23, the 2-4 flow hole FD24 capable of communicating with the 2-4 opening P24, the 2-5 flow hole FD25 capable of communicating with the 2-5 opening P25, and the 2-6 flow hole FD26 capable of communicating with the 2-6 opening P26. The second multi-way valve MV2 includes the second movable disk MD2 described later that slides and rotates on the second fixed disk FD2. The second movable disk MD2 has the second through hole MD21 and the second communication hole MD22 communicating with the 2-2 flow hole FD22, the 2-3 flow hole FD23, the 2-4 flow hole FD24, the 2-5 flow hole FD25, and the 2-6 flow hole FD26.

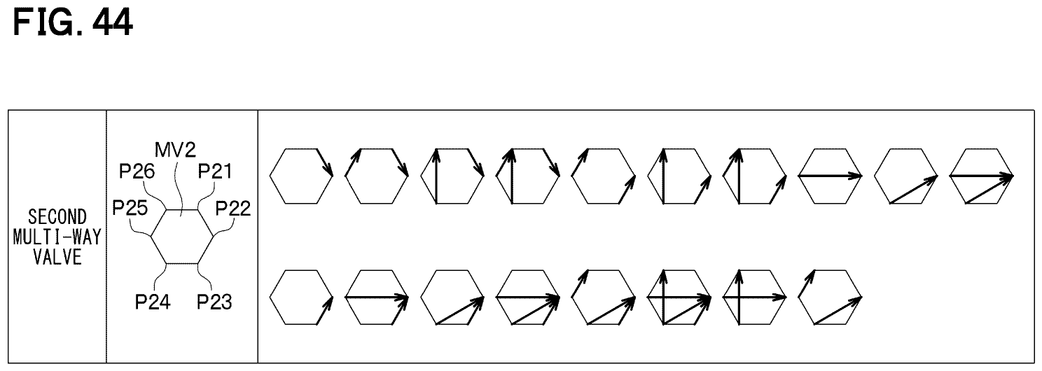

The second multi-way valve MV2 is provided in the upward direction DRa2 relative to the second movable disk MD2 and the second fixed disk FD2, and the 2-1 opening P21 is formed in a port (not illustrated) for introducing the coolant into the upper flow path VF2. As illustrated in FIG. 44, the second multi-way valve MV2 according to the present embodiment can switch an outflow destination of the coolant flowing in from the 2-1 opening P21, the 2-3 opening P23, the 2-4 opening P24, and the 2-5 opening P25 to the 2-2 opening P22, the 2-5 opening P25, and the 2-6 opening P26 according to the operation mode of the temperature control device.

Specifically, the second multi-way valve MV2 can be switched to any one of eighteen operations: an operation in which the 2-1 opening P21 communicates with the 2-2 opening P22, an operation in which the 2-1 opening P21 communicates with the 2-2 opening P22 and the 2-5 opening P25 communicates with the 2-6 opening P26, an operation in which the 2-1 opening P21 communicates with the 2-2 opening P22 and the 2-4 opening P24 communicates with the 2-6 opening P26, an operation in which the 2-1 opening P21 communicates with the 2-2 opening P22 and the 2-4 opening P24 and the 2-5 opening P25 communicate with the 2-6 opening P26, an operation in which the 2-3 opening P23 communicates with the 2-2 opening P22 and the 2-5 opening P25 communicates with the 2-6 opening P26, an operation in which the 2-3 opening P23 communicates with the 2-2 opening P22 and the 2-4 opening P24 communicates with the 2-6 opening P26, an operation in which the 2-3 opening P23 communicates with the 2-2 opening P22 and the 2-4 opening P24 and the 2-5 opening P25 communicate with the 2-6 opening P26, and an operation in which the 2-5 opening P25 communicates with the 2-2 opening P22, an operation in which the 2-4 opening P24 communicates with the 2-2 opening P22, an operation in which the 2-4 opening P24 and the 2-5 opening P25 communicate with the 2-2 opening P22, an operation in which the 2-3 opening P23 communicates with the 2-2 opening P22, and an operation in which the 2-3 opening P23 and the 2-5 opening P25 communicate with the 2-2 opening P22, an operation in which the 2-3 opening P23 and the 2-4 opening P24 communicate with the 2-2 opening P22, an operation in which the 2-3 opening P23, the 2-4 opening P24, and the 2-5 opening P25 communicate with the 2-2 opening P22, an operation in which the 2-3 opening P23 and the 2-4 opening P24 communicate with the 2-2 opening P22 and the 2-5 opening P25 communicates with the 2-6 opening P26, an operation in which the 2-3 opening P23 and the 2-5 opening P25 communicate with the 2-2 opening P22 and the 2-4 opening P24 communicates with the 2-6 opening P26, an operation in which the 2-5 opening P25 communicates with the 2-2 opening P22 and the 2-4 opening P24 communicates with the 2-6 opening P26, and an operation in which the 2-4 opening P24 communicates with the 2-2 opening P22 and the 2-5 opening P25 communicates with the 2-6 opening P26.

As illustrated in FIG. 42, the third multi-way valve MV3 has two coolant inlets and three coolant outlets. In the present embodiment, the two coolant inlets formed in the third multi-way valve MV3 are referred to as the 3-1 opening P31 and the 3-5 opening P35, and the three coolant outlets formed in the third multi-way valve MV3 are referred to as the 3-2 opening P32, the 3-3 opening P33, and the 3-4 opening P34.

The third multi-way valve MV3 includes the third fixed disk FD3, which will be described later, having the 3-2 flow hole FD32 capable of communicating with the 3-2 opening P32, the 3-3 flow hole FD33 capable of communicating with the 3-3 opening P33, the 3-4 flow hole FD34 capable of communicating with the 3-4 opening P34, and the 3-5 flow hole FD35 capable of communicating with the 3-5 opening P35. The third multi-way valve MV3 includes the third movable disk MD3 described later that slides and rotates on the third fixed disk FD3. The third movable disk MD3 includes the third movable disk MD3, which will be described later, having the third through hole MD31 and the third communication hole MD32 communicating with the 3-2 flow hole FD32, the 3-3 flow hole FD33, the 3-4 flow hole FD34, and the 3-5 flow hole FD35.

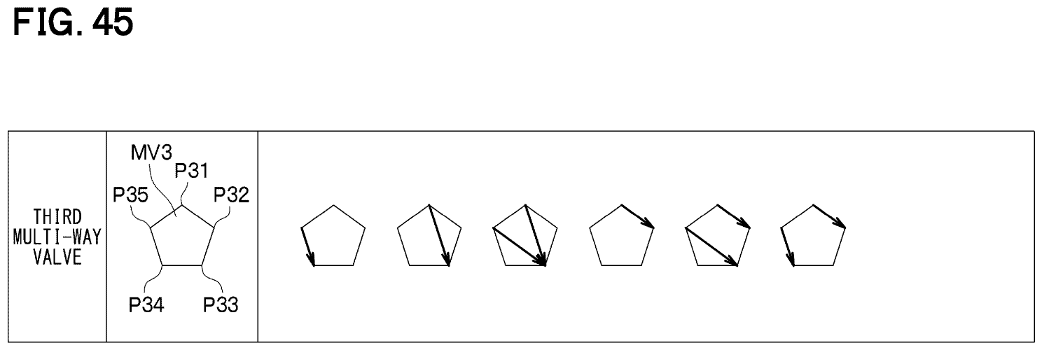

The third multi-way valve MV3 is provided in the upward direction DRa2 relative to the third movable disk MD3 and the third fixed disk FD3, and the 3-1 opening P31 is formed in a port (not illustrated) for introducing the coolant into the third multi-way valve MV3. As illustrated in FIG. 45, the third multi-way valve MV3 according to the present embodiment can switch an outflow destination of the coolant flowing in from the 3-1 opening P31 and the 3-5 opening P35 to the 3-2 opening P32, the 3-3 opening P33, and the 3-4 opening P34 according to the operation mode of the temperature control device.

Specifically, the third multi-way valve MV3 can be switched to any one of six operations: an operation in which the 3-5 opening P35 communicates with the 3-4 opening P34, an operation in which the 3-1 opening P31 communicates with the 3-3 opening P33, an operation in which the 3-1 opening P31 and the 3-5 opening P35 communicate with the 3-3 opening P33, an operation in which the 3-1 opening P31 communicates with the 3-2 opening P32, an operation in which the 3-1 opening P31 communicates with the 3-2 opening P32 and the 3-5 opening P35 communicates with the 3-3 opening P33, and an operation in which the 3-1 opening P31 communicates with the 3-2 opening P32 and the 3-5 opening P35 communicates with the 3-4 opening P34.

As illustrated in FIG. 42, the fourth multi-way valve MV4 has two coolant inlets and three coolant outlets. In the present embodiment, the two coolant inlets formed in the fourth multi-way valve MV4 are referred to as a 4-1 opening P41 and a 4-4 opening P44, and the three coolant outlets formed in the fourth multi-way valve MV4 are referred to as a 4-2 opening P42, a 4-3 opening P43, and a 4-5 opening P45.

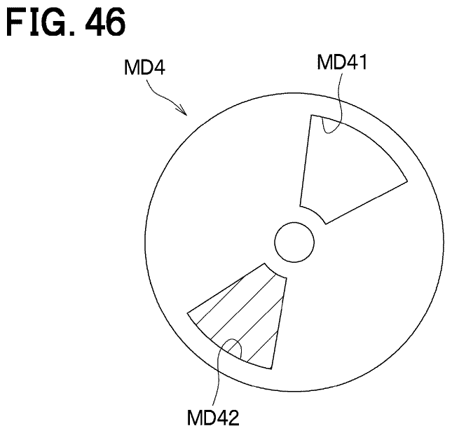

The fourth multi-way valve MV4 includes a fourth fixed disk FD4, which will be described later, having a 4-2 flow hole FD42 capable of communicating with the 4-2 opening P42, a 4-3 flow hole FD43 capable of communicating with the 4-3 opening P43, a 4-4 flow hole FD44 capable of communicating with the 4-4 opening P44, and a 4-5 flow hole FD45 capable of communicating with the 4-5 opening P45. The fourth multi-way valve MV4 has a fourth movable disk MD4 illustrated in FIG. 46 that slides and rotates on the fourth fixed disk FD4. The fourth movable disk MD4 has a fourth through hole MD41 and a fourth communication hole MD42 communicating with the 4-2 flow hole FD42, the 4-3 flow hole FD43, the 4-4 flow hole FD44, and the 4-5 flow hole FD45.

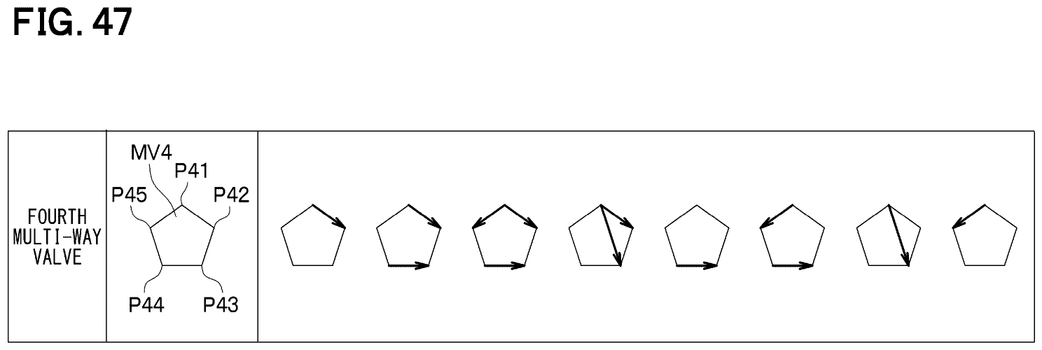

The fourth multi-way valve MV4 is provided in the upward direction DRa2 relative to the fourth movable disk MD4 and the fourth fixed disk FD4, and the 4-1 opening P41 is formed in a port (not illustrated) for introducing the coolant into the fourth multi-way valve MV4. As illustrated in FIG. 47, the fourth multi-way valve MV4 according to the present embodiment can switch an outflow destination of the coolant flowing in from the 4-1 opening P41 and the 4-4 opening P44 to the 4-2 opening P42, the 4-3 opening P43, and the 4-5 opening P45 according to the operation mode of the temperature control device.

Specifically, the fourth multi-way valve MV4 can be switched to any one of eight operations: an operation in which the 4-1 opening P41 communicates with the 4-2 opening P42, an operation in which the 4-1 opening P41 communicates with the 4-2 opening P42 and the 4-4 opening P44 communicates with the 4-3 opening P43, an operation in which the 4-1 opening P41 communicates with the 4-2 opening P42 and the 4-5 opening P45 and the 4-4 opening P44 communicates with the 4-3 opening P43, an operation in which the 4-1 opening P41 communicates with the 4-2 opening P42 and the 4-3 opening P43, an operation in which the 4-4 opening P44 communicates with the 4-3 opening P43, an operation in which the 4-1 opening P41 communicates with the 4-5 opening P45 and the 4-4 opening P44 communicates with the 4-3 opening P43, an operation in which the 4-1 opening P41 communicates with the 4-3 opening P43, and an operation in which the 4-1 opening P41 communicates with the 4-5 opening P45.

As illustrated in FIG. 42, the fifth multi-way valve MV5 has three coolant inlets and three coolant outlets. In the present embodiment, the three coolant inlets formed in the fifth multi-way valve MV5 are referred to as a 5-2 opening P52, a 5-4 opening P54, and a 5-5 opening P55, and the three coolant outlets formed in the fifth multi-way valve MV5 are referred to as a 5-1 opening P51, a 5-3 opening P53, and a 5-6 opening P56.

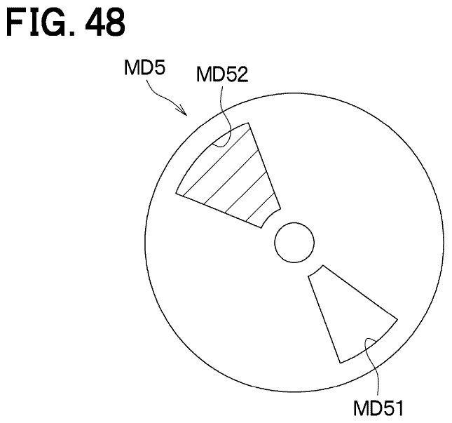

The fifth multi-way valve MV5 has a fifth fixed disk FD5 having a 5-2 flow hole FD52 capable of communicating with the 5-2 opening P52, a 5-3 flow hole FD53 capable of communicating with the 5-3 opening P53, a 5-4 flow hole FD54 capable of communicating with the 5-4 opening P54, and a 5-5 flow hole FD55 capable of communicating with the 5-5 opening P55. The fifth multi-way valve MV5 has a fifth movable disk MD5 illustrated in FIG. 48 that slides and rotates on the fifth fixed disk FD5. The fifth movable disk MD5 has a fifth through hole MD51 and a fifth communication hole MD52 communicating with the 5-2 flow hole FD52, the 5-3 flow hole FD53, the 5-4 flow hole FD54, the 5-5 flow hole FD55, and a 5-6 flow hole FD56.

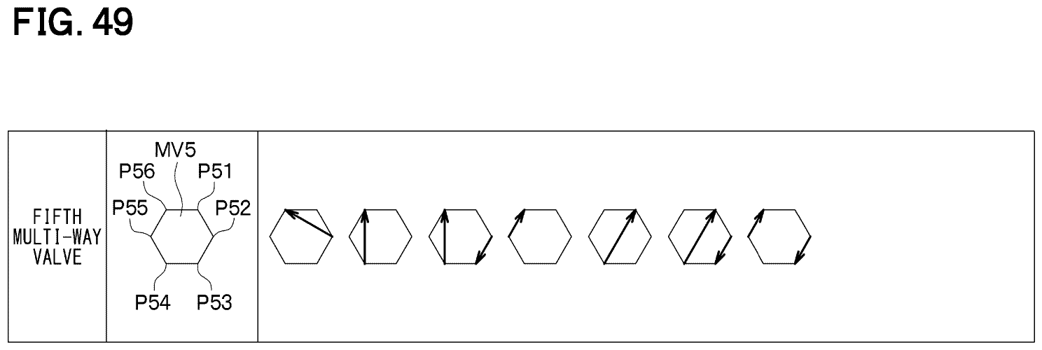

The fifth multi-way valve MV5 is provided in the upward direction DRa2 relative to the fifth movable disk MD5 and the fifth fixed disk FD5, and the 5-1 opening P51 is formed in a port (not illustrated) for introducing the coolant into the fifth multi-way valve MV5. As illustrated in FIG. 49, the fifth multi-way valve MV5 according to the present embodiment can switch an outflow destination of the coolant flowing in from the 5-2 opening P52, the 5-4 opening P54, and the 5-5 opening P55 to the 5-1 opening P51, the 5-3 opening P53, and the 5-6 opening P56 according to the operation mode of the temperature control device.

Specifically, the fifth multi-way valve MV5 can be switched to any one of seven operations: an operation in which the 5-2 opening P52 communicates with the 5-6 opening P56, an operation in which the 5-4 opening P54 communicates with the 5-6 opening P56, an operation in which the 5-2 opening P52 communicates with the 5-3 opening P53 and the 5-4 opening P54 communicates with the 5-6 opening P56, an operation in which the 5-5 opening P55 communicates with the 5-6 opening P56, an operation in which the 5-4 opening P54 communicates with the 5-1 opening P51, an operation in which the 5-2 opening P52 communicates with the 5-3 opening P53 and the 5-4 opening P54 communicates with the 5-1 opening P51, and an operation in which the 5-2 opening P52 communicates with the 5-3 opening P53 and the 5-5 opening P55 communicates with the 5-6 opening P56.

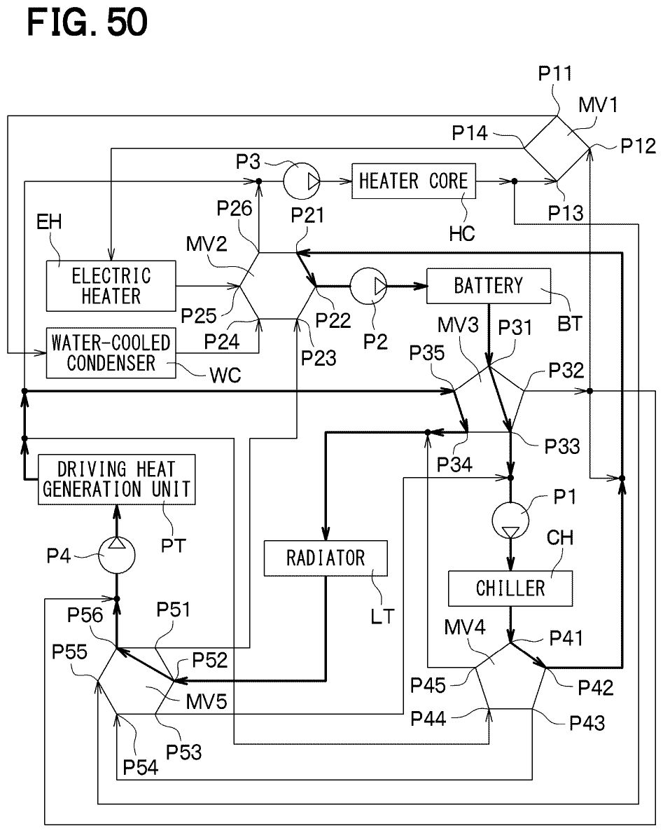

Next, a flow of the coolant flowing through the fluid circuit system 1 when the temperature control device according to the present embodiment executes various operation modes will be described. In the fluid circuit system 1 according to the present embodiment, the operation of the first multi-way valve MV1 to the fifth multi-way valve MV5 is switched according to the operation mode of the temperature control device. Hereinafter, a flow of the coolant flowing through the fluid circuit system 1 when four representative operation modes are executed among the operation modes executed by the temperature control device according to the present embodiment will be described with reference to FIGS. 50 to 53. In FIGS. 50 to 53, the flow of the coolant circulating in the fluid circuit system 1 is indicated by an arrow thicker than an arrow indicating the fluid circuit FC.

### (1) 2-1 Mode

In the 2-1 mode, the coolant is circulated by the fluid circuit system 1 as illustrated in FIG. 50. Specifically, in the 2-1 mode, the fluid circuit system 1 operates the first pump P1 and the second pump P2 to circulate the coolant between the battery BT and the chiller CH. In the 2-1 mode, the fluid circuit system 1 operates the fourth pump P4 to circulate the coolant between the radiator LT and the driving heat generation unit PT.

When the fluid circuit system 1 circulates the coolant in this way, the second multi-way valve MV2 needs to adjust a rotational position of the second movable disk MD2 to allow the 2-1 opening P21, which is the coolant inlet, to communicate with the 2-2 opening P22, which is the coolant outlet. The third multi-way valve MV3 needs to adjust a rotational position of the third movable disk MD3 to allow the 3-1 opening P31, which is the coolant inlet, to communicate with the 3-3 opening P33, which is the coolant outlet. Further, the third multi-way valve MV3 needs to adjust the rotational position of the third movable disk MD3 to allow the 3-5 opening P35, which is the coolant inlet, to communicate with the 3-4 opening P34, which is the coolant outlet. The fourth multi-way valve MV4 needs to adjust a rotational position of the fourth movable disk MD4 to allow the 4-1 opening P41, which is the coolant inlet, to communicate with the 4-2 opening P42, which is the coolant outlet. The fifth multi-way valve MV5 needs to adjust a rotational position of the fifth movable disk MD5 to allow the 5-2 opening P52, which is the coolant inlet, to communicate with the 5-6 opening P56, which is the coolant outlet.

### (2) 2-2 Mode

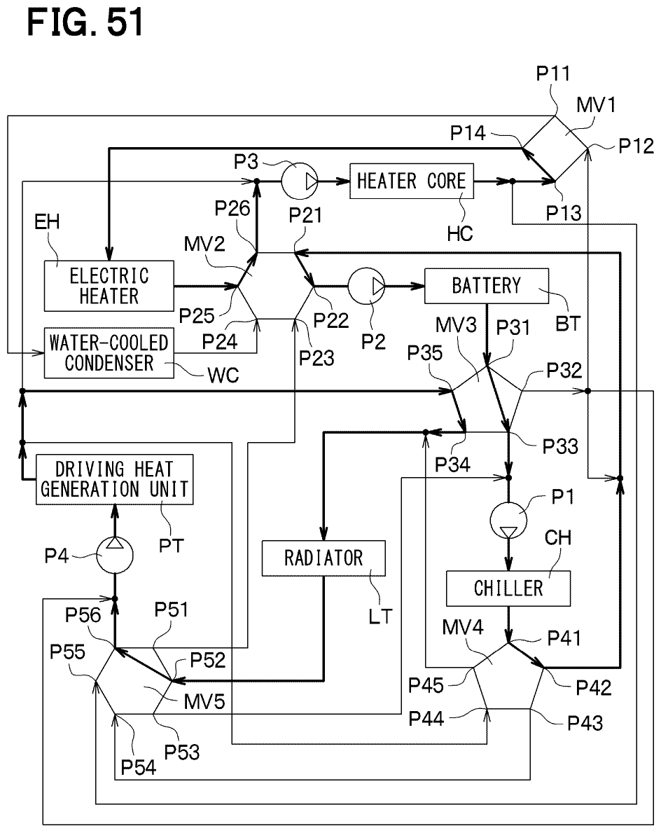

In the 2-2 mode, the coolant is circulated by the fluid circuit system 1 as illustrated in FIG. 51. Specifically, in the 2-2 mode, the fluid circuit system 1 operates the first pump P1 and the second pump P2 to circulate the coolant between the battery BT and the chiller CH. In the 2-2 mode, the fluid circuit system 1 operates the fourth pump P4 to circulate the coolant between the radiator LT and the driving heat generation unit PT. Further, in the 2-2 mode, the fluid circuit system 1 operates the third pump P3 to circulate the coolant between the heater core HC and the electric heater EH.

When the fluid circuit system 1 circulates the coolant in this way, the first multi-way valve MV1 needs to adjust a rotational position of the first movable disk MD1 to allow the 1-3 opening P13, which is the coolant inlet, to communicate with the 1-4 opening P14, which is the coolant outlet. The second multi-way valve MV2 needs to adjust the rotational position of the second movable disk MD2 to allow the 2-1 opening P21, which is the coolant inlet, to communicate with the 2-2 opening P22, which is the coolant outlet. Further, the second multi-way valve MV2 needs to adjust the rotational position of the second movable disk MD2 to allow the 2-5 opening P25, which is the coolant inlet, to communicate with the 2-6 opening P26, which is the coolant outlet.

The third multi-way valve MV3 needs to adjust the rotational position of the third movable disk MD3 to allow the 3-1 opening P31, which is the coolant inlet, to communicate with the 3-3 opening P33, which is the coolant outlet. Further, the third multi-way valve MV3 needs to adjust the rotational position of the third movable disk MD3 to allow the 3-5 opening P35, which is the coolant inlet, to communicate with the 3-4 opening P34, which is the coolant outlet. The fourth multi-way valve MV4 needs to adjust a rotational position of the fourth movable disk MD4 to allow the 4-1 opening P41, which is the coolant inlet, to communicate with the 4-2 opening P42, which is the coolant outlet. The fifth multi-way valve MV5 needs to adjust a rotational position of the fifth movable disk MD5 to allow the 5-2 opening P52, which is the coolant inlet, to communicate with the 5-6 opening P56, which is the coolant outlet.

### (3) 2-3 Mode

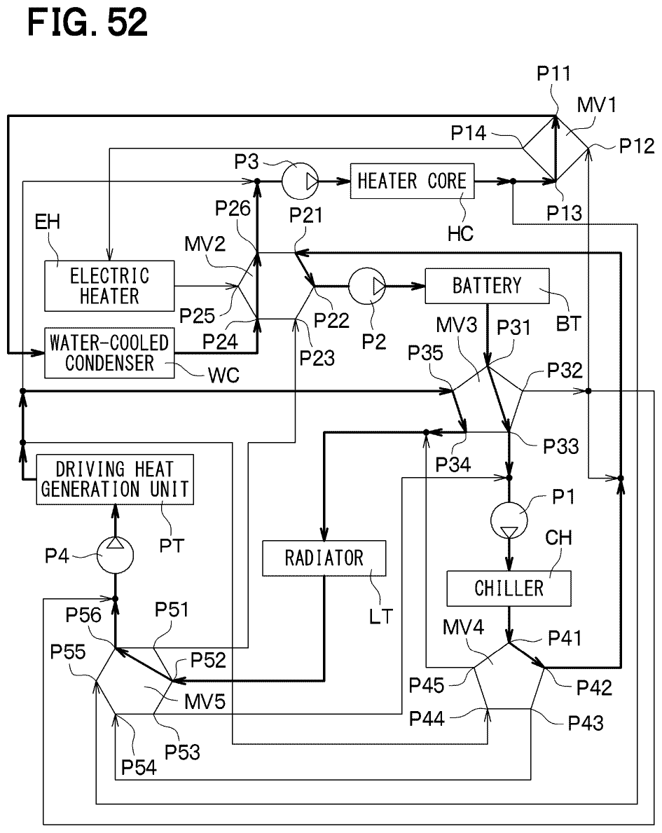

In the 2-3 mode, the coolant is circulated by the fluid circuit system 1 as illustrated in FIG. 52. Specifically, in the 2-3 mode, the fluid circuit system 1 operates the first pump P1 and the second pump P2 to circulate the coolant between the battery BT and the chiller CH. In the 2-3 mode, the fluid circuit system 1 operates the fourth pump P4 to circulate the coolant between the radiator LT and the driving heat generation unit PT. Further, in the 2-3 mode, the fluid circuit system 1 operates the third pump P3 to circulate the coolant between the heater core HC and the water-cooled condenser WC.

When the fluid circuit system 1 circulates the coolant in this way, the first multi-way valve MV1 needs to adjust a rotational position of the first movable disk MD1 to allow the 1-3 opening P13, which is the coolant inlet, to communicate with the 1-1 opening P11, which is the coolant outlet. The second multi-way valve MV2 needs to adjust the rotational position of the second movable disk MD2 to allow the 2-1 opening P21, which is the coolant inlet, to communicate with the 2-2 opening P22, which is the coolant outlet. Further, the second multi-way valve MV2 needs to adjust the rotational position of the second movable disk MD2 to allow the 2-4 opening P24, which is the coolant inlet, to communicate with the 2-6 opening P26, which is the coolant outlet.

The third multi-way valve MV3 needs to adjust a rotational position of the third movable disk MD3 to allow the 3-1 opening P31, which is the coolant inlet, to communicate with the 3-3 opening P33, which is the coolant outlet. Further, the third multi-way valve MV3 needs to adjust the rotational position of the third movable disk MD3 to allow the 3-5 opening P35, which is the coolant inlet, to communicate with the 3-4 opening P34, which is the coolant outlet. The fourth multi-way valve MV4 needs to adjust a rotational position of the fourth movable disk MD4 to allow the 4-1 opening P41, which is the coolant inlet, to communicate with the 4-2 opening P42, which is the coolant outlet. The fifth multi-way valve MV5 needs to adjust a rotational position of the fifth movable disk MD5 to allow the 5-2 opening P52, which is the coolant inlet, to communicate with the 5-6 opening P56, which is the coolant outlet.

### (4) 2-4 Mode

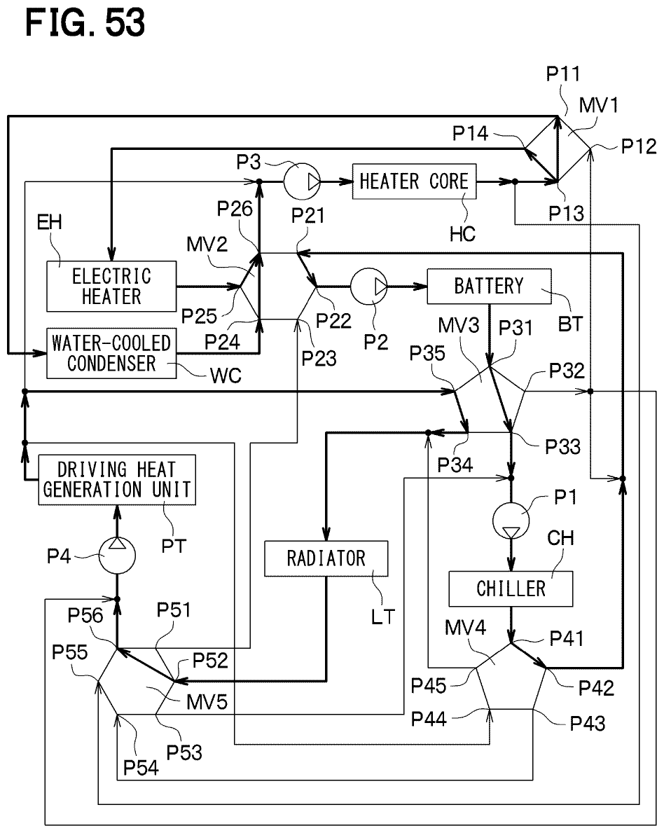

In the 2-4 mode, the coolant is circulated by the fluid circuit system 1 as illustrated in FIG. 53. Specifically, in the 2-4 mode, the fluid circuit system 1 operates the first pump P1 and the second pump P2 to circulate the coolant between the battery BT and the chiller CH. In the 2-3 mode, the fluid circuit system 1 operates the fourth pump P4 to circulate the coolant between the radiator LT and the driving heat generation unit PT. Further, in the 2-3 mode, the fluid circuit system 1 operates the third pump P3 to circulate the coolant between the heater core HC, the electric heater EH, and the water-cooled condenser WC.

When the fluid circuit system 1 circulates the coolant in this way, the first multi-way valve MV1 needs to adjust the rotational position of the first movable disk MD1 to allow the 1-3 opening P13, which is the coolant inlet, to communicate with the 1-1 opening P11 and the 1-4 opening P14, which are the coolant outlets. The second multi-way valve MV2 needs to adjust the rotational position of the second movable disk MD2 to allow the 2-1 opening P21, which is the coolant inlet, to communicate with the 2-2 opening P22, which is the coolant outlet. Further, the second multi-way valve MV2 needs to adjust the rotational position of the second movable disk MD2 to allow the 2-4 opening P24 and the 2-5 opening P25, which are the coolant inlets, to communicate with the 2-6 opening P26, which is the coolant outlet.

The third multi-way valve MV3 needs to adjust a rotational position of the third movable disk MD3 to allow the 3-1 opening P31, which is the coolant inlet, to communicate with the 3-3 opening P33, which is the coolant outlet. Further, the third multi-way valve MV3 needs to adjust the rotational position of the third movable disk MD3 to allow the 3-5 opening P35, which is the coolant inlet, to communicate with the 3-4 opening P34, which is the coolant outlet. The fourth multi-way valve MV4 needs to adjust a rotational position of the fourth movable disk MD4 to allow the 4-1 opening P41, which is the coolant inlet, to communicate with the 4-2 opening P42, which is the coolant outlet. The fifth multi-way valve MV5 needs to adjust a rotational position of the fifth movable disk MD5 to allow the 5-2 opening P52, which is the coolant inlet, to communicate with the 5-6 opening P56, which is the coolant outlet.

It is assumed that the fluid circuit system 1 according to the present embodiment is configured such that the second multi-way valve MV2 is in a closed configuration so as to close the unnecessary inlet and the unnecessary outlet of the second multi-way valve MV2 when the temperature control device executes the four operation modes.

When the temperature control device executes the 2-1 mode and the second multi-way valve MV2 is in the closed configuration, the second multi-way valve MV2 needs to close the 2-3 opening P23, the 2-4 opening P24, the 2-5 opening P25, and the 2-6 opening P26. When the temperature control device executes the 2-2 mode and the second multi-way valve MV2 is in the closed configuration, the second multi-way valve MV2 needs to close the 2-3 opening P23 and the 2-4 opening P24. When the temperature control device executes the 2-3 mode and the second multi-way valve MV2 is in the closed configuration, the second multi-way valve MV2 needs to close the 2-3 opening P23 and the 2-5 opening P25. When the temperature control device executes the 2-4 mode and the second multi-way valve MV2 is in the closed configuration, the second multi-way valve MV2 needs to close the 2-3 opening P23.

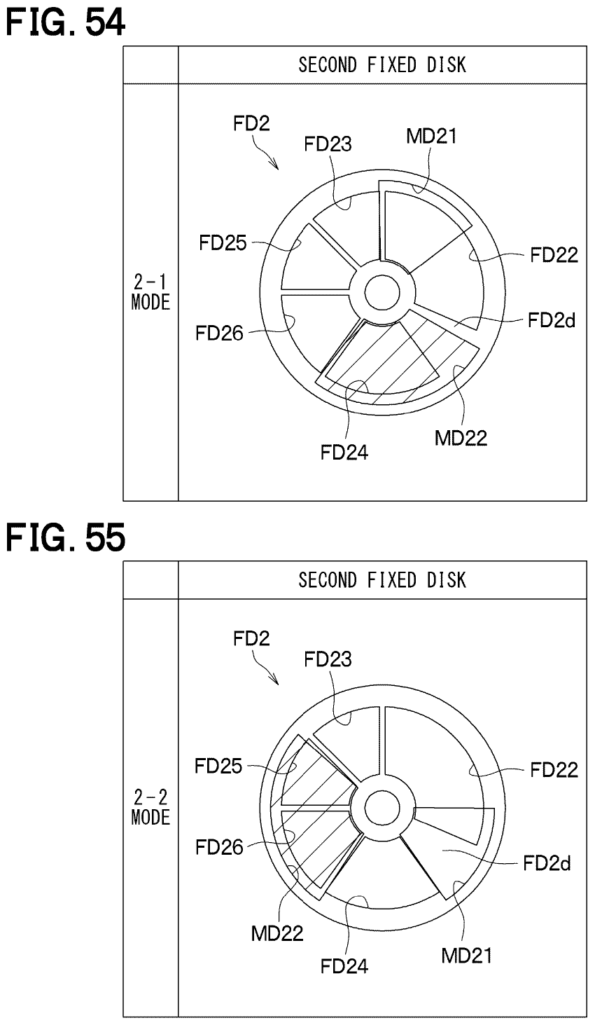

A comparative example in which the second multi-way valve MV2 is in the closed configuration in all of the four operation modes will be described with reference to comparative examples of FIGS. 54 to 57. FIGS. 54 to 57 illustrate the comparative second fixed disk CFD2 and the comparative second movable disk CMD2 for the fluid circuit system 1 to close the unnecessary inlet and the unnecessary outlet of the second multi-way valves MV2 in all of the four operation modes.

When the comparative second fixed disk CFD2 illustrated in FIG. 54 is used, a communication range between the second through hole MD21 and the 2-2 flow hole FD22 is narrow when the temperature control device executes the 2-2 mode. When the temperature control device executes the 2-4 mode, a communication range between the second communication hole MD22 and the 2-4 flow hole FD24 and a communication range between the second communication hole MD22 and the 2-6 flow hole FD26 are narrow.

When the coolant flows through such a portion having a narrow communication range, a pressure loss that occurs when the coolant flows tends to increase. Such an increase in the pressure loss leads to an increase in a pressure loss in the entire fluid circuit system 1, and is therefore undesirable.

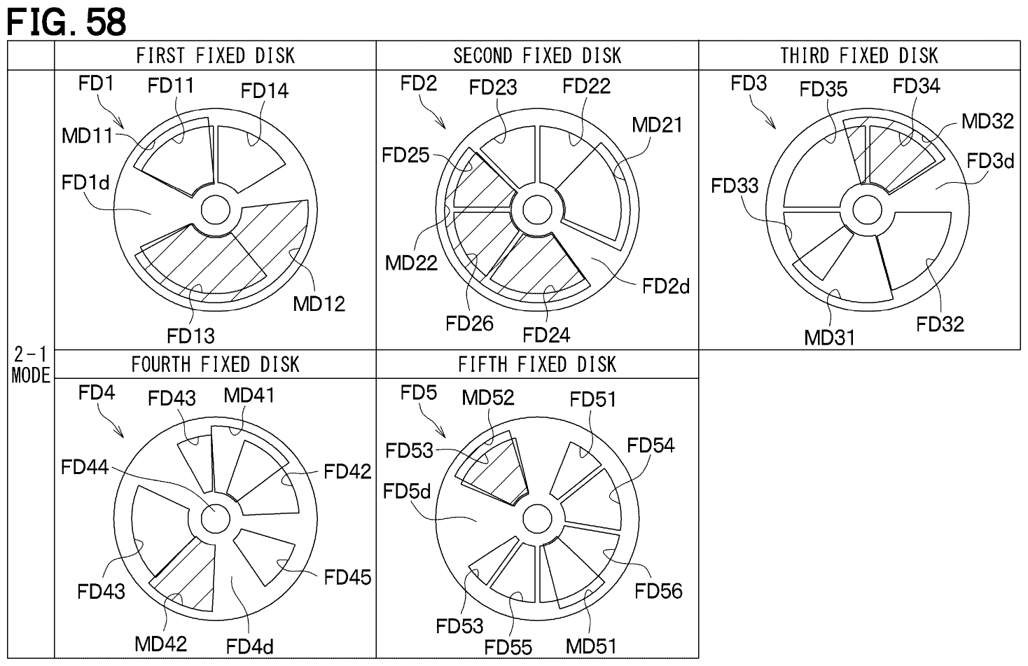

According to intensive study of the inventor, it has been found that by increasing a size of the second communication hole MD22 of the second multi-way valve MV2, the four operation modes can be achieved without necessarily closing the unnecessary inlet and the unnecessary outlet. The fluid circuit system 1 according to the present embodiment including the second multi-way valve MV2 in which the size of the second communication hole MD22 is increased will be described with reference to FIGS. 58 to 64.

A reason why the unnecessary inlet and the unnecessary outlet of the second multi-way valve MV2 are not necessarily closed is that an operation pattern of the second multi-way valve MV2 is significantly larger than that of the first multi-way valve MV1, the third multi-way valve MV3, the fourth multi-way valve MV4, and the fifth multi-way valve MV5. In other words, when the unnecessary inlet and the unnecessary outlet of the second multi-way valve MV2 are necessarily closed, a structure of the second multi-way valve MV2 may be complicated compared with the first multi-way valve MV1, the third multi-way valve MV3, the fourth multi-way valve MV4, and the fifth multi-way valve MV5.

In the four operation modes, the rotational positions of the second movable disk MD2 of the second multi-way valve MV2, the third movable disk MD3 of the third multi-way valve MV3, the fourth movable disk MD4 of the fourth multi-way valve MV4, and the fifth fixed disk MD5 of the fifth multi-way valve MV5 are the same. Therefore, operations of the second multi-way valve MV2, the third multi-way valve MV3, the fourth multi-way valve MV4, and the fifth multi-way valve MV5 will be described only in the 2-1 mode, and description for the other modes will be omitted.

First, the 2-1 mode will be described. When the operation mode of the temperature control device is set to the 2-1 mode, the first movable disk MD1 is positioned at a rotational position illustrated in FIG. 58. Specifically, when the operation mode is set to the 2-1 mode, the first movable disk MD1 is positioned at a position where the first through hole MD11 communicates with the 1-1 flow hole FD11, and the first communication hole MD12 communicates with the 1-3 flow hole FD13.

Accordingly, the 1-2 opening P12 communicates with the 1-1 opening P11 via the first through hole MD11 and the 1-1 flow hole FD11. The 1-3 opening P13 and the 1-4 opening P14 are closed.

When the operation mode of the temperature control device is set to the 2-1 mode, the second movable disk MD2 is positioned at a position where the second through hole MD21 communicates with the 2-2 flow hole FD22. The second movable disk MD2 is positioned at a position where the second communication hole MD22 communicates with the 2-4 flow hole FD24, the 2-5 flow hole FD25, and the 2-6 flow hole FD26.

Accordingly, the 2-1 opening P21 communicates with the 2-2 opening P22 via the second through hole MD21 and the 2-2 flow hole FD22. The 2-4 opening P24 communicates with the 2-6 opening P26 via the 2-4 flow hole FD24, the second communication hole MD22, and the 2-6 flow hole FD26. Further, the 2-5 opening P25 communicates with the 2-6 opening P26 via the 2-5 flow hole FD25, the second communication hole MD22, and the 2-6 flow hole FD26. The 2-3 opening P23 is closed.

When the operation mode of the temperature control device is set to the 2-1 mode, the third movable disk MD3 is positioned at a position where the third through hole MD31 communicates with the 3-3 flow hole FD33. The third movable disk MD3 is positioned at a position where the third communication hole MD32 communicates with the 3-4 flow hole FD34 and the 3-5 flow hole FD35.

Accordingly, the 3-1 opening P31 communicates with the 3-3 opening P33 via the third through hole MD31 and the 3-3 flow hole FD33. The 3-5 opening P35 communicates with the 3-4 opening P34 via the third communication hole MD32 and the 3-4 flow hole FD34. The 3-2 opening P32 is closed.

When the operation mode of the temperature control device is set to the 2-1 mode, the fourth movable disk MD4 is positioned at a position where the fourth through hole MD41 communicates with the 4-2 flow hole FD42, and the fourth communication hole MD42 faces a fourth partition portion FD4d.

Accordingly, the 4-1 opening P41 communicates with the 4-2 opening P42 via the fourth through hole MD41 and the 4-2 flow hole FD42. The 4-3 opening P43 and the 4-5 opening P45 are closed.

When the operation mode of the temperature control device is set to the 2-1 mode, the fifth movable disk MD5 is positioned at a position where the fifth through hole MD51 communicates with the 5-6 flow hole FD56, and the fifth communication hole MD52 communicates with the 5-3 flow hole FD53.

Accordingly, the 5-2 opening P52 communicates with the 5-6 opening P56 via the fifth through hole MD51 and the 5-6 flow hole FD56. The 5-1 opening P51, the 5-3 opening P53, the 5-4 opening P54, and the 5-5 opening P55 are closed.

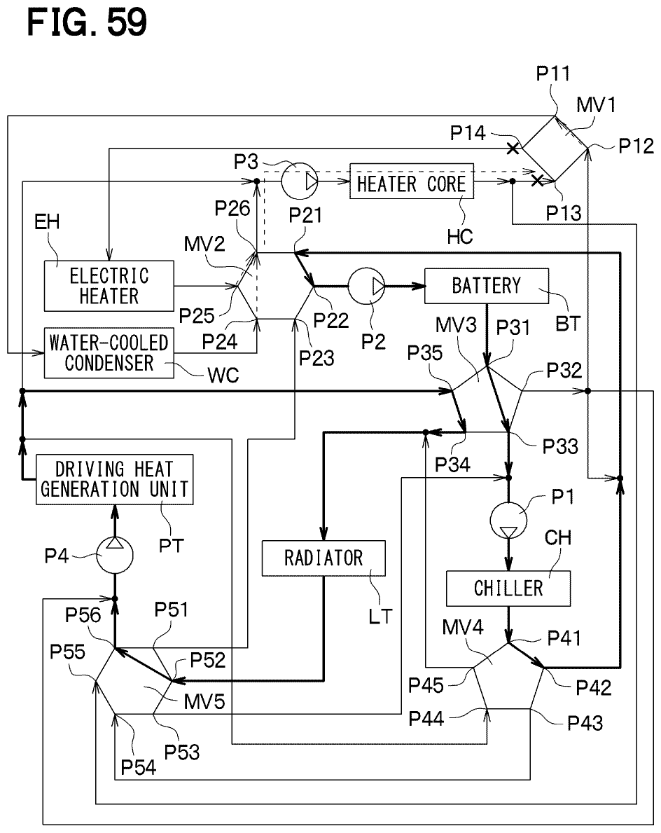

A flow of the coolant in the fluid circuit FC when the open and closed states of the coolant inlet and the coolant outlet of the first multi-way valve MV1 to the fifth multi-way valve MV5 are set in this manner will be described with reference to FIG. 59.

As described above, in the 2-1 mode, the fluid circuit system 1 allows the 2-1 opening P21 of the second multi-way valve MV2 to communicate with the 2-2 opening P22. In the fluid circuit system 1, the 3-1 opening P31 of the third multi-way valve MV3 communicates with the 3-3 opening P33, and the 3-5 opening P35 communicates with the 3-4 opening P34. Further, in the fluid circuit system 1, the 4-1 opening P41 of the fourth multi-way valve MV4 communicates with the 4-2 opening P42, and the 5-2 opening P52 of the fifth multi-way valve MV5 communicates with the 5-6 opening P56.

Accordingly, the fluid circuit system 1 can circulate the coolant in the fluid circuit FC by operating the first pump P1 and the second pump P2. The fluid circuit system 1 can guide the coolant to the battery BT and the chiller CH. The fluid circuit system 1 can circulate the coolant in the fluid circuit FC by operating the fourth pump P4. The fluid circuit system 1 can guide the coolant to the radiator LT and the driving heat generation unit PT.

In the fluid circuit system 1 according to the present embodiment, the 1-2 opening P12, which is the unnecessary inlet of the first multi-way valve MV1, communicates with the 1-1 opening P11, which is the unnecessary outlet. In the fluid circuit system 1, the 2-4 opening P24 and the 2-5 opening P25, which are the unnecessary inlets of the second multi-way valve MV2, communicate with the 2-6 opening P26, which is the unnecessary outlet. In this case, the coolant pumped by the third pump P3 may pass through the first multi-way valve MV1 and the second multi-way valve MV2 and flow into the electric heater EH and the water-cooled condenser WC that do not require the coolant to flow.

In contrast, in the fluid circuit system 1 according to the present embodiment, in the 2-1 mode, the 1-3 opening P13 of the first multi-way valve MV1 connected to a downstream side of a refrigerant flow of the fluid circuit FC in which the electric heater EH and the water-cooled condenser WC are disposed is closed. In the fluid circuit system 1, in the 2-1 mode, the 1-4 opening P14 of the first multi-way valve MV1 connected to an upstream side of a refrigerant flow of the fluid circuit FC in which the electric heater EH is disposed is closed. Therefore, it is possible to prevent the coolant pumped by the third pump P3 from flowing through the fluid circuit FC to the water-cooled condenser WC. That is, the fluid circuit system 1 can prohibit a flow of the coolant that may pass through an unnecessary inlet and an unnecessary outlet in an open state in the second multi-way valve MV2 by the first multi-way valve MV1 different from the second multi-way valve MV2.

In the fluid circuit system 1 according to the present embodiment, the fluid circuit system 1 does not operate the third pump P3 in the 2-1 mode. Therefore, the 1-2 opening P12 of the first multi-way valve MV1 communicates with the 1-1 opening P11, the 2-4 opening P24 and the 2-5 opening P25 of the second multi-way valve MV2 communicate with the 2-6 opening P26, and the fluid circuit FC in which the water-cooled condenser WC is disposed enables circulation of the coolant. Even in this case, the coolant does not flow through the water-cooled condenser WC. That is, the fluid circuit system 1 can open the unnecessary inlet and the unnecessary outlet that communicate with the circuit in which the third pump P3, which does not operate in the 2-1 mode, is disposed.

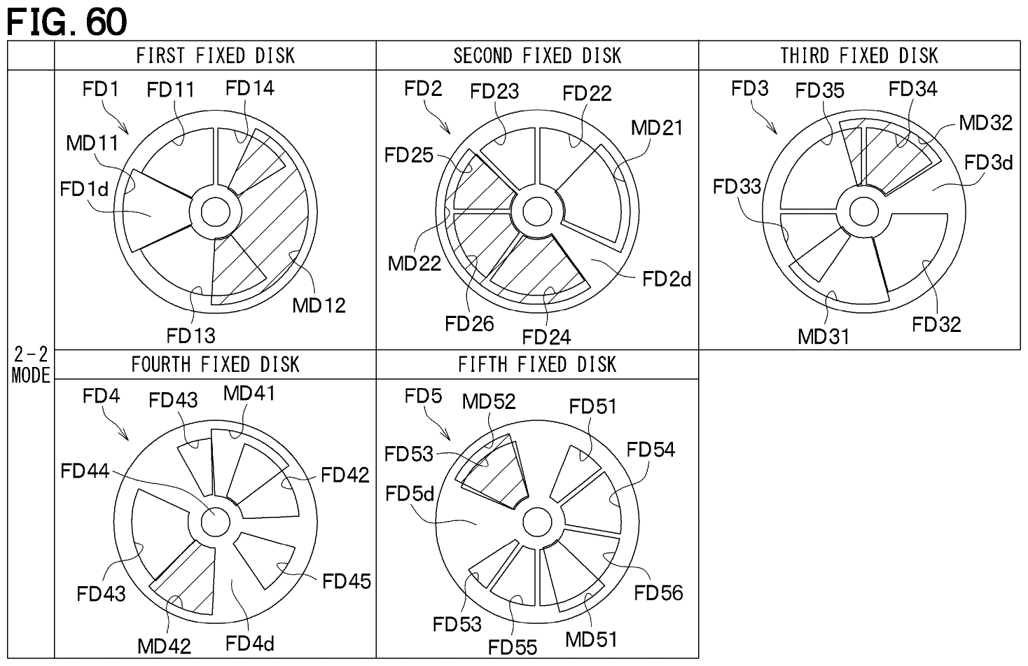

Next, the 2-2 mode will be described. When the operation mode of the temperature control device is set to the 2-2 mode, the first movable disk MD1 is positioned at a rotational position illustrated in FIG. 60. Specifically, when the operation mode is set to the 2-2 mode, the first movable disk MD1 is positioned at a position where the first through hole MD11 faces the first partition portion FD1d. The first movable disk MD1 is positioned at a position where the first communication hole MD12 communicates with the 1-3 flow hole FD13 and the 1-4 flow hole FD14.

Accordingly, the 1-3 opening P13 communicates with the 1-4 opening P14 via the 1-3 flow hole FD13, the first communication hole MD12, and the 1-4 flow hole FD14. The 1-1 opening P11 and the 1-2 opening P12 are closed.

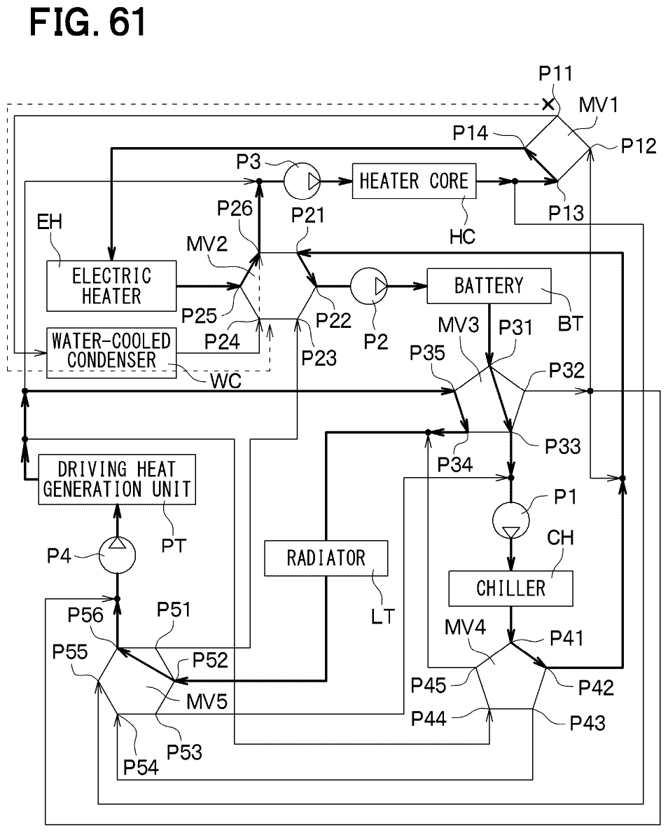

A flow of the coolant in the fluid circuit FC when the open and closed states of the coolant inlet and the coolant outlet of the first multi-way valve MV1 to the fifth multi-way valve MV5 are set in this manner will be described with reference to FIG. 61.

As described above, in the 2-2 mode, the fluid circuit system 1 allows the 1-3 opening P13 of the first multi-way valve MV1 to communicate with the 1-4 opening P14, and allows the 2-1 opening P21 of the second multi-way valve MV2 to communicate with the 2-2 opening P22. In the fluid circuit system 1, the 3-1 opening P31 of the third multi-way valve MV3 communicates with the 3-3 opening P33, and the 3-5 opening P35 communicates with the 3-4 opening P34. Further, in the fluid circuit system 1, the 4-1 opening P41 of the fourth multi-way valve MV4 communicates with the 4-2 opening P42, and the 5-2 opening P52 of the fifth multi-way valve MV5 communicates with the 5-6 opening P56.

Accordingly, the fluid circuit system 1 can circulate the coolant in the fluid circuit FC by operating the first pump P1 and the second pump P2. The fluid circuit system 1 can guide the coolant to the battery BT and the chiller CH. The fluid circuit system 1 can circulate the coolant in the fluid circuit FC by operating the fourth pump P4. The fluid circuit system 1 can guide the coolant to the radiator LT and the driving heat generation unit PT. Further, the fluid circuit system 1 can circulate the coolant in the fluid circuit FC by operating the third pump P3. The fluid circuit system 1 can guide the coolant to the heater core HC and the electric heater EH.

In the fluid circuit system 1 according to the present embodiment, the 2-4 opening P24, which is the unnecessary inlet of the second multi-way valve MV2, communicates with the 2-6 opening P26. In this case, the coolant pumped by the third pump P3 may pass through the first multi-way valve MV1 and the second multi-way valve MV2 and flow into the water-cooled condenser WC that does not require the coolant to flow.

In contrast, in the fluid circuit system 1 according to the present embodiment, in the 2-2 mode, the 1-1 opening P11 of the first multi-way valve MV1 connected to an upstream side of a refrigerant flow of the fluid circuit FC in which the water-cooled condenser WC is disposed is closed. Therefore, it is possible to prevent the coolant pumped by the third pump P3 from flowing through the fluid circuit FC to the water-cooled condenser WC. That is, the fluid circuit system 1 can prohibit a flow of the coolant that may pass through an unnecessary inlet in an open state in the second multi-way valve MV2 by the first multi-way valve MV1 different from the second multi-way valve MV2.

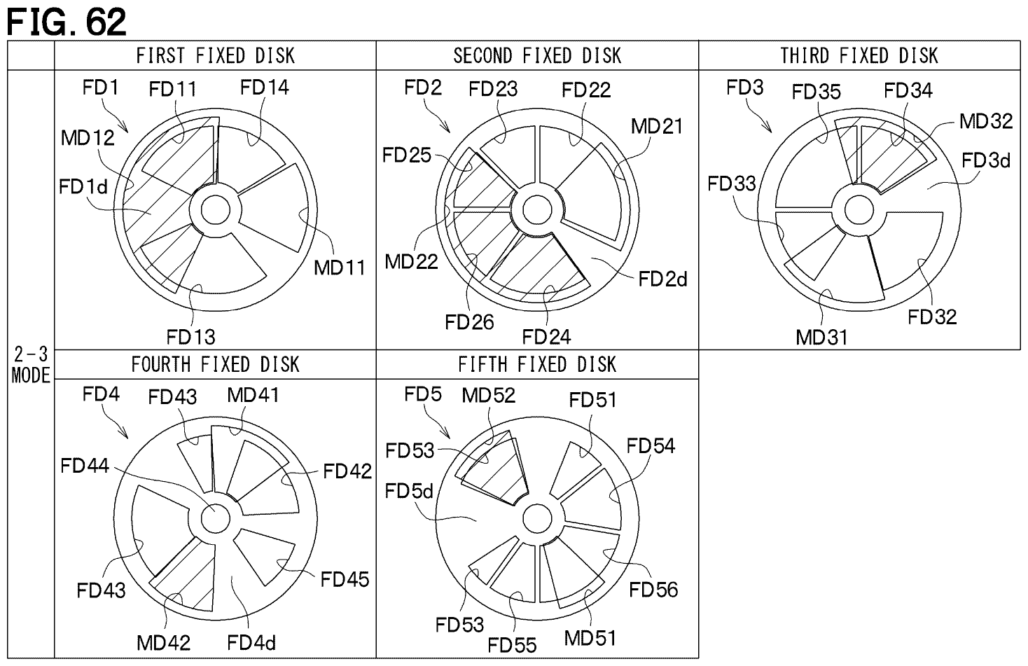

Next, the 2-3 mode will be described. When the operation mode of the temperature control device is set to the 2-3 mode, the first movable disk MD1 is positioned at a rotational position illustrated in FIG. 62. Specifically, when the operation mode is set to the 2-3 mode, the first movable disk MD1 is positioned at a position where the first through hole MD11 faces the first partition portion FD1d. The first movable disk MD1 is positioned at a position where the first communication hole MD12 communicates with the 1-1 flow hole FD11 and the 1-3 flow hole FD13.

Accordingly, the 1-3 opening P13 communicates with the 1-1 opening P11 via the 1-3 flow hole FD13, the first communication hole MD12, and the 1-1 flow hole FD11. The 1-2 opening P12 and the 1-4 opening P14 are closed.

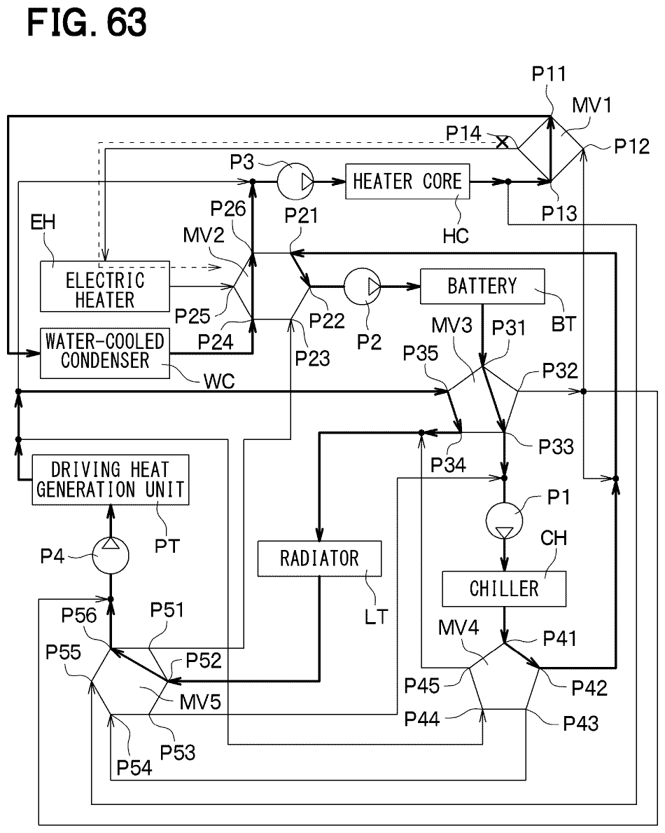

A flow of the coolant in the fluid circuit FC when the open and closed states of the coolant inlet and the coolant outlet of the first multi-way valve MV1 to the fifth multi-way valve MV5 are set in this manner will be described with reference to FIG. 63.

As described above, in the 2-3 mode, the fluid circuit system 1 allows the 1-3 opening P13 of the first multi-way valve MV1 to communicate with the 1-1 opening P11. In the fluid circuit system 1, the 2-1 opening P21 of the second multi-way valve MV2 communicates with the 2-2 opening P22, and the 2-4 opening P24 communicates with the 2-6 opening P26. In the fluid circuit system 1, the 3-1 opening P31 of the third multi-way valve MV3 communicates with the 3-3 opening P33, and the 3-5 opening P35 communicates with the 3-4 opening P34. Further, in the fluid circuit system 1, the 4-1 opening P41 of the fourth multi-way valve MV4 communicates with the 4-2 opening P42, and the 5-2 opening P52 of the fifth multi-way valve MV5 communicates with the 5-6 opening P56.

Accordingly, the fluid circuit system 1 can circulate the coolant in the fluid circuit FC by operating the first pump P1 and the second pump P2. The fluid circuit system 1 can guide the coolant to the battery BT and the chiller CH. The fluid circuit system 1 can circulate the coolant in the fluid circuit FC by operating the fourth pump P4. The fluid circuit system 1 can guide the coolant to the radiator LT and the driving heat generation unit PT. Further, the fluid circuit system 1 can circulate the coolant in the fluid circuit FC by operating the third pump P3. The fluid circuit system 1 can guide the coolant to the heater core HC and the water-cooled condenser WC.

In the fluid circuit system 1 according to the present embodiment, the 2-5 opening P25, which is the unnecessary inlet of the second multi-way valve MV2, communicates with the 2-6 opening P26. In this case, the coolant pumped by the third pump P3 may pass through the first multi-way valve MV1 and the second multi-way valve MV2 and flow into the electric heater EH that does not require the coolant to flow.

In contrast, in the fluid circuit system 1 according to the present embodiment, in the 2-3 mode, the 1-4 opening P14 of the first multi-way valve MV1 connected to the upstream side of the refrigerant flow of the fluid circuit FC in which the electric heater EH is disposed is closed. Therefore, it is possible to prevent the coolant pumped by the third pump P3 from flowing through the fluid circuit FC to the electric heater EH. That is, the fluid circuit system 1 can prohibit a flow of the coolant that may pass through an unnecessary inlet in an open state in the second multi-way valve MV2 by the first multi-way valve MV1 different from the second multi-way valve MV2.

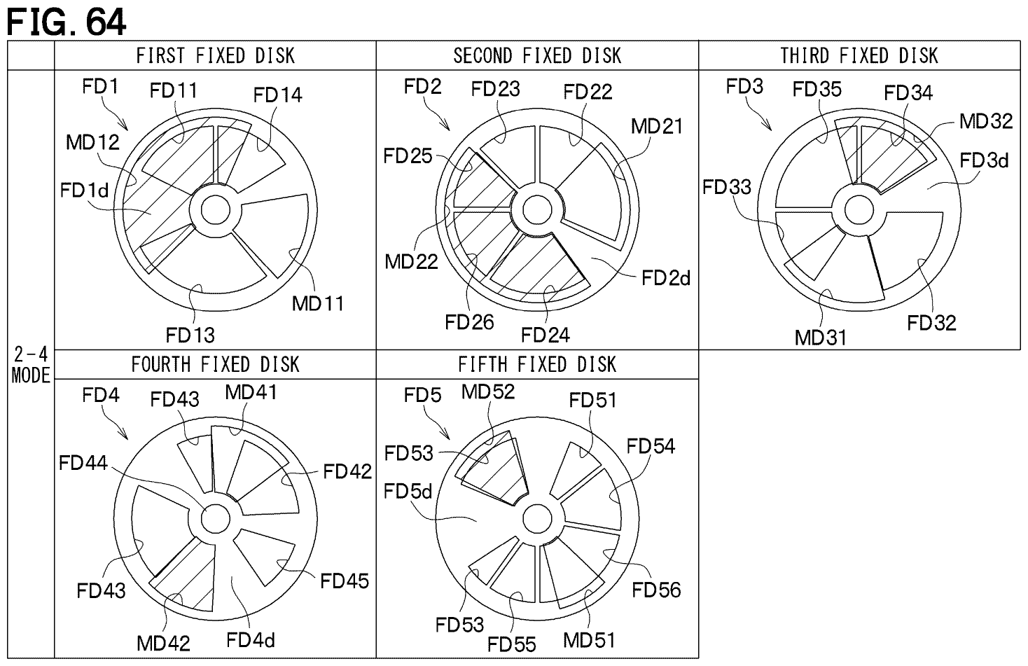

Next, the 2-4 mode will be described. When the operation mode of the temperature control device is set to the 2-4 mode, the first movable disk MD1 is positioned at a rotational position illustrated in FIG. 64. Specifically, when the operation mode is set to the 2-4 mode, the first movable disk MD1 is positioned at a position where the first through hole MD11 faces the first partition portion FD1d. The first movable disk MD1 is positioned at a position where the first communication hole MD12 communicates with the 1-1 flow hole FD11, the 1-3 flow hole FD13, and the 1-4 flow hole FD14.

A flow of the coolant in the fluid circuit FC when the open and closed states of the coolant inlet and the coolant outlet of the first multi-way valve MV1 to the fifth multi-way valve MV5 are set in this manner will be described.

As described above, in the 2-4 mode, the fluid circuit system 1 allows the 1-3 opening P13 of the first multi-way valve MV1 to communicate with the 1-1 opening P11 and the 1-4 opening P14. In the fluid circuit system 1, the 2-1 opening P21 of the second multi-way valve MV2 communicates with the 2-2 opening P22, and the 2-4 opening P24 communicates with the 2-6 opening P26. In the fluid circuit system 1, the 3-1 opening P31 of the third multi-way valve MV3 communicates with the 3-3 opening P33, and the 3-5 opening P35 communicates with the 3-4 opening P34. Further, in the fluid circuit system 1, the 4-1 opening P41 of the fourth multi-way valve MV4 communicates with the 4-2 opening P42, and the 5-2 opening P52 of the fifth multi-way valve MV5 communicates with the 5-6 opening P56.

Accordingly, the fluid circuit system 1 can circulate the coolant in the fluid circuit FC by operating the first pump P1 and the second pump P2. The fluid circuit system 1 can guide the coolant to the battery BT and the chiller CH. The fluid circuit system 1 can circulate the coolant in the fluid circuit FC by operating the fourth pump P4. The fluid circuit system 1 can guide the coolant to the radiator LT and the driving heat generation unit PT. Further, the fluid circuit system 1 can circulate the coolant in the fluid circuit FC by operating the third pump P3. The fluid circuit system 1 can guide the coolant to the heater core HC, the electric heater EH, and the water-cooled condenser WC.

In the 2-4 mode, the unnecessary inlet and the unnecessary outlet of the first multi-way valve MV1 to the fifth multi-way valve MV5 are closed.

Accordingly, as compared with a case where the fluid circuit system 1 is configured to close the unnecessary inlet and the unnecessary outlet of the first multi-way valve MV1 to the fifth multi-way valve MV5 when the temperature control device executes the four operation modes, restrictions on the first multi-way valve MV1 to the third multi-way valve MV3 are reduced.

For example, when the second multi-way valve MV2 is in the closed configuration, it is necessary to close the unnecessary inlet and the unnecessary outlet of the second multi-way valve MV2 in all of the four operation modes. In this case, as described above, when the temperature control device executes the 2-2 mode, a communication range between the second through hole MD21 and the 2-2 flow hole FD22 is narrow. When the temperature control device executes the 2-4 mode, a communication range between the second communication hole MD22 and the 2-4 flow hole FD24 and a communication range between the second communication hole MD22 and the 2-6 flow hole FD26 are narrow.

In contrast, the second multi-way valve MV2 is in the closed configuration. A flow of the coolant that may pass through an unnecessary inlet in an open state in the second multi-way valve MV2 can be prohibited by the first multi-way valve MV1 different from the second multi-way valve MV2. Accordingly, the size of the second communication hole MD22 can be increased. Therefore, it is possible to reduce an increase in pressure loss due to a flow of the coolant to a portion having a narrow communication range.

Therefore, it is possible to reduce power consumption of the first pump P1, the second pump P2, the third pump P3, and the fourth pump P4 that generate the flow of the fluid in the fluid circuit FC. Therefore, running cost of the entire fluid circuit system 1 can be reduced.

By reducing the pressure loss when the fluid flows through the second multi-way valve MV2, capacities of the first pump P1, the second pump P2, the third pump P3, and the fourth pump P4 can be reduced. Therefore, initial cost of the entire fluid circuit system 1 can be reduced.

Further, in the present embodiment, the rotational position of the second movable disk MD2 of the second multi-way valve MV2 can be made common in each of the 2-1 mode, the 2-2 mode, the 2-3 mode, and the 2-4 mode of the temperature control device. Therefore, it is not necessary to adjust the rotational position of the second movable disk MD2 when the operation mode of the temperature control device is switched from any of the four operation modes to a different operation mode. Therefore, power consumption of the second multi-way valve MV2 can be reduced. Therefore, running cost of the entire fluid circuit system 1 can be reduced.

### Third Embodiment

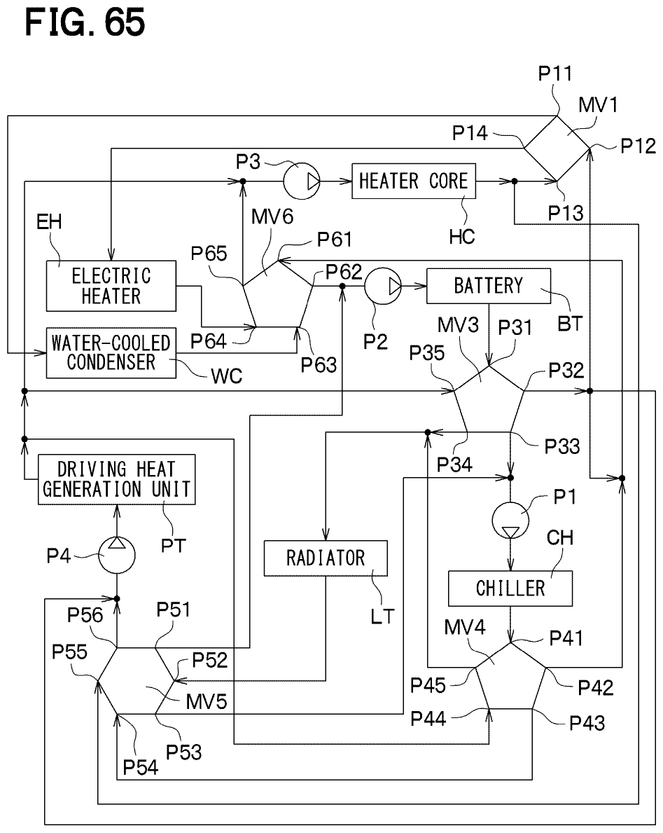

Next, the third embodiment will be described with reference to FIGS. 65 to 71. The present embodiment is different from the second embodiment in that the second multi-way valve MV2 is replaced with a sixth multi-way valve MV6, and a part of the fluid circuit FC is changed with the replacement with the sixth multi-way valve MV6. The other configuration is similar as that of the third embodiment. Therefore, in the present embodiment, portions different from the second embodiment will be mainly described, and description of portions similar to the second embodiment may be omitted.

As illustrated in FIG. 65, the sixth multi-way valve MV6 according to the present embodiment is implemented with a five-way valve having three coolant inlets and two coolant outlets. Specifically, the sixth multi-way valve MV6 has a 6-1 opening P61, a 6-3 opening P63, and a 6-4 opening P64, which are coolant inlets, and further has a 6-2 opening P62 and a 6-5 opening P65, which are coolant outlets.

In the fluid circuit system 1 according to the present embodiment, the configuration is changed from the six-way valve to the five-way valve as compared with the second multi-way valve MV2 according to the second embodiment, and the number of coolant inlets is reduced. However, the fluid circuit system 1 according to the present embodiment can support all the operation modes executable by the temperature control device according to the second embodiment. That is, the sixth multi-way valve MV6 according to the present embodiment can cope with all of the eighteen operations of the second multi-way valve MV2 described in the second embodiment. A reason why the configuration of the sixth multi-way valve MV6 can cope with all of the eighteen operations of the second multi-way valve MV2 according to the second embodiment even when the number of the coolant inlets is one less than that of the second multi-way valve MV2 will be described.

As described in the second embodiment, the second multi-way valve MV2 can execute any one of eighteen operations. The inventor has considered grouping similar operations among the eighteen operations of the second multi-way valve MV2. Specifically, as illustrated in FIG. 66, the inventor has considered that, among the eighteen operations, putting together one group of operations in which the coolant flows into the 2-1 opening P21, which is the coolant inlet, one group of operations in which the coolant does not flow out from the 2-6 opening P26, which is the coolant outlet, one group of operations including an operation of guiding the coolant from the 2-4 opening P24 to the 2-6 opening P26 and guiding the coolant from the 2-5 opening P25 to the 2-2 opening P22, and one group of operations including an operation of guiding the coolant from the 2-4 opening P24 to the 2-2 opening P22 and guiding the coolant from the 2-5 opening P25 to the 2-6 opening P26.

Hereinafter, the one group of operations in which the coolant flows into the 2-1 opening P21 which is the coolant inlet is referred to as an operation of a first group, and the one group of operations in which the coolant does not flow out from the 2-6 opening P26 which is the coolant outlet is referred to as an operation of a second group. The one group of operations including the operation of guiding the coolant from the 2-4 opening P24 to the 2-6 opening P26 and guiding the coolant from the 2-5 opening P25 to the 2-2 opening P22 is referred to as an operation of a third group. The one group of operations including the operation of guiding the coolant from the 2-4 opening P24 to the 2-2 opening P22 and guiding the coolant from the 2-5 opening P25 to the 2-6 opening P26 is referred to as an operation of a fourth group. In FIG. 66, each of the operation of the first group, the operation of the second group, the operation of the third group, and the operation of the fourth group is boxed.

The operation of the first group includes the operation in which the 2-1 opening P21 communicates with the 2-2 opening P22, the operation in which the 2-1 opening P21 communicates with the 2-2 opening P22 and the 2-5 opening P25 communicates with the 2-6 opening P26, the operation in which the 2-1 opening P21 communicates with the 2-2 opening P22 and the 2-4 opening P24 communicates with the 2-6 opening P26, the operation in which the 2-1 opening P21 communicates with the 2-2 opening P22 and the 2-4 opening P24 and the 2-5 opening P25 communicate with the 2-6 opening P26, the operation in which the 2-3 opening P23 communicates with the 2-2 opening P22 and the 2-5 opening P25 communicates with the 2-6 opening P26, the operation in which the 2-3 opening P23 communicates with the 2-2 opening P22 and the 2-4 opening P24 communicates with the 2-6 opening P26, and the operation in which the 2-3 opening P23 communicates with the 2-2 opening P22 and the 2-4 opening P24 and the 2-5 opening P25 communicate with the 2-6 opening P26.

The operation of the second group includes the operation in which the 2-5 opening P25 communicates with the 2-2 opening P22, the operation in which the 2-4 opening P24 communicates with the 2-2 opening P22, the operation in which the 2-4 opening P24 and the 2-5 opening P25 communicate with the 2-2 opening P22, the operation in which the 2-3 opening P23 communicates with the 2-2 opening P22, the operation in which the 2-3 opening P23 and the 2-5 opening P25 communicate with the 2-2 opening P22, the operation in which the 2-3 opening P23 and the 2-4 opening P24 communicate with the 2-2 opening P22, and the operation in which the 2-3 opening P23, the 2-4 opening P24, and the 2-5 opening P25 communicate with the 2-2 opening P22.

The operation of the third group includes the operation in which the 2-3 opening P23 and the 2-5 opening P25 communicate with the 2-2 opening P22 and the 2-4 opening P24 communicates with the 2-6 opening P26, and the operation in which the 2-5 opening P25 communicates with the 2-2 opening P22 and the 2-4 opening P24 communicates with the 2-6 opening P26.

The operation of the fourth group includes the operation in which the 2-4 opening P24 communicates with the 2-2 opening P22 and the 2-5 opening P25 communicates with the 2-6 opening P26, and the operation in which the 2-3 opening P23 and the 2-4 opening P24 communicate with the 2-2 opening P22 and the 2-5 opening P25 communicates with the 2-6 opening P26.

The inventor has considered the operation of the second multi-way valve MV2 capable of corresponding to each of the four groups of operations.

Specifically, as illustrated in FIG. 66, the operation of the first group is in an operation in which the 2-1 opening P21 and the 2-3 opening P23 communicate with the 2-2 opening P22, and the 2-4 opening P24 and the 2-5 opening P25 communicate with the 2-6 opening P26. Therefore, the operation of the first group can be replaced with the operation in which the 2-1 opening P21 and the 2-3 opening P23 communicate with the 2-2 opening P22, and the 2-4 opening P24 and the 2-5 opening P25 communicate with the 2-6 opening P26.

The operation of the second group is in the operation in which the 2-3 opening P23, the 2-4 opening P24, and the 2-5 opening P25 communicate with the 2-2 opening P22. Therefore, the operation of the second group can be replaced with the operation in which the 2-3 opening P23, the 2-4 opening P24, and the 2-5 opening P25 communicate with the 2-2 opening P22.

The operation of the third group is in the operation in which the 2-3 opening P23 and the 2-5 opening P25 communicate with the 2-2 opening P22 and the 2-4 opening P24 communicates with the 2-6 opening P26. Therefore, the operation of the third group can be replaced with the operation in which the 2-3 opening P23 and the 2-5 opening P25 communicate with the 2-2 opening P22 and the 2-4 opening P24 communicates with the 2-6 opening P26.

The operation of the fourth group is in the operation in which the 2-3 opening P23 and the 2-4 opening P24 communicate with the 2-2 opening P22 and the 2-5 opening P25 communicates with the 2-6 opening P26. Therefore, the operation of the fourth group can be replaced with the operation in which the 2-3 opening P23 and the 2-4 opening P24 communicate with the 2-2 opening P22 and the 2-5 opening P25 communicates with the 2-6 opening P26.

In this way, the eighteen operations of the second multi-way valve MV2 can be replaced with the four operations. By replacing the eighteen operations of the second multi-way valve MV2 with the four operations, when each operation mode of the temperature control device is executed, the unnecessary inlet and the unnecessary outlet of the second multi-way valve MV2 are opened, so that the coolant may flow into a connection device that does not require the coolant to flow.

However, the fluid circuit system 1 according to the present embodiment can prohibit a flow of the coolant that may pass through an unnecessary inlet and an unnecessary outlet in an open state in the second multi-way valve MV2 by closing an opening of the first multi-way valve MV1 or the like different from the second multi-way valve MV2. Therefore, in the fluid circuit system 1 according to the present embodiment, even when the eighteen operations of the second multi-way valve MV2 are replaced with the four operations, it is possible to prevent the flow of the coolant to the connection device that does not require the coolant to flow.

The inventor has focused on the four operations replaced from the eighteen operations of the second multi-way valve MV2, and considered further simplifying the configuration of the second multi-way valve MV2. In all of the four operations replaced from the eighteen operations, the 2-3 opening P23 communicates with the 2-2 opening P22. That is, in the second multi-way valve MV2 in which the eighteen operations are integrated into the four operations, the 2-3 opening P23 which is the coolant inlet always communicates with the 2-2 opening P22 which is the coolant outlet. Therefore, a flow path that allows the 2-3 opening P23 to communicate with the 2-2 opening P22 does not need to be switched between opening and closing by the second movable disk MD2. This has been found by intensive studies of the inventor.

Thus, the inventor has found that, in the fluid circuit system 1, the second multi-way valve MV2, which is the six-way valve, can be replaced with the sixth multi-way valve MV6, which is the five-way valve having one less coolant inlet than the second multi-way valve MV2. Even when the second multi-way valve MV2 is replaced with the sixth multi-way valve MV6, the fluid circuit system 1 according to the present embodiment can support all the operation modes executable by the temperature control device according to the second embodiment.

A specific configuration of the sixth multi-way valve MV6 capable of executing four operations replaced from the eighteen operations of the second multi-way valve MV2 will be described.

As illustrated in FIG. 65, the sixth multi-way valve MV6 has three coolant inlets and two coolant outlets. In the present embodiment, the three coolant inlets formed in the sixth multi-way valve MV6 are referred to as the 6-1 opening P61, the 6-3 opening P63, and the 6-4 opening P64, and the two coolant outlets formed in the sixth multi-way valve MV6 are referred to as the 6-2 opening P62 and the 6-5 opening P65.

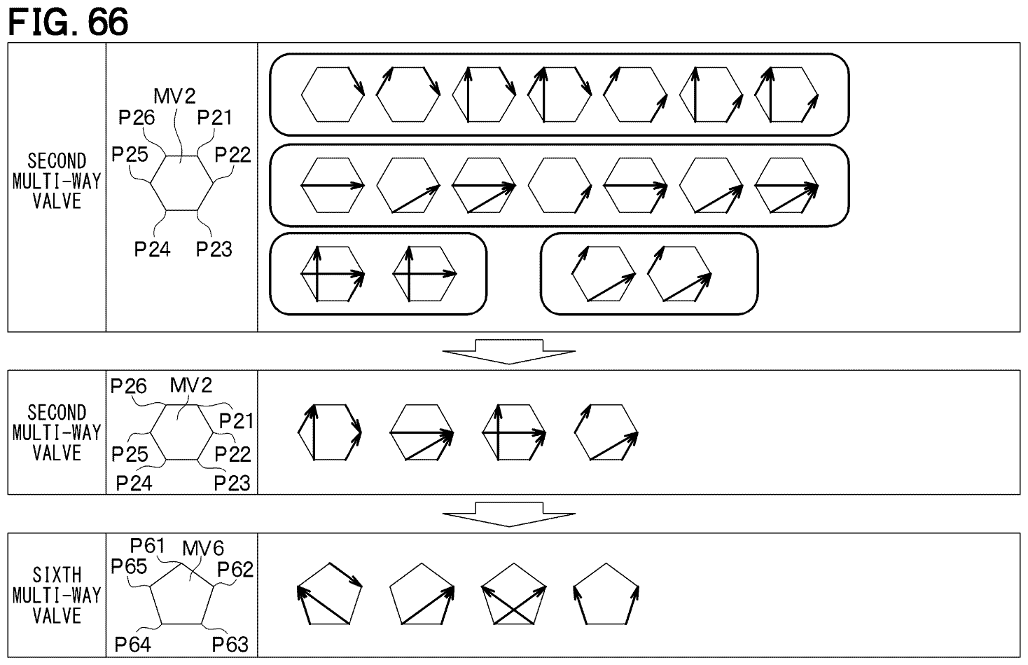

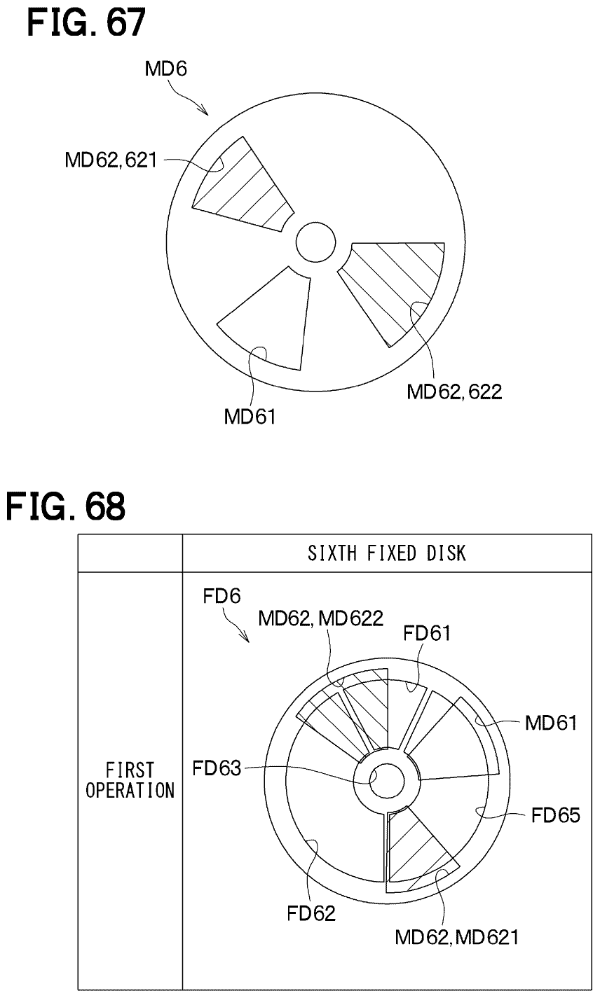

The sixth multi-way valve MV6 has a sixth fixed disk FD6, which will be described later, having a 6-1 flow hole FD61 capable of communicating with the 6-1 opening P61, a 6-2 flow hole FD62 capable of communicating with the 6-2 opening P62, a 6-3 flow hole FD63 capable of communicating with the 6-3 opening P63, and a 6-5 flow hole FD65 capable of communicating with the 6-5 opening P65. The sixth multi-way valve MV6 has a sixth movable disk MD6 illustrated in FIG. 67 that slides and rotates on the sixth fixed disk FD6. The sixth movable disk MD6 has a sixth through hole MD61 and two sixth communication holes MD62 communicating with the 6-1 flow hole FD61, the 6-2 flow hole FD62, and the 6-5 flow hole FD65. Hereinafter, of the two sixth communication holes MD62, one side is also referred to as a one-side sixth communication hole MD621, and the other side is also referred to as an other-side sixth communication hole MD622.

The 6-1 flow hole FD61, the 6-2 flow hole FD62, and the 6-5 flow hole FD65 formed in the sixth fixed disk FD6 can be opened and closed according to a rotational position of the sixth movable disk MD6. In contrast, the 6-3 flow hole FD63 formed in the sixth fixed disk FD6 cannot be opened and closed by the sixth movable disk MD6, and always communicates with the 6-3 opening P63. The 6-3 flow hole FD63 communicates with the 6-2 opening P62 and the 6-5 opening P65. That is, the 6-3 opening P63, which is the coolant inlet, is configured to have a constant communication structure that always communicates with the 6-2 opening P62 and the 6-5 opening P65, which are the coolant outlets.

The sixth multi-way valve MV6 is provided in the upward direction DRa2 relative to the sixth movable disk MD6 and the sixth fixed disk FD6, and the 6-4 opening P64 is formed in a port (not illustrated) for introducing the coolant into the sixth multi-way valve MV6.

The sixth multi-way valve MV6 according to the present embodiment can switch an outflow destination of the coolant flowing in from the 6-1 opening P61 and the 6-4 opening P64 to the 6-2 opening P62 and the 6-5 opening P65 according to the operation mode of the temperature control device. By switching the outflow destination of the coolant flowing in from the 6-1 opening P61 and the 6-4 opening P64 to the 6-2 opening P62 and the 6-5 opening P65, it is possible to execute four operations which are replaced from the eighteen operations of the second multi-way valve MV2. Hereinafter, the four operations executed by the sixth multi-way valve MV6 are also referred to as a first operation, a second operation, a third operation, and a fourth operation. The first operation, the second operation, the third operation, and the fourth operation correspond to the operation of the first group, the operation of the second group, the operation of the third group, and the operation of the fourth group described above.

A relative position of the sixth movable disk MD6 with respect to the sixth fixed disk FD6 when the sixth multi-way valve MV6 executes the first operation to the fourth operation will be described with reference to FIGS. 68 to 71.

First, the first operation will be described. When the sixth multi-way valve MV6 executes the first operation, the sixth movable disk MD6 is positioned at the rotational position illustrated in FIG. 68. Specifically, when the sixth multi-way valve MV6 executes the first operation, the sixth movable disk MD6 is positioned at a position where the sixth through hole MD61 communicates with the 6-5 flow hole FD65. The sixth movable disk MD6 is positioned at a position where the one-side sixth communication hole MD621 communicates with the 6-5 flow hole FD65 and the other-side sixth communication hole MD622 communicates with the 6-1 flow hole FD61 and the 6-2 flow hole FD62.

Accordingly, the 6-4 opening P64 communicates with the 6-5 opening P65 via the sixth through hole MD61 and the 6-5 flow hole FD65. The 6-1 opening P61 communicates with the 6-2 opening P62 via the 6-1 flow hole FD61, the other-side sixth communication hole MD622, and the 6-2 flow hole FD62. As described above, the 6-3 opening P63 always communicates with the 6-2 opening P62 and the 6-5 opening P65.

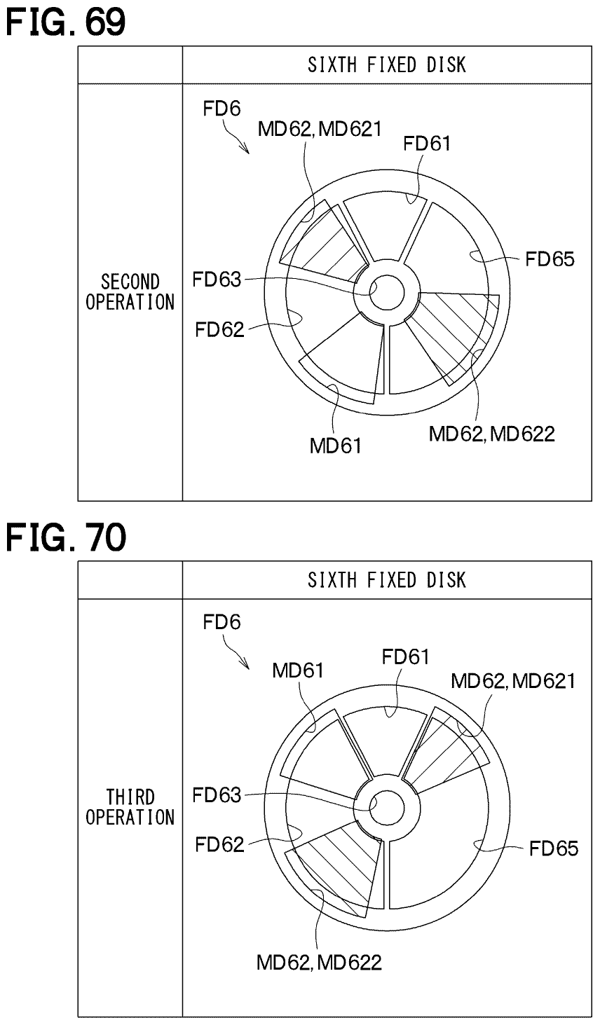

Next, the second operation will be described. When the sixth multi-way valve MV6 executes the second operation, the sixth movable disk MD6 is positioned at the rotational position illustrated in FIG. 69. Specifically, when the sixth multi-way valve MV6 executes the second operation, the sixth movable disk MD6 is positioned at a position where the sixth through hole MD61 communicates with the 6-2 flow hole FD62. The sixth movable disk MD6 is positioned at a position where the one-side sixth communication hole MD621 communicates with the 6-2 flow hole FD62 and the other-side sixth communication hole MD622 communicates with the 6-5 flow hole FD65.

Accordingly, the 6-4 opening P64 communicates with the 6-2 opening P62 via the sixth through hole MD61 and the 6-2 flow hole FD62. As described above, the 6-3 opening P63 always communicates with the 6-2 opening P62 and the 6-5 opening P65. The 6-1 opening P61 is closed.

Next, the third operation will be described. When the sixth multi-way valve MV6 executes the third operation, the sixth movable disk MD6 is positioned at the rotational position illustrated in FIG. 70. Specifically, when the sixth multi-way valve MV6 executes the third operation, the sixth movable disk MD6 is positioned at a position where the sixth through hole MD61 communicates with the 6-2 flow hole FD62. The sixth movable disk MD6 is positioned at a position where the one-side sixth communication hole MD621 communicates with the 6-5 flow hole FD65 and the other-side sixth communication hole MD622 communicates with the 6-2 flow hole FD62.

Accordingly, the 6-4 opening P64 communicates with the 6-2 opening P62 via the sixth through hole MD61 and the 6-2 flow hole FD62. As described above, the 6-3 opening P63 always communicates with the 6-2 opening P62 and the 6-5 opening P65. The 6-1 opening P61 is closed.

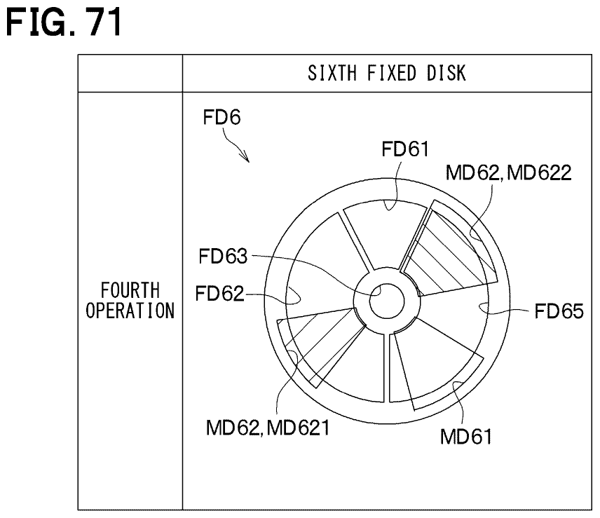

Next, the fourth operation will be described. When the sixth multi-way valve MV6 executes the fourth operation, the sixth movable disk MD6 is positioned at the rotational position illustrated in FIG. 71. Specifically, when the sixth multi-way valve MV6 executes the fourth operation, the sixth movable disk MD6 is positioned at a position where the sixth through hole MD61 communicates with the 6-5 flow hole FD65. The sixth movable disk MD6 is positioned at a position where the one-side sixth communication hole MD621 communicates with the 6-2 flow hole FD62 and the other-side sixth communication hole MD622 communicates with the 6-5 flow hole FD65.

Accordingly, the 6-4 opening P64 communicates with the 6-5 opening P65 via the sixth through hole MD61 and the 6-5 flow hole FD65. As described above, the 6-3 opening P63 always communicates with the 6-2 opening P62 and the 6-5 opening P65. The 6-1 opening P61 is closed.

The sixth multi-way valve MV6 capable of executing such four operations can correspond to all of the eighteen operations described in the second embodiment. When the temperature control device executes the 2-1 mode, the 2-2 mode, the 2-3 mode, and the 2-4 mode described in the second embodiment, these four operation modes can be supported by executing the first operation.

For example, a flow of the coolant flowing through the fluid circuit system 1 according to the present embodiment when the temperature control device executes the 2-1 mode described in the second embodiment will be described. In the 2-1 mode, the rotational positions of the first movable disk MD1 of the first multi-way valve MV1, the third movable disk MD3 of the third multi-way valve MV3, the fourth movable disk MD4 of the fourth multi-way valve MV4, and the fifth fixed disk FD5 of the fifth multi-way valve MV5 are similar as those described in the second embodiment. Therefore, the description of the operations of the first multi-way valve MV1, the third multi-way valve MV3, the fourth multi-way valve MV4, and the fifth multi-way valve MV5 will be omitted.

When the operation mode of the temperature control device is set to the 2-1 mode, the sixth movable disk MD6 executes the first operation. Accordingly, the 6-4 opening P64 communicates with the 6-5 opening P65 via the sixth through hole MD61 and the 6-5 flow hole FD65. The 6-1 opening P61 communicates with the 6-2 opening P62 via the 6-1 flow hole FD61, the other-side sixth communication hole MD622, and the 6-2 flow hole FD62.

A flow of the coolant in the fluid circuit FC when the open and closed states of the coolant inlet and the coolant outlet of the sixth multi-way valve MV6 are set in this manner will be described.

As described above, in the 2-1 mode, the fluid circuit system 1 allows the 6-1 opening P61 of the sixth multi-way valve MV6 to communicate with the 6-2 opening P62.

Accordingly, the fluid circuit system 1 can circulate the coolant in the fluid circuit FC by operating the first pump P1 and the second pump P2. The fluid circuit system 1 can guide the coolant to the battery BT and the chiller CH. The fluid circuit system 1 can circulate the coolant in the fluid circuit FC by operating the fourth pump P4. The fluid circuit system 1 can guide the coolant to the radiator LT and the driving heat generation unit PT.

In the fluid circuit system 1 according to the present embodiment, the 6-3 opening P63, which is the unnecessary inlet of the sixth multi-way valve MV6, communicates with the 6-2 opening P62 and the 6-5 opening P65 which is the unnecessary outlet. Further, the fluid circuit system 1 allows the 6-4 opening P64, which is the unnecessary inlet of the sixth multi-way valve MV6, to communicate with the 6-5 opening P65, which is the unnecessary outlet. In this case, the coolant pumped by the third pump P3 may pass through the first multi-way valve MV1 and the second multi-way valve MV2 and flow into the electric heater EH, the water-cooled condenser WC, and the heater core HC that do not require the coolant to flow.

In contrast, in the fluid circuit system 1 according to the present embodiment, in the 2-1 mode, the 1-3 opening P13 of the first multi-way valve MV1 connected to a downstream side of a refrigerant flow of the fluid circuit FC in which the electric heater EH, the water-cooled condenser WC, and the heater core HC are disposed is closed. In the fluid circuit system 1, in the 2-1 mode, the 1-4 opening P14 of the first multi-way valve MV1 connected to the upstream side of the refrigerant flow of the fluid circuit FC in which the electric heater EH is disposed is closed. Therefore, it is possible to prevent the coolant pumped by the third pump P3 from flowing through the fluid circuit FC and to the electric heater EH, the water-cooled condenser WC, and the heater core HC. That is, the fluid circuit system 1 can prohibit a flow of the coolant that may pass through an unnecessary inlet and an unnecessary outlet in an open state in the sixth multi-way valve MV6 by the first multi-way valve MV1 different from the sixth multi-way valve MV6.

Accordingly, as compared with the second embodiment, the second multi-way valve MV2, which is the six-way valve, can be replaced with the sixth multi-way valve MV6, which is the five-way valve. Therefore, the sixth multi-way valve MV6, which has a simpler structure than the second multi-way valve MV2, can be adopted. By replacing the second multi-way valve MV2, which is the six-way valve, with the sixth multi-way valve MV6, which is the five-way valve, it is possible to reduce the number of flow paths of the fluid circuit FC to which the valves are connected. Therefore, production cost of the fluid circuit system 1 can be reduced.

The sixth multi-way valve MV6 can cope with the eighteen operations of the second multi-way valve MV2 by executing the first operation to the fourth operation. Therefore, power consumption of the sixth multi-way valve MV6 can be reduced as compared with the power consumption of the second multi-way valve MV2 according to the second embodiment in which the second movable disk MD2 is rotated every eighteen operations. Therefore, the running cost of the entire fluid circuit system 1 can be reduced.

The sixth multi-way valve MV6 has the 6-3 opening P63 that always communicates with the 6-2 opening P62 and the 6-5 opening P65. Therefore, an opening area of the 6-3 opening P63, through which the coolant always flows, does not change depending on the rotational position of the sixth movable disk MD6. That is, the 6-3 opening P63 is always fully open regardless of the operation mode of the temperature control device, and the opening area does not decrease according to the rotational position of the sixth movable disk MD6.

Therefore, as compared with a configuration in which an opening area changes according to the rotational position of the sixth movable disk MD6, it is possible to reduce a pressure loss that occurs when the coolant passes through the 6-3 opening P63. Therefore, capacities of the first pump P1, the second pump P2, the third pump P3, and the fourth pump P4 can be reduced. Therefore, initial cost of the entire fluid circuit system 1 can be reduced.

### Fourth Embodiment

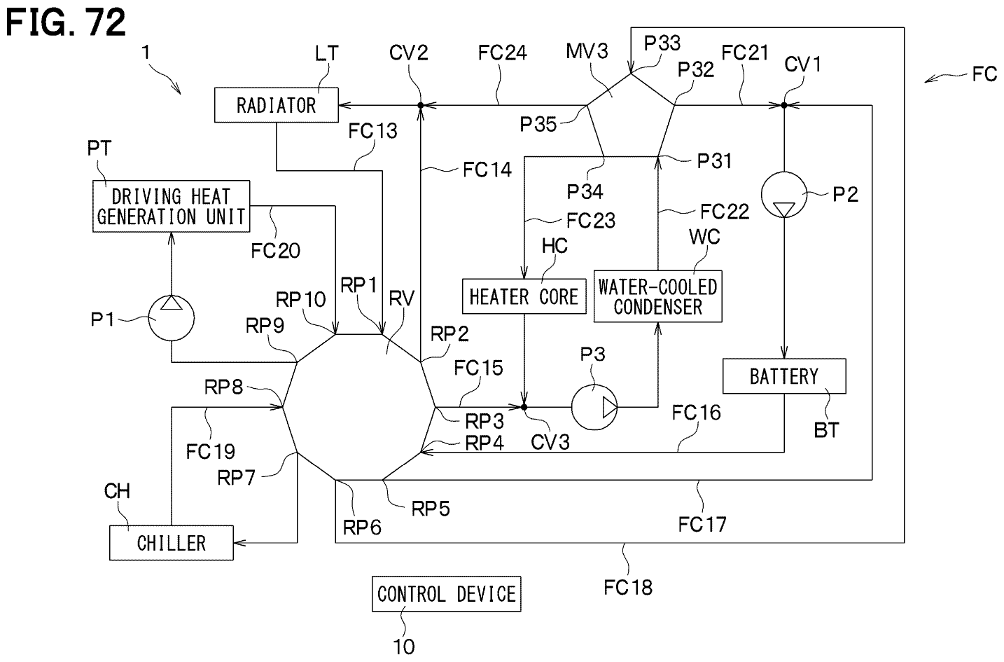

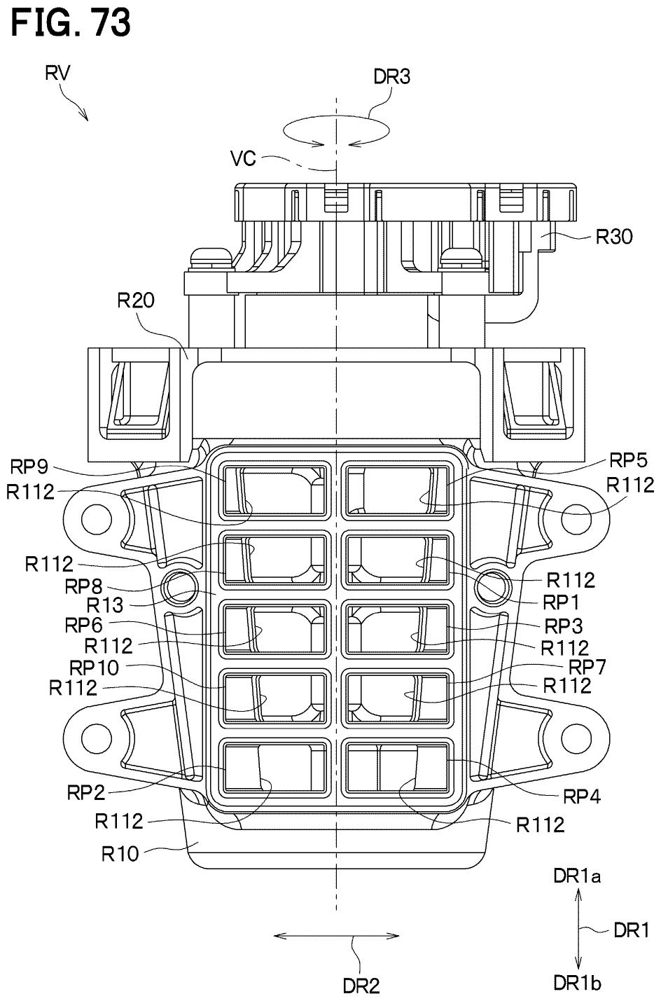

Next, the fourth embodiment will be described with reference to FIGS. 72 to 105. The present embodiment is different from the first embodiment in that the fluid circuit FC is different from the first embodiment, the first multi-way valve MV1 is eliminated, and the second multi-way valve MV2 is replaced with a fluid control valve RV. The other configuration is similar as that of the first embodiment. Therefore, in the present embodiment, portions different from the first embodiment will be mainly described, and description of portions similar to the first embodiment may be omitted.

First, the fluid circuit FC according to the present embodiment will be described with reference to FIG. 72. The fluid circuit system 1 according to the present embodiment includes the fluid control valve RV and the third multi-way valve MV3 as valve devices that switch the fluid circuit FC. As illustrated in FIG. 72, the fluid control valve RV is a valve device having a multi-way valve structure including four coolant inlets and six coolant outlets.

Hereinafter, the four coolant inlets formed in the fluid control valve RV are referred to as a first opening RP1, a fourth opening RP4, an eighth opening RP8, and a tenth opening RP10. The six coolant outlets formed in the fluid control valve RV are referred to as a second opening RP2, a third opening RP3, a fifth opening RP5, a sixth opening RP6, a seventh opening RP7, and a ninth opening RP9. In the fluid control valve RV indicated by a decagon in FIG. 72, ten vertices of the decagon indicate the first opening RP1, the second opening RP2, the third opening RP3, the fourth opening RP4, the fifth opening RP5, the sixth opening RP6, the seventh opening RP7, the eighth opening RP8, the ninth opening RP9, and the tenth opening RP10 of the fluid control valve RV.

In the fluid control valve RV, a coolant outlet of the second connection portion CV2 is connected to the first opening RP1, one coolant inlet of the second connection portion CV2 is connected to the second opening RP2, and one coolant inlet of the third connection portion CV3 is connected to the third opening RP3. In the fluid control valve RV, a coolant outlet of the first connection portion CV1 is connected to the fourth opening RP4, one coolant inlet of the first connection portion CV1 is connected to the fifth opening RP5, and the 3-3 opening P33 of the third multi-way valve MV3 is connected to the sixth opening RP6. In the fluid control valve RV, the eighth opening RP8 is connected to the seventh opening RP7, the seventh opening RP7 is connected to the eighth opening RP8, the tenth opening RP10 is connected to the ninth opening RP9, and the ninth opening RP9 is connected to the tenth opening RP10.

In the third multi-way valve MV3, a coolant outlet of the third connection portion CV3 is connected to the 3-1 opening P31, the other coolant inlet of the first connection portion CV1 is connected to the 3-2 opening P32, and the sixth opening RP6 of the fluid control valve RV is connected to the 3-3 opening P33. In the third multi-way valve MV3, the other coolant inlet of the third connection portion CV3 is connected to the 3-4 opening P34, and the other coolant inlet of the second connection portion CV2 is connected to the 3-5 opening P35.

Hereinafter, a flow path connecting the first opening RP1 of the fluid control valve RV and the coolant outlet of the second connection portion CV2 is referred to as a CV2-RP1 flow path FC13. A flow path connecting the second opening RP2 of the fluid control valve RV and the one coolant inlet of the second connection portion CV2 is referred to as an RP2-CV2 flow path FC14. A flow path connecting the third opening RP3 of the fluid control valve RV and the one coolant inlet of the third connection portion CV3 is referred to as an RP3-CV3 flow path FC15. A flow path connecting the fourth opening RP4 of the fluid control valve RV and the coolant outlet of the first connection portion CV1 is referred to as a CV1-RP4 flow path FC16. A flow path connecting the fifth opening RP5 of the fluid control valve RV and the one coolant inlet of the first connection portion CV1 is referred to as an RP5-CV1 flow path FC17. A flow path connecting the sixth opening RP6 of the fluid control valve RV and the 3-3 opening P33 of the third multi-way valve MV3 is referred to as an RP6-P33 flow path FC18. A flow path connecting the seventh opening RP7 and the eighth opening RP8 of the fluid control valve RV is referred to as an RP7-RP8 flow path FC19. A flow path connecting the ninth opening RP9 and the tenth opening RP10 of the fluid control valve RV is referred to as an RP9-RP10 flow path FC20.

A flow path connecting the 3-2 opening P32 of the third multi-way valve MV3 and the other coolant inlet of the first connection portion CV1 is referred to as a P32-CV1 flow path FC21. A flow path connecting the 3-1 opening P31 of the third multi-way valve MV3 and the coolant outlet of the third connection portion CV3 is referred to as a P31-CV3 flow path FC22. A flow path connecting the 3-4 opening P34 of the third multi-way valve MV3 and the other coolant inlet of the third connection portion CV3 is referred to as a P34-CV3 flow path FC23. A flow path connecting the 3-5 opening P35 of the third multi-way valve MV3 and the other coolant inlet of the second connection portion CV2 is referred to as a P35-CV2 flow path FC24.

The radiator LT is provided in the CV2-RP1 flow path FC13. The second pump P2 and the battery BT are provided in the CV1-RP4 flow path FC16. The chiller CH is provided in the RP7-RP8 flow path FC19. The first pump P1 and the driving heat generation unit PT are provided in the RP9-RP10 flow path FC20. The third pump P3 and the water-cooled condenser WC are provided in the P31-CV3 flow path FC22. The heater core HC is provided in the P34-CV3 flow path FC23.

The fluid control valve RV is configured to change an outflow destination of the coolant flowing into the fluid control valve RV by communicating the coolant inlet of the fluid control valve RV with the coolant outlet of the fluid control valve RV. The fluid control valve RV can switch the flow path through which the coolant flows in the fluid circuit FC by changing the outflow destination of the coolant.

Next, the fluid control valve RV will be described with reference to FIGS. 73 to 80. As illustrated in FIGS. 73 to 80, the fluid control valve RV according to the present embodiment includes a main body R10, a main body cover R20, a power portion R30, a valve R40, a seal portion R50, a biasing portion R60, and the like. The fluid control valve RV according to the present embodiment is implemented as a rotary valve device in which the power portion R30 rotates the valve R40 about a valve axis VC described later, thereby switching the fluid circuit FC.

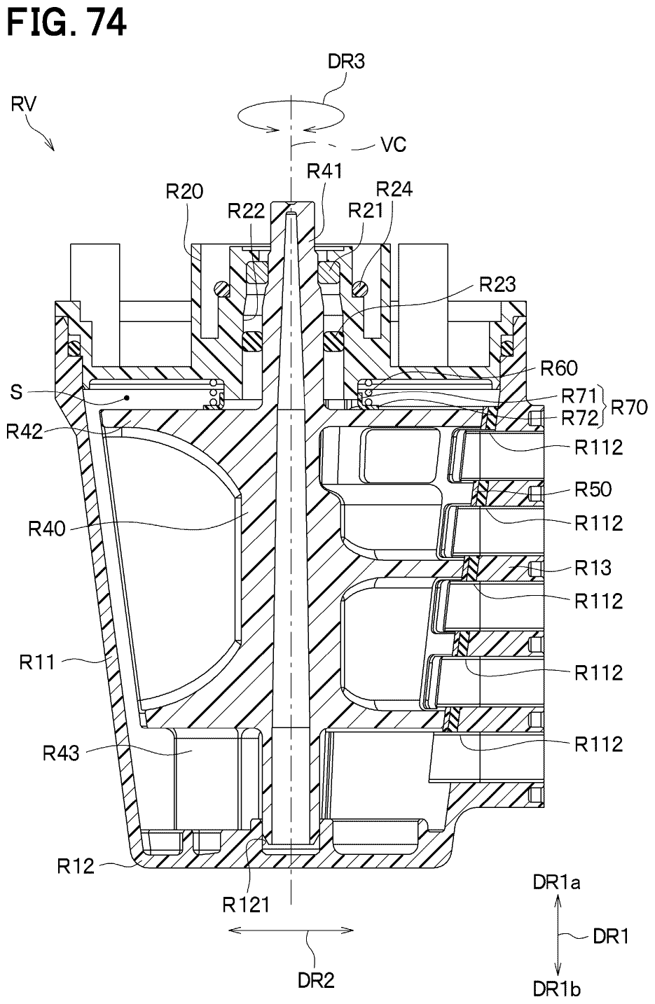

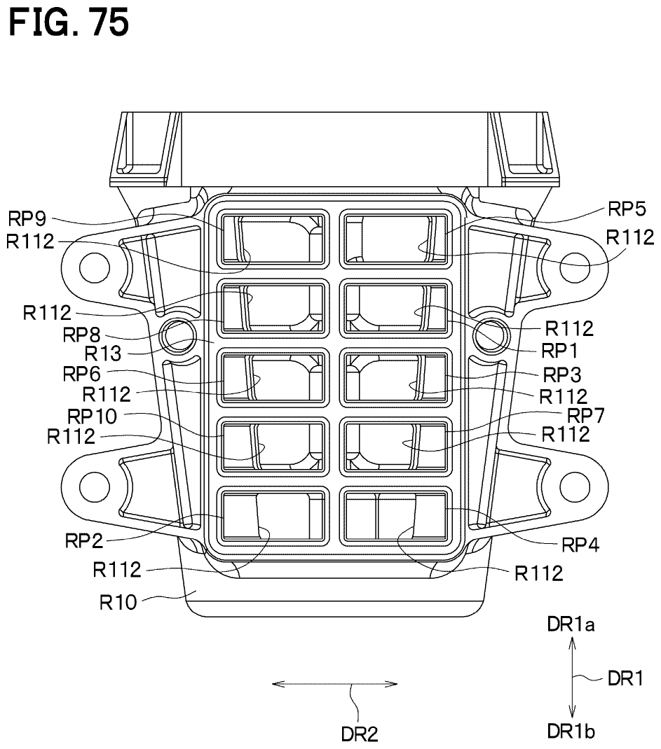

As illustrated in FIGS. 73 to 75, the main body R10 is a housing that forms an outer shell of the fluid control valve RV and forms therein a valve accommodating space S for accommodating the valve R40. The main body R10 is a non-rotating member that does not rotate. Specifically, the main body R10 includes a tubular portion R11 formed in a bottomed tubular shape, a bottom portion R12 forming a portion on a bottom side of the bottomed tubular shape, and a port forming portion R13 through which fluid flows into and out of the valve accommodating space S. The tubular portion R11, the bottom portion R12, and the port forming portion R13 are molded by, for example, injection molding in which a resin material is poured into a metal mold and solidified into a desired shape. In FIGS. 74 and 75, the power portion R30 is omitted.

As illustrated in FIG. 74, the valve R40 and the seal portion R50 are accommodated in the valve accommodating space S inside the main body R10. An opening side of the tubular portion R11 of the main body R10 is closed by the main body cover R20.

Hereinafter, as illustrated in FIG. 74 and the like, a direction along the valve axis VC is referred to as a valve axial direction DR1. Various configurations and the like will be described with a direction on one side in the valve axial direction DR1 being a first valve axial direction DR1a and a direction opposite to the first valve axial direction DR1a being a second valve axial direction DR1b. In the present embodiment, the opening side of the tubular portion R11 is defined as the first valve axial direction DR1a, and a bottom portion R12 side of the main body R10 is defined as the second valve axial direction DR1b.

Various configurations and the like will be described with a direction perpendicular to the valve axial direction DR1 and radially extending from the valve axis VC being a valve radial direction DR2, and a direction around the valve axis VC centered on the valve axis VC being a valve circumferential direction DR3. The valve circumferential direction DR3 is a direction in which the valve R40 is rotated by a driving force supplied from the power portion R30. One side of the valve circumferential direction DR3 is referred to as a first valve circumferential direction DR3a, and the other side is referred to as a second valve circumferential direction DR3b. The directions illustrated in FIG. 74 and the like are examples, and do not limit an installation state of the fluid control valve RV according to the present disclosure.

The tubular portion R11 is a portion surrounding most of the valve R40, and is formed in a cylindrical shape. The tubular portion R11 is formed such that a central axis thereof is coaxial with the valve axis VC. The tubular portion R11 is formed in a substantially conical shape whose outer diameter and inner diameter decrease from the first valve axial direction DR1a toward the second valve axial direction DR1b. That is, the tubular portion R11 is formed in a substantially conical shape in which a second valve axial direction DR1b side is an apex side and a first valve axial direction DR1a side is a bottom side.

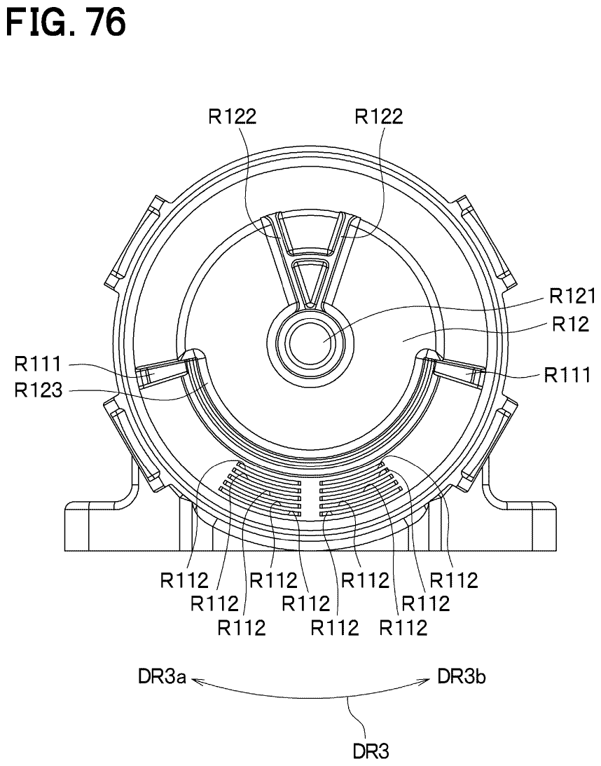

As illustrated in FIG. 76, a circumferential-side seal restricting portion R111 that restricts movement of the seal portion R50 in the valve circumferential direction DR3 is provided inside the tubular portion R11. When the valve R40 rotates in the valve circumferential direction DR3, the circumferential-side seal restricting portion R111 restricts the seal portion R50 from moving in the valve circumferential direction DR3 along with the rotation of the valve R40. The circumferential-side seal restricting portion R111 protrudes toward the valve axis VC at positions corresponding to an end portion of the seal portion R50 on a first valve circumferential direction DR3a side and an end portion of the seal portion R50 on a second valve circumferential direction DR3b side.

As illustrated in FIGS. 74 to 76, the tubular portion R11 is formed with ten cutout portions R112 communicating with the first opening RP1 to the tenth opening RP10. The ten cutout portions R112 penetrate the tubular portion R11 in the valve radial direction DR2 at a portion of the tubular portion R11 where the port forming portion R13 is provided. The ten cutout portions R112 are formed in a lattice shape with five cutout portions R112 lined up in the valve axial direction DR1 and two cutout portions R112 lined up in the valve circumferential direction DR3.

The bottom portion R12 closes a part of the valve accommodating space S and supports a rotation shaft R41 of the valve R40 to be described later. As illustrated in FIG. 76, the bottom portion R12 has a support hole R121 into which the second valve axial direction DR1b side of the rotation shaft R41 of the valve R40 is fitted. The support hole R121 rotatably supports the rotation shaft R41.

The bottom portion R12 is provided with two rotation restricting portions R122 that restrict the rotation of the valve R40. The rotation restricting portions R122 are formed at a position where the rotation restricting portions R122 can abut against a stopper R43 of the valve R40 to be described later. When the valve R40 rotates in the first valve circumferential direction DR3a, the stopper R43 of the valve R40 abuts against the one rotation restricting portion R122, thereby restricting the rotation of the valve R40 in the first valve circumferential direction DR3a. When the valve R40 rotates in the second valve circumferential direction DR3b, the stopper R43 of the valve R40 abuts against the other rotation restricting portion R122, thereby restricting the rotation of the valve R40 in the second valve circumferential direction DR3b.

Further, the bottom portion R12 is provided with a radial-side seal restricting portion R123 that restricts movement of the seal portion R50 in the valve circumferential direction DR3 and the valve radial direction DR2. When the valve R40 rotates in the valve circumferential direction DR3, the radial-side seal restricting portion R123 restricts the seal portion R50 from moving in the valve circumferential direction DR3 and from moving inward in the valve radial direction DR2 along with the rotation of the valve R40. The radial-side seal restricting portion R123 is formed in a groove shape recessed along the valve circumferential direction DR3 from one circumferential-side seal restricting portion R111 to the other circumferential-side seal restricting portion R111.

The port forming portion R13 is a portion in which the first opening RP1 to the tenth opening RP10 are formed. The port forming portion R13 has a rectangular parallelepiped shape, and is formed such that the valve axial direction DR1 is a longitudinal direction. In the port forming portion R13, the first opening RP1 to the tenth opening RP10 penetrate the port forming portion R13 in the valve radial direction DR2.

The ninth opening RP9, the eighth opening RP8, the sixth opening RP6, the tenth opening RP10, and the second opening RP2 are formed side by side in this order from the first valve axial direction DR1a toward the second valve axial direction DR1b on the first valve circumferential direction DR3a side. The fifth opening RP5, the first opening RP1, the third opening RP3, the seventh opening RP7, and the fourth opening RP4 are formed side by side in this order from the first valve axial direction DR1a toward the second valve axial direction DR1b on the second valve circumferential direction DR3b side.

Hereinafter, one group of openings including the ninth opening RP9, the eighth opening RP8, the sixth opening RP6, the tenth opening RP10, and the second opening RP2 may be referred to as first-column openings. One group of openings including the fifth opening RP5, the first opening RP1, the third opening RP3, the seventh opening RP7, and the fourth opening RP4 may be referred to as second-column openings. One group of openings including the ninth opening RP9 and the fifth opening RP5 may be referred to as first-stage openings, and one group of openings including the eighth opening RP8 and the first opening RP1 may be referred to as second-stage openings. One group of openings including the sixth opening RP6 and the third opening RP3 may be referred to as third-stage openings, and one group of openings including the tenth opening RP10 and the seventh opening RP7 may be referred to as fourth-stage openings. One group of openings including the second opening RP2 and the fourth opening RP4 may be referred to as fifth-stage openings. The disposition of the first opening RP1 to the tenth opening RP10 is not limited to this example and can be changed as appropriate.

The main body cover R20 closes the valve accommodating space S by closing the opening side of the tubular portion R11 in the main body R10, and supports the rotation shaft R41 of the valve R40. The main body cover R20 includes a bearing portion R21 that supports a first valve axial direction DR1a side of the rotation shaft R41 of the valve R40, and an annular cover seal R23 that seals a gap between a shaft hole R22 in the main body cover R20 into which the rotation shaft R41 is inserted and the rotation shaft R41. Further, the main body cover R20 is provided with a drive unit seal R24 that seals a gap between a portion of the main body cover R20 into which the power portion R30 is inserted and the power portion R30.

The bearing portion R21 is implemented with, for example, a ball bearing or a rolling bearing, and rotatably supports the rotation shaft R41. The cover seal R23 is implemented with, for example, an O-ring formed of an elastically deformable rubber member. The cover seal R23 ensures sealing between the main body cover R20 and the rotation shaft R41. The drive unit seal R24 is implemented with, for example, an O-ring formed of an elastically deformable rubber member. The drive unit seal R24 ensures sealing between the main body cover R20 and the power portion R30.

The main body cover R20 is fixed to the tubular portion R11 by snap-fitting. The drive unit M20 is fixed to the main body cover R20 by a screw member.

The power portion R30 is an actuator for outputting a rotational force for rotating the valve R40. The power portion R30 includes a motor (not illustrated) as a drive source that rotates the valve R40, and a speed reduction mechanism (not illustrated) that transmits an output of the motor to the rotation shaft R41 of the valve R40. As the motor, for example, a servo motor, a stepping motor, or a brushless motor can be adopted. As the speed reduction mechanism, for example, a gear mechanism including a helical gear or a spur gear can be adopted. The motor rotates according to a control signal from the control device 10 electrically coupled to the motor.

The valve R40 is a valve member that rotates about the valve axis VC by a rotational force output from the power portion R30 to switch a flow of the fluid to the first opening RP1 to the tenth opening RP10. As illustrated in FIG. 74, the valve R40 is disposed in the valve accommodating space S and is provided at a position where the valve R40 does not abut against an inner circumferential surface of the tubular portion R11 so as to be rotatable. That is, the valve R40 is disposed such that a predetermined gap is formed between the valve R40 and the tubular portion R11. The valve R40 is formed such that a central axis thereof is coaxial with the valve axis VC and also coaxial with the central axis of the tubular portion R11.

The valve R40 is formed in a substantially conical shape whose outer diameter decreases from the first valve axial direction DR1a toward the second valve axial direction DR1b. That is, the valve R40 is formed in a substantially conical shape in which the second valve axial direction DR1b side is an apex side and the first valve axial direction DR1a side is a bottom side.

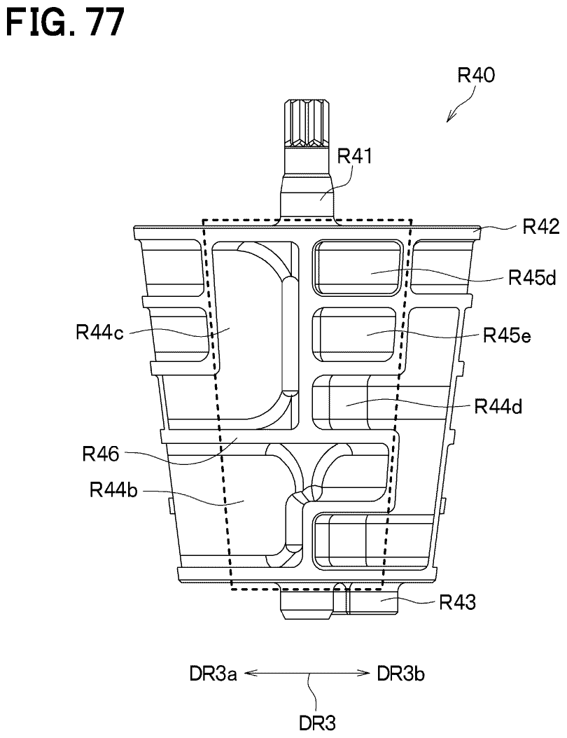

As illustrated in FIGS. 74 and 77, the valve R40 has the rotation shaft R41, a valve outer wall portion R42 forming a substantially conical outer shell, and the stopper R43. The valve outer wall portion R42, the rotation shaft R41, and the stopper R43 are integrally molded.

The valve outer wall portion R42 has a conical shape along the tubular portion R11. That is, an outer circumferential surface of the valve outer wall portion R42 and the inner circumferential surface of the tubular portion R11 are substantially parallel to each other at portions facing each other, and a distance in the valve radial direction DR2 between the outer circumferential surface of the valve outer wall portion R42 and the inner circumferential surface of the tubular portion R11 is substantially constant.

As illustrated in FIGS. 77 to 80, six fluid passages R44a, R44b, R44c, R44d, R44e, and R44f corresponding to the first opening RP1 to the tenth opening RP10 are formed in the valve outer wall portion R42. The six fluid passages R44a, R44b, R44c, R44d, R44e, and R44f are flow paths through which the coolant flowing from the first opening RP1, the fourth opening RP4, the eighth opening RP8, and the tenth opening RP10 flows.

Further, seven closing portions R45a, R45b, R45c, R45d, R45e, R45f, and R45g that prohibit the fluid from flowing into the valve accommodating space S are formed in the valve outer wall portion R42. Hereinafter, the six fluid passages R44a, R44b, R44c, R44d, R44e, and R44f are also referred to as six fluid passages R44a to R44f. The seven closing portions R45a, R45b, R45c, R45d, R45e, R45f, and R45g are also referred to as seven closing portions R45a to R45g.

Any one of the six fluid passages R44a to R44f and the seven closing portions R45a to R45g faces any one of the first opening RP1 to the tenth opening RP10 when the valve R40 rotates. A rib R46 that partitions the six fluid passages R44a to R44f and the seven closing portions R45a to R45g is formed in the valve outer wall portion R42.

These six fluid passages R44a to R44f switch an inflow and outflow of the fluid to and from the fluid control valve RV by rotating the valve R40 and switching an opening that the six fluid passages R44a to R44f face among the first opening RP1 to the tenth opening RP10. These seven closing portions R45a to R45g prohibit the inflow and outflow of the fluid to and from an opening that the seven closing portions R45a to R45g face among the first opening RP1 to the tenth opening RP10 by rotating the valve R40 and switching the opening that the seven closing portions R45a to R45g face. The rib R46 surrounds the six fluid passages R44a to R44f and the seven closing portions R45a to R45g.

Hereinafter, the six fluid passages R44a to R44f are referred to as a first fluid passage R44a, a second fluid passage R44b, a third fluid passage R44c, a fourth fluid passage R44d, a fifth fluid passage R44e, and a sixth fluid passage R44f, respectively. The first fluid passage R44a, the second fluid passage R44b, the third fluid passage R44c, the fourth fluid passage R44d, the fifth fluid passage R44e, and the sixth fluid passage R44f may be referred to as the first fluid passage R44a to the sixth fluid passage R44f.

The seven closing portions R45a to R45g are referred to as a first closing portion R45a, a second closing portion R45b, a third closing portion R45c, a fourth closing portion R45d, a fifth closing portion R45e, a sixth closing portion R45f, and a seventh closing portion R45g. The first closing portion R45a, the second closing portion R45b, the third closing portion R45c, the fourth closing portion R45d, the fifth closing portion R45e, the sixth closing portion R45f, and the seventh closing portion R45g may be referred to as the first closing portion R45a to the seventh closing portion R45g. In the valve R40, any one of the first fluid passage R44a to the sixth fluid passage R44f and any one of the first closing portion R45a to the seventh closing portion R45g face any one of the first opening RP1 to the tenth opening RP10.

The six fluid passages R44a to R44f are formed in the valve outer wall portion R42 so as to be recessed toward the valve axis VC along at least one of the valve axial direction DR1 and the valve circumferential direction DR3.

Each of the six fluid passages R44a to 44f has a shape corresponding to the first opening RP1 to the tenth opening RP10 having a lattice opening shape. The first fluid passage R44a to the sixth fluid passage R44f have a size capable of spanning two or more of the first opening RP1 to the tenth opening RP10 when the valve R40 is rotated and positioned at a position facing the first opening RP1 to the tenth opening RP10.

The first fluid passage R44a to the sixth fluid passage R44f are formed such that at least one of the first opening RP1, the fourth opening RP4, the eighth opening RP8, and the tenth opening RP10, which are coolant inlets, can communicate with at least one of the second opening RP2, the third opening RP3, the fifth opening RP5, the sixth opening RP6, the seventh opening RP7, and the ninth opening RP9, which are coolant outlets. Accordingly, the first fluid passage R44a to the sixth fluid passage R44f can guide the fluid flowing in from any of the communicating first opening RP1, the fourth opening RP4, the eighth opening RP8, and the tenth opening RP10 to any of the communicating second opening RP2, the third opening RP3, the fifth opening RP5, the sixth opening RP6, the seventh opening RP7, and the ninth opening RP9.

When the first closing portion R45a to the seventh closing portion R45g face any one of the first opening RP1, the fourth opening RP4, the eighth opening RP8, and the tenth opening RP10, the first closing portion R45a to the seventh closing portion R45g are capable of prohibiting the fluid from flowing into the valve accommodating space S from the facing coolant inlet. Specifically, the first closing portion R45a to the seventh closing portion R45g have opening shapes corresponding to the first opening RP1, the fourth opening RP4, the eighth opening RP8, and the tenth opening RP10, and are recessed toward the valve axis VC.

The first closing portion R45a to the seventh closing portion R45g are capable of prohibiting an outflow of the fluid from the facing coolant outlet when facing any one of the second opening RP2, the third opening RP3, the fifth opening RP5, the sixth opening RP6, the seventh opening RP7, and the ninth opening RP9. Specifically, the first closing portion R45a to the seventh closing portion R45g have opening shapes corresponding to the second opening RP2, the third opening RP3, the fifth opening RP5, the sixth opening RP6, the seventh opening RP7, and the ninth opening RP9, and are recessed toward the valve axis VC.

The first fluid passage R44a to the sixth fluid passage R44f and the first closing portion R45a to the seventh closing portion R45g are partitioned by the rib R46. That is, the first fluid passage R44a to the sixth fluid passage R44f and the first closing portion R45a to the seventh closing portion R45g are each surrounded by the rib R46.

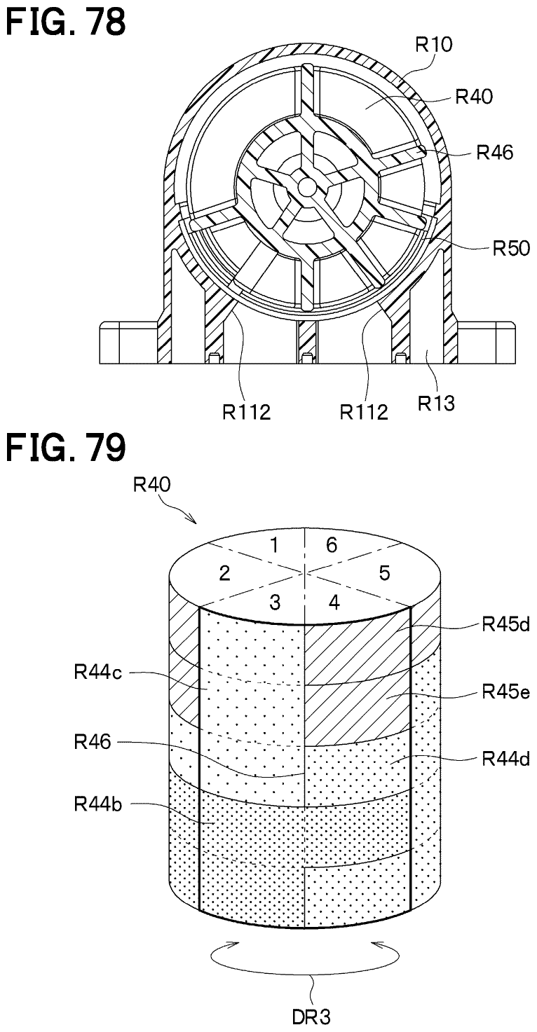

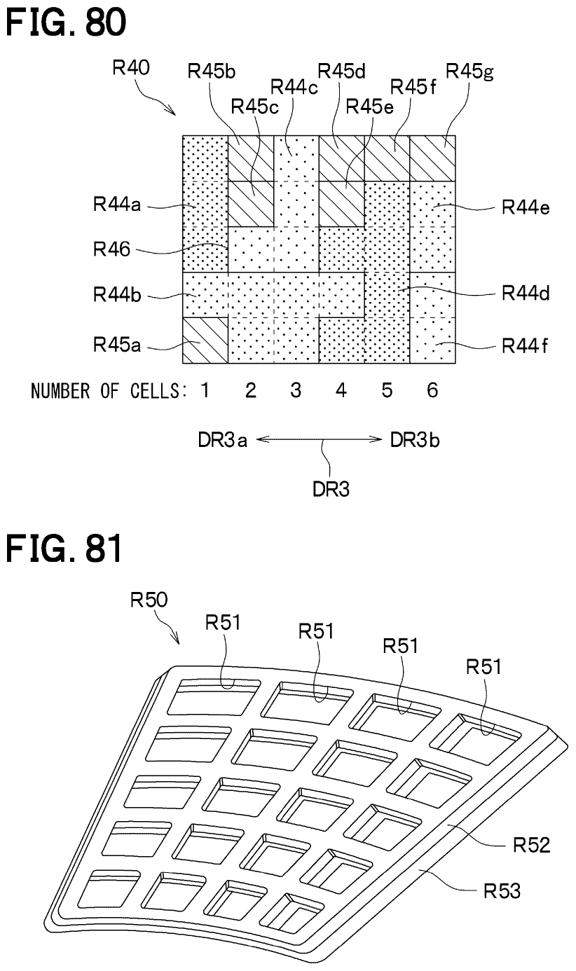

Specific shapes and formation positions of the first fluid passage R44a to the sixth fluid passage R44f and the first closing portion R45a to the seventh closing portion R45g will be described with reference to FIGS. 79 and 80. FIG. 79 schematically illustrates the valve R40, and illustrates a portion facing the first opening RP1 to the tenth opening RP10 surrounded by thick lines. The valve R40 illustrated in FIG. 80 indicates a surface side of the valve R40 when the valve R40 is rotated in the valve circumferential direction DR3 so that the first fluid passage R44a to the sixth fluid passage R44f and the first closing portion R45a to the seventh closing portion R45g can be seen. In FIG. 80, a lattice-shaped mass schematically illustrates a portion where the first fluid passage R44a to the sixth fluid passage R44f and the first closing portion R45a to the seventh closing portion R45g are formed when the valve R40 is developed in the valve circumferential direction DR3. A grid indicated by solid lines indicates a portion where the rib R46 is formed, and a grid indicated by broken lines indicates a portion where the rib R46 is not formed. For easy understanding of the drawing, the first fluid passage R44a to the sixth fluid passage R44f are hatched with a dot pattern, and the first closing portion R45a to the seventh closing portion R45g are hatched with diagonal lines.

As illustrated in FIGS. 79 and 80, the first fluid passage R44a to the sixth fluid passage R44f and the first closing portion R45a to the seventh closing portion R45g are formed over the entire valve axial direction DR1 of the valve outer wall portion R42 and over the entire valve circumferential direction DR3. The first fluid passage R44a to the sixth fluid passage R44f and the first closing portion R45a to the seventh closing portion R45g are formed in any of a plurality of columns in the valve circumferential direction DR3 when the valve outer wall portion R42 is divided into the plurality of columns and in any of a plurality of stages in the valve axial direction DR1 when the valve outer wall portion R42 is divided into the plurality of stages.

When the fluid passage of each column is one cell of a fluid passage, the first fluid passage R44a to the sixth fluid passage R44f are formed in six cells in the valve outer wall portion R42. That is, the first fluid passage R44a to the sixth fluid passage R44f are formed in one or a plurality of six columns when the valve outer wall portion R42 is divided into six columns in the valve circumferential direction DR3. The valve R40 rotates in the valve circumferential direction DR3 such that the first fluid passage R44a to the sixth fluid passage R44f facing the first opening RP1 to the tenth opening RP10 disposed side by side in two columns in the valve circumferential direction DR3 change for every column.

The valve outer wall portion R42 is divided into five sections in the valve axial direction DR1 and into six sections in the valve circumferential direction DR3, and each area of the partitioned valve outer wall portion R42 is defined as one section. The one section corresponds to each of the first opening RP1 to the tenth opening RP10, and in FIGS. 79 and 80, a size of each section is illustrated in the same shape for easy understanding.

When the valve outer wall portion R42 is divided into the five sections in the valve axial direction DR1, the sections are defined as a first-stage section, a second-stage section, a third-stage section, a fourth-stage section, and a fifth-stage section from the first valve axial direction DR1a side toward the second valve axial direction DR1b side. When the valve outer wall portion R42 is divided into six sections in the valve circumferential direction DR3, the sections are defined as a first-column section, a second-column section, a third-column section, a fourth-column section, a fifth-column section, and a sixth-column section from the first valve circumferential direction DR3a side toward the second valve circumferential direction DR3b side. The column corresponds to the cell described above.

The first fluid passage R44a to the sixth fluid passage R44f thus defined are in any of the first to fifth stages and have a shape obtained by combining a plurality of sections positioned in any of the first to sixth columns. The first fluid passage R44a to the sixth fluid passage R44f are formed at positions that can face any of the first opening RP1, the fourth opening RP4, the eighth opening RP8, and the tenth opening RP10, which are the coolant inlets. The first fluid passage R44a to the sixth fluid passage R44f are formed at positions that can face any of the second opening RP2, the third opening RP3, the fifth opening RP5, the sixth opening RP6, the seventh opening RP7, and the ninth opening RP9, which are the coolant outlets.

The first closing portion R45a to the seventh closing portion R45g correspond to one section positioned in any one of the first to fifth stages and any one of the first to sixth columns. The first closing portion R45a to the seventh closing portion R45g are formed at positions that can face any one of the first opening RP1, the fourth opening RP4, the eighth opening RP8, and the tenth opening RP10, which are coolant inlets, or any one of the second opening RP2, the third opening RP3, the fifth opening RP5, the sixth opening RP6, the seventh opening RP7, and the ninth opening RP9, which are coolant outlets. Hereinafter, shapes and formed positions of the first fluid passage R44a to the sixth fluid passage R44f and the first closing portion R45a to the seventh closing portion R45g will be described using sections.

The first fluid passage R44a has a shape that combines a first-stage and first-column section, a second-stage and first-column section, and a third-stage and first-column section. The first fluid passage R44a thus configured can span three openings that are connected in the valve axial direction DR1. It is assumed that the valve R40 rotates in the valve circumferential direction DR3 and the first fluid passage R44a is positioned at a position facing the first opening RP1 to the tenth opening RP10. The first fluid passage R44a can face the first-stage opening, the second-stage opening, and the third-stage opening.

The second fluid passage R44b has a shape that combines a fourth-stage and first-column section, a fourth-stage and second-column section, a fifth-stage and second-column section, a fourth-stage and third-column section, a fifth-stage and third-column section, and a fourth-stage and fourth-column section. The second fluid passage R44b thus configured can span two openings in the valve axial direction DR1, and can span two openings in the valve circumferential direction DR3. The second fluid passage R44b can span three or four openings adjacent to each other in one of the valve axial direction DR1 or the valve circumferential direction DR3.

It is assumed that the valve R40 rotates in the valve circumferential direction DR3 and the second fluid passage R44b is positioned at a position facing the first opening RP1 to the tenth opening RP10. The second fluid passage R44b can face the fourth-stage opening and the fifth-stage opening.

The third fluid passage R44c has a shape that combines a third-stage and second-column section, a first-stage and third-column section, a second-stage and third-column section, and a third-stage and third-column section. The third fluid passage R44c thus configured can span three openings that are connected in the valve axial direction DR1 and can span two openings in the valve circumferential direction DR3. It is assumed that the valve R40 rotates in the valve circumferential direction DR3 and the third fluid passage R44c is positioned at a position facing the first opening RP1 to the tenth opening RP10. The third fluid passage R44c can face the first-stage opening, the second-stage opening, and the third-stage opening.

The fourth fluid passage R44d has a shape that combines a third-stage and fourth-column section, a fifth-stage and fourth-column section, a second-stage and fifth-column section, a third-stage and fifth-column section, a fourth-stage and fifth-column section, and a fifth-stage and fifth-column section. The fourth fluid passage R44d thus configured can span four openings that are connected in the valve axial direction DR1. The fourth fluid passage R44d can span six openings adjacent to each other in one of the valve axial direction DR1 and the valve circumferential direction DR3. It is assumed that the valve R40 rotates in the valve circumferential direction DR3 and the fourth fluid passage R44d is positioned at a position facing the first opening RP1 to the tenth opening RP10. The fourth fluid passage R44d can face the the second-stage opening, the third-stage opening, fourth-stage opening, and the fifth-stage opening.

The fifth fluid passage R44e has a shape that combines a second-stage and sixth-column section and a third-stage and sixth-column section. The fifth fluid passage R44e thus configured can span two openings that are connected in the valve axial direction DR1. It is assumed that the valve R40 rotates in the valve circumferential direction DR3 and the fifth fluid passage R44e is positioned at a position facing the first opening RP1 to the tenth opening RP10. The fifth fluid passage R44e can face the second-stage opening and the third-stage opening.

The sixth fluid passage R44f has a shape that combines a fourth-stage and sixth-column section and a fifth-stage and sixth-column section are combined. The sixth fluid passage R44f thus configured can span two openings that are connected in the valve axial direction DR1. It is assumed that the valve R40 rotates in the valve circumferential direction DR3 and the sixth fluid passage R44f is positioned at a position facing the first opening RP1 to the tenth opening RP10. The sixth fluid passage R44f can face the fourth-stage opening and the fifth-stage opening.

The first closing portion R45a is formed in a fifth-stage and first-column section. When the valve R40 rotates in the valve circumferential direction DR3 and is positioned at a position facing the first opening RP1 to the tenth opening RP10, the first closing portion R45a thus configured can face the fifth-stage opening. When the first closing portion R45a is positioned at a position facing the second opening RP2, the first closing portion R45a closes the second opening RP2, thereby prohibiting the fluid from flowing out of the second opening RP2. When the first closing portion R45a is positioned at a position facing the fourth opening RP4, the first closing portion R45a closes the fourth opening RP4, thereby prohibiting the fluid from flowing into the fourth opening RP4.

The second closing portion R45b is formed in a first-stage and second-column section. When the valve R40 rotates in the valve circumferential direction DR3 and is positioned at a position facing the first opening RP1 to the tenth opening RP10, the second closing portion R45b thus configured can face the first-stage opening. When the second closing portion R45b is positioned at a position facing the ninth opening RP9, the second closing portion R45b closes the ninth opening RP9, thereby prohibiting the fluid from flowing out of the ninth opening RP9. When the second closing portion R45b is positioned at a position facing the fifth opening RP5, the second closing portion R45b closes the fifth opening RP5, thereby prohibiting the fluid from flowing out of the fifth opening RP5.

The third closing portion R45c is formed in a second-stage and second-column section. When the valve R40 rotates in the valve circumferential direction DR3 and is positioned at a position facing the first opening RP1 to the tenth opening RP10, the third closing portion R45c thus configured can face the second-stage opening. When the third closing portion R45c is positioned at a position facing the eighth opening RP8, the third closing portion R45c closes the eighth opening RP8, thereby prohibiting the fluid from flowing into the eighth opening RP8. When the third closing portion R45c is positioned at a position facing the first opening RP1, the third closing portion R45c closes the first opening RP1, thereby prohibiting the fluid from flowing into the first opening RP1.

The fourth closing portion R45d is formed in a first-stage and fourth-column section. When the valve R40 rotates in the valve circumferential direction DR3 and is positioned at a position facing the first opening RP1 to the tenth opening RP10, the fourth closing portion R45d thus configured can face the first-stage opening. When the fourth closing portion R45d is positioned at a position facing the ninth opening RP9, the fourth closing portion R45d closes the ninth opening RP9, thereby prohibiting the fluid from flowing out of the ninth opening RP9. When the fourth closing portion R45d is positioned at a position facing the fifth opening RP5, the fourth closing portion R45d closes the fifth opening RP5, thereby prohibiting the fluid from flowing out of the fifth opening RP5.

The fifth closing portion R45e is formed in a second-stage and fourth-column section. When the valve R40 rotates in the valve circumferential direction DR3 and is positioned at a position facing the first opening RP1 to the tenth opening RP10, the fifth closing portion R45e thus configured can face the second-stage opening. When the fifth closing portion R45e is positioned at a position facing the eighth opening RP8, the fifth closing portion R45e closes the eighth opening RP8, thereby prohibiting the fluid from flowing into the eighth opening RP8. When the fifth closing portion R45e is positioned at a position facing the first opening RP1, the fifth closing portion R45e closes the first opening RP1, thereby prohibiting the fluid from flowing into the first opening RP1.

The sixth closing portion R45f is formed in a first-stage and fifth-column section. When the valve R40 rotates in the valve circumferential direction DR3 and is positioned at a position facing the first opening RP1 to the tenth opening RP10, the sixth closing portion R45f thus configured can face the first-stage opening. When the sixth closing portion R45f is positioned at a position facing the ninth opening RP9, the sixth closing portion R45f closes the ninth opening RP9, thereby prohibiting the fluid from flowing out of the ninth opening RP9. When the sixth closing portion R45f is positioned at a position facing the fifth opening RP5, the sixth closing portion R45f closes the fifth opening RP5, thereby prohibiting the fluid from flowing out of the fifth opening RP5.

The seventh closing portion R45g is formed in a first-stage and sixth-column section. When the valve R40 rotates in the valve circumferential direction DR3 and is positioned at a position facing the first opening RP1 to the tenth opening RP10, the seventh closing portion R45g thus configured can face the first-stage opening. When the seventh closing portion R45g is positioned at a position facing the ninth opening RP9, the seventh closing portion R45g closes the ninth opening RP9, thereby prohibiting the fluid from flowing out of the ninth opening RP9. When the seventh closing portion R45g is positioned at a position facing the fifth opening RP5, the seventh closing portion R45g closes the fifth opening RP5, thereby prohibiting the fluid from flowing out of the fifth opening RP5.

The valve R40 has the rotation shaft R41 protruding from the first valve axial direction DR1a side and the second valve axial direction DR1b side. In the rotation shaft R41, a portion protruding toward the first valve axial direction DR1a side is rotatably supported by the bearing portion R21, and a portion protruding toward the second valve axial direction DR1b side is rotatable by the support hole R121 formed in the bottom portion R12. An end portion of the rotation shaft R41 on the first valve axial direction DR1a side penetrates the main body cover R20 and is connected to the speed reduction mechanism of the power portion R30.

Further, the valve R40 is provided with the stopper R43 on a surface on the second valve axial direction DR1b side. The stopper R43 extends in the valve axial direction DR1 toward the second valve axial direction DR1b side at a position away from the rotation shaft R41 in the valve radial direction DR2. The stopper R43 is formed at a position facing the rotation restricting portion R122 in the valve circumferential direction DR3, and can abut against the rotation restricting portion R122 when the valve R40 rotates in the valve circumferential direction DR3. The seal portion R50 is provided between the valve outer wall portion R42 of the valve R40 and the tubular portion R11 of the main body R10.

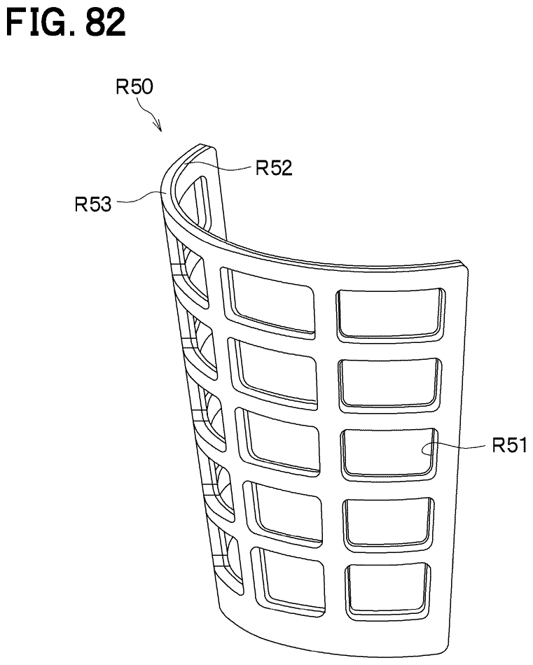

The seal portion R50 is disposed between the valve outer wall portion R42 and a portion of the tubular portion R11 where the ten cutout portions R112 are formed, and seals a predetermined gap between the valve R40 and the ten cutout portions R112. The seal portion R50 is configured to cover all of the ten cutout portions R112. In the seal portion R50, as illustrated in FIG. 81, twenty seal flow holes R51 through which the fluid flowing through the ten cutout portions R112 passes are formed.

As illustrated in FIG. 81, the seal portion R50 is formed in a substantially fan-shaped plate shape in a state before being attached between the valve outer wall portion R42 and the tubular portion R11. As illustrated in FIG. 82, the seal portion R50 is disposed such that a plate thickness direction is the valve radial direction DR2. When the seal portion R50 is disposed between the valve outer wall portion R42 and the tubular portion R11, the seal portion R50 is bent and disposed such that a portion forming an arc extends in the valve circumferential direction DR3 and is disposed along the inner circumferential surface of the tubular portion R11. Thus, a plate surface of the seal portion R50 has a planar shape before being attached, and has a curved surface shape bent in the valve circumferential direction DR3 when attached.

The seal portion R50 is provided between the two circumferential-side seal restricting portions R111, and one side and the other side in the valve circumferential direction DR3 are respectively supported by the circumferential-side seal restricting portions R111. A second valve axial direction DR1b side of the seal portion R50 is fitted to and supported by the circumferential-side seal restricting portion R111 formed on the bottom portion R12.

The seal portion R50 includes a sliding portion R52 positioned on a valve outer wall portion R42 side and a pressing portion R53 positioned on a tubular portion R11 side when the seal portion R50 is disposed between the valve outer wall portion R42 and the tubular portion R11. That is, the seal portion R50 is implemented by stacking the sliding portion R52 and the pressing portion R53 in the plate thickness direction. The sliding portion R52 and the pressing portion R53 are formed of different materials.

Specifically, in the seal portion R50, the sliding portion R52 is formed of a high sliding member having a relatively small friction coefficient. In contrast, the pressing portion R53 is formed of an elastic member such as a rubber member. The seal portion R50 is formed by, for example, applying the sliding portion R52 formed of fluororesin or the like to a surface of a pressing portion R53 formed of an elastic member such as a rubber member. Alternatively, the seal portion R50 may be formed by integrally assembling the sliding portion R52 formed of a fluororesin or the like and the pressing portion R53 formed of an elastic member such as a rubber member, or by bonding the sliding portion R52 and the pressing portion R53 with an adhesive or the like, or by baking the sliding portion R52 and the pressing portion R53.

Accordingly, when the seal portion R50 is disposed between the valve outer wall portion R42 and the tubular portion R11, the pressing portion R53 can be deformed to match a shape of the tubular portion R11, making the pressing portion R53 easier to fit in. Therefore, assembly of the seal portion R50 can be improved, and a gap between the valve R40 and the seal portion R50 and a gap between the main body R10 and the seal portion R50 can be reduced. Therefore, it is possible to prevent the fluid from flowing through the gap between the valve R40 and the seal portion R50 and the gap between the main body R10 and the seal portion R50.

Further, since the sliding portion R52 positioned on the valve outer wall portion R42 side is a high sliding member having a relatively small friction coefficient such as a P fluororesin, sliding resistance between the valve R40 and the seal portion R50 can be reduced.

The seal portion R50 according to the present embodiment is formed such that a size in the valve circumferential direction DR3 is larger than a range in which the ten cutout portions R112 are formed in the tubular portion R11. In the seal portion R50, twenty seal flow holes R51 penetrating the seal portion R50 in the plate thickness direction are formed over the entire valve axial direction DR1 and the entire valve circumferential direction DR3, and are formed in a lattice shape. The seal flow holes R51 are formed side by side in five stages in the valve axial direction DR1 and in four columns in the valve circumferential direction DR3.

The seal flow holes R51, which are lined up in groups of five in the valve axial direction DR1 and in groups of four in the valve circumferential direction DR3, have opening shapes that correspond to the ten cutout portions R112. In other words, each of the seal flow hole R51 has an opening shape corresponding to the first fluid passage R44a to the sixth fluid passage R44f, and specifically, corresponds to a section forming the first fluid passage R44a to the sixth fluid passage R44f.

Among the seal flow holes R51 lined up in four columns in the valve circumferential direction DR3, a group of seal flow holes R51 in two central columns are formed at positions facing the ten cutout portions R112. The group of seal flow holes R51 in the two central columns allows the fluid flowing through the ten cutout portions R112 to pass therethrough.

In contrast, a group of seal flow holes R51 in one column formed at an end portion on the first valve circumferential direction DR3a side and a group of seal flow holes R51 in one column formed at an end portion on the second valve circumferential direction DR3b side are formed at positions not facing the ten cutout portions R112. The group of seal flow holes R51 in the one column formed at the end portion on the first valve circumferential direction DR3a side is formed on the first valve circumferential direction DR3a side with respect to the ten cutout portions R112. The group of seal flow holes R51 in the one column formed at the end portion on the second valve circumferential direction DR3b side is formed on the second valve circumferential direction DR3b side with respect to the ten cutout portions R112.

Of the seal portion R50, a portion forming the group of seal flow holes R51 in the two central columns surrounds the ten cutout portions R112, and prevents fluids passing through each of the ten cutout portions R112 from mixing.

Of the seal portion R50, the group of seal flow holes R51 in the one column formed at the end portion on the first valve circumferential direction DR3a side and the group of seal flow holes R51 in the one column formed at the end portion on the second valve circumferential direction DR3b side surround fluid passages that do not face the ten cutout portions R112. Accordingly, the seal portion R50 has the group of seal flow holes R51 in the one column formed at the end portion on the first valve circumferential direction DR3a side and the second valve circumferential direction DR3b side, which seal the fluid passages of the first fluid passage R44a to the sixth fluid passage R44f that do not face the ten cutout portions R112. In this case, the seal portion R50 prevents the fluids flowing through the fluid passages, which do not face the ten cutout portions R112, among the first fluid passage R44a to the sixth fluid passage R44f.

The number of columns of the ten cutout portions R112 lined up in two columns in the valve circumferential direction DR3 is defined as the number of columns of openings, and the number of columns of the seal flow holes R51 lined up in four columns in the valve circumferential direction DR3 is defined as the number of columns of flow holes. In the present embodiment, the number of columns of openings is set to two. The number of columns of flow holes is set to four. That is, in the present embodiment, the number of columns of flow holes is set to be more than the number of columns of openings by two columns. Specifically, the number of the seal flow holes R51 provided on each of one side and the other side in the valve circumferential direction DR3 is more than the number of the ten cutout portions R112 lined up in two columns in the valve circumferential direction DR3 by one column. Accordingly, the seal portion R50 has the group of seal flow holes R51 in the one column on the first valve circumferential direction DR3a side and the group of seal flow holes R51 in the one column on the second valve circumferential direction DR3b side, which are formed at positions not facing the ten cutout portions R112 in the valve circumferential direction DR3.

A reason why the number of columns of flow holes is set to be more than the number of columns of openings will be described with reference to FIG. 77. FIG. 77 illustrates a front view of the valve R40 when the valve R40 is positioned at a position where a part of the second fluid passage R44b and the third fluid passage R44c face the first column of openings and a part of the second fluid passage R44b and a part of the fourth fluid passage R44d face the second-column opening. A broken line in FIG. 77 indicates a range of the valve outer wall portion R42 covered by the first opening RP1 to the tenth opening RP10.

As described above, the fourth fluid passage R44d can span the two openings in the valve circumferential direction DR3. Therefore, when the first valve circumferential direction DR3a side of the fourth fluid passage R44d is positioned at a position facing the second-column opening, the second valve circumferential direction DR3b side does not face the first opening RP1 to the tenth opening RP10. Then, the fourth fluid passage R44d allows the third opening RP3 and the fourth opening RP4, which are not adjacent to each other, to communicate with each other via a portion on the second valve circumferential direction DR3b side which does not face the first opening RP1 to the tenth opening RP10 on the second valve circumferential direction DR3b side. Therefore, the fluid flowing into the valve R40 from the fourth opening RP4 flows to the third opening RP3 via the portion of the fourth fluid passage R44d on the second valve circumferential direction DR3b side. That is, the fluid flowing into the valve R40 from the fourth opening RP4 bypasses positions of the fourth fluid passage R44d that face the first opening RP1 to the tenth opening RP10 and flows to the third opening RP3.

It is assumed that the number of columns of flow holes is set to the same number as the number of columns of openings. In this case, when the fluid flowing into the valve R40 from the fourth opening RP4 flows into a portion of the fourth fluid passage R44d on the second valve circumferential direction DR3b side, the fluid may leak from a gap between the outer circumferential surface of the valve outer wall portion R42 and the inner circumferential surface of the tubular portion R11.

In contrast, in the present embodiment, the number of columns of flow holes is set to be more than the number of columns of openings by two columns. The seal portion R50 has a portion that forms the group of seal flow holes R51 in the one column on the first valve circumferential direction DR3a side and the group of seal flow holes R51 in the one column on the second valve circumferential direction DR3b side at a position not facing the first opening RP1 to the tenth opening RP10 in the valve circumferential direction DR3.

It is assumed that the second valve circumferential direction DR3b side of the fourth fluid passage R44d is positioned at a position not facing the first opening RP1 to the tenth opening RP10. Even in this case, the seal portion R50 surrounds a portion of the fourth fluid passage R44d in which a portion that forms the group of seal flow holes R51 in the one column on the second valve circumferential direction DR3b side does not face the first opening RP1 to the tenth opening RP10. Therefore, when the fluid flowing into the valve R40 from the fourth opening RP4 flows into the portion of the fourth fluid passage R44d on the second valve circumferential direction DR3b side, it is possible to prevent the fluid from leaking from the gap between the outer circumferential surface of the valve outer wall portion R42 and the inner circumferential surface of the tubular portion R11.

Returning to FIG. 74, the biasing portion R60 is provided between a first valve axial direction DR1a side of the valve R40 and a second valve axial direction DR1b side of the main body cover R20. The biasing portion R60 is a member that presses the valve R40 in the second valve axial direction DR1b, and is implemented with, for example, a compression coil spring. The compression coil spring is provided between the valve R40 and the main body cover R20 in a compressed state, and presses the valve R40 in the second valve axial direction DR1b by a biasing force generated by compression.

A spring guide R70 is provided between the first valve axial direction DR1a side of the valve R40 and the second valve axial direction DR1b side of the main body cover R20. The spring guide R70 supports the biasing portion R60 implemented with a compression coil spring. The spring guide R70 includes a cylindrical portion R71 provided inside the biasing portion R60 and a disk portion R72 having a thin disk shape and connected to the cylindrical portion R71 on the second valve axial direction DR1b side.

The cylindrical portion R71 extends along the valve axial direction DR1, and an inside thereof is supported by the main body cover R20. The disk portion R72 is placed on the first valve axial direction DR1a side of the valve R40 and supported by the valve R40. The disk portion R72 supports a second valve axial direction DR1b side of the biasing portion R60.

The spring guide R70 thus configured can reduce a positional deviation of the biasing portion R60 in the valve radial direction DR2 and transmit the biasing force of the biasing portion R60 to the valve R40.

The fluid control valve RV thus configured allows the first opening RP1, the fourth opening RP4, the eighth opening RP8, and the tenth opening RP10, which are coolant inlets, to communicate with the second opening RP2, the third opening RP3, the fifth opening RP5, the sixth opening RP6, the seventh opening RP7, and the ninth opening RP9, which are coolant outlets, depending on the rotational position of the valve R40.

The rotational position of the valve R40 of the fluid control valve RV is adjusted by the control device 10 according to the operation mode of the temperature control device. That is, the coolant outlet communicating with the coolant inlet in the fluid control valve RV is changed according to the operation mode of the temperature control device.

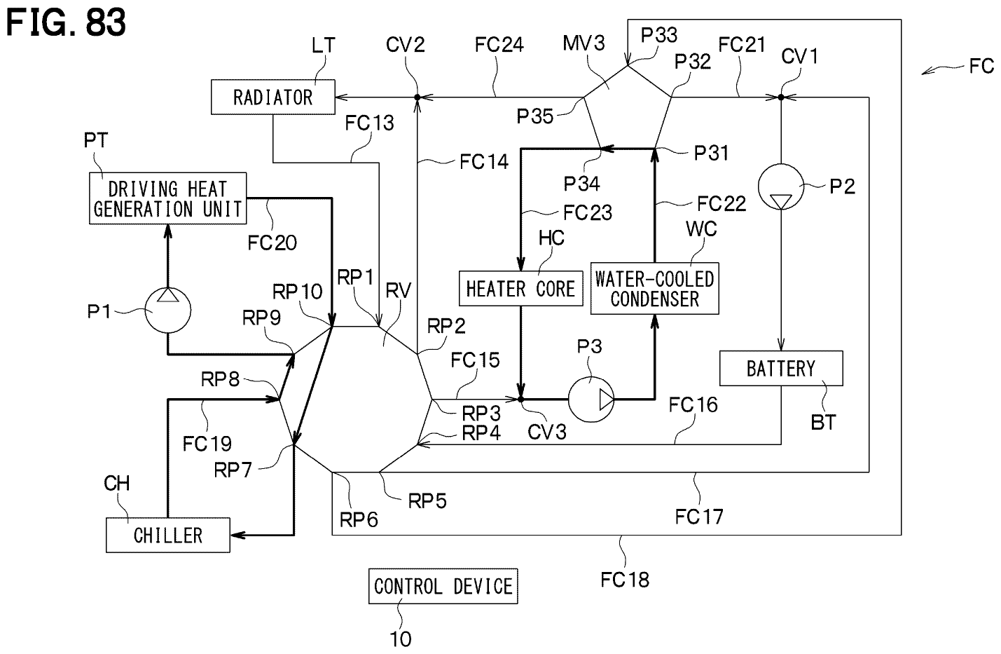

Next, the operation mode of the temperature control device according to the present embodiment will be described. The temperature control device according to the present embodiment can cool and heat the vehicle interior using the vehicle air conditioning device by switching the operation mode. The temperature control device can cool and heat the battery BT, which is a connection device connected to the fluid circuit system 1. The temperature control device can discard heat generated in the driving heat generation unit PT, which is a connection device connected to the temperature control device, and further cool the driving heat generation unit PT. The switching of the operation mode is executed by the control device 10. Hereinafter, among the operation modes executed by the temperature control device according to the present embodiment, five representative operation modes will be described with reference to FIGS. 83 to 87. In FIGS. 83 to 87, the flow of the coolant circulating in the fluid circuit system 1 is indicated by an arrow thicker than an arrow indicating the fluid circuit FC.

### (1) 3-1 Mode

The 3-1 mode is an operation mode in which heat of the driving heat generation unit PT that generates heat during operation is discarded while heating the vehicle interior without cooling or heating the battery BT. In the 3-1 mode, the coolant is circulated by the fluid circuit system 1 as illustrated in FIG. 83. Specifically, in the 3-1 mode, the fluid circuit system 1 operates the first pump P1 to circulate the coolant between the chiller CH and the driving heat generation unit PT using the RP9-RP10 flow path FC20 and the RP7-RP8 flow path FC19.

In the 3-1 mode, the fluid circuit system 1 operates the third pump P3 to circulate the coolant between the water-cooled condenser WC and the heater core HC using the P31-CV3 flow path FC22 and the P34-CV3 flow path FC23.

In the 3-1 mode, since the coolant is not circulated to the battery BT, the battery BT is not heated or cooled.

When the fluid circuit system 1 circulates the coolant in this way, the fluid control valve RV needs to adjust the rotational position of the valve R40 to allow the tenth opening RP10, which is the coolant inlet, to communicate with the seventh opening RP7, which is the coolant outlet. The fluid control valve RV needs to adjust the rotational position of the valve R40 to allow the eighth opening RP8, which is the coolant inlet, to communicate with the ninth opening RP9, which is the coolant outlet. The third multi-way valve MV3 needs to adjust the rotational position of the third movable disk MD3 to allow the 3-1 opening P31, which is the coolant inlet, to communicate with the 3-4 opening P34, which is the coolant outlet.

### (2) 3-2 Mode

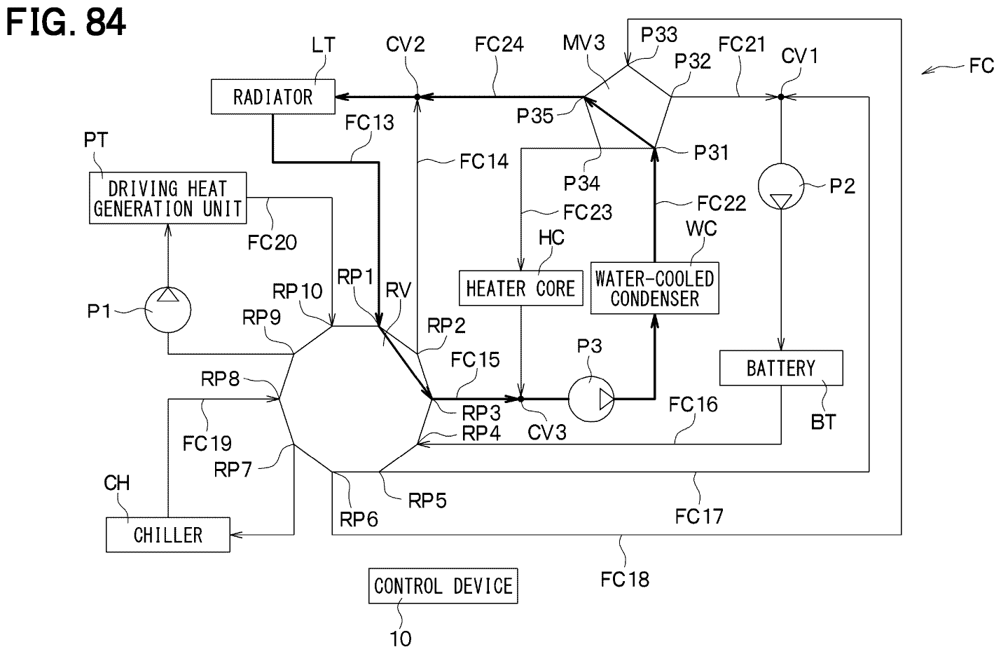

The 3-2 mode is an operation mode in which the vehicle interior is cooled without cooling or heating the battery BT and the driving heat generation unit PT. In the 3-2 mode, the coolant is circulated by the fluid circuit system 1 as illustrated in FIG. 84. Specifically, in the 3-2 mode, the fluid circuit system 1 operates the third pump P3 to circulate the coolant between the water-cooled condenser WC and the radiator LT using the P31-CV3 flow path FC22, the P35-CV2 flow path FC24, the CV2-RP1 flow path FC13, and the RP3-CV3 flow path FC15.

In the 1-3 mode, the coolant is not circulated to the battery BT and the driving heat generation unit PT. Therefore, the battery BT and the driving heat generation unit PT are not heated or cooled. In this case, heat generated by the operation of the driving heat generation unit PT is stored in the driving heat generation unit PT. In the 3-2 mode, the coolant is not circulated to the battery BT. Therefore, the battery BT is not heated or cooled.

When the fluid circuit system 1 circulates the coolant in this way, the fluid control valve RV needs to adjust the rotational position of the valve R40 to allow the first opening RP1, which is the coolant inlet, to communicate with the third opening RP3, which is the coolant outlet. The third multi-way valve MV3 needs to adjust a rotational position of the third movable disk MD3 to allow the 3-1 opening P31, which is the coolant inlet, to communicate with the 3-5 opening P35, which is the coolant outlet.

### (3) 3-3 Mode

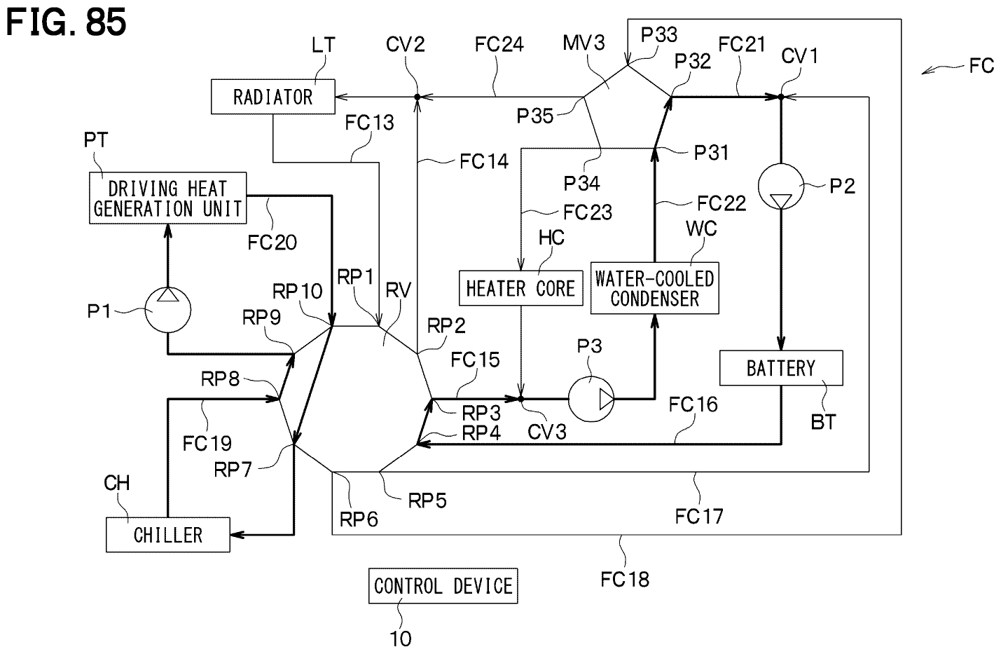

The 3-3 mode is an operation mode in which the heat of the driving heat generation unit PT is discarded while heating the battery BT without cooling or heating the vehicle interior. In the 3-3 mode, the coolant is circulated by the fluid circuit system 1 as illustrated in FIG. 85. Specifically, in the 3-3 mode, the fluid circuit system 1 operates the first pump P1 to circulate the coolant between the chiller CH and the driving heat generation unit PT using the RP9-RP10 flow path FC20 and the RP7-RP8 flow path FC19.

In the 3-3 mode, the fluid circuit system 1 operates the second pump P2 and the third pump P3 to circulate the coolant between the water-cooled condenser WC and the battery BT using the P31-CV3 flow path FC22, the P32-CV1 flow path FC21, the CV1-RP4 flow path FC16, and the RP3-CV3 flow path FC15.

When the fluid circuit system 1 circulates the coolant in this way, the fluid control valve RV needs to adjust the rotational position of the valve R40 to allow the tenth opening RP10, which is the coolant inlet, to communicate with the seventh opening RP7, which is the coolant outlet. The fluid control valve RV needs to adjust the rotational position of the valve R40 to allow the eighth opening RP8, which is the coolant inlet, to communicate with the ninth opening RP9, which is the coolant outlet. Further, the fluid control valve RV needs to adjust the rotational position of the valve R40 to allow the fourth opening RP4, which is the coolant inlet, to communicate with the third opening RP3, which is the coolant outlet. The third multi-way valve MV3 needs to adjust the rotational position of the third movable disk MD3 to allow the 3-1 opening P31, which is the coolant inlet, to communicate with the 3-2 opening P32, which is the coolant outlet.

### (4) 3-4 Mode

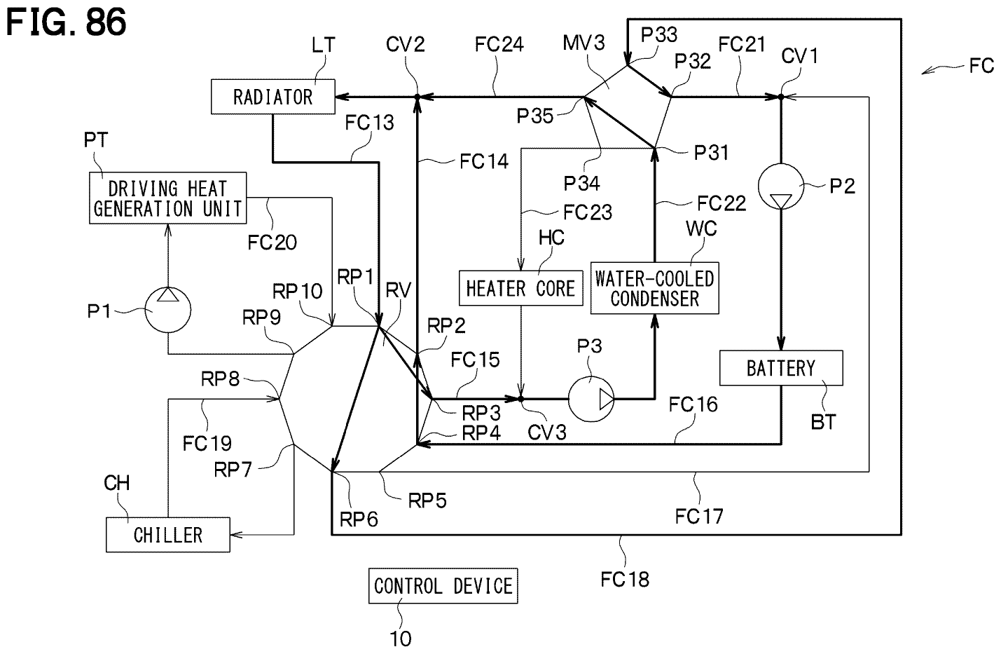

The 3-4 mode is an operation mode in which the vehicle interior is cooled and the battery BT is cooled without cooling or heating the driving heat generation unit PT. In the 3-4 mode, the coolant is circulated by the fluid circuit system 1 as illustrated in FIG. 86. Specifically, in the 3-4 mode, the fluid circuit system 1 operates the second pump P2 and the third pump P3 to circulate the coolant between the water-cooled condenser WC, the radiator LT, and the battery BT using the P31-CV3 flow path FC22, the P35-CV2 flow path FC24, the CV2-RP1 flow path FC13, the RP3-CV3 flow path FC15, the RP6-P33 flow path FC18, the P32-CV1 flow path FC21, the CV1-RP4 flow path FC16, and the RP2-CV2 flow path FC14.

When the fluid circuit system 1 circulates the coolant in this way, the fluid control valve RV needs to adjust the rotational position of the valve R40 to allow the first opening RP1, which is the coolant inlet, to communicate with the third opening RP3 and the sixth opening RP6, which are the coolant outlets. Further, the fluid control valve RV needs to adjust the rotational position of the valve R40 to allow the fourth opening RP4, which is the coolant inlet, to communicate with the second opening RP2, which is the coolant outlet. The third multi-way valve MV3 needs to adjust the rotational position of the third movable disk MD3 to allow the 3-1 opening P31, which is the coolant inlet, to communicate with the 3-5 opening P35, which is the coolant outlet. The third multi-way valve MV3 needs to adjust the rotational position of the third movable disk MD3 to allow the 3-3 opening P33, which is the coolant inlet, to communicate with the 3-2 opening P32, which is the coolant outlet.

### (5) 3-5 Mode

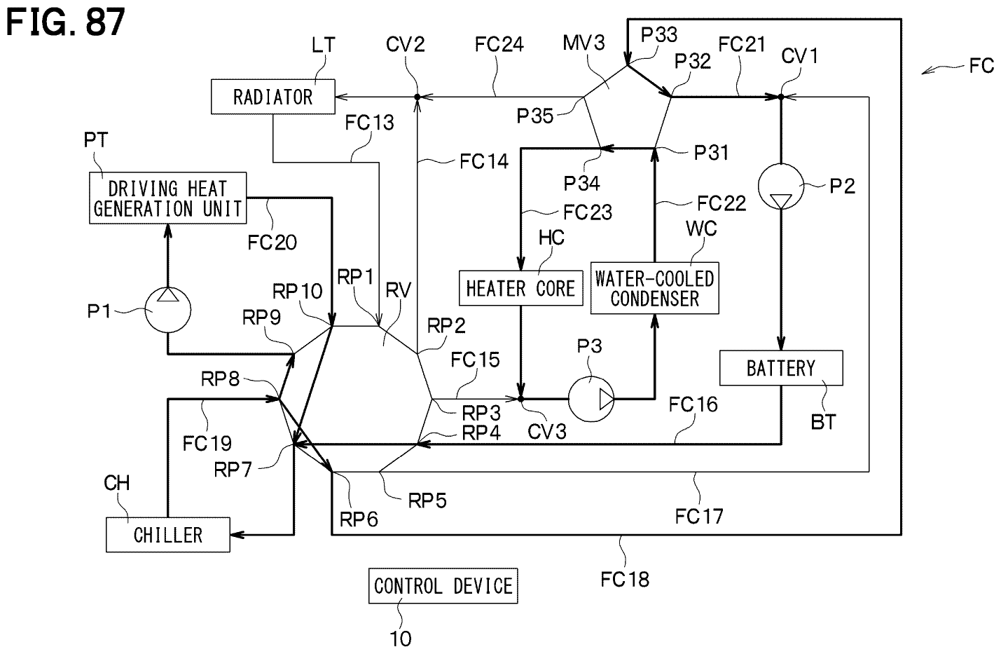

The 3-5 mode is an operation mode in which the vehicle interior is heated and the heat of the driving heat generation unit PT is discarded while the battery BT is cooled. In the 3-5 mode, the coolant is circulated by the fluid circuit system 1 as illustrated in FIG. 87. Specifically, in the 3-5 mode, the fluid circuit system 1 operates the first pump P1 and the second pump P2 to circulate the coolant between the driving heat generation unit PT, the battery BT, and the chiller CH using the RP9-RP10 flow path FC20, the RP7-RP8 flow path FC19, the RP6-P33 flow path FC18, the P32-CV1 flow path FC21, and the CV1-RP4 flow path FC16.

In the 3-5 mode, the fluid circuit system 1 operates the third pump P3 to circulate the coolant between the water-cooled condenser WC and the heater core HC using the P31-CV3 flow path FC22 and the P34-CV3 flow path FC23.

When the fluid circuit system 1 circulates the coolant in this way, the fluid control valve RV needs to adjust the rotational position of the valve R40 to allow the eighth opening RP8, which is the coolant inlet, to communicate with the sixth opening RP6 and the ninth opening RP9, which are the coolant outlets. The fluid control valve RV needs to adjust the rotational position of the valve R40 to allow the fourth opening RP4, which is the coolant inlet, to communicate with the seventh opening RP7, which is the coolant outlet. Further, the fluid control valve RV needs to adjust the rotational position of the valve R40 to allow the tenth opening RP10, which is the coolant inlet, to communicate with the seventh opening RP7, which is the coolant outlet. The third multi-way valve MV3 needs to adjust the rotational position of the third movable disk MD3 to allow the 3-1 opening P31, which is the coolant inlet, to communicate with the 3-4 opening P34, which is the coolant outlet. The third multi-way valve MV3 needs to adjust the rotational position of the third movable disk MD3 to allow the 3-3 opening P33, which is the coolant inlet, to communicate with the 3-2 opening P32, which is the coolant outlet.

It is assumed that the fluid circuit system 1 according to the present embodiment is configured to close all the unnecessary inlets and the unnecessary outlets of the fluid control valve RV when the temperature control device executes the five operation modes. A hypothetical configuration of the fluid control valve RV when the fluid circuit system 1 closes the unnecessary inlet and the unnecessary outlet of the fluid control valve RV when such a temperature control device executes the operation mode will be described.

When the fluid control valve RV is in the closed configuration when the temperature control device executes the 3-1 mode, the fluid control valve RV needs to close the first opening RP1, the second opening RP2, the third opening RP3, the fourth opening RP4, the fifth opening RP5, and the sixth opening RP6.

When the fluid control valve RV is in the closed configuration when the temperature control device executes the 3-2 mode, the fluid control valve RV needs to close the second opening RP2, the fourth opening RP4, the fifth opening RP5, the sixth opening RP6, the seventh opening RP7, the eighth opening RP8, the ninth opening RP9, and the tenth opening RP10.

When the fluid control valve RV is in the closed configuration when the temperature control device executes the 3-3 mode, the fluid control valve RV needs to close the first opening RP1, the second opening RP2, the fifth opening RP5, and the sixth opening RP6.

When the fluid control valve RV is in the closed configuration when the temperature control device executes the 3-4 mode, the fluid control valve RV needs to close the fifth opening RP5, the seventh opening RP7, the eighth opening RP8, the ninth opening RP9, and the tenth opening RP10.

When the fluid control valve RV is in the closed configuration when the temperature control device executes the 3-5 mode, the fluid control valve RV needs to close the first opening RP1, the second opening RP2, the third opening RP3, and the fifth opening RP5.

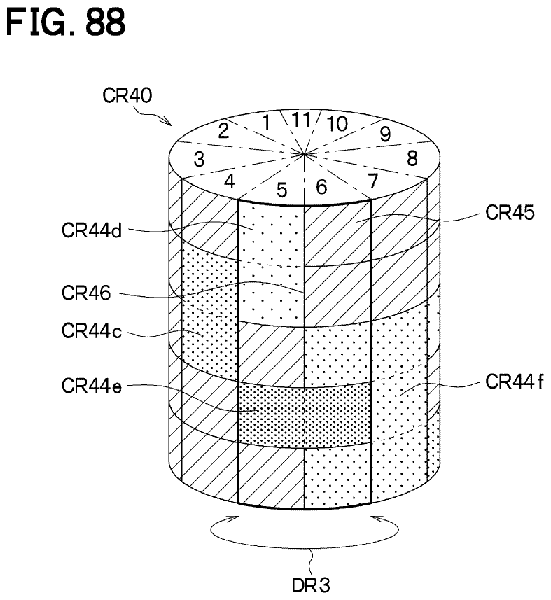

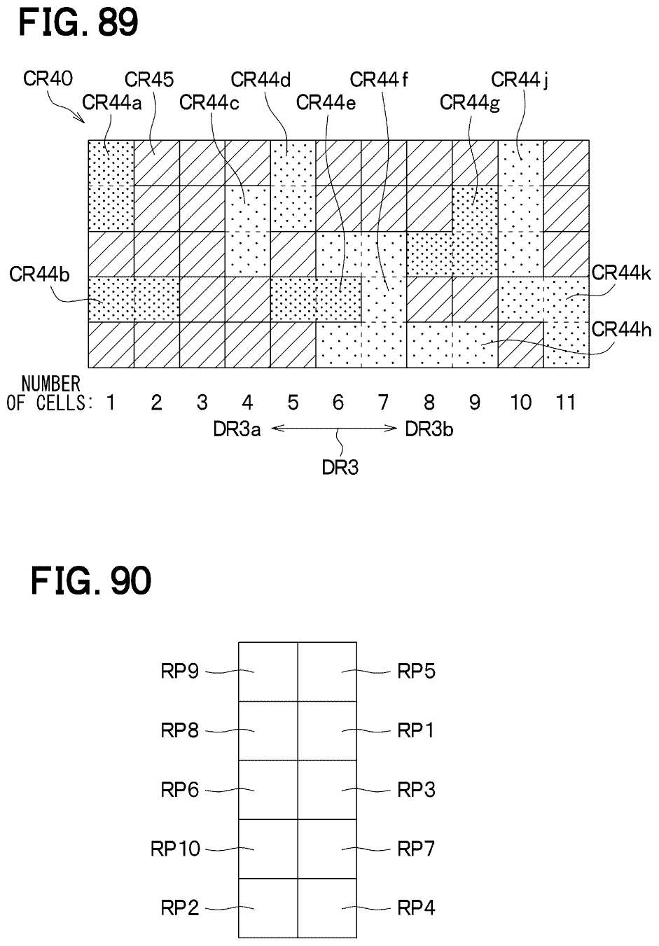

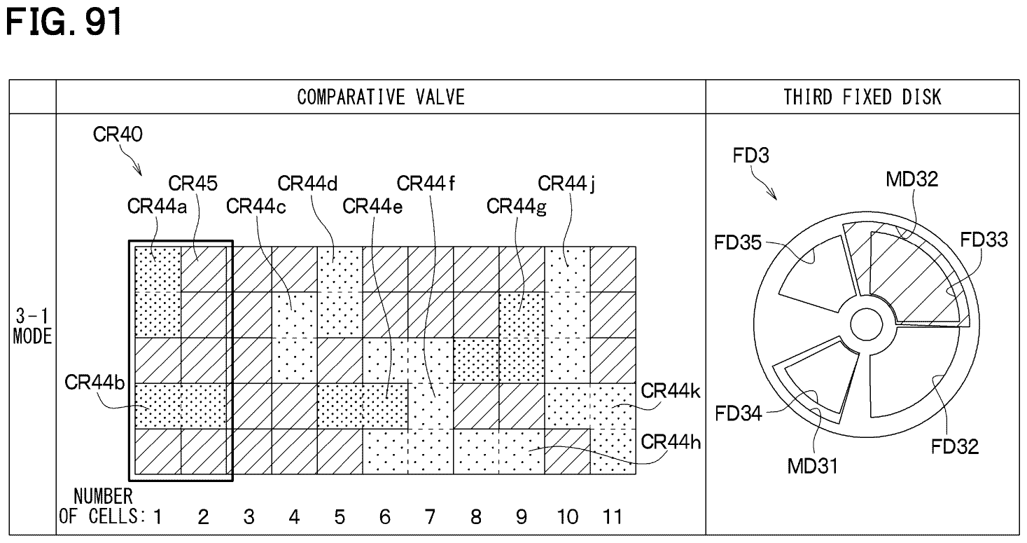

A comparative example in which the fluid control valve RV is in the closed configuration in all of the five operation modes will be described with reference to comparative examples of FIGS. 88 to 95. FIG. 88 schematically illustrates a comparative valve CR40, and illustrates a portion facing the first opening RP1 to the tenth opening RP10 surrounded by thick lines. The comparative valve CR40 illustrated in FIG. 89 illustrates a surface side of the comparative valve CR40 when the comparative valve CR40 is rotated in the valve circumferential direction DR3. FIG. 90 schematically illustrates the first opening RP1 to the tenth opening RP10 formed in the port forming portion R13. A square schematically illustrating the first opening RP1 to the tenth opening RP10 in FIG. 90 corresponds to a square illustrated in FIG. 91 and the like.

FIGS. 91 to 95 illustrate development views of the comparative valve CR40 for the fluid circuit system 1 to close the unnecessary inlet and the unnecessary outlet of the fluid control valve RV in all of the five operation modes. The comparative valve CR40 is configured to close the unnecessary inlet and the unnecessary outlet in each of the five operation modes.

As illustrated in FIG. 89, in the comparative valve CR40, a plurality of comparative fluid passages CR44 corresponding to the first opening RP1 to the tenth opening RP10 are formed. Specifically, ten comparative fluid passages CR44a, CR44b, CR44c, CR44d, CR44e, CR44f, CR44g, CR44h, CR44j, and CR44k through which the fluid flows are formed in the comparative valve CR40. These ten comparative fluid passages CR44a, CR44b, CR44c, CR44d, CR44e, CR44f, CR44g, CR44h, CR44j, and CR44k are formed so that when the comparative valve CR40 rotates, any one of the ten comparative fluid passages faces any one of the first opening RP1 to the tenth opening RP10. For easy understanding of the drawing, the ten comparative fluid passages CR44a, CR44b, CR44c, CR44d, CR44e, CR44f, CR44g, CR44h, CR44j, and CR44k are hatched with dot patterns.

Further, the valve outer wall portion R42 is formed with twenty-nine comparative closing portions CR45 that prohibit the fluid from flowing into the valve accommodating space S. These twenty-nine comparative closing portions CR45 are formed such that any one of the comparative closing portions CR45 faces any one of the first opening RP1 to the tenth opening RP10 when the comparative valve CR40 rotates. For easy understanding of the drawing, the twenty-nine comparative closing portions CR45 are hatched with diagonal lines.

Hereinafter, the ten comparative fluid passages CR44a, CR44b, CR44c, CR44d, CR44e, CR44f, CR44g, CR44h, CR44j, and CR44k may be referred to as ten comparative fluid passages CR44a to CR44k. The ten comparative fluid passages CR44a, CR44b, CR44c, CR44d, CR44e, CR44f, CR44g, CR44h, CR44j, and CR44k are referred to as a first comparative fluid passage CR44a, a second comparative fluid passage CR44b, a third comparative fluid passage CR44c, a fourth comparative fluid passage CR44d, a fifth comparative fluid passage CR44e, a sixth comparative fluid passage CR44f, a seventh comparative fluid passage CR44g, an eighth comparative fluid passage CR44h, a ninth comparative fluid passage CR44j, and a tenth comparative fluid passage CR44k, respectively.

The first comparative fluid passage CR44a to the tenth comparative fluid passage CR44k and the twenty-nine comparative closing portions CR45 are formed in eleven cells in the comparative valve CR40. That is, the first comparative fluid passage CR44a to the tenth comparative fluid passage CR44k and the twenty-nine comparative closing portions CR45 are formed in any of eleven columns when the comparative valve CR40 is divided into eleven columns in the valve circumferential direction DR3.

When the comparative valve CR40 is divided into the five sections in the valve axial direction DR1, the sections are defined as a first-stage section, a second-stage section, a third-stage section, a fourth-stage section, and a fifth-stage section from the first valve axial direction DR1a side toward the second valve axial direction DR1b side. When the valve outer wall portion R42 is divided into eleven sections in the valve circumferential direction DR3, the sections are defined as a first-column section, a second-column section, a third-column section, a fourth-column section, a fifth-column section, a sixth-column section, a seventh-column section, an eighth-column section, a ninth-column section, a tenth-column section, and an eleventh-column section from the first valve circumferential direction DR3a side toward the second valve circumferential direction DR3b side.

The first comparative fluid passage CR44a to the tenth comparative fluid passage CR44k thus defined are in any of the first to fifth stages and have a shape obtained by combining a plurality of sections positioned in any of the first to eleventh columns. The first comparative fluid passage CR44a to the tenth comparative fluid passage CR44k are formed at a position that can face any one of the first opening RP1, the fourth opening RP4, the eighth opening RP8, and the tenth opening RP10, which are the coolant inlets, and can face any one of the second opening RP2, the third opening RP3, the fifth opening RP5, the sixth opening RP6, the seventh opening RP7, and the ninth opening RP9, which are the coolant outlets.

Each of the twenty-nine comparative closing portions CR45 correspond to one section positioned in any one of the first to fifth columns and any one of the first to eleventh columns. The twenty-nine comparative closing portions CR45 are formed at positions where the first comparative fluid passage CR44a to the tenth comparative fluid passage CR44k are not formed. Hereinafter, shapes and formed positions of the first comparative fluid passage CR44a to the tenth comparative fluid passage CR44k will be described using sections.

The first comparative fluid passage CR44a has a shape that combines a first-stage and first-column section and a second-stage and first-column section. The first comparative fluid passage CR44a thus configured can span two openings that are connected in the valve axial direction DR1.

The second comparative fluid passage CR44b has a shape that combines a fourth-stage and first-column section and a fourth-stage and second-column section. The second comparative fluid passage CR44b thus configured can span two openings that are connected in the valve circumferential direction DR3.

The third comparative fluid passage CR44c has a shape that combines a second-stage and fourth-column section and a third-stage and fourth-column section. The third comparative fluid passage CR44c thus configured can span two openings that are connected in the valve axial direction DR1.

The fourth comparative fluid passage CR44d has a shape that combines a first-stage and fifth-column section and a second-stage and fifth-column section. The fourth comparative fluid passage CR44d thus configured can span two openings that are connected in the valve axial direction DR1.

The fifth comparative fluid passage CR44e has a shape that combines a fourth-stage and fifth-column section and a fourth-stage and sixth-column section. The fifth comparative fluid passage CR44e thus configured can span two openings that are connected in the valve circumferential direction DR3.

The sixth comparative fluid passage CR44f has a shape that combines a third-stage and sixth-column section, a fifth-stage and sixth-column section, a third-stage and seventh-column section, a fourth-stage and seventh-column section, and a fifth-stage and seventh-column section. The sixth comparative fluid passage CR44f thus configured can span five openings adjacent to each other in one of the valve axial direction DR1 and the valve circumferential direction DR3.

The seventh comparative fluid passage CR44g has a shape that combines a third-stage and eighth-column section, a second-stage and ninth-column section, and a third-stage and ninth-column section. The seventh comparative fluid passage CR44g thus configured can span three openings adjacent to each other in one of the valve axial direction DR1 and the valve circumferential direction DR3.

The eighth comparative fluid passage CR44h has a shape that combines a fifth-stage and eighth-column section and a fifth-stage and ninth-column section. The eighth comparative fluid passage CR44h thus configured can span two openings that are connected in the valve circumferential direction DR3.

The ninth comparative fluid passage CR44j has a shape that combines a first-stage and tenth-column section, a second-stage and tenth-column section, and a third-stage and tenth-column section. The ninth comparative fluid passage CR44j thus configured can span three openings that are connected in the valve axial direction DR1.

The tenth comparative fluid passage CR44k has a shape that combines a fourth-stage and tenth-column section, a fourth-stage and eleventh-column section, and a fifth-stage and eleventh-column section. The tenth comparative fluid passage CR44k thus configured can span three openings adjacent to each other in one of the valve axial direction DR1 and the valve circumferential direction DR3.

The operation modes when the fluid control valve RV has the comparative valve CR40 will be described with reference to FIGS. 91 to 95. In FIGS. 91 to 95, portions of the first comparative fluid passage CR44a to the tenth comparative fluid passage CR44k facing the first opening RP1 to the tenth opening RP10 in each of the five operation modes are surrounded by a square. FIGS. 91 to 95 illustrate relative positions of the third through hole MD31 and the third communication hole MD32 with respect to the 3-2 flow hole FD32, the 3-3 flow hole FD33, the 3-4 flow hole FD34, and the 3-5 flow hole FD35 of the third fixed disk FD3 in the five operation modes. In FIGS. 91 to 95, in order to make the drawings easy to see, a portion of the third fixed disk FD3 covered by the third communication hole MD32 is hatched.

First, the 3-1 mode will be described. When the operation mode of the temperature control device is set to the 3-1 mode, the comparative valve CR40 is positioned at a rotational position illustrated in FIG. 91. Specifically, when the operation mode is set to the 3-1 mode, the comparative valve CR40 is positioned at a position where the first comparative fluid passage CR44a communicates with the eighth opening RP8 and the ninth opening RP9. The comparative valve CR40 is positioned at a position where the second comparative fluid passage CR44b communicates with the seventh opening RP7 and the tenth opening RP10.

Accordingly, the eighth opening RP8, which is the coolant inlet, communicates with the ninth opening RP9, which is the coolant outlet, via the first comparative fluid passage CR44a. The tenth opening RP10, which is the coolant inlet, communicates with the seventh opening RP7, which is the coolant outlet, via the second comparative fluid passage CR44b. The first opening RP1, the second opening RP2, the third opening RP3, the fourth opening RP4, the fifth opening RP5, and the sixth opening RP6 are closed by the comparative closing portion CR45.

When the operation mode of the temperature control device is set to the 3-1 mode, the third movable disk MD3 is positioned at a position where the third through hole MD31 communicates with the 3-4 flow hole FD34, and the third communication hole MD32 faces the 3-3 flow hole FD33. The 3-2 flow hole FD32 and the 3-5 flow hole FD35 do not face either the third through hole MD31 or the third communication hole MD32.

Accordingly, the 3-1 opening P31 communicates with the 3-4 opening P34 via the third through hole MD31 and the 3-4 flow hole FD34. The 3-3 flow hole FD33 is closed by the third communication hole MD32. Therefore, the 3-3 opening P33 is closed. The 3-2 flow hole FD32 and the 3-5 flow hole FD35 do not communicate with either the third through hole MD31 or the third communication hole MD32, and are closed by the third movable disk MD3. Therefore, the 3-2 opening P32 and the 3-5 opening P35 are closed.

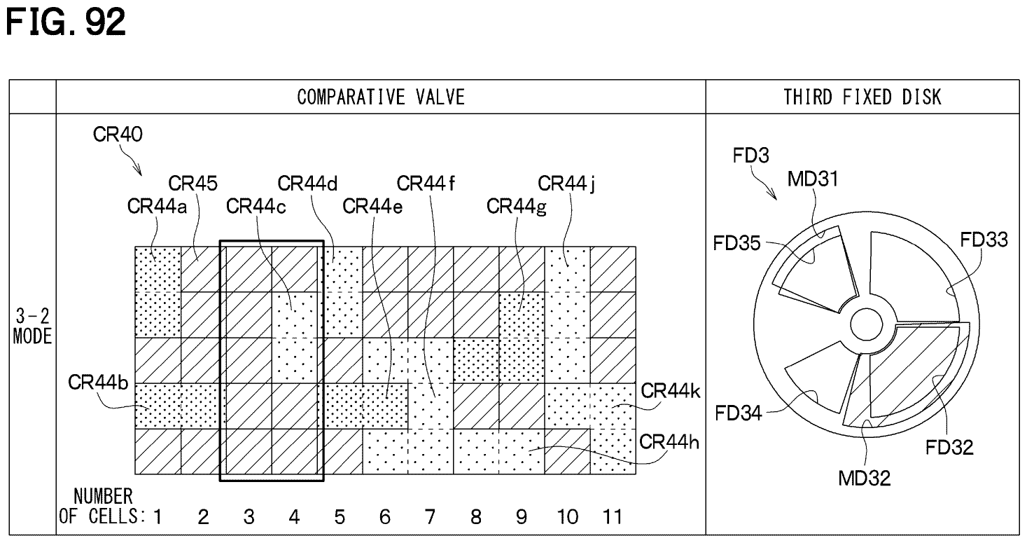

Next, the 3-2 mode will be described. When the operation mode of the temperature control device is set to the 3-2 mode, the comparative valve CR40 is positioned at a rotational position illustrated in FIG. 92. Specifically, when the operation mode is set to the 3-2 mode, the comparative valve CR40 is positioned at a position where the third comparative fluid passage CR44c communicates with the first opening RP1 and the third opening RP3. Accordingly, the first opening RP1, which is the coolant inlet, communicates with the third opening RP3, which is the coolant outlet, via the third comparative fluid passage CR44c. The second opening RP2, the fourth opening RP4, the fifth opening RP5, the sixth opening RP6, the seventh opening RP7, the eighth opening RP8, the ninth opening RP9, and the tenth opening RP10 are closed by the comparative closing portion CR45.

When the operation mode of the temperature control device is set to the 3-2 mode, the third movable disk MD3 is positioned at a position where the third through hole MD31 communicates with the 3-5 flow hole FD35, and the third communication hole MD32 faces the 3-2 flow hole FD32. The 3-3 flow hole FD33 and the 3-4 flow hole FD34 do not face either the third through hole MD31 or the third communication hole MD32.

Accordingly, the 3-1 opening P31 communicates with the 3-5 opening P35 via the third through hole MD31 and the 3-5 flow hole FD35. The 3-2 flow hole FD32 is closed by the third communication hole MD32. Therefore, the 3-2 opening P32 is closed. The 3-3 flow hole FD33 and the 3-4 flow hole FD34 do not communicate with either the third through hole MD31 or the third communication hole MD32, and are closed by the third movable disk MD3. Therefore, the 3-3 opening P33 and the 3-4 opening P34 are closed.

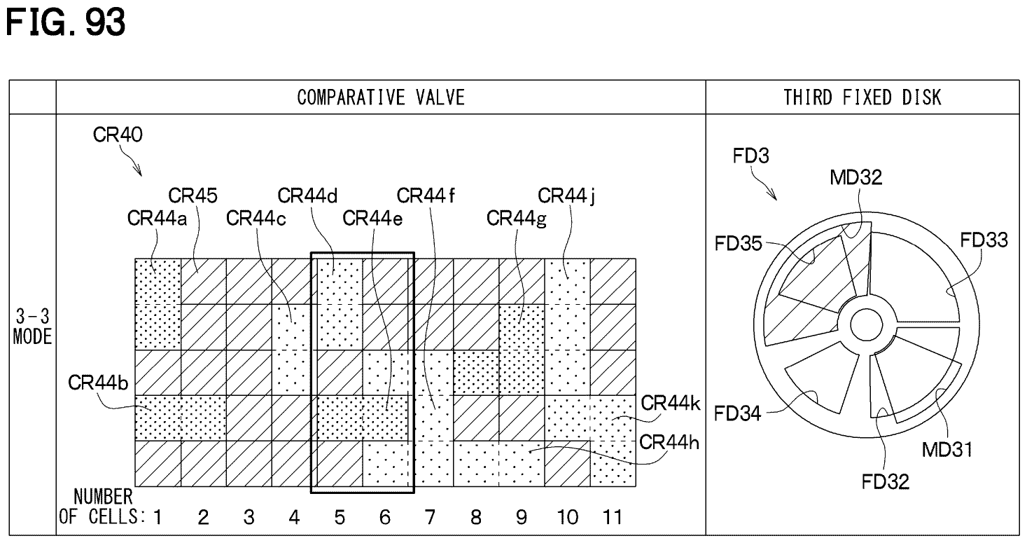

Next, the 3-3 mode will be described. When the operation mode of the temperature control device is set to the 3-3 mode, the comparative valve CR40 is positioned at a rotational position illustrated in FIG. 93. Specifically, when the operation mode is set to the 3-3 mode, the comparative valve CR40 is positioned at a position where the fourth comparative fluid passage CR44d communicates with the eighth opening RP8 and the ninth opening RP9. The comparative valve CR40 is positioned at a position where the fifth comparative fluid passage CR44e communicates with the seventh opening RP7 and the tenth opening RP10. When the operation mode is set to the 3-3 mode, the comparative valve CR40 is positioned at a position where the sixth comparative fluid passage CR44f communicates with the third opening RP3 and the fourth opening RP4.

Accordingly, the eighth opening RP8, which is the coolant inlet, communicates with the ninth opening RP9, which is the coolant outlet, via the fourth comparative fluid passage CR44d. The tenth opening RP10, which is the coolant inlet, communicates with the seventh opening RP7, which is the coolant outlet, via the fifth comparative fluid passage CR44e. The fourth opening RP4, which is the coolant inlet, communicates with the third opening RP3, which is the coolant outlet, via a portion of the sixth comparative fluid passage CR44f that does not face the first opening RP1 to the tenth opening RP10. The first opening RP1, the second opening RP2, the fifth opening RP5, and the sixth opening RP6 are closed by the comparative closing portion CR45.

When the operation mode of the temperature control device is set to the 3-3 mode, the third movable disk MD3 is positioned at a position where the third through hole MD31 communicates with the 3-2 flow hole FD32, and the third communication hole MD32 faces the 3-5 flow hole FD35. The 3-3 flow hole FD33 and the 3-4 flow hole FD34 do not face either the third through hole MD31 or the third communication hole MD32.

Accordingly, the 3-1 opening P31 communicates with the 3-2 opening P32 via the third through hole MD31 and the 3-2 flow hole FD32. The 3-5 flow hole FD35 is closed by the third communication hole MD32. Therefore, the 3-5 opening P35 is closed. The 3-3 flow hole FD33 and the 3-4 flow hole FD34 do not communicate with either the third through hole MD31 or the third communication hole MD32, and are closed by the third movable disk MD3. Therefore, the 3-3 opening P33 and the 3-4 opening P34 are closed.

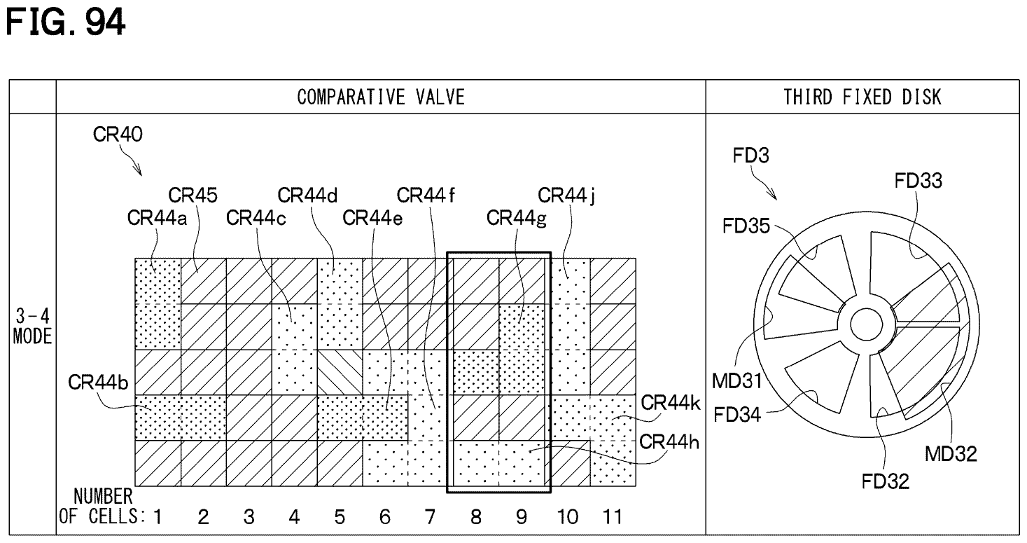

Next, the 3-4 mode will be described. When the operation mode of the temperature control device is set to the 3-4 mode, the comparative valve CR40 is positioned at a rotational position illustrated in FIG. 94. Specifically, when the operation mode is set to the 3-4 mode, the comparative valve CR40 is positioned at a position where the seventh comparative fluid passage CR44g communicates with the first opening RP1, the third opening RP3, and the sixth opening RP6. The comparative valve CR40 is positioned at a position where the eighth comparative fluid passage CR44h communicates with the second opening RP2 and the fourth opening RP4.

Accordingly, the first opening RP1, which is the coolant inlet, communicates with the third opening RP3 and the sixth opening RP6, which are the coolant outlets, via the seventh comparative fluid passage CR44g. The fourth opening RP4, which is the coolant inlet, communicates with the second opening RP2, which is the coolant outlet, via the eighth comparative fluid passage CR44h. The fifth opening RP5, the seventh opening RP7, the eighth opening RP8, the ninth opening RP9, and the tenth opening RP10 are closed by the comparative closing portion CR45.

When the operation mode of the temperature control device is set to the 3-4 mode, the third movable disk MD3 is positioned at a position where the third through hole MD31 communicates with the 3-5 flow hole FD35. The third movable disk MD3 is positioned at a position where the third communication hole MD32 communicates with the 3-2 flow hole FD32 and the 3-3 flow hole FD33. The 3-4 flow hole FD34 does not face either the third through hole MD31 or the third communication hole MD32.

Accordingly, the 3-1 opening P31 communicates with the 3-5 opening P35 via the third through hole MD31 and the 3-5 flow hole FD35. The 3-3 opening P33 communicates with the 3-2 opening P32 via the 3-3 flow hole FD33, the third communication hole MD32, and the 3-2 flow hole FD32. The 3-4 flow hole FD34 does not communicate with either the third through hole MD31 or the third communication hole MD32, and is closed by the third movable disk MD3. Therefore, the 3-4 opening P34 is closed.

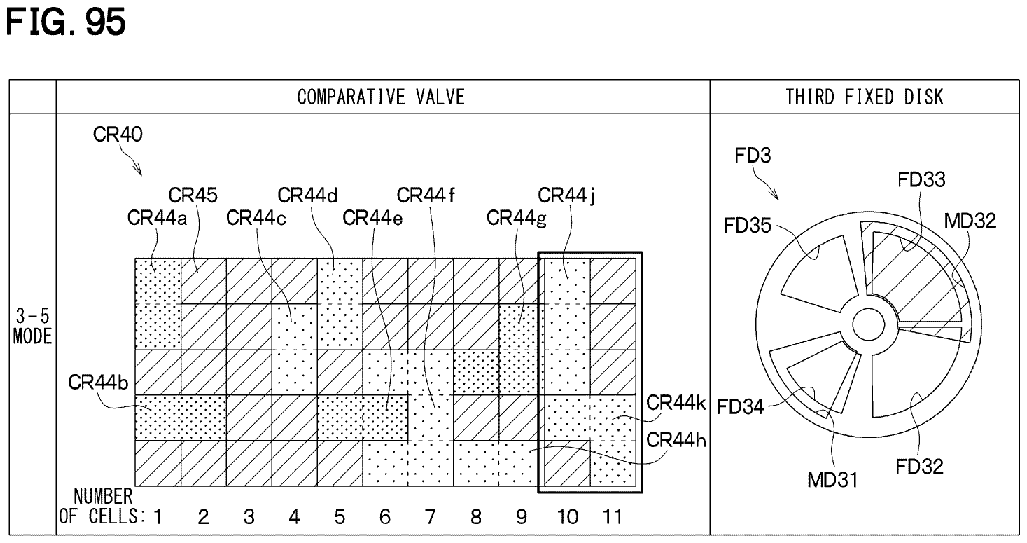

Next, the 3-5 mode will be described. When the operation mode of the temperature control device is set to the 3-5 mode, the comparative valve CR40 is positioned at a rotational position illustrated in FIG. 95. Specifically, when the operation mode is set to the 3-5 mode, the comparative valve CR40 is positioned at a position where the ninth comparative fluid passage CR44j communicates with the sixth opening RP6, the eighth opening RP8, and the ninth opening RP9. The comparative valve CR40 is positioned at a position where the tenth comparative fluid passage CR44k communicates with the fourth opening RP4, the seventh opening RP7, and the tenth opening RP10.

Accordingly, the eighth opening RP8, which is the coolant inlet, communicates with the sixth opening RP6 and the ninth opening RP9, which are the coolant outlets, via the ninth comparative fluid passage CR44j. The fourth opening RP4 and the tenth opening RP10, which are the coolant inlets, communicate with the seventh opening RP7, which is the coolant outlet, via the tenth comparative fluid passage CR44k. The first opening RP1, the second opening RP2, the third opening RP3, and the fifth opening RP5 are closed by the comparative closing portion CR45.

When the operation mode of the temperature control device is set to the 3-5 mode, the third movable disk MD3 is positioned at a position where the third through hole MD31 communicates with the 3-4 flow hole FD34. The third movable disk MD3 is positioned at a position where the third communication hole MD32 communicates with the 3-2 flow hole FD32 and the 3-3 flow hole FD33. The 3-5 flow hole FD35 does not face either the third through hole MD31 or the third communication hole MD32.

Accordingly, the 3-1 opening P31 communicates with the 3-4 opening P34 via the third through hole MD31 and the 3-4 flow hole FD34. The 3-3 opening P33 communicates with the 3-2 opening P32 via the 3-3 flow hole FD33, the third communication hole MD32, and the 3-2 flow hole FD32. The 3-5 flow hole FD35 does not communicate with either the third through hole MD31 or the third communication hole MD32, and is closed by the third movable disk MD3. Therefore, the 3-5 opening P35 is closed.

Thus, even when the fluid circuit system 1 includes the fluid control valve RV having the comparative valve CR40, it is possible to cope with the five operation modes of the temperature control device. When the fluid control valve RV is in the closed configuration, the number of cells of the comparative valve CR40 is more than the number of cells of the valve R40. Specifically, the comparative valve CR40 has eleven cells while the valve R40 has six cells.

In this case, when an outer diameter of the comparative valve CR40 is equal to an outer diameter of the valve R40, a size of the cell of the comparative valve CR40 in the valve circumferential direction DR3 is smaller than a size of the cell of the valve R40 in the valve circumferential direction DR3. Flow paths of the first comparative fluid passage CR44a to the tenth comparative fluid passage CR44k formed in the comparative valve CR40 may be smaller than flow paths of the first fluid passage R44a to the sixth fluid passage R44f formed in the valve R40.

The size of the cell of the comparative valve CR40 in the valve circumferential direction DR3 and the size of the cell of the valve R40 in the valve circumferential direction DR3 correspond to a size of the first opening RP1 to the tenth opening RP10 in the valve circumferential direction DR3. Therefore, in the fluid control valve RV having the comparative valve CR40, an opening area of each of the first opening RP1 to the tenth opening RP10 is smaller than that of the fluid control valve RV having the valve R40.

In this case, a pressure loss that occurs when the coolant flows through the fluid control valve RV having the comparative valve CR40 may be larger than a pressure loss that occurs when the coolant flows through the fluid control valve RV having the valve R40. A pressure loss that occurs when the coolant passes through the first opening RP1 to the tenth opening RP10 may be larger in the fluid control valve RV having the comparative valve CR40 than in the fluid control valve RV having the valve R40.

Such an increase in the pressure loss leads to an increase in a pressure loss in the entire fluid circuit system 1, and is therefore undesirable.

When the outer diameter of the comparative valve CR40 is made larger than the outer diameter of the valve R40 in order to prevent an increase in pressure loss, a housing of the fluid control valve RV itself becomes larger. An increase in the size of the housing of the fluid control valve RV causes an increase in production cost of the fluid control valve RV and increases production cost of the entire fluid circuit system 1, which is undesirable. Further, an increase in the size of the housing of the fluid control valve RV is undesirable because the increase in the size of the housing of the fluid control valve RV causes deterioration in mountability when mounting the fluid control valve RV on a vehicle, such as restricting an installation position or requiring a large installation space.

Thus, there are various problems when the fluid circuit system 1 is configured to close all the unnecessary inlets and the unnecessary outlets of the fluid control valve RV when the temperature control device executes the five operation modes.

In contrast, the fluid circuit system 1 according to the present embodiment is not necessarily configured to close the unnecessary inlet and the unnecessary outlet of the fluid control valve RV. That is, the fluid circuit system 1 according to the present embodiment has a configuration in which the state of the unnecessary inlet and the unnecessary outlet of the fluid control valve RV may be either an open state or a closed state.

In the fluid circuit system 1, a configuration of the fluid control valve RV is a configuration for preventing the coolant from flowing into the connection device that does not require the coolant to flow in each of the five operation modes. Specifically, in the fluid circuit system 1 according to the present embodiment, the valve R40 of the fluid control valve RV is different from a configuration of the comparative valve CR40.

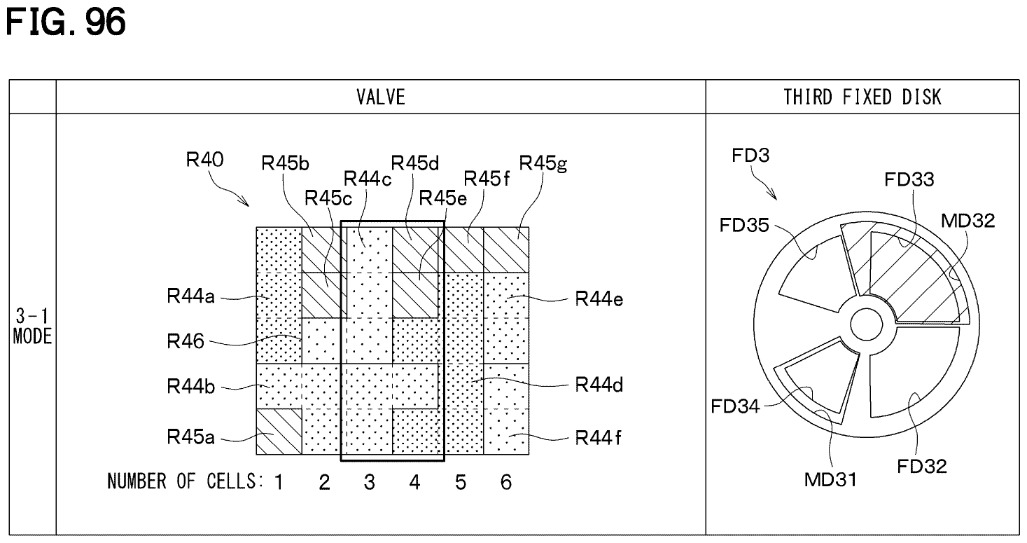

The fluid circuit system 1 including the fluid control valve RV and the third multi-way valve MV3 having such a different configuration will be described with reference to FIGS. 96 to 105. Since the configuration of the third multi-way valve MV3 is the same as that of the comparative example described above, detailed description of an operation of the third multi-way valve MV3 in each operation mode will be omitted.

First, the 3-1 mode will be described. When the operation mode of the temperature control device is set to the 3-1 mode, the third movable disk MD3 is positioned at a rotational position illustrated in FIG. 96. Accordingly, the 3-1 opening P31 communicates with the 3-4 opening P34 via the third through hole MD31 and the 3-4 flow hole FD34. The 3-2 opening P32, the 3-3 opening P33, and the 3-5 opening P35 are closed.

When the operation mode of the temperature control device is set to the 3-1 mode, the valve R40 is positioned at a position where the second fluid passage R44b communicates with the second opening RP2, the seventh opening RP7, and the tenth opening RP10. When the operation mode is set to the 3-1 mode, the valve R40 is positioned at a position where the third fluid passage R44c communicates with the sixth opening RP6, the eighth opening RP8, and the ninth opening RP9, and the fourth fluid passage R44d communicates with the third opening RP3 and the fourth opening RP4.

Accordingly, the tenth opening RP10, which is the coolant inlet, communicates with the second opening RP2 and the seventh opening RP7, which are the coolant outlets, via the second fluid passage R44b. The eighth opening RP8, which is a coolant inlet, communicates with the sixth opening RP6 and the ninth opening RP9, which are coolant outlets, via the third fluid passage R44c. The fourth opening RP4, which is the coolant inlet, communicates with the third opening RP3, which is the coolant outlet, via the fourth fluid passage R44d. The third opening RP3 and the fourth opening RP4 communicate with each other via a portion of the fourth fluid passage R44d not facing the first opening RP1 to the tenth opening RP10 on the second valve circumferential direction DR3b side.

The first opening RP1 is closed by the fifth closing portion R45e. The fifth opening RP5 is closed by the fourth closing portion R45d.

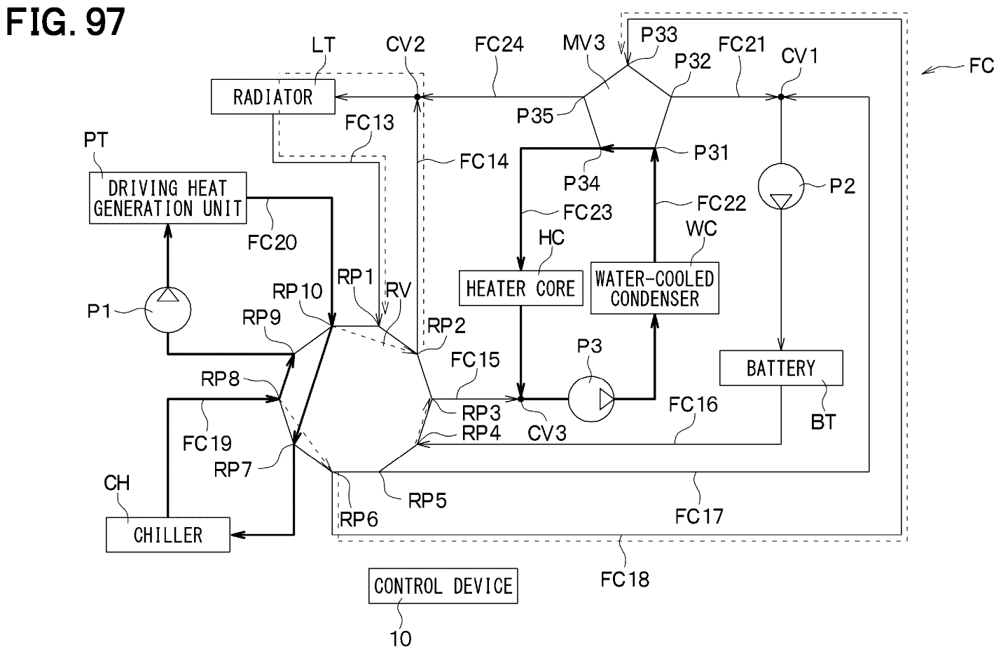

A flow of the coolant in the fluid circuit FC when the open and closed states of the coolant inlet and the coolant outlet of the fluid control valve RV are set in this manner will be described with reference to FIG. 97.

As described above, in the 3-1 mode, the fluid circuit system 1 allows the tenth opening RP10 of the fluid control valve RV to communicate with the seventh opening RP7, and allows the eighth opening RP8 to communicate with the ninth opening RP9. Accordingly, the fluid circuit system 1 can circulate the coolant through the RP9-RP10 flow path FC20 and the RP7-RP8 flow path FC19 by operating the first pump P1. The fluid circuit system 1 can guide the coolant to the chiller CH and the driving heat generation unit PT.

In the 3-1 mode, the fluid circuit system 1 allows the 3-1 opening P31 of the third multi-way valve MV3 to communicate with the 3-4 opening P34. Accordingly, the fluid circuit system 1 can circulate the coolant through the P31-CV3 flow path FC22 and the P34-CV3 flow path FC23 by operating the third pump P3. The fluid circuit system 1 can guide the coolant to the water-cooled condenser WC and the heater core HC.

In the fluid circuit system 1 according to the present embodiment, the tenth opening RP10 of the fluid control valve RV communicates with the second opening RP2, which is the unnecessary outlet, and the eighth opening RP8 of the fluid control valve RV communicates with the sixth opening RP6, which is the unnecessary outlet. In the fluid circuit system 1, the fourth opening RP4, which is the unnecessary inlet of the fluid control valve RV, communicates with the third opening RP3, which is the unnecessary outlet.

In this case, the coolant pumped by the first pump P1 may flow through the RP2-CV2 flow path FC14 and the CV2-RP1 flow path FC13, and may flow into the radiator LT that does not require the coolant to flow. The coolant pumped by the first pump P1 may flow through the RP6-P33 flow path FC18, the P32-CV1 flow path FC21, and the CV1-RP4 flow path FC16, and the battery BT into which the coolant need not flow.

In contrast, in the fluid circuit system 1 according to the present embodiment, in the 3-1 mode, the first opening RP1 of the fluid control valve RV connected to a downstream side of a refrigerant flow of the CV2-RP1 flow path FC13 in which the radiator LT is disposed is closed by the fifth closing portion R45e. Therefore, it is possible to prevent the coolant pumped by the first pump P1 from flowing through the RP2-CV2 flow path FC14 and the CV2-RP1 flow path FC13 to the radiator LT. That is, the fluid circuit system 1 can prohibit a flow of the coolant that may pass through the unnecessary inlet in the open state in the fluid control valve RV by the unnecessary inlet in the closed state thereof.

In the fluid circuit system 1 according to the present embodiment, in the 3-1 mode, the 3-3 opening P33 of the third multi-way valve MV3 connected to a downstream side of a refrigerant flow of the RP6-P33 flow path FC18 is closed by the third movable disk MD3. Therefore, it is possible to prevent the coolant pumped by the first pump P1 from flowing through the RP6-P33 flow path FC18, the P32-CV1 flow path FC21, and the CV1-RP4 flow path FC16 to the battery BT. That is, the fluid circuit system 1 can prohibit a flow of the coolant that may pass through the unnecessary outlet in the open state in the fluid control valve RV by closing the 3-3 opening P33 of the third multi-way valve MV3.

In the fluid circuit system 1 according to the present embodiment, the fourth opening RP4, which is the unnecessary inlet of the fluid control valve RV, communicates with the third opening RP3, which is the unnecessary outlet. However, a circuit formed by the P31-CV3 flow path FC22 and the P34-CV3 flow path FC23 to which the third opening RP3 is connected via the RP3-CV3 flow path FC15 is a closed circuit. Therefore, the coolant does not flow from the third opening RP3 to the RP3-CV3 flow path FC15, and the coolant does not flow from the RP3-CV3 flow path FC15 to the third opening RP3.

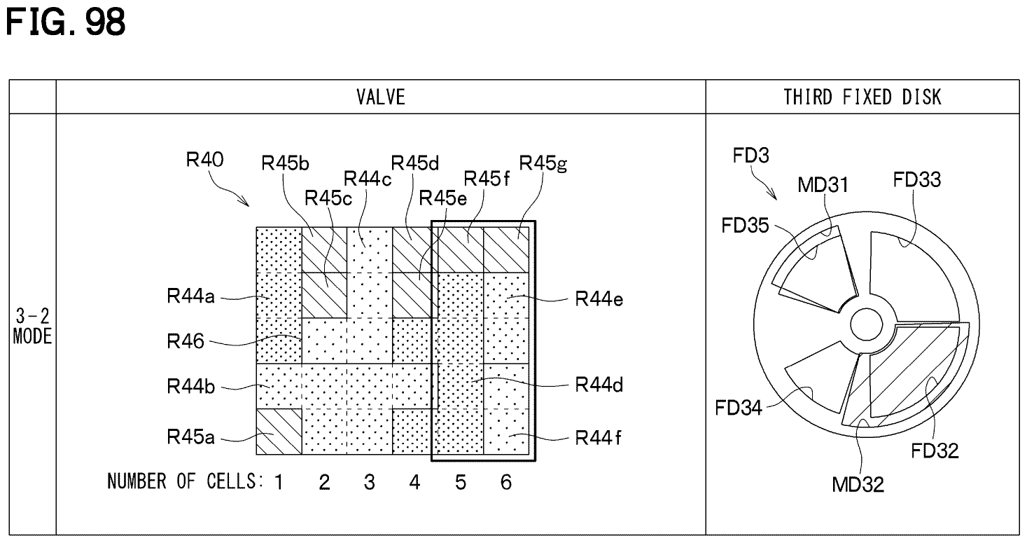

Next, the 3-2 mode will be described. When the operation mode of the temperature control device is set to the 3-2 mode, the third movable disk MD3 is positioned at a rotational position illustrated in FIG. 98. Accordingly, the 3-1 opening P31 communicates with the 3-5 opening P35 via the third through hole MD31 and the 3-5 flow hole FD35. The 3-2 opening P32, the 3-3 opening P33, and the 3-4 opening P34 are closed.

When the operation mode of the temperature control device is set to the 3-2 mode, the fourth fluid passage R44d of the valve R40 communicates with the second opening RP2, the sixth opening RP6, the eighth opening RP8, and the tenth opening RP10. When the operation mode is set to the 3-2 mode, the valve R40 is positioned at a position where the fifth fluid passage R44e communicates with the first opening RP1 and the third opening RP3 and the sixth fluid passage R44f communicates with the fourth opening RP4 and the seventh opening RP7.

Accordingly, the eighth opening RP8 and the tenth opening RP10, which are coolant inlets, communicate with the second opening RP2 and the sixth opening RP6, which are coolant outlets, via the fourth fluid passage R44d. The first opening RP1, which is the coolant inlet, communicates with the third opening RP3, which is the coolant outlet, via the fifth fluid passage R44e. The fourth opening RP4, which is the coolant inlet, communicates with the seventh opening RP7, which is the coolant outlet, via the sixth fluid passage R44f.

The ninth opening RP9 is closed by the sixth closing portion R45f. The fifth opening RP5 is closed by the seventh closing portion R45g.

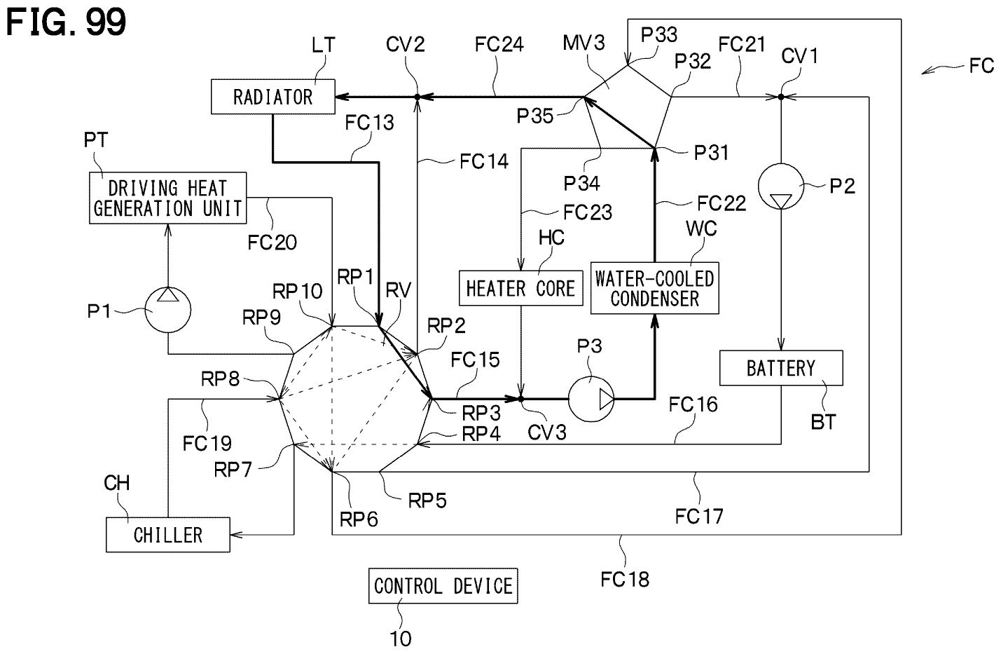

A flow of the coolant in the fluid circuit FC when the open and closed states of the coolant inlet and the coolant outlet of the fluid control valve RV are set in this manner will be described with reference to FIG. 99.

As described above, in the 3-2 mode, the fluid circuit system 1 allows the first opening RP1 of the fluid control valve RV to communicate with the third opening RP3, and allows the 3-1 opening P31 of the third multi-way valve MV3 to communicate with the 3-5 opening P35. Accordingly, the fluid circuit system 1 can circulate the coolant through the P31-CV3 flow path FC22, the P35-CV2 flow path FC24, the CV2-RP1 flow path FC13, and the RP3-CV3 flow path FC15 by operating the third pump P3. The fluid circuit system 1 can guide the coolant to the water-cooled condenser WC and the radiator LT.

In the fluid circuit system 1 according to the present embodiment, the eighth opening RP8 and the tenth opening RP10, which are unnecessary inlets of the fluid control valve RV, communicate with the second opening RP2 and the sixth opening RP6, which are unnecessary outlets. In the fluid circuit system 1, the fourth opening RP4, which is the unnecessary inlet of the fluid control valve RV, communicates with the seventh opening RP7, which is the unnecessary outlet. In this case, the coolant pumped by the first pump P1 and the second pump P2 may flow through the RP9-RP10 flow path FC20 and the RP7-RP8 flow path FC19, and may flow into the driving heat generation unit PT and the chiller CH that do not require the coolant to flow. The coolant pumped by the first pump P1 and the second pump P2 may flow through the RP6-P33 flow path FC18, the P32-CV1 flow path FC21, and the CV1-RP4 flow path FC16, and may flow into the battery BT that does not require the coolant to flow.

In contrast, the fluid circuit system 1 according to the present embodiment does not operate the first pump P1 and the second pump P2 in the 3-2 mode. Therefore, the eighth opening RP8 and the tenth opening RP10 of the fluid control valve RV communicate with the second opening RP2 and the sixth opening RP6, and the fourth opening RP4 communicates with the seventh opening RP7, so that a circuit including the RP9-RP10 flow path FC20 in which the driving heat generation unit PT is disposed and the RP7-RP8 flow path FC19 in which the chiller CH is disposed enables circulation of the coolant. Even in this case, the coolant does not flow into the driving heat generation unit PT and the chiller CH. Since the fourth opening RP4 of the fluid control valve RV communicates with the seventh opening RP7, even when the circuit including the CV1-RP4 flow path FC16 in which the battery BT is disposed enables circulation of the coolant, the coolant does not flow into the battery BT. That is, the fluid circuit system 1 can open the unnecessary inlet and the unnecessary outlet that communicate circuits in which the first pump P1 and the second pump P2, which do not operate in the 3-2 mode, are disposed.

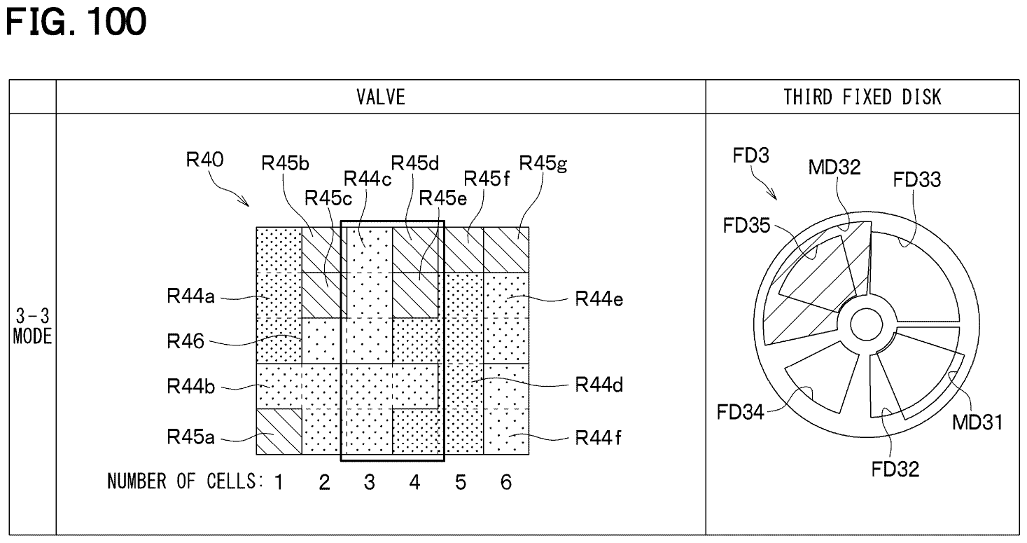

Next, the 3-3 mode will be described. When the operation mode of the temperature control device is set to the 3-3 mode, the third movable disk MD3 is positioned at a rotational position illustrated in FIG. 100. Accordingly, the 3-1 opening P31 communicates with the 3-2 opening P32 via the third through hole MD31 and the 3-2 flow hole FD32. The 3-3 opening P33, the 3-4 opening P34, and the 3-5 opening P35 are closed.

When the operation mode of the temperature control device is set to the 3-3 mode, the valve R40 is positioned at a position where the second fluid passage R44b communicates with the second opening RP2, the seventh opening RP7, and the tenth opening RP10. When the operation mode is set to the 3-3 mode, the valve R40 is positioned at a position where the third fluid passage R44c communicates with the sixth opening RP6, the eighth opening RP8, and the ninth opening RP9, and the fourth fluid passage R44d communicates with the third opening RP3 and the fourth opening RP4.

Accordingly, the tenth opening RP10, which is the coolant inlet, communicates with the second opening RP2 and the seventh opening RP7, which are the coolant outlets, via the second fluid passage R44b. The eighth opening RP8, which is a coolant inlet, communicates with the sixth opening RP6 and the ninth opening RP9, which are coolant outlets, via the third fluid passage R44c. The fourth opening RP4, which is the coolant inlet, communicates with the third opening RP3, which is the coolant outlet, via the fourth fluid passage R44d. The third opening RP3 and the fourth opening RP4 communicate with each other via the portion of the fourth fluid passage R44d not facing the first opening RP1 to the tenth opening RP10 on the second valve circumferential direction DR3b side.

The first opening RP1 is closed by the fifth closing portion R45e. The fifth opening RP5 is closed by the fourth closing portion R45d.

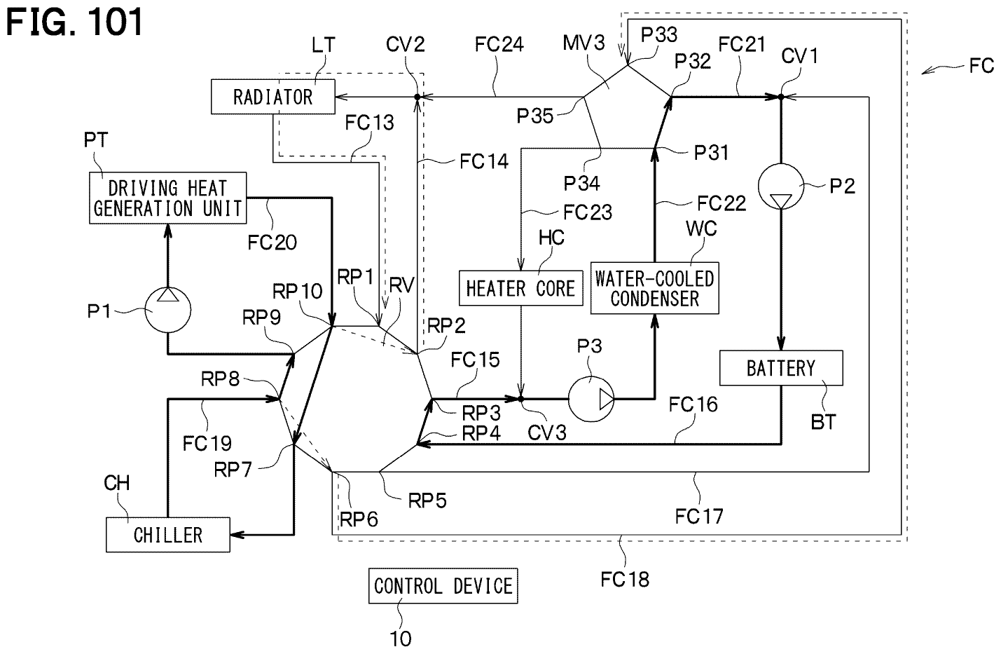

A flow of the coolant in the fluid circuit FC when the open and closed states of the coolant inlet and the coolant outlet of the fluid control valve RV are set in this manner will be described with reference to FIG. 101.

As described above, in the 3-3 mode, the fluid circuit system 1 allows the tenth opening RP10 of the fluid control valve RV to communicate with the seventh opening RP7, and allows the eighth opening RP8 to communicate with the ninth opening RP9. Accordingly, the fluid circuit system 1 can circulate the coolant through the RP9-RP10 flow path FC20 and the RP7-RP8 flow path FC19 by operating the first pump P1. The fluid circuit system 1 can guide the coolant to the chiller CH and the driving heat generation unit PT.

In the 3-3 mode, the fluid circuit system 1 allows the fourth opening RP4 of the fluid control valve RV to communicate with the third opening RP3, and allows the 3-1 opening P31 of the third multi-way valve MV3 to communicate with the 3-2 opening P32. Accordingly, the fluid circuit system 1 can circulate the coolant through the P31-CV3 flow path FC22, the P32-CV1 flow path FC21, the CV1-RP4 flow path FC16, and the RP3-CV3 flow path FC15 by operating the second pump P2 and the third pump P3. The fluid circuit system 1 can guide the coolant to the water-cooled condenser WC and the battery BT.

In the fluid circuit system 1 according to the present embodiment, the tenth opening RP10 of the fluid control valve RV communicates with the second opening RP2, which is the unnecessary outlet, and the eighth opening RP8 of the fluid control valve RV communicates with the sixth opening RP6, which is the unnecessary outlet. In this case, the coolant pumped by the first pump P1 may flow through the RP2-CV2 flow path FC14 and the CV2-RP1 flow path FC13, and may flow into the radiator LT that does not require the coolant to flow. The coolant pumped by the first pump P1 and the second pump P2 may flow through the RP6-P33 flow path FC18, the P32-CV1 flow path FC21, and the CV1-RP4 flow path FC16, and may flow into the battery BT that does not require the coolant to flow.

In contrast, in the fluid circuit system 1 according to the present embodiment, in the 3-3 mode, the first opening RP1 of the fluid control valve RV connected to the downstream side of the refrigerant flow of the CV2-RP1 flow path FC13 in which the radiator LT is disposed is closed by the fifth closing portion R45e. Therefore, it is possible to prevent the coolant pumped by the first pump P1 from flowing through the RP2-CV2 flow path FC14 and the CV2-RP1 flow path FC13 to the radiator LT. That is, the fluid circuit system 1 can prohibit a flow of the coolant that may pass through the unnecessary inlet in the open state in the fluid control valve RV by the unnecessary outlet in the closed state thereof.

In the fluid circuit system 1 according to the present embodiment, in the 3-3 mode, the 3-3 opening P33 of the third multi-way valve MV3 connected to the downstream side of the refrigerant flow of the RP6-P33 flow path FC18 is closed by the third movable disk MD3. Therefore, the coolant pumped by the first pump P1 can be prohibited from flowing through the RP6-P33 flow path FC18, the P32-CV1 flow path FC21, and the CV1-RP4 flow path FC16 to the battery BT that does not require the coolant to flow.

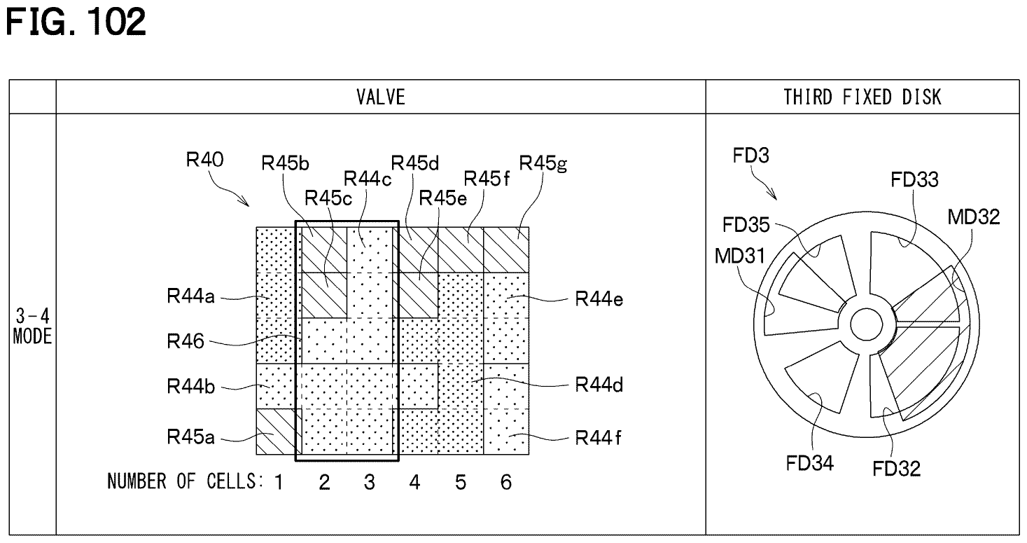

Next, the 3-4 mode will be described. When the operation mode of the temperature control device is set to the 3-4 mode, the third movable disk MD3 is positioned at a rotational position illustrated in FIG. 102. Accordingly, the 3-1 opening P31 communicates with the 3-5 opening P35 via the third through hole MD31 and the 3-5 flow hole FD35. The 3-3 opening P33 communicates with the 3-2 opening P32 via the 3-3 flow hole FD33, the third communication hole MD32, and the 3-2 flow hole FD32. The 3-4 opening P34 is closed.

When the operation mode of the temperature control device is set to the 3-4 mode, the valve R40 is positioned at a position where the second fluid passage R44b communicates with the second opening RP2, the fourth opening RP4, the seventh opening RP7, and the tenth opening RP10. When the operation mode is set to the 3-4 mode, the valve R40 is positioned at a position where the third fluid passage R44c communicates with the first opening RP1, the third opening RP3, the fifth opening RP5, and the sixth opening RP6.

Accordingly, the fourth opening RP4 and the tenth opening RP10, which are coolant inlets, communicate with the second opening RP2 and the seventh opening RP7, which are coolant outlets, via the second fluid passage R44b. The first opening RP1, which is the coolant inlet, communicates with the third opening RP3, the fifth opening RP5, and the sixth opening RP6, which are the coolant outlets, via the third fluid passage R44c.

The eighth opening RP8 is closed by the third closing portion R45c. The ninth opening RP9 is closed by the second closing portion R45b.

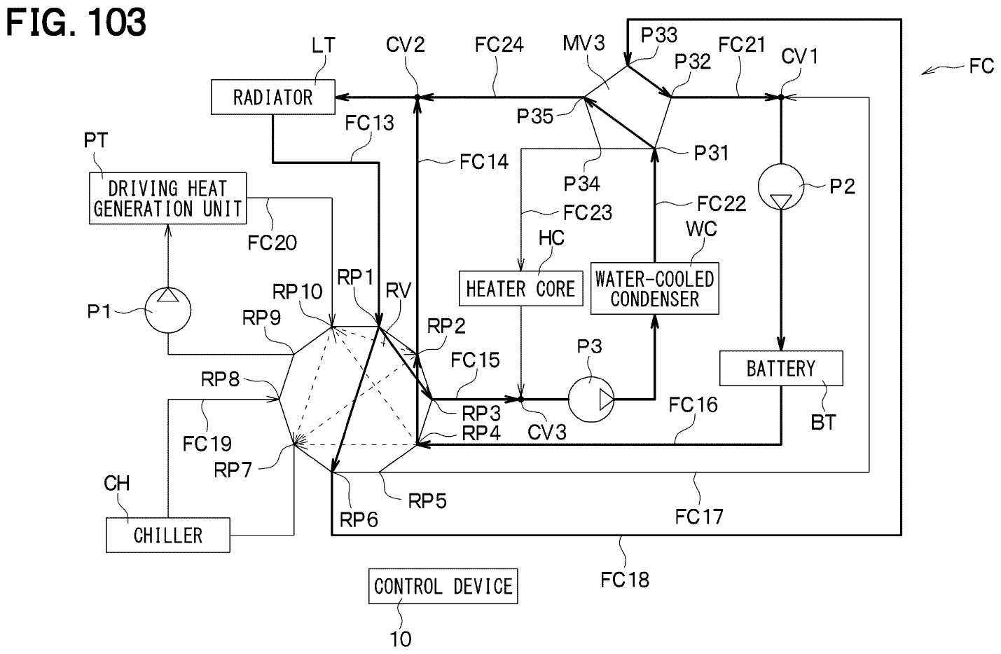

A flow of the coolant in the fluid circuit FC when the open and closed states of the coolant inlet and the coolant outlet of the fluid control valve RV are set in this manner will be described with reference to FIG. 103.

As described above, in the 3-4 mode, the fluid circuit system 1 allows the first opening RP1 of the fluid control valve RV to communicate with the third opening RP3 and the sixth opening RP6, and allows the fourth opening RP4 to communicate with the second opening RP2. In the fluid circuit system 1, the 3-1 opening P31 of the third multi-way valve MV3 communicates with the 3-5 opening P35, and the 3-3 opening P33 communicates with the 3-2 opening P32. Accordingly, the fluid circuit system 1 can circulate the coolant through the P31-CV3 flow path FC22, the P35-CV2 flow path FC24, the CV2-RP1 flow path FC13, the RP3-CV3 flow path FC15, the RP6-P33 flow path FC18, the P32-CV1 flow path FC21, the CV1-RP4 flow path FC16, and the RP2-CV2 flow path FC14 by operating the second pump P2 and the third pump P3. The fluid circuit system 1 can guide the coolant to the water-cooled condenser WC, the radiator LT, and the battery BT.

In the fluid circuit system 1 according to the present embodiment, the fourth opening RP4 of the fluid control valve RV communicates with the seventh opening RP7 which is the unnecessary outlet. In the fluid circuit system 1, the tenth opening RP10, which is the unnecessary inlet of the fluid control valve RV, communicates with the second opening RP2 and the seventh opening RP7, which is the unnecessary outlet. In this case, the coolant pumped by the first pump P1 may flow through the RP9-RP10 flow path FC20 and the RP7-RP8 flow path FC19, and may flow into the driving heat generation unit PT and the chiller CH that do not require the coolant to flow.

In contrast, the fluid circuit system 1 according to the present embodiment does not need to operate the first pump P1 in the 3-4 mode. Therefore, the fourth opening RP4 of the fluid control valve RV communicates with the seventh opening RP7, and the tenth opening RP10 communicates with the second opening RP2 and the seventh opening RP7, so that the circuit including the RP9-RP10 flow path FC20 in which the driving heat generation unit PT is disposed and the RP7-RP8 flow path FC19 in which the chiller CH is disposed enables circulation of the coolant. Even in this case, the coolant does not flow into the driving heat generation unit PT and the chiller CH. That is, the fluid circuit system 1 can open the unnecessary inlet and the unnecessary outlet that communicate with the circuit in which the first pump P1, which does not operate in the 3-4 mode, is disposed.

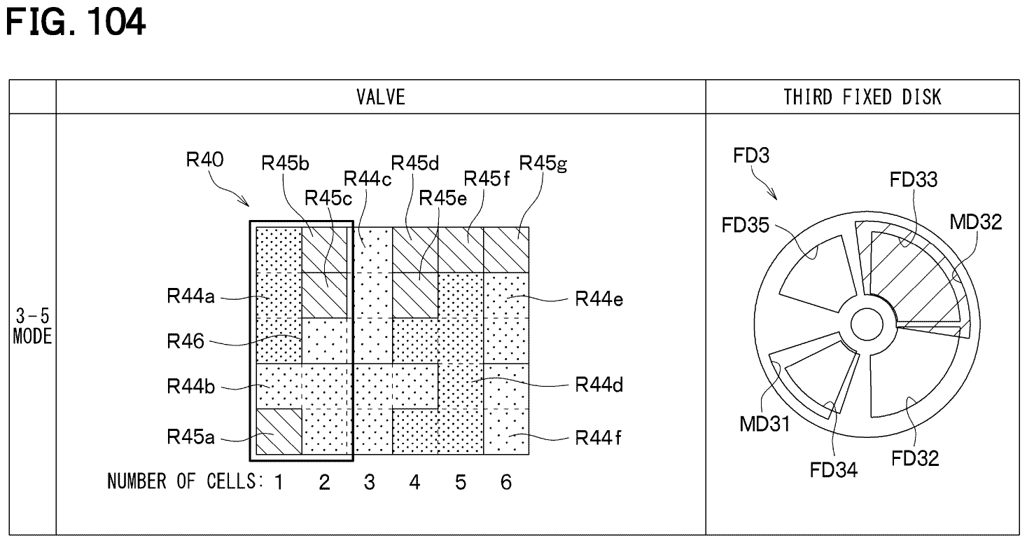

Next, the 3-5 mode will be described. When the operation mode of the temperature control device is set to the 3-5 mode, the third movable disk MD3 is positioned at a rotational position illustrated in FIG. 104. Accordingly, the 3-1 opening P31 communicates with the 3-4 opening P34 via the third through hole MD31 and the 3-4 flow hole FD34. The 3-3 opening P33 communicates with the 3-2 opening P32 via the 3-3 flow hole FD33, the third communication hole MD32, and the 3-2 flow hole FD32. The 3-4 opening P34 is closed.

When the operation mode of the temperature control device is set to the 3-5 mode, the valve R40 is positioned at a position where the first fluid passage R44a communicates with the sixth opening RP6, the eighth opening RP8, and the ninth opening RP9. When the operation mode is set to the 3-5 mode, the valve R40 is positioned at a position where the second fluid passage R44b communicates with the fourth opening RP4, the seventh opening RP7, and the tenth opening RP10. When the operation mode is set to the 3-5 mode, the valve R40 is positioned at a position where the third fluid passage R44c communicates with the third opening RP3.

Accordingly, the eighth opening RP8, which is the coolant inlet, communicates with the sixth opening RP6 and the ninth opening RP9, which are the coolant outlets, via the first fluid passage R44a. The fourth opening RP4 and the tenth opening RP10, which are the coolant inlets, communicate with the seventh opening RP7, which is the coolant outlet, via the second fluid passage R44b.

The first opening RP1 is closed by the third closing portion R45c. The second opening RP2 is closed by the first closing portion R45a. The third opening RP3 is closed by the second fluid passage R44b. The fifth opening RP5 is closed by the second closing portion R45b.

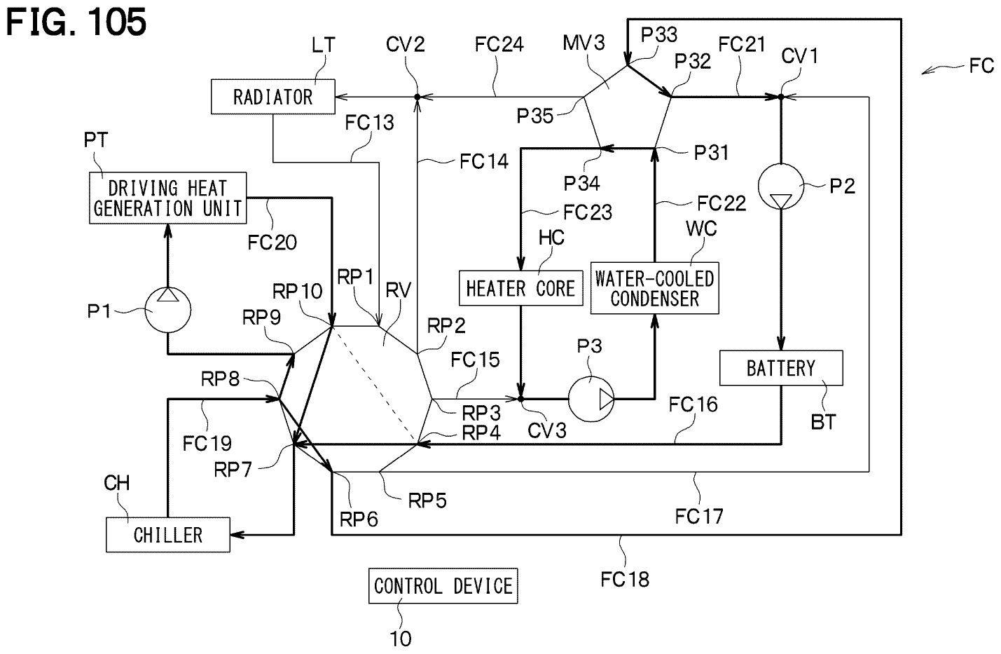

A flow of the coolant in the fluid circuit FC when the open and closed states of the coolant inlet and the coolant outlet of the fluid control valve RV are set in this manner will be described with reference to FIG. 105.

As described above, in the 3-5 mode, the fluid circuit system 1 allows the eighth opening RP8 to communicate with the sixth opening RP6 and the ninth opening RP9, allows the fourth opening RP4 to communicate with the seventh opening RP7, and allows the tenth opening RP10 to communicate with the seventh opening RP7. Accordingly, the fluid circuit system 1 can circulate the coolant through the RP9-RP10 flow path FC20, the RP7-RP8 flow path FC19, the RP6-P33 flow path FC18, the P32-CV1 flow path FC21, and the CV1-RP4 flow path FC16 by operating the first pump P1 and the second pump P2. The fluid circuit system 1 can guide the coolant to the driving heat generation unit PT, the battery BT, and the chiller CH.

The fluid circuit system 1 according to the present embodiment allows the fourth opening RP4 and the tenth opening RP10, which are the coolant inlet of the fluid control valve RV, to communicate with each other. Even in such a case, an outflow destination of the coolant flowing in from the fourth opening RP4 and an outflow destination of the coolant flowing in from the tenth opening RP10 are both the seventh opening RP7, so there is no problem.

Accordingly, as compared with a case where the fluid circuit system 1 is configured to close the unnecessary inlet and the unnecessary outlet of the fluid control valve RV when the temperature control device executes the five operation modes, restrictions on the fluid control valve RV can be reduced.

Specifically, it is possible to cope with the five operation modes of the temperature control device even without a configuration in which the unnecessary inlet and the unnecessary outlet of the fluid control valve RV are closed. As compared with the number of cells of the comparative valve CR40 for putting the fluid control valve RV in the closed configuration, the number of cells of the valve R40 according to the present embodiment can be reduced.

Therefore, when the outer diameter of the valve R40 is equal to the outer diameter of the comparative valve CR40, the size of the cell of the valve R40 in the valve circumferential direction DR3 can be larger than the size of the cell of the comparative valve CR40 in the valve circumferential direction DR3. Therefore, it is easy to make a size of the flow path of the first fluid passage R44a to the sixth fluid passage R44f formed in the valve R40 larger than a size of the flow path of the first comparative fluid passage CR44a to the tenth comparative fluid passage CR44k formed in the comparative valve CR40.

The fluid control valve RV having the valve R40 can increase the opening area of the first opening RP1 to the tenth opening RP10 as compared with the fluid control valve RV having the comparative valve CR40.

Therefore, the pressure loss that occurs when the coolant flows through the fluid control valve RV having the valve R40 can be made smaller than the pressure loss that occurs when the coolant flows through the fluid control valve RV having the comparative valve CR40.

Therefore, it is possible to reduce power consumption of the first pump P1, the second pump P2, and the third pump P3 that generate the flow of the fluid in the fluid circuit FC. Therefore, running cost of the entire fluid circuit system 1 can be reduced.

By reducing the pressure loss when the fluid flows through the fluid control valve RV, capacities of the first pump P1, the second pump P2, and the third pump P3 can be reduced. Therefore, initial cost of the entire fluid circuit system 1 can be reduced.

It is easy to reduce an increase in pressure loss when the coolant flows through the fluid control valve RV without increasing the outer diameter of the valve R40. Therefore, an increase in size of the housing of the fluid control valve RV itself due to an increase in size of the valve R40 can be avoided. In other words, by not necessarily closing the unnecessary inlet and the unnecessary outlet of the fluid control valve RV in the fluid circuit system 1, the fluid control valve RV can be easily downsized. Therefore, the production cost of the fluid control valve RV can be reduced, and the mountability of the fluid control valve RV can be improved.

### Other Embodiments

Although the representative embodiments of the present disclosure are described above, the present disclosure is not limited to the embodiments described above, and various modifications can be made, for example, as follows.

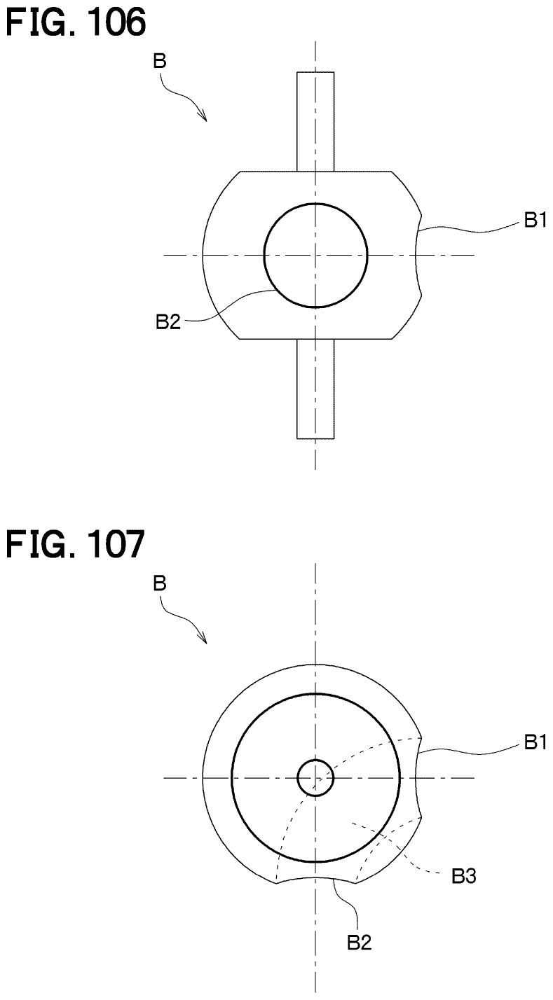

In the above-described embodiment, an example is described in which the first multi-way valve MV1 to the sixth multi-way valve MV6 are disk valve devices and the fluid control valve RV is a rotary valve device, but the present disclosure is not limited thereto. Any of the first multi-way valve MV1 to the sixth multi-way valve MV6 and the fluid control valve RV may adopt a ball valve device in which a spherical ball valve B illustrated in FIGS. 106 to 110 is accommodated in a housing (not illustrated). The ball valve device is a valve device that switches a flow of a fluid flowing through the fluid circuit FC by rotating the ball valve B, which is a valve member, to open and close an inlet for allowing the fluid to flow in and an outlet for allowing the fluid to flow out, which are formed in the housing (not illustrated).

As illustrated in FIGS. 106 and 107, the ball valve B may have a hollow shape having a fluid flow path B3 through which a fluid flows, and may have a configuration in which the fluid flows in the fluid flow path B3 from one inflow portion B1 toward one outflow portion B2. In this case, the ball valve device opens the inlet and the outlet formed in the housing by allowing the inflow portion B1 and the outflow portion B2 to communicate with the inlet and the outlet. In the ball valve device, the inflow portion B1 and the outflow portion B2 are positioned at positions not facing the inlet and the outlet formed in the housing, so that the fluid can be prohibited from flowing to an unnecessary inlet and an unnecessary outlet of another valve device provided in the fluid circuit system 1.

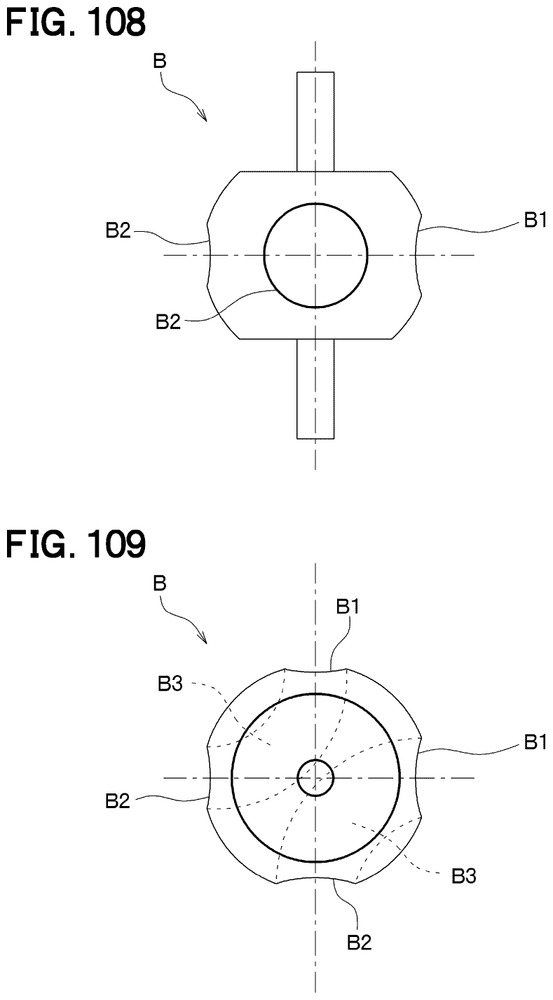

As illustrated in FIG. 108 and FIG. 109, the ball valve B may have a configuration in which two inflow portions B1 and two outflow portions B2 are provided and two fluid flow paths B3 are provided therein.

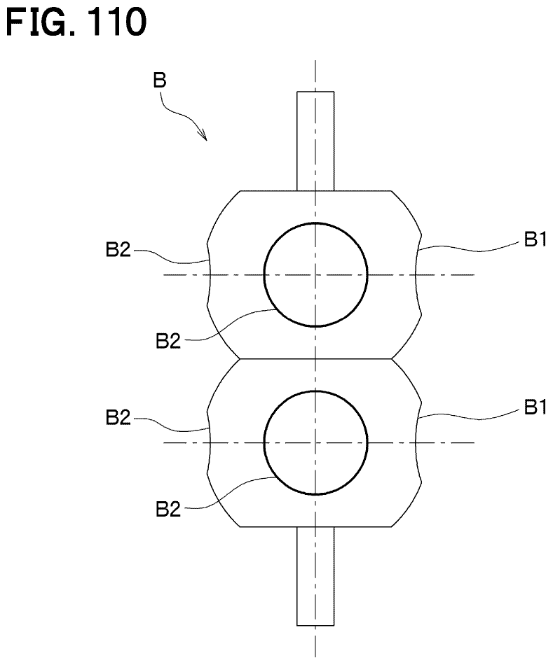

As illustrated in FIG. 110, the ball valve B may be implemented by connecting two spherical members in each of which the inflow portion B1 and the outflow portion B2 are formed.

In the above-described embodiment, an example is described in which the fluid flowing through the fluid circuit system 1 is coolant, but the present disclosure is not limited thereto. The fluid flowing through the fluid circuit system 1 may be, for example, a fluid other than coolant, such as gas or oil.

In the above-described embodiment, the example is described in which the fluid circuit system 1 is applied to a temperature control device mounted on an electric vehicle that is a vehicle, but the present disclosure is not limited thereto. For example, the fluid circuit system 1 may be applied to a vehicle having an internal combustion engine as power, a temperature control device used in a factory or a house, or the like.

In the above-described embodiment, the configuration is described in which the valve device has two or more coolant inlets and two or more coolant outlets, but the present disclosure is not limited thereto. For example, the valve device may have one coolant outlet as long as the valve device has two or more coolant inlets. The valve device may have one coolant inlet as long as the valve device has two or more coolant outlets.

In the embodiments described above, it is needless to say that the elements forming the embodiments are not necessarily essential except when those elements are clearly indicated to be essential in particular, when those elements are considered to be obviously essential in principle, and the like.

In the embodiments described above, when referring to the number, the numerical value, the amount, the range, and the like of the components of the embodiment, the present disclosure is not limited to a specific number of components of the embodiments, except when particularly noted as being essential, when limited to a specific number in principle, and the like.

In the embodiments described above, when referring to the shape, the positional relationship, and the like of the component and the like, the present disclosure is not limited to the shape, the positional relationship, and the like, except when particularly noted, when limited to a specific shape, a specific positional relationship in principle, and the like.

The control device 10 and a method therefor according to the present disclosure may be implemented with a dedicated computer provided by including a processor and a memory that are programmed to execute one or more functions embodied by a computer program. The control device 10 and the method therefor according to the present disclosure may be implemented with a dedicated computer provided by including a processor with one or more dedicated hardware logic circuits. The control device 10 and the method therefor according to the present disclosure may be implemented with one or more dedicated computers, each including a combination of a processor and a memory that are programmed to execute one or more functions and a processor formed of one or more hardware logic circuits. The computer program may be stored in a computer-readable non-transient tangible storage medium, as an instruction executed by a computer.

What is claimed is:

1. A fluid circuit system configured to guide fluid to a plurality of connection devices, the fluid circuit system comprising:
a fluid circuit configured to allow fluid to flow therethrough; and
a plurality of valve devices configured to switch flow of fluid through the fluid circuit, wherein
each of the valve devices includes
a housing defining an inlet for introducing fluid and an outlet for discharging fluid, and
a valve member accommodated inside the housing and configured to open and close the inlet and the outlet,
each of the valve devices has a multi-way valve structure defining inlets including the inlet and outlets including the outlet, and
each of the valve devices is switchable between
guiding fluid by the valve member to the connection device that requires fluid to flow and
prohibiting fluid by the valve member from flowing to the connection device that does not require fluid to flow, and
an unnecessary inlet is the inlet, which is connected to the connection device that does not require fluid to flow,
an unnecessary outlet is the outlet, which is connected to the connection device that does not require fluid to flow,
one of the valve devices, which is different from a predetermined valve device among the valve devices, is configured to close the inlet and the outlet to prohibit flow of fluid to the unnecessary inlet of the predetermined valve device in an open state and the unnecessary outlet of the predetermined valve device in the open state,
one of the valve devices, which is different from the predetermined valve device and provided in refrigerant flow on an upstream side of the unnecessary inlet in the open state, is configured to close the outlet to prohibit flow of fluid to the unnecessary inlet in the open state, and
one of the valve devices, which is different from the predetermined valve device and provided in refrigerant flow on a downstream side of the unnecessary outlet in the open state, is configured to close the inlet to prohibit flow of fluid to the unnecessary outlet in the open state.

2. The fluid circuit system according to claim 1, wherein
at least one of the unnecessary inlet and the unnecessary outlet has a constant communication structure that is not closed by the valve member.

3. The fluid circuit system according to claim 1, wherein
the valve devices are any one of or a combination of
disk valve devices each including the valve member that is rotatable and including a movable disk defining a hole to allow fluid to flow therethrough, and
rotary valve devices each including the valve member that is rotatable and including a tubular valve configured to open and close the inlet and the outlet according to a rotational position, and
ball valve devices including the valve member that is rotatable and including a spherical valve configured to open and close the inlet and the outlet according to a rotational position.
